(19) United States
(12) Patent Application Publication
(10) Pub. No.: US 2007/0256059 A1
(43) Pub. Date: Nov. 1, 2007

(54) Abstract platform to facilitate the interoperability of information

(76) Inventors: Suzanne Joy Sullivan, Mt. Albert (NZ); David Gray Hughes, Waiatarua (NZ); Adrian Laurence Meekings, Glenn Innes (NZ); Michael James Blyth, Whenuapai (NZ)

Correspondence Address: MCDERMOTT, WILL & EMERY LLP, 227 WEST MONROE STREET, CHICAGO, IL, 60606-5096, US

(21) Appl. No.: 11/542,265

(22) Filed: Oct. 2, 2006

Related U.S. Application Data
(60) Provisional application No. 60/722,896, filed on Sep. 30, 2005.

(51) Int. Cl. G06F 9/45

(52) U.S. Cl. 717/139; 717/148

(57) ABSTRACT

A universal virtual computer allows a homogeneous grid environment to be provided from a set of heterogeneous hosts. This is achieved by providing a common execution format through cross-compilation.

The present application claims priority to U.S. Provisional Patent Application No. 60/722,896, filed Sep. 30, 2005.

### TECHNICAL FIELD

This invention relates to grid computing and information technology. The invention has particular relevance to homogeneous environments for mobile agents that can lead to a distributed Operating System.

### BACKGROUND

Distributed computing has been deployed mostly in academic and scientific environments since the 1980s, however, it is only now with the massive connectivity of the Internet and the requirements for large processing that distributed computing has now matured into the grid. The concept of the grid is similar to that of an electricity provider, where users simply draw the amount of computational power they require from an effectively endless supply. There are many popular implementations of the grid such as the Globus Toolkit™.

As the number of computing systems and platforms has become more diverse, there has become a demand for a Universal Virtual Computer (UVC) that can support both computational content and a business platform. This need is driven primarily by a Universal Machine's incapacity for change. Therefore, a holistic approach that incorporates all generic functionality is desirable.

Historically, there has been an attempt to provide intermediate platforms or formats that can facilitate interoperability, including the HTML, which lacks computational completeness—but none of these goes far as the Universal Virtual Computer (UVC).

Adobe Acrobat™ by Adobe is an example of such a platform that aims to act as an intermediate format standard, through which other formats can be converted. Users can construct content on specialised software and then distribute content through the Acrobat constructed. Both these platforms, however, are not computationally complete, so they cannot emulate other processes or platforms. Specifically, these formats limit the type of content that can be represented. The Java Virtual Machine is an example of a platform that is computationally complete. The Java Virtual Machine can indeed act as an intermediate format via its property of computational completeness and not directly through any specific design characteristic that facilitates interoperability.

### OBJECT OF THE INVENTION

It is an object of the invention to provide a Universal Virtual Machine that overcomes or at least ameliorates disadvantages of existing machines, systems or methods. Alternatively, it is an object of the invention to provide a useful alternative to known machines, systems or methods.

### SUMMARY OF THE INVENTION

In one aspect the invention provides a Universal Virtual Computer (UVC) having means to produce a homogeneous grid environment from a set of heterogeneous hosts by enabling computational completeness via a common execution format.

In a preferred embodiment the common execution format can be simulated on any machine in the grid environment through cross-compilation.

The UVC may include means to support an Operating System that serves mobile agents that are able to transcode from hosts on a peer-to-peer network.

In another aspect the invention provides a Universal Virtual Computer comprising a memory store of Sets, a central processor that enables computational completeness and means to transmit instructions to a multitude of components to be completed asynchronously.

In yet another aspect the invention provides a UVC in a grid network including means to prevent undesirable hosts from joining the grid network, as directed by the Operating System.

The UVC is preferably capable of computational completeness and fully operational without extension.

The UVC may be extended such that some components allow for the compilation and execution of binaries designed for von Neumann processors.

The compilation and execution of binaries is preferably derived from an abstract set of machine instructions that can be reproduced on various von Neumann processors.

In a further aspect the invention provides a UVC where a first component processes instructions either synchronously or asynchronously so that synchronous instructions are completed immediately and asynchronous instructions are forwarded to one or more additional components to be completed in parallel while the first component completes further instructions.

In a still further aspect the invention provides a UVC that supports a plurality of mobile agents and assigns an account to each mobile agent, and means to add and/or deduct resources to or from the account upon purchase of resources.

Preferably the mobile agent is destroyed when the account has a null balance.

Multiple components that each provide a resource may be made available via a market orientated mechanism including but not limited to bandwidth, computation and memory.

A Realtime-Marketplace may be provided that allows mobile agents to purchase the resource for a specific time period and up to a limited level that is negotiated by the mobile agent prior to resource usage enabling the resource to be drawn on demand.

A Prepaid-Marketplace may be provided that allows mobile agents to reserve the resource at a required level for a specific time period, for which a price is determined prior to purchasing the resource.

The purchase can preferably be represented by the Universal Virtual Computer as an identifier to be sold in an open digital marketplace, later to be reclaimed by any mobile agent that presents the same identifier.

Alternatively or additionally the purchase can be represented by the Universal Virtual Computer as an identifier to be sold in an open digital marketplace, later to be reclaimed by any mobile agent that presents the same identifier.

The purchase can alternatively be represented by the Universal Virtual Computer as an identifier to be sold in an open digital marketplace, later to be reclaimed by any mobile agent that presents the same identifier.

Preferably, the capacity of the resource can be recharged at the discretion of the host environment.

The resource may be made available at a cost effective rate using a standby model where resource availability is erratic and distributed as the remainder after the Realtime-Marketplace has been satisfied.

Alternatively or additionally the resource can be made available at a cost effective rate using a standby model where resource availability is erratic and distributed as the remainder after the Prepaid-Marketplace has been satisfied.

Preferably, the resource can be made available at a more cost effective rate using an idle model where resource availability is not only erratic but can experience major lulls and distributed as the remainder after the Realtime-Marketplace and the Prepaid-Marketplace have been satisfied.

Preferably, the resource can be made available at the most cost effective rate for one or more marketplaces for the resource using a background model where resource availability is totally unreliable and is distributed as a remainder after all other marketplaces have been satisfied.

The purchase transaction may include a reimbursement price for which the mobile agent is willing to accept in exchange for the unexpected cancellation of either the purchase transaction as a realtime contract or as a prepaid contract.

Other aspects of the invention will be apparent from the following description.

The invention takes grid computing further by supporting heterogeneous environments and total security to enable an open grid that allows anyone to join—providing they can find a Node partner already on the network that will allow them to enter. The invention goes further than a traditional grid because it is not constrained by legacy components that expose vulnerabilities that result in a non-zero attack surface area. Instead, the invention offers a hardware platform (the III-Emulator at 551 of FIG. 3, 751 of FIG. 4, 951 of FIG. 5, 1151 of FIG. 6, 1351 of FIG. 7, 1551 of FIG. 8 and 17001 of FIG. 74) capable of supporting a distributed Operating System. The Interoperable Infrastructure (III) Model (refer to 12000 of FIG. 61 and 12200 of FIG. 62) was originally proposed by Dr Kay Fielden in a paper—Fielden, K. (2004). An Interoperable Information Infrastructure Model (III-Model). In J. Cooper & P. Swatman (Eds.), Proceedings of the 12th CollECTeR Workshop on eCommerce (CD-Rom ed.). Adelaide, Australia. Paper presented at the 12th CollECTeR Workshop on eCommerce, 7-8 May, Adelaide, Australia (hereinafter the Fielden paper).

In order to facilitate interoperability, the invention operates as a Universal Virtual Computer (UVC)—an essentially future proof platform that does not need to be altered and can represent any kind of information. (See “The UVC: a Method for Preserving Digital Documents—Proof of Concept” ISBN: 90-6259-157-4 by Ir. Raymond Lorie, December 2002, Copyright: IBM/Koninklijke Bibliotheek).

The III-Emulator is different to the Java Virtual Machine in that the III-Emulator aims to provide a homogenous Operating System where Java only provides a homogeneous platform. The homogeneous Operating System offers high-level governance functions to enforce compliancy of intellectual property rights. It offers the capacity to trace illegal money transactions and prevent the dissemination of stolen information. To enable the homogeneous Operating System, a mechanism to induce super-conductive transcoding (described further below) coupled with a method to enable software to operate with zero dependencies enables mobile agents to transcode seamlessly from Node to Node. The III-Emulator does not attempt to provide interoperability at a semantic level in the way that the XML Data Type Definition does, but rather at the level at which the data is encoded.

A homogeneous Operating System is a foundation requirement for the Interoperable Information Infrastructure (III) as it enables a coherent policy to be enforced across a distributed network. The III is a natural extension of the Global Information Infrastructure (GII), which is the framework that results from the need for information to be exchanged in an agreed and acceptable manner. It includes a collection of platforms, protocols and interfaces including the Internet, telephone and banking systems.

The GII has a number of problems including susceptibility to malicious attack, interoperability problems and sheer complexity for users. The invention can be applied to the GII to prevent these problems and migrate the GII to the Interoperable Information Infrastructure (III).

Thus the invention allows the very high level objectives proposed by Dr Fielden to be implemented in an actual III-Model (12000 of FIG. 61 and 12200 of FIG. 62). In reconfiguring the entire hardware architecture, Operating System and high level applications that manage grid activity, the opportunity has been taken to maximise the value when starting from a clean slate design. This issue is compounded by the fact that a Universal Virtual Computer (UVC) may not alter its design after its release. Although there is no direct compatibility (other than via emulation) with existing systems, this architecture is free to implement any mechanism that may produce value, not limited by the need for backward compatibility. The invention enables a plurality of heterogeneous environments to support mobile agents that can seamlessly transcode from one environment to another without undergoing unconstrained alteration of form. It is this homogeneous environment that maximises value through the form. The invention creates a homogeneous environment that maximises value through the simplification of digital economic activity.

The III-Model Candidate described herein is useful because it can be applied as a commercial trading environment capable of migrating the old economy into its digital future including the capacity to enforce license fees for certain rights (for example patent rights) in the old economy. Any high level governance is directed by the homogeneous Operating System. Individuals can utilise this grid to generate revenue from both hardware and intellectual property. Governments can tax all transactions and can issue directives from tracing money to banning undesirable content.

The invention allows seamless transcoding of mobile agents on a homogeneous Operating System. All functionality is fixed eternally and results in a Universal Virtual Computer (UVC). The invention is structured as two parts, one being absolutely defined and known as the III-Model (12000 of FIG. 61 and 12200 of FIG. 62) and the other being abstract and specifically undefined and is known as a 3IP (see 3IP-Interface at 17000 of FIG. 74). Since the 3IP is undefined it allows for various implementations to operate in parallel that results in an open grid platform with heterogeneous hosts, yet appears as an homogeneous environment for Digital Businesses (mobile agents). The invention is described functionally at a high level with sufficient detail to provide an absolute implementation, however, its deliberate avoidance of specificity enables its actual implementation can embody any form, provided that it adheres to the invention's requirements. The invention's combination of abstraction and functional description means that the implementation can take any physical form including quantum computing, magneto logic, biological computers, Field Programmable Gate Arrays (FPGA), traditional von Neumann architecture or dedicated circuits that are optimised for the implementation of the invention.

Model

The invention is embodied as a hardware platform that supports a Node (380, 395 of FIG. 2d and 200a-200e of FIG. 2a) on a grid network. The hardware platform is called the III-Emulator and can be simulated from other hardware or software platforms. Platforms occur at many points within information and computing systems including hardware, Operating System and applications. Platforms are useful in software because they provide a set of functions that applications can draw on. However, once a platform is established, it suffers from inflexibility because it becomes an interface and by its nature it can't change. Software on the newer version of the platform can't execute on older platforms. In a grid environment, this poses a serious problem as mobile agents are free to move from Node to Node and must be unencumbered in their execution.

Central to the III-Model's (12000 of FIG. 61 and 12200 of FIG. 62) ability to support a unified Operating System across a heterogeneous environment is its ability to allow Digital-Businesses (8800 of FIG. 45) to transcode across multiple platforms, retain its integrity and not grow in size with each transcode event. Digital-Businesses are capable of seamless transcoding because their shape or form is identical on each Node—hence the mandatory requirement that all properties for information on this Universal Virtual Computer (UVC) be fixed for eternity. Once Digital Businesses are free to move to any platform, they can be managed within an abstract Operating System that may ultimately also undergo transcoding during upgrades.

Without the III-Model, transcoding between platforms is a creative process because one platform format is mapped into another. The semantic characteristics of each platform are represented as data structures in each format. A problem arises when the structural symmetry for information context varies dynamically and requires intelligence to approximate a one to one mapping. There is no guarantee that an identical mapping can always be made. The III-Model (12000 of FIG. 61 and 12200 of FIG. 62) reduces the transcoding problem to a task of cross-compilation where the target platform utilises a set of machine instructions that can be substituted for combinations of instructions on the source platform in the event that they do not exist on the target platform. This is possible because the abstract 3IP component is required to conform to an idealistic von Neumann architecture by implementing the 3IP-Interface (17000 of FIG. 74). The implementation of the 3IP can define any number of instructions—provided that the instruction set enables computational completeness. Transcoding occurs at peer connections when Node (12010a, 12010b and 12010n of FIG. 61 and 12210a, 12210b, 12210n of FIG. 62) partners propagate Digital-Businesses between each other. In building the transcoder, each instruction in the source 3IP needs to be translated into one or more instructions in the target 3IP; or one or more instructions in the source 3IP is condensed into a single instruction in the target 3IP. By simply substituting instructions, an exact behavioural replica is fashioned. For example, if the source 3IP uses a floating point instruction that does not exist on the destination 3IP, then a series of instructions that simulate the behaviour of the floating point instruction must be produced on the target 3IP. Traditionally, cross compilers are unable to address the issue of seamless transcoding because they contain platform specific dependencies in the form of library calls. The III-Emulator has zero dependencies, so it can guarantee software behavioural integrity.

The invention is an abstract specification because it requires additional architecture that is not specified within this document in order to be actually implemented. The abstract specification allows different platforms to appear as if they are part of the homogenous grid, because the same behaviour can be modelled in a variety of ways.

FIG. 2b shows how a Digital-Business can cycle in a loop and not undergo continuous change of form as it moves through Nodes X, Y and Z.

In order for a platform to be part of the III-Model, the platform needs to structure itself to process information within a specific format, which is referred to in this document as a 3IP. The 3IP is non-restrictive because it allows the platform to be implemented physically in almost any way while logically enables it to describe any information in an identical way as all 3IPs do. The 3IP is therefore naturally both forwards and backwardly compatible because its format is fixed by the definition of the III-Model (12000 of FIG. 61 and 12200 of FIG. 62).

In order to implement the invention, a number of Nodes (380, 395 of FIG. 2d and 200a-200e of FIG. 2a) are required—each of them connected ad hoc in a peer-to-peer fashion. Each Node consists of an Interoperability Layer (101a of FIG. 1 and 202a of FIG. 2) and a Governance Layer (101b of FIG. 1 and 202b of FIG. 2a) with the Digital-Businesses (8800 of FIG. 45) operating from the Information Layer (202c of FIG. 2). Digital-Businesses are able to propagate from Node to Node along these partnership connections. The Governance Layer is the foundation of the homogenous Operating System.

The III-Model refers to the holistic system that emerges when a multitude of Interoperability Layers are configured with a suitable Governance Layer to operate as a grid network.

Dr Fielden's 4 Layered Model

The invention adheres to Dr Fielden's 4 layered model, as shown in FIG. 1. Layer 1 is the Host Platform Layer (101z of FIG. 1, 202z of FIG. 2a) is the host on which the Layer 2 or the Interoperability Layer (101a of FIG. 1 and 202a of FIG. 2a) executes. This can be hardware and/or software, the only requirement being that Layer 1 can execute or implement software and is therefore computationally complete. From a traditional ISO perspective Layer 1 can be thought of as consisting of the physical, data link, network and transport layers.

Layer 2 (Interoperability Layer) is implemented by the 3IP Model Candidate itself (the invention) and includes the 3IP and software required to transcode each 3IP it supports. The remaining architecture in Layer 3 that is the Governance Layer (101b of FIG. 1, 202b of FIG. 2a and 6475 of FIG. 33) and Layer 4 that is the Information Layer (101c of FIG. 1 and FIG. 2a) is virtual and is constructed entirely from within Layer 2 (Interoperability Layer) that represents the III-Model Candidate.

Layer 3 (Governance Layer) is infrastructure and is concerned with governance both legally and mechanically and has a function similar to that of an Operating System.

Layer 4 (Information Layer) is any information in the form of a Digital-Business (8800 of FIG. 45). All information that exists as a Digital-Business must communicate with the underlying infrastructure through the Governance Layer that enables the action to be meaningful in a legislated environment.

Functionality of the Invention

The III-Model (12200 of FIG. 62 and 12000 of FIG. 61) deployment reduces complexity and increases productivity through the use of a III-Model Candidate as described herein. Since all 3IPs (see 3IP-Interface at 17000 of FIG. 74) are bound to the architecture of the III-Model Candidate, it must provide adequate functionality to enable all information to be represented on the platform. It is desirable that core functionality is not stored in the 3IP since this cannot be transcoded to other platforms—where this functionality does not reside. The role of the 3IP is to provide computation by engaging the Host Platform (6840 of FIG. 35 and 7200 of FIG. 37). For example, a 3IP could be used to build a quantum computer, but this implementation would still represent information in a manner that is consistent with the III-Model Candidate.

In a preferred embodiment, the core mechanisms and emergent behaviour, when coupled with additional systems external to those referred to in this document are delivered by this III-Model Candidate as follows: —

Introspective Scope

All software is forced to execute at a level of scope as defined by Set Theory. This means that software is unable to affect other software for which it does not contain a reference. Mechanisms (such as the Reference Membrane as conceived by Dr Fielden) to enable software to communicate safely are beyond the scope of this document and are the function of the Governance Layer (see Appendix G for an explanation on the Kernel-Image that is derived from this patent).

Abstract Human Communication

The III-Model Candidate may not change over time as it is a Universal Virtual Computer (UVC). Therefore communication with people is structured in a form that is both forwardly and backwardly compatible. Communication with people is delivered to an abstract human body as a sensory experience. Returning information is encoded as a sensory perception, generated from an abstract human body. New sensory data can be added over time without effecting old Interoperability Layer devices and sensory resolution can be increased at any point.

Capacity for Trade

The Digital-Businesses (8800 of FIG. 45) are able to engage in trade with one another. The Interoperability Layer (101a of FIG. 1, 202a of FIG. 2a) enables a monetary platform backed on computational credits to enable Digital-Business to Digital-Business trading.

Governance-Layer Superstructure

Each Interoperability Layer device utilises an identical superstructure for the Governance Layer (101b of FIG. 1, 202b of FIG. 2a and 6475 of FIG. 33), therefore, the homogenous Operating System can operate on any 3IP (see 3IP-Interface at 17000 of FIG. 74) by utilising this universal structure.

Information Obtains Autonomy Across a Grid

Information located at the Information Layer (101c of FIG. 1 and 202c of FIG. 2a) is structured so that it takes the form of a Digital-Business and is free to migrate from Node to Node (200a-200e of FIG. 2a, 380 and 395 of FIG. 2d). It may duplicate itself any number of times and is able to easily communicate with any instance that it has created. Applications can therefore execute in parallel, but they need to be written to take advantage of this unique environment. Unlike conventional grids that are job orientated and take inputs to generate an output, the III-Model (12000 of FIG. 61 and 12200 of FIG. 62) grid endows each Digital-Business with a natural autonomy and persistence so that it may achieve immortality, providing that the Digital-Business has sufficient funds to pay for the resources it consumes.

Transcoding is illustrated in FIG. 2b. Referring to that Figure, the invention enables a Digital-Business to transcode from heterogeneous Nodes X (320 of FIG. 2b), Y (320 of FIG. 2b) and Z (325 of FIG. 2b) to take equivalent forms Digital-Business-Q1 (335 of FIG. 2b), Digital-Business-Q2 (340 of FIG. 2b) and Digital-Business-Q3 (345 of FIG. 2b) respectively. The Operating System itself can be transcoded in an identical way to produce a single abstract homogeneous Operating System.

Introspective Scope of Execution

The unique mathematics on which the invention operates is derived from Set Theory to provide total protection against attack. If the software is required to communicate with other software, it can utilise a mechanism defined by Dr Fielden known as a Reference-Membrane that takes place within the Governance Layer (101b of FIG. 1, 202b of FIG. 2a and 6475 of FIG. 33) and is beyond the scope of this document. Introspective scope of execution prevents software from accessing other software for which it does not contain a reference and is similar to traditional object orientation, except this property is exhibited by the hardware itself.

The Kernel-Image (see Appendix G for an explanation on the Kernel-Image that is derived from this patent) has only one instruction to obtain a new reference—known as Get-Child, which retrieves a specified Child Set from within a Parent Set. There is absolutely no instruction to retrieve the reference to a Parent Set—even though these Sets may exist privately and in plurality in the Kernel-Image.

Generates Revenue from Hardware

This III-Model Candidate forces all Digital-Businesses (8800 of FIG. 45) to pay for the resource they consume. This drives software into an economic framework where it is financially accountable for its behaviour. There are numerous resources on the III-Emulator, some of which include:—
Mass storage, such as a hard disk
Fast storage, such as memory
Computational process for which there are multiple forms that may be handled by different dedicated circuits
Bandwidth connectivity with adjacent Nodes (200a-200e of FIG. 2a, 380, 395 of FIG. 2d).
Electrical power trading with adjacent Nodes.

Referring to FIG. 2d, it can be seen that the majority of resources are stored on the Node, but power transmission and bandwidth are shared between Node partners (12010a, 12010b, 12010n of FIG. 61 and 12210a, 12210b, 12210n of FIG. 62).

Forward and Backwardly Compatible

This III-Model Candidate enables forward and backward compatibility by preventing the Interoperability Layer (101a of FIG. 1 and 202a of FIG. 2a) from changing throughout its life and by providing sufficient functionality to manage any mandatory changes at a platform level. Forward and backward compatibility is achieved because the functional architecture of the invention is fixed so new software can execute on old III-Emulators and old software can execute on new III-Emulators.

Device Independence

The Interoperability Layer (101a of FIG. 1, 202a of FIG. 2a) can be compiled for any Host Platform (6840 of FIG. 35 and 7200 of FIG. 37) with sufficient resource and can run software. Digital-Businesses (8800 of FIG. 45) operate in mechanically identical ways on an identical Interoperability Layer no matter what the underlying Host Platform is, in a similar way that Java and .Net do through machine emulation.

Avoids the Von Neumann Bottleneck

The architecture is optimised for a hardware implementation where processes can execute in parallel on multiple components in the III-Emulator.

Real-Time Platform

Digital-Businesses are able to reserve resource in order to obtain guaranteed availability. They can also reserve real-time resource capacity to manage unpredictable demand.

Architecture

The invention is an abstract specification designed to provide an optimised implementation in hardware, specifically to avoid the von Neumann Bottleneck but also to provide sufficient degrees of freedom to implement with a wide range of hardware solutions. However, the invention is only a small part of the full deployment. The invention contains multiple independent circuits that can execute in parallel and are known as Emulator-Components. The components and data flows are shown in further detail in FIGS. 3-8.

In the preferred embodiment there are 12 Emulator-Components:—

Kernel-Image

The Kernel-Image (see Appendix G for an explanation on the Kernel-Image that is derived from this patent) is responsible for storing the state information for everything on the Node including the Governance Layer (101b of FIG. 1, 202b of FIG. 2a and 6475 of FIG. 33) and every Digital-Business (8800 of FIG. 45). It acts as a storage of Sets and does not include network connectivity, disk storage or memory storage of binary files.

UPT-Cycler

The UPT-Cycler (1470 of FIG. 8 and 1600 of FIG. 9) is a component responsible for the Primary-Dataflow and computational completeness. The UPT-Cycler engages the other Emulator-Components to achieve parallel execution in hardware. The UPT-Cycler processes each instruction immediately and in parallel with other instructions. If an instruction is unable to be completed in a single iteration known as a Digital-Business-Cycle (DBC), then it is considered asynchronous and is handed over to another dedicated Emulator-Component.

Fast-ABS

The Fast-ABS (6000 of FIG. 31) manages the storage and retrieval of binary data at a high speed and presumably high cost through cache or memory. Binary data can be transferred to the Slow-ABS (5800 of FIG. 30) by the ABS-Bus (6200 of FIG. 32). The Fast-ABS communicates with the 3IP-AVM (17200 of FIG. 75), 3IP-AVMF-Verifier (17025 of FIG. 74 and 23000 of FIG. 91), Human-Communication-Manager (700 of FIG. 4 and 900 of FIG. 5), the Plugin-Manager (7600 of FIG. 39) and the ABS-Bus (6200 of FIG. 32).

Slow-ABS

The Slow-ABS is identical to the Fast-ABS except it manages slow binary data either across disk or network storage. The Slow-ABS communicates with the Environment-Manager (710 of FIG. 4), the Partner-Channel-Manager (13000 of FIG. 66), the Plugin-Manager and the ABS-Bus.

ABS-Bus

The ABS-Bus allows binary data to the transferred between the Slow-ABS and the Fast-ABS.

Partner-Channel-Manager

The Partner-Channel-Manager manages communication between adjacent Nodes on the grid network. Digital-Businesses (8800 of FIG. 45) can migrate to Peer Nodes using this component and are reconstructed within the Kernel-Image (see Appendix G) of the adjacent Node.

Human-Communication-Manager

The Human-Communication-Manager (see Appendix F) interfaces with people through display equipment on Nodes. The Human-Communication-Manager delivers a logical format known as a Mesh-Blueprint that delivers a sensory experience and receives a sensory perception to and from the user.

Environment-Manager

The Environment-Manager (710 of FIG. 4) probes the underlying host platform (6840 of FIG. 35 and 7200 of FIG. 37) to provide—amongst many things:
1) Critical performance data to the Governance Layer (101b of FIG. 1, 202b of FIG. 2a and 6475 of FIG. 33) so that the real-time properties of the Interoperability Layer (101a of FIG. 1 and 202a of FIG. 2a) may be maintained.
2) Timing signals from the system clock.
   Asynchronous-Duplicator

The Asynchronous-Duplicator (440 of FIG. 3) manages the duplication of Sets so as not to overload the UPT-Cycler (1470 of FIG. 8 and 1600 of FIG. 9).

Plugin-Manager

The Plugin-Manager (7600 of FIG. 39) provides an opportunity for 3IP (see 3IP-Interface at 17000 of FIG. 74) developers to integrate specialised hardware into the invention and still maintain absolute security by preventing references from being exchanged with components that are not trusted that are developed by third parties.

Asynchronous-Virtual-Machine-Queuer

The Asynchronous-Virtual-Machine-Queuer (410 of FIG. 3) acts as a store for precompiled jobs that are ready to execute in the 3IP-AVM (17200 of FIG. 75) of the 3IP-Interface (17000 of FIG. 74).

Asynchronous-Virtual-Machine-Queuer

The Asynchronous-Virtual-Machine-Queuer (410 of FIG. 3) acts as a store for precompiled jobs that are ready to execute in the 3IP-AVM (17200 of FIG. 75) of the 3IP-Interface (17000 of FIG. 74).

AVMF-Verify-Queuer

The AVMF-Verify-Queuer (490 of FIG. 3) acts as a store for unverified executable jobs that are ready to be verified in the 3IP-AVMF-Verifier (17025 of FIG. 74 and 23000 of FIG. 91) of the 3IP-Interface (17000 of FIG. 74).

3IP-AVM

The 3IP-AVM (17200 of FIG. 75) provides an opportunity for efficient execution utilising the von Neumann architecture under a closed scope to guarantee security.

3IP-AVMF-Verifier

The 3IP-AVMF-Verifier (17025 of FIG. 74 and 23000 of FIG. 91) ensures that jobs destined for the 3IP-AVM are of the correct form and adhere to the Asynchronous-Virtual-Machine-Format or AVMF (see Appendix E).

### BRIEF DESCRIPTION OF THE DRAWINGS

An embodiment of the invention will be described further below by way of example with reference to the drawings. Attached hereto as Appendix H is a description of the conventions used in the Figures.

FIG. 1 shows the invention—the Interoperability Layer (110a)—an abstract platform in the context of an exemplary deployment as sandwiched between the Governance Layer (101b) and the Host Platform Layer (101z). However, the Host Platform Layer (101z and 202z of FIG. 2a) can be avoided if the invention is implemented directly in hardware. The stack is shown as an isolated unit as it conforms to the 4-layered model proposed by Dr Fielden with the function of each layer summarised. This stack is unengaged to the peer-to-peer network.

FIG. 2b shows a Digital-Business (8800 of FIG. 45) as it moves in a loop where it exists in states Digital-Business-Q1 (335), Digital-Business-Q2 (340) and Digital-Business-Q3 (345). The III-Model Candidate ensures that the Digital-Business can transcode in form from one Node (310, 320 and 325) to another endlessly in a super-conductive fashion without increasing in size with each loop or degrading the integrity of its logical behaviour.

FIG. 2d shows the high level behaviour of a Node (380) and its connectivity to other Node Partners (395). Nodes can transmit bandwidth (385) and electricity (390) to each other—via the Partner-Channel-Manager (13000 of FIG. 66). Other resources—Plugin-Customised-Transmission (396)—can also be transmitted via the Plugin-Manager (7600 of FIG. 39) involving continuous delivery such as oil or water or quantum delivery such as rail.

FIG. 3 shows the Primary-Dataflow of the invention as the UPT-Cycler (470) passes instructions to the Asynchronous-Duplicator (440), Asynchronous-Virtual-Machine-Queuer (410), ABS-Bus (420) and AVMF-Verify-Queuer (490). Each Emulator-Component is able to process tasks asynchronously. The UPT-Cycler attempts to process all instructions from a Digital-Business (8800 of FIG. 45) stack immediately, but some—such as a recursive copy—have an unknown processing requirement and must be performed asynchronously. These asynchronous tasks that are generated by the UPT-Cycler (1600 of FIG. 9 and 1470 of FIG. 8) are sent to the appropriate Emulator-Components (FIGS. 3-8) across a bus known as the UPT-Execution-Interface (475 of FIG. 3 and FIG. 84).

FIG. 4 shows the KI-Dataflow that operates buses to a number of Emulator-Components that are connected to the Kernel-Image (680). Each bus presents the KI-Interface (685 of FIG. 4 and FIG. 94) these Emulator-Components include the ABS-Bus (620), Partner-Channel-Manager (630), Asynchronous-Duplicator (640), 3IP-AVM (760), Fast-ABS (650), Human-Communication-Manager (700), Environment-Manager (710), UPT-Cycler (670) and Plugin-Manager (720). The KI-Interface (see FIG. 94 and Appendix C) enables access to the collection of sets inside the Kernel-Image (see Appendix G), while ensuring that scope protection is preserved at a hardware level. This means that sets are unable to locate their Parents, but can modify any of their Children. Although each Emulator-Component with KI-Interface access is treated at the same level of trust as the Kernel-Image itself, the protection offered is absolute and circumvents accidental coding or engineering errors. This scope protection propagates up the stack and can be relied upon by Digital-Businesses (8800 of FIG. 45) that prevents any form of malware.

FIG. 5 shows the ABS-Dataflow that enables 64-bit blocks of data of logically unlimited length to be transferred across multiple buses to various Emulator-Components (FIGS. 3-8). The ABS-Dataflow contains both a high speed and a low speed type of bus. The high speed bus transmits 64-bit blocks between the Fast-ABS (6000 of FIG. 31) and the 3IP-AVM (960), ABS-Bus (820), 3IP-AVMF-Verifier (970), Human-Communication-Manager (900) and Plugin-Manager (920). The low speed bus transmits 64-bit blocks between the Slow-ABS and the Partner-Channel-Manager (830), ABS-Bus (820), Environment-Manager (910) and Plugin-Manager (920). Both the high speed and low speed bus use the same logical access mechanism known as the ABS-Interface (855 and 865).

FIG. 6 shows the IO-Dataflow that involves information entering and leaving the invention. Each data stream operates physically on its own bus and utilises its own logical communications protocol. The UPT-Cycler (1070) utilises the Permanent-Storage-A (1130f), which is undefined and can represent anything from a hard drive to a network connection. The Partner-Channel-Manager (1030) utilises the PCM-Interface (1130a) that enables connections to multiple Node Partners (12010a, 12010b, 12010n of FIG. 61 and 12210a, 12210b, 12210n of FIG. 62). The PCM-Interface (130125 of FIG. 66) has its behaviour defined as an interface definition (see Appendix C), but its actual implementation is abstract and so is undefined—enabling it to be implemented across any transport layer. The Human-Communication-Manager (1100) receives sensory perception data and transmits sensory experience data to the display equipment (see Human-Communication-Manager). The Environment-Manager (1110) receives data from the Host Platform Layer (101z of FIG. 1 and 202z of FIG. 2a) in an implementation specific manner and so is undefined. The Plugin-Manager (1120) receives data from the individual Plugins via the Plugin-Farm (7660 of FIG. 39) as well as any power or physically transmitted material involved in the Plugin-Customised-Transmission (396 of FIG. 2d)

FIG. 7 shows the start up sequence for the invention. The UPT-Cycler (1270) assumes the role as the start up co-ordinator and engages the invention in 2 stages. Stage 1 involves priming the Kernel-Image (1280) so that other Emulator-Components (FIGS. 3-8) can utilise it during their start up routines. Stage 2 involves starting all the other Emulator-Components and ends with the UPT-Cycler starting itself so as to provide computation for Digital-Businesses (8800 of FIG. 45).

FIG. 8 shows the Event-Triggered-Dataflow where events are generated by the Kernel Image (see Appendix G) when they have been previously set up by software executing via the UPT-Cycler (1470 of FIG. 8 and 1600 of FIG. 9). There are 2 types of events. The first simply executes additional software inside the UPT-Cycler and the second transmits the event to a physical Emulator-Component including: Asynchronous-Virtual-Machine-Queuer (1410), Partner-Channel-Manager (1430), Asynchronous-Duplicator (1440), ABS-Bus (1420), AVMF-Verify-Queuer (1490), Human-Communication-Manager (1500), Environment-Manager (1510) and Plugin-Manager (1520).

FIG. 9 shows the UPT-Cycler (1600), which provides access to computation for Digital-Business (8800 of FIG. 45) residing in the Information Layer (101c of FIG. 1) as well as software executing in the Governance Layer (101b of FIG. 1, 202b of FIG. 2a and 6475 of FIG. 33). The UPT-Cycler manages the start up sequence of the invention and continues executing once this is completed. The UPT-Cycler also manages the shutdown sequence. During its operation, the UPT-Cycler will transmit events to various Emulator-Components (FIGS. 3-8) or execute additional software that has been triggered by these events. The UPT-Cycler utilises a high priority bus to the Kernel-Image (1690) to optimise its processing.

FIG. 10 shows the KI-Switcher (1800) that operates as the core processor of the UPT-Cycler to process Digital-Business-Cycles. The KI-Switcher contains a Digital-Business-Selector (1810) and numerous Item-Processors (1820, 1830 and 1840). The Digital-Business-Selector determines which Digital-Businesses are to be processed in a manner that is consistent with the Resource-Model. The Item-Processors (2480a, 2480b, 2480n of FIG. 13) process a single UPT either immediately; or over a number of iterations if the operation cannot be completed in a single Digital-Business-Cycle.

FIG. 13 shows the Digital-Business-Selector (2400 and 1810 of FIG. 10) that is responsible for determining which Digital-Business to process. The Digital-Business-Selector provides a new Digital-Business Cursor-Identification (2490) each time it receives the Item-Processor-Notification (2470). The Digital-Business-Selector ensures that the marketplaces are satisfied in the following order: Realtime, Prepaid, Standby, Idle and Background as per the Resource-Model. It ensures that each Digital-Business is assigned to the same Item-Processor so as to prevent the need to swap sets from one Isolated-Memory-Segment (9600a, 9600b, 9600c and 9600n of FIG. 49) to another in the Kernel-Image (see Appendix G), where each Isolated-Memory-Segment may serve a single KI-Interface bus.

FIG. 27 shows the structure of a Monitor (5200) that is a mechanism whereby software can be made aware of changes to specific Children. Monitors can be set by Emulator-Components (FIGS. 3-8), in which case the Type of the ET-Instance (5220) will be of Type-Emulator-Component (see Appendix A) and the Whole and Float values of the ET-Instance are used to indicate which event triggered the Monitor. Otherwise the ET-Instance is the Thread-Instance (10485a, 10485b, 10485n of FIG. 53 and 10600 of FIG. 54), which holds five Stacks on which the UPTs held in the DB-Event (5230) will be processed. Monitors may be processed in parallel therefore each MG-Capture-Instance (5295) in the Event-Parameters-List (5295) are the Event-Parameters that represent the state of the Parent at the time the Monitor was triggered. See Appendix G for explanation of Monitors.

FIG. 30 shows the Slow-ABS (5800) that operates as an abstract mass storage mechanism, probably utilising a hard disk or network for physical storage during implementation and is known as Permanent-Storage-B (5805). The Slow-ABS has 4 buses that each use the ABS-Interface (5820) that connect to the ABS-Bus (5830), Partner-Channel-Manager (5840), Environment Manager (5850) and Plugin-Manager (5855).

FIG. 31 shows the Fast-ABS (6000) that operates as a fast and transient store of data. It differs from the Slow-ABS (5800 of FIG. 30) in that the data store is on board the Fast-ABS, Emulator-Component (FIGS. 3-8) and is known as the Fast-ABS-Store (6011). The Fast-ABS communicates with 4 buses using the ABS-Interface (6020) to the 3IP-AVM (17200 of FIG. 75), the Human-Communication-Manager (6060), the AVMF-Verifier (6040) and the ABS-Bus (6050).

FIG. 32 shows the ABS-Bus (6200) as it operates as a fast bus between the Fast-ABS (6000 of FIG. 31) and the Slow-ABS (5800 of FIG. 30). The ABS-Bus enables 64-bit data blocks to be transferred directly from Fast-ABS to Slow-ABS and vice versa.

FIG. 33 shows the Powerset (6400) in the Kernel-Image (Appendix G), which is the outermost set in the universe and can be accessed with the KI-Interface (FIG. 94 and Appendix C) instruction Get-Powerset. The Powerset contains the Governance-Layer-Superstructure (6410) as its immediate Child for security reasons the Governance-Layer-Superstructure operates as the Governance Layer (101b of FIG. 1, 202b of FIG. 2a, 6475 of FIG. 33) in Dr Fielden's 4 Layered III-Model.

FIG. 34 shows the Governance-Boot-Instance (6600a) that is the first executable code to be launched during the boot up of the III-Emulator. The Governance-Boot-Instance has access to the Governance-Layer-Superstructure (6615 of FIG. 34 and 6410 of FIG. 33), so as to gain full access to the Governance Layer (101b of FIG. 1, 202b of FIG. 2a, 6475 of FIG. 33).

FIG. 35 shows the Global-Static-Store (6800) that is a reference used by the Governance Layer to store shared information that it generates for multiple Digital-Businesses. The Global-Static-Store (also 6440 of FIG. 33) is part of the Governance-Layer-Superstructure (6410 of FIG. 33). Data moving through the KI-Interface with references in the Global-Static-Store are forced to utilise the Backplane-Bus (see Appendix G—2900 of FIG. G1) so as to escape the Isolated-Memory-Segment (9600a, 9600b, 9600c and 9600n of FIG. 49) associated with each Digital-Business (8800 of FIG. 45). The Global-Static-Store operates as an access point between the Interoperability Layer (101a of FIG. 1 and 202a of FIG. 2a) and the Governance Layer (101b of FIG. 1, 202b of FIG. 2a, 6475 of FIG. 33).

FIG. 36 shows the Transport (7010), which is a Child of the Global-Static-Store. The Transport enables communication between Digital-Businesses on Node partners through the Governance Layer.

FIG. 37 shows the Host Platform (7200 of FIG. 37 and 6840 of FIG. 35) of the Global-Static-Store (6800 of FIG. 35 and 6440 of FIG. 33) that stores data related to the platform hardware.

FIG. 38 shows the Plugin-Powerset (7400 of FIG. 38 and 6858 of FIG. 35) as provided by the Plugin-Manager (7600 of FIG. 39) when a new connection is made to a Plugin. The Governance Layer (101b of FIG. 1, 202b of FIG. 2a and 6475 of FIG. 33) inserts the ILI-Plugin-Instance (7410 of FIG. 38 and 6859 of FIG. 35) to enable the authorisation of the Plugin (7665a, 7665b and 7665n of FIG. 39) on behalf of a Digital-Business (8800 of FIG. 45).

FIG. 39 shows the Plugin-Manager (7600) that enables the III-Emulator to accept new Plugin components without compromising the security of the III-Emulator. This is useful, because third parties may develop Plugins without risk of undermining the integrity of the III-Emulator. It is not necessary to verify Plugin integrity as all references that are utilised inside the Plugin-Powerset (6858 of FIG. 35 and 7400 of FIG. 38) are translated into a closed set of handles for the actual Plugin hardware available in the Plugin-Farm (7660).

FIG. 41 shows the Digital-Business-Execution-Sequence (8000 of FIG. 41 and 6810 of FIG. 35) that is used by the Digital-Business-Selector (2400 of FIG. 13 and 1810 of FIG. 10) to determine the next Digital-Business (8800 of FIG. 45) to process (see Digital-Business-Selector) by the Item-Processor (1840, 1830 and 1820 of FIG. 10).

FIG. 42 shows the Realtime-Sequence (8200) that is a Child of the Digital-Business-Execution-Sequence (6810 of FIG. 35 and 8000 of FIG. 41). The Realtime-Sequence allows Digital-Businesses (8800 of FIG. 45) with an RCS-Item (8235a, 8235b and 8235n of FIG. 42) in the Realtime-Computation-Schedule (8220 of FIG. 42) to receive priority processing ahead of all other Digital-Businesses.

FIG. 43 shows the Prepaid-Sequence (8400) that is a Child of the Digital-Business-Execution-Sequence (6810 of FIG. 35 and 8000 of FIG. 41). The Prepaid-Sequence allows Digital-Businesses (8800 of FIG. 45) with PCS-Items (8435a, 8435b, 8435n of FIG. 43) in the Prepaid-Computation-Schedule (8420 of FIG. 43) to receive priority processing ahead of all other Digital-Businesses, once the Digital-Businesses in the Realtime-Sequence (8200 of FIG. 42) have been processed.

FIG. 44 shows the PCS-Item (8600a and 8600b) and the RCS-Item (8700a and 8700b) as used by the UPT-Cycler's (1470 of FIG. 8 and 1600 of FIG. 9) Digital-Business-Selector (1810 of FIG. 10 and 2400 of FIG. 13) to determine the next Digital-Business (8800 of FIG. 45) to receive computation. The PCS-Item shows the detail on the PI-Prepaid-Release (8630a and 8630b) that enables a PCS-Item to be deleted from its schedule, regardless of where it is located in the schedule.

FIG. 45 shows a Digital Business (8800) that operates as a mobile-agent on a Node (200a-200e of FIG. 2a, 380 and 395 of FIG. 2d). A Digital-Business is characterised by being an isolated unit of software that is unable to be affected by other Digital-Businesses on the same Node, either directly by reference modification or indirectly through resource fluctuation induced by massive consumption by other Digital-Businesses. A Digital-Business contains an entire copy of the Governance Layer (101b of FIG. 1, 202b of FIG. 2a and 6475 of FIG. 33) so as to enable parallel execution when implemented in a Field Programmable Gate Array (FPGA) fabric. Digital-Businesses have their own bank account represented by the Bank-Account-Field (8890 of FIG. 45) and are removed from the Node once they become insolvent. Digital-Businesses are able to propagate from Node to Node.

FIG. 47 shows the DB-Resource-Release (9200) that is used by the Item-Processor (2480a, 2480b and 2480n of FIG. 13) to remove RCS-Items (8700a and 8700b of FIG. 44) in the Realtime-Computation-Schedule (9240 of FIG. 47 and 8220 of FIG. 42) and Digital-Businesses (9255, 9265 of FIG. 47 and 8800 of FIG. 45) from the Standby-Computation-Schedule (9250 of FIG. 47 and 8040 of FIG. 41) and the Idle-Computation-Schedule (9260 of FIG. 47 and 8050 of FIG. 41) when the Stacks (10610, 10620, 10630, 10640 and 10650 of FIG. 54) are empty. These items are removed from the schedule regardless of their location.

FIG. 48 shows the DB-Execution (9400) that forms part of the Digital-Business (8800 of FIG. 45) that contains all runtime information for the Digital-Business. The behaviour of the Digital-Business is determined by the Design-Time-Execution (9420) while the Operating System support is provided in the Governance-Execution (9430). The Super-Stacks (9410) are used to process Monitors (5200). The Activity-Status-Field (9440) is used to lock the Digital-Business. The Realtime-Reservation (9450) manages on-demand supplier resource. The Maximum-Volume (9460) specifies the maximum amount of resource this Digital-Business can obtain.

FIG. 49 shows how an individual Digital-Business (8800 of FIG. 45) is allocated to a single Isolated-Memory-Segment (9600a, 9600b, 9600c, 9600n) in the Kernel-Image (see Appendix G). The Digital-Business-Selector (1810 of FIG. 10 and 2400 of FIG. 13) ensures that the same Item-Processor (1820, 1830, 1840 of FIG. 10) manages a single Digital-Business. Each Item-Processor has access to a single Isolated-Memory-Segment so as to allows execution in parallel.

FIG. 50 shows the DTE-Instance (9800a) that manages the behaviour of the Digital-Business (8800 of FIG. 45) and is the result of the design-time compilation of the Digital-Business source code. The DTE-Instance is likely to have a reference to itself (9800b) so that it can access the DB-Data (9845) that operates as an onboard hard drive or permanent storage. The Governance-Layer-Interface-Field (9810) contains a reference to the Governance-Layer-Interface (9815) that enables the Digital-Business to communicate with the Governance Layer (101b of FIG. 1, 202b of FIG. 2a and 6475 of FIG. 33). The DTE-Boot-Drop-Field (9820) contains the Boot-Drop-Instance (9825 and see FIG. 52 below) that contains five Children that determine the point of entry for this Digital-Business once it is loaded from Permanent-Storage-A (1130f of FIG. 6 and 1700 of FIG. 9) by the UPT-Cycler (1470 of FIG. 8 and 1600 of FIG. 9). The Active-Thread (9830) contains the runtime component of the DTE-Instance and the DB-Boot-Field (9850) contains Object-Orientated support in the Boot-Data-Set (9855) for parameters during propagation across Nodes (200a-200e of FIG. 2a, 380 and 395 of FIG. 2d).

FIG. 51 shows the GE-Instance (10000a) that manages the Operating System that services requests for a single DTE-Instance (9800a of FIG. 50). The Governance-Layer-Superstructure-Field (10010) contains a reference to the Governance-Layer-Superstructure (10015) that enables the Operating System to access everything below the Powerset (6400 of FIG. 33) including the entire Governance-Layer (6475 of FIG. 33). The Global-Static-Store-Field (10020) contains a reference to the Global-Static-Store (6440 of FIG. 33, 6800 of FIG. 35 and 10025 of FIG. 51) that stores shared information across all GE-Instances running on the Node. The Every-Digital-Business-Spawned-Field (10030) contains a reference to the Every-Digital-Business-Spawn (10035) that is a spawned Cursor to this executing Digital-Business inside Every-Digital-Business (6450 of FIG. 33) to enable the GE-Instance to know which Digital-Business it must service. The GE-Boot-Drop-Field (10040) contains the Boot-Drop-Instance (see FIG. 52 below) that determines the entry points for the Governance Layer (101b of FIG. 1, 202b of FIG. 2a) execution.

FIG. 52 shows the Boot-Drop-Instance (10200) that contains five entry points for either the DTE-Instance (9800a and 9800b of FIG. 50) or the GE-Instance (10000a and 10000b of FIG. 51). Each entry point is a Universal-Process-Type or UPT (see Appendix B) that when placed on the Stack will begin execution. The five stacks represent five marketplaces as conforming to the Resource-Model (see Resource-Model). The BDI-Realtime-Field (10210) contains a UPT for the realtime stack. The BDI-Prepaid-Field (10220) contains a UPT for the prepaid stack. The BDI-Standby-Field (10230) contains a UPT for the standby stack. The BDI-Idle-Field (10240) contains a UPT for the idle stack. The BDI-Background-Field (10250) contains a UPT for the background stack.

FIG. 53 shows the Thread-Group (10400) as found in the Active-Thread (10050 of FIG. 51 and 9830 of FIG. 50) of either the GE-Instance (10000a of FIG. 51) or the DTE-Instance (9800a of FIG. 50). The Active-Thread determines the execution configuration for either the GE-Instance or DTE-Instance structure. By shifting the Cursor in the Active-Thread, a different Thread-Group is selected to receive all the computational power. The Thread-Group itself contains the Active-Stacks (10410) or the Threads (10420). The Threads contains a Thread-List (10480) that lists clusters of threads of execution within the DTE-Instance or GE-Instance structure. The Active-Stacks contains spawned references to the threads to enable processing to be distributed quickly according to the Resource-Model (see Resource-Model).

FIG. 54 shows the Thread-Instance (10600) as 5 threads of execution and is found in either one of the Active-Stacks (10410 of FIG. 53) or as listed in the Thread-List (10480 of FIG. 53). The Thread-Instance contains five stacks as per the Resource-Model (see Resource-Model). Each stack contains a series of UPTs that represents the state of computation and represents a single Thread of execution.

FIG. 55 shows the UPT-Method (10800 and see Appendix B) that is responsible for the creation of a method frame. Each method frame is able to access software delivered by the Startup-UPT (11336 of FIG. 58) of the Method-Call-Item (11326 of FIG. 58 and 10830 of FIG. 55). Software is executed from the Pseudo-Stack (10880), which operates as a normal stack. However, when a Value inside a Field contains a type of Type-Inputs-Field, Type-Locals-Field, Type-Outputs-Field, Type-Global-Field or Type-Static-Field (see Appendix A), then the UPT-Method ensures that the actual value for this variable is looked up from within the method frame. This mechanism splits the Data Segment (DS) and Code Segment (CS).

FIG. 56 shows the Boot-Data-Set (11000) that is inserted into the DB-Boot-Field (9850 of FIG. 50) during Digital-Business (8800 of FIG. 45) propagation via the Partner-Channel-Manager (13000 of FIG. 66). The Boot-Data-Set contains a list of unlinked Object Orientated classes in the Unlinked-Class-List (11010). It is responsibility of software executing in the Boot-Drop-Instance (9820 of FIG. 50 and 10200 of FIG. 52) to link and execute software contained in the Unlinked-Class-List (11010). The Type-Of-Boot-Field (11035) will indicate if this is a DTE-Instance (9800a of FIG. 50) or GE-Instance (10000a of FIG. 51) boot. The Parameter-Field (11045) contains any additional parameters to be used during booting.

FIG. 57 shows the Variable-Definitions (11200) that are used in the separation of the Code Segment and the Data Segment when creating a method frame for use in Object Orientated support. The Index-Start-Point (11230, 11270 and 11310) are used to store all the values for this variable as used across every method frame. The actual value that is utilised is referenced via an index and performed in situ during UPT execution.

FIG. 58 shows the Method-Call-Item (11326) that represents the life of a method from the moment it is called to the moment it exits. The Method-Call-Item is placed on the stack and will automatically generate a UPT-Method (11350 of FIG. 59) that continues execution in the new method frame.

FIG. 59 shows the UPT-Method (11350) that contains executable software in a method frame and is generated by the Method-Call-Item (11326 of FIG. 58). The UPT-Method contains a Pseudo-Stack-Field (11351) where execution occurs on the Pseudo-Stack (11352) instead of on the real stack in which the UPT-Method is contained. The UPT-Method exits when the Pseudo-Stack is empty, at which point the UPT-Method is removed from the stack e and execution continues normally again on the real stack. The Method-Values-Field (11353), Object-Field (11355) and Static-Variable-List-Field (11357) are used to dynamically look up actual variable values in the Data Segment for the method frame.

FIG. 60 shows the Object (11800) that represents an instantiation of a class. Classes compile into Unlinked-Class-Lists (11010 of FIG. 56). Prior to instantiation, the Unlinked-Class-List needs to be linked so that the UPTs they contain can execute on the stack.

FIG. 61 shows the III-Model (12000) with multiple Nodes (12010a, 12010b and 12010n). Each Node contains a III-Emulator (12021, 12031 and 12041) and a Governance Layer (101b of FIG. 1 and 202b of FIG. 2a). Each Node is connected by a pair of PCM-Interfaces (12056, 12066 and 12076).

FIG. 62 shows the III-Model (12200) in a different view from that of FIG. 61. FIG. 62 shows the Partner-Channel-Manager (12220, 12230 and 12240) that creates an NI-Partner (12285b and 12305b) for each partner connected to the Node.

FIG. 63 shows an NI-Partner (12400) that is created for each partner Node by the Partner-Channel-Manager (13000 of FIG. 66). The Partner-Online (12420) defines the connection between the 2 Nodes. The Node-Transfers-Field (12430) contains a list of DB-Partners (12436a-12436n of FIG. 63 and 13200 of FIG. 67) that enables bandwidth to be transferred by individual Digital-Businesses (8800 of FIG. 45) between Nodes.

FIG. 64 shows Bandwidth-Bookings (12600) that stores all the Realtime and Prepaid reservations for bandwidth for every Digital-Business (8800 of FIG. 45) on the Node.

FIG. 65 shows the NI-Partner (12800) that represents a connection to a partner Node (200a-e of FIG. 2a and 380, 395 of FIG. 2d). It contains Private-Information (12810) relating to that Node for the Governance Layer's own internal reference and Public-Information (12820) that is made available to the Digital-Businesses (8800 of FIG. 45) on the Node. The difference is academic since the Governance Layer (101b of FIG. 1 and 202b of FIG. 2a) presents the information to the Digital-Businesses anyway.

FIG. 66 shows the Partner-Channel-Manager (13000) as connected to multiple, Nodes (13090, 13110 and 13130). Each connection utilises a pair of PCM-Interfaces (130125). The Partner-Channel-Manager contains two main components being the Transmitter (13020) and the Scheduler (13030). The Transmitter is responsible for the transmission of bandwidth and electricity between Node partners by encoding the PCM-Interface in a platform specific manner. The Scheduler is responsible for implementing the Resource-Model in the context of bandwidth and electricity.

FIG. 67 shows the DB-Partner (13200) that represents a connection by a single Digital-Business (8800 of FIG. 45) to another Digital-Business on a peer Node. The DB-Partner is utilised by the Partner-Channel-Manager (13000 of FIG. 66) during transmission of bandwidth.

FIG. 68 shows the PCM-Resource-Release (13400) that is used by the Partner-Channel-Manager (13000 of FIG. 66) to release reservations once they have expired.

FIG. 69 shows the ID-Set (7500) that is used to store 128-bit number by combining two 64-bit Whole numbers from the Black-ID (7515) and the White-ID (7525).

FIG. 70 shows the Transfers (13600) that are used to transfer Prepaid and Realtime reservations by the Partner-Channel-Manager (13000 of FIG. 66). PCM-Transfer-Items (13816, 13826, 13836, 13846 and 13856) in the Send (13800) are Manabars-Sets awaiting transfer to the peer Node (200a-e of FIG. 2a and 380, 395 of FIG. 2d). The PCM-Transfer-Items (13916, 13926, 13936, 13946 and 13956) in the Receive (13900) have already arrived from the peer Node.

FIG. 71 shows the Booking-Schedules (14000) as part of Transport (14150 of FIG. 71 and 7010 of FIG. 36). The Booking-Schedules contain Active-Booking-Schedules (14010) that represent reservations that are being processed. The Frozen-Booking-Schedules (13420) represent schedules that are unable to be satisfied due to the DB-Partner being unable to be serviced due to connection failure.

FIG. 72 shows the Node communication (14200) as part of the Digital-Business (14250 of FIG. 72 and 8800 of FIG. 45). Maintains a list of all DB-Partners that is used to notify all connections if there is a failure in the PCM-Interface (130125 of FIG. 66).

FIG. 73 shows the Realtime-Contract-Instance (14400) and the Prepaid-Contract-Instance (14500). The Realtime-Contract-Instance contains all the data for a realtime reservation while a Prepaid-Contract-Instance represents a prepaid reservation in accordance with the Resource-Model.

FIG. 74 shows the 3IP-Interface Dataflow as data moves between the III-Common-Context (17035) and the 3IP-Interface (17000). This figure captures the lifecycle of executable Asynchronous-Virtual-Machine-Format or AVMF (see Appendix E) software. Software is initially verified with the AVMF-Verify-Interface (17075). After it is verified, it is executed in the 3IP-AVM (17010). The 3IP-AVM checks if verification is successful via the Authorised-AVMF-Interface (17080).

FIG. 75 shows the 3IP-AVM (17200) that utilises the von Neumann-Processor-Farm (17205) that is controlled by the AVM-Job-Manager (17230). Each executable unit of AVMF code is transmitted to an AVM-Processor (17210a, 17210b and 17210n of FIG. 75 and 17400 of FIG. 76). Once a AVMF job is executing it can access a series of Fast-ABS (17296) sequences and can create new ones, but it does not have access to the Kernel-Image (17290).

FIG. 76 shows AVM-Processor (17210a, 17210b and 17210n of FIG. 75 and 17400 of FIG. 76) that is responsible for executing AVMF code in a simplified von Neumann architecture. Each AVM-Processor contains an AP-CPU (17435) that is connected to the Scoped-FABS-Interface (17495), the AP-Memory (17420) that is an array of 64-bit blocks and the CPU-Stack-Bus (17465). The AP-CPU is responsible for interpreting and executing each Asynchronous-Virtual-Machine-Instruction or AVMI (see Appendix E).

FIG. 77 shows the Resource-Pricing (19000) that contains pricing information for each resource available on the invention.

FIG. 78 shows a Pricing-Item (20000) that determines the Engagement-Fee (20025) to begin using realtime resource. It contains the Usage-Fee (20035) that determines the cost of ongoing use of realtime resource in the Realtime-Marketplace. The Pricing-Item contains the Reimbursement-Price (20050) that is the price paid by the Governance Layer (101b of FIG. 1 and 202b of FIG. 2a) to the Digital-Business (8800 of FIG. 45) in the event that the reserved resource is not utilised. The Contract-Transfer-Fee (20060) is the charge for the Digital-Business in the event that it transfers the contract into a promissory note for trading off the local Node (200a-200e of FIG. 2a and 380, 395 of FIG. 2d). This fee is charged when another Digital-Business claims the contract with the promissory note. Finally, the Pricing-Item contains Spot-Prices (20070) for the Standby-Marketplace (20075), Idle-Marketplace (20085) and Background-Marketplace (20095).

FIG. 79 shows the PCM-Connection-Request-Image (21000) that is inserted into the PCM-Notify (7065 of FIG. 36) to propagate a Digital-Business (8800 of FIG. 45) to a peer Node partner (12010a, 12010b, 12016n of FIG. 61 and 12210a, 12210b, 12210n of FIG. 62). Specifically, the PCM-Connection-Request-Image forms the Digital-Business by supplying an entire DTE-Instance (9800a of FIG. 50) image. This generic mechanism can be used to transport Digital-Businesses created by exotic languages or alternative environments that may be developed in the future.

FIG. 80 shows the PCM-Mapped-Set (21100) that is likely to be used by the Governance Layer (101b of FIG. 1, 202b of FIG. 2a) to track mapped sets between Digital-Businesses (8800 of FIG. 45) on the local Node 0 and Node partner (12010a, 12010b, 12010n of FIG. 61 and 12210a, 12210b, 12210n of FIG. 62). For example, if a Digital-Business requests a propagation, a reference to the propagation can be structured as a PCM-Mapped-Set which is mapped using the UPT-Map (see Appendix B). After propagating to the peer Node, the PCM-Mapped-Set behaves like an Entangled-Set (13295) so that the DB-Partner-Field (21110), DB-Reference-Field (21130) and the Peer-Node-Field (21150) no longer exist so that the PCM-Mapped-Set contains no Children. At any point if the peer Node reuses this reference and transmits it to the local Node, the PCM-Mapped-Set will be restored. In this manner the PCM-Mapped-Set information can be held private but the peer Node is able to utilise the reference to identify the set without gaining access to its contents. Therefore, the contents of the PCM-Mapped-Set are not transferred in the PCM-Interface (130125 of FIG. 66).

FIG. 81 shows the PCM-Connection-Request-Object-Orientation (21200) and performs a similar role to the PCM-Connection-Request-Image (21000 of FIG. 79) by creating a new Digital-Business (8800 of FIG. 45) on a peer Node (200a-e of FIG. 2a and 380, 395 of FIG. 2d). The DTE-Instance (9800a of FIG. 50) of the target Digital-Business is constructed automatically and the executable software is derived from a cluster of unlinked classes via the Unlinked-Class-List-Field (21270).

FIG. 82 shows the PCM-Connection-Result (21400) that is returned after a propagation request has been made through the PCM-Notify (7065 of FIG. 36).

FIG. 83 shows PCM-Transfer-Item (21600) that is used to transmit sets to a specific Digital-Business (8800 of FIG. 45) on a peer Node (200a-e of FIG. 2a and 380, 395 of FIG. 2d).

FIG. 84 shows the UPT-Execution-Interface (475 of FIG. 3) that is used in the Primary-Dataflow (see FIG. 3) to transmit UPTs (see Appendix B) to Emulator-Components (FIGS. 3-8) for asynchronous processing.

FIG. 85 shows the Scoped-FABS-Interface (17240 of FIG. 75 and 17495 of FIG. 76) that is used by the FABS-Access-Manager (17230 of FIG. 75) to allow the reading and writing of Fast-ABS (6000 of FIG. 31) sequences by executing AVMF code via the UPT-AVM (see Appendix B).

FIG. 86 shows UPT-Event-Triggered-Interface (1475 of FIG. 8) that is utilised in the Event-Triggered-Dataflow 0 to deliver Monitor events to Emulator-Components via the KI-Broadcast (see Appendix G) instruction.

FIG. 87 shows the PCM-Interface (130125 of FIG. 66) that is responsible for the transmission of Digital-Businesses (8800 of FIG. 45) and data across Nodes (200a-e of FIG. 2a and 380, 395 of FIG. 2d). Although the behaviour of the PCM-Interface is specified, the implementation is left undefined to maximise deployment opportunities.

FIG. 88 shows the Execution-Interface (17270 of FIG. 75) that is responsible for transmitting AVMF sequences to the next available AVM-Processor (17210a, 17210b, 17210n of FIG. 75 and 17400 of FIG. 76) for execution.

FIG. 89 shows the AVM-Interface (17299 of FIG. 75) that transmits the UPT-AVM (see Appendix B) execution job to the Job-Scheduler (17275 of FIG. 75) of the 3IP-AVM (17200 of FIG. 75).

FIG. 90 shows the AVMF-Verify-Interface (23050 of FIG. 91) that transmits the UPT-AVMF to the Verification-Job-Manager (23040 of FIG. 91) so that an AVMF sequence can be verified prior to execution.

FIG. 91 shows the 3IP-AVMF-Verifier (23000) that processes multiple UPT-AVMF (see Appendix B) UPTs continuously. The 3IP-AVMF-Verifier has numerous verification processors inside the AVMF-Verifier-Farm (23015). Once a sequence has been verified it is stored to the Authentication-Database (23030) to enable the 3IP-AVM (see Appendix B) to assure the sequence integrity via the Verified-AVMF-Interface (23035).

FIG. 92 shows the Verification-Processor (23200) that is responsible for verifying the execution integrity of a single AVMF sequence. The sequence is transferred via the Verification-Interface (23270) of the Verification-Job-Manager (23265). The Verification-Processor loads the AVMF sequence into the Proposed-AVMF (23215), configures the Boolean-Land-Array (23220) and Boolean-Jump-Array (23225) before verifying this sequence with the Integrity-Checker (23250). The Integrity-Checker performs a number of tests in parallel as the sequence is scanned.

FIG. 93 shows the Verification-Interface (23270 of FIG. 92) that is used by the Verification-Processor (23200 of FIG. 92) to load the next verification job from the Verification-Job-Manager (23265 of FIG. 92).

FIG. 94 shows the KI-Interface (see Appendix G) that is used by every Emulator-Component (FIGS. 3-8) in the KI-Dataflow (see FIG. 4).

FIG. 95 shows the ILI-Phenotype-Data (23800 of and 6866 of FIG. 35) that delivers a Sensory-Experience and captures a Sensory-Perception directly to and from the user (see Appendix F).

FIG. 96 shows an exemplary deployment of the Human-Communication-Manager (24000) that contains multiple sensory channels that can each attend an independent display device.

FIG. 97 shows an exemplary configuration of the Mesh-Blueprint (24200) as used in the Render-Field (23830 of FIG. 95) of the ILI-Phenotype-Data (23800 of FIG. 95). The Mesh-Blueprint contains the Sensory-Experience.

FIG. 98 shows the Entity (24400) that delivers a Sensory-Experience and captures a Sensory-Perception for a single entity in the virtual universe.

FIG. 99 shows the MB-Render-Information (24600) that allows multiple sensory data components to be overlayed in a single Sensory-Experience.

FIG. 100 shows the Render-Information (24800) for the sound experience.

FIG. 101 shows the Render-Information (25000) for the visual experience.

FIG. 102 shows the Appearance (25200) that is used in the visual experience to define textures, materials, lights, colour and transparency of objects.

FIG. 103 shows a Texture (25400) that is used to provide texture data for the Texture-Field (25210 of FIG. 102).

FIG. 104 shows the XYZ-Position-Set (25600) and the RGB-Set (25700). The XYZ-Position-Set is used to store a location in the virtual universe. The RGB-Set is used to define a colour.

### DETAILED DESCRIPTION

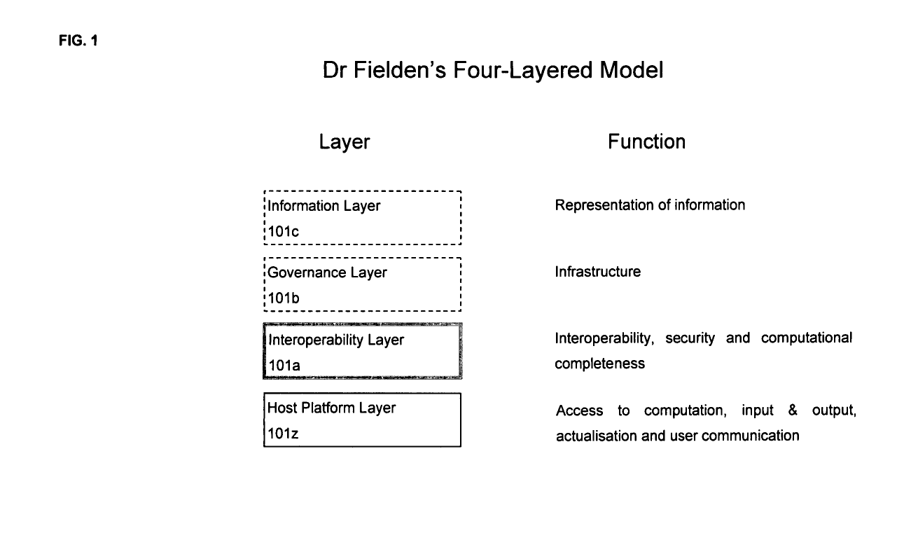

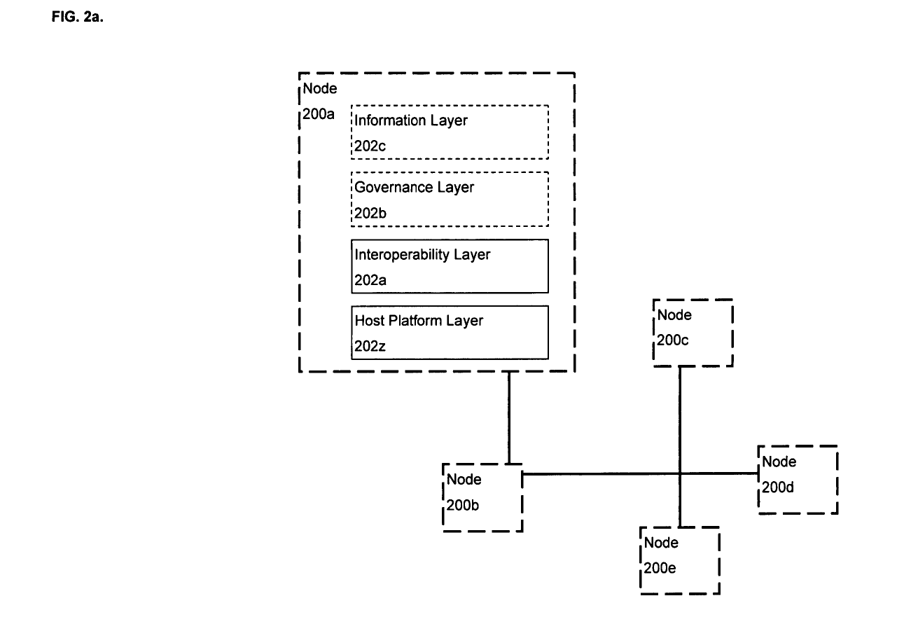

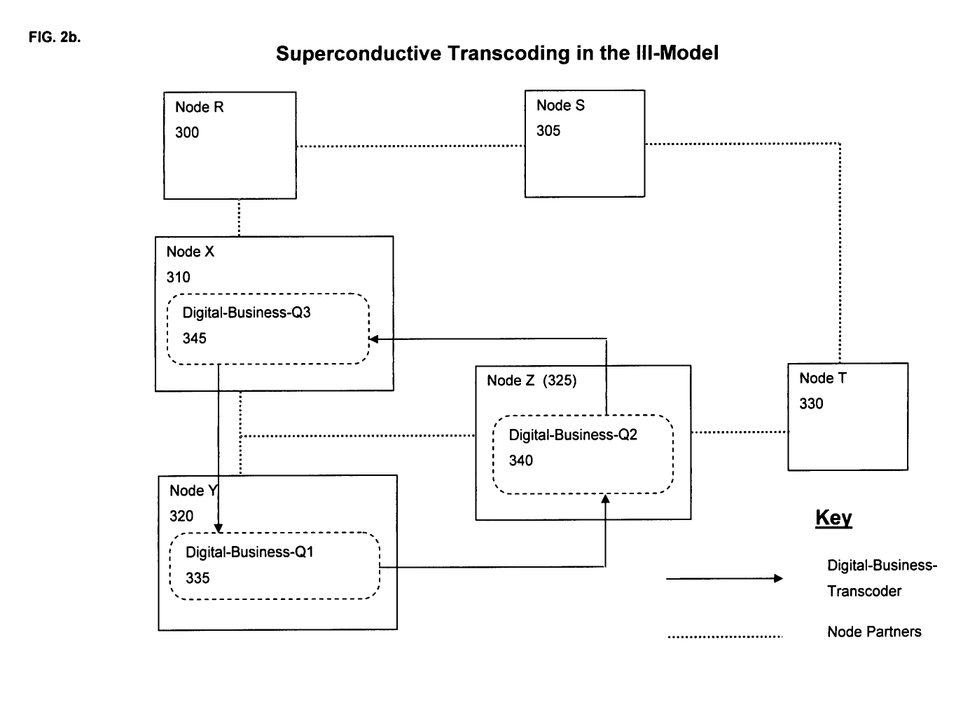

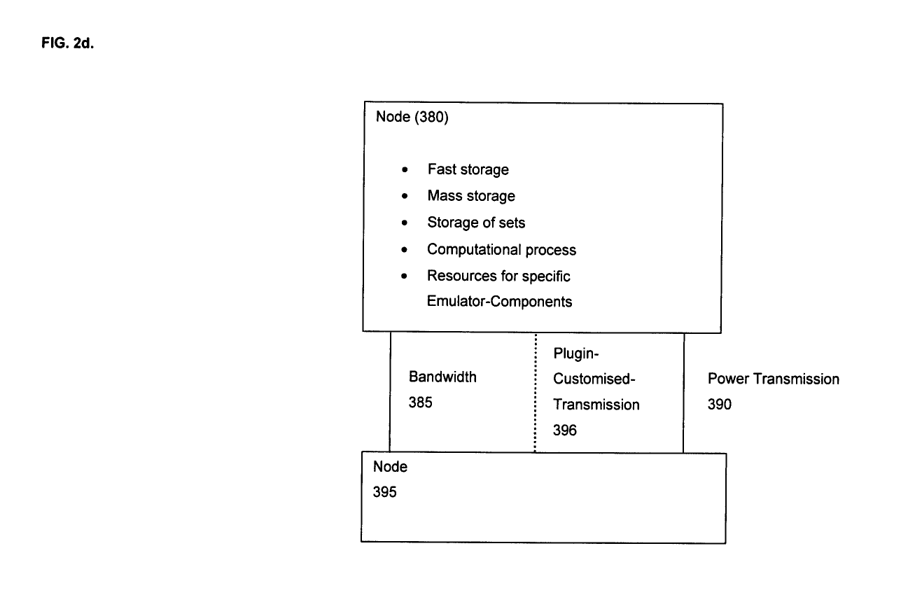

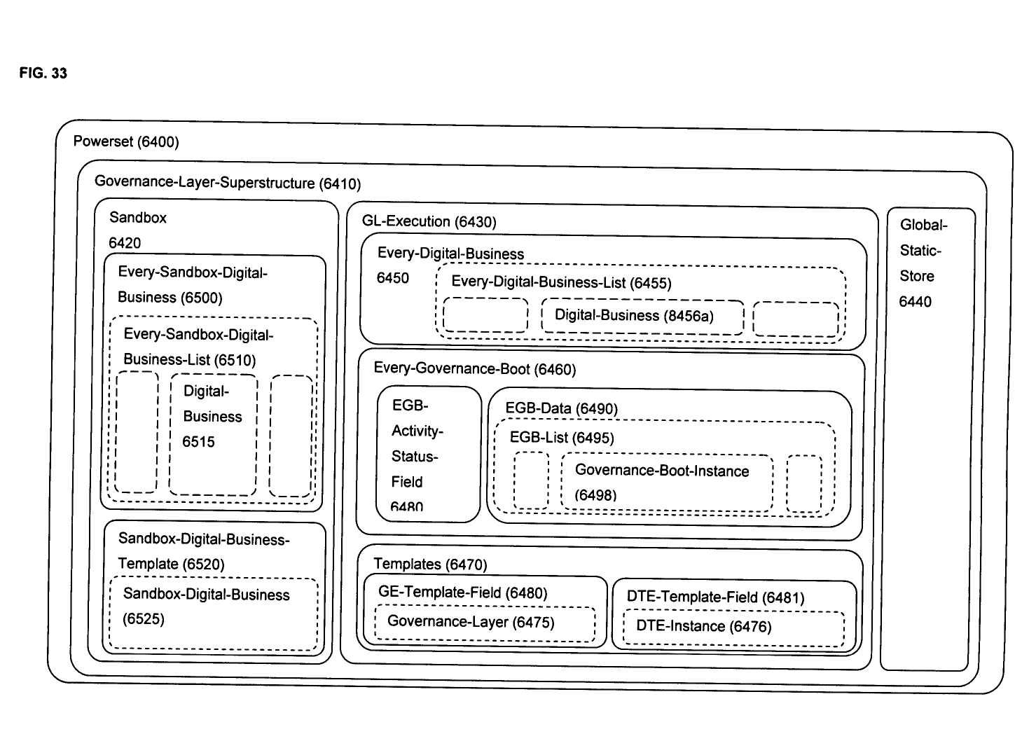

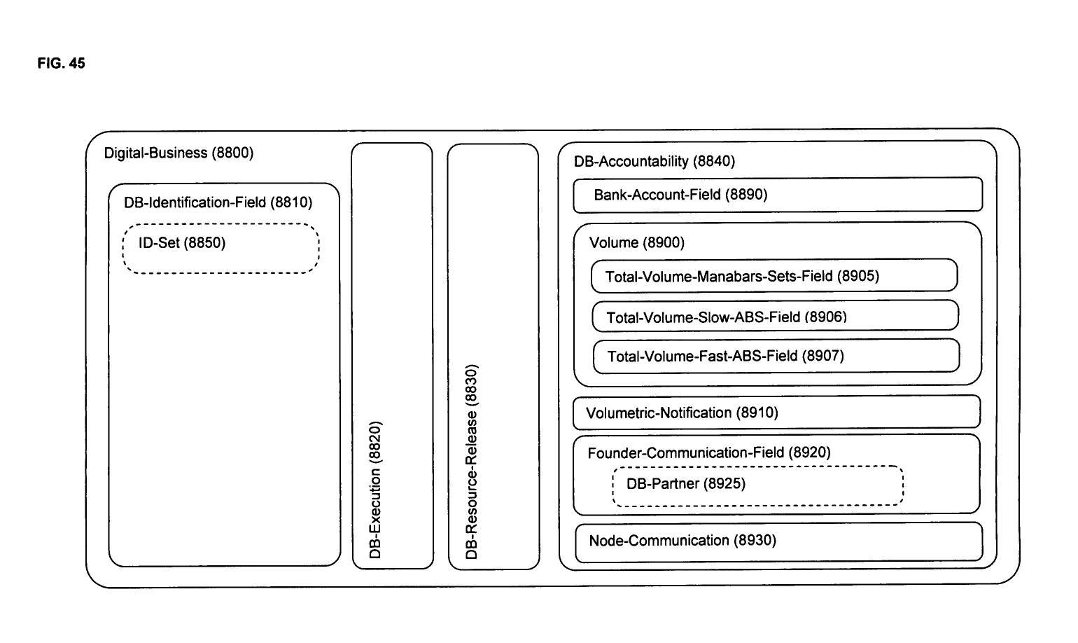

FIG. 2a shows an exemplary system deployment in its full operational context. The invention—a III-Model Candidate (102a) is only one component of Node, which is itself only one entity in the grid network. The Nodes (200a-200e OF FIG. 2a and 380, 395 of FIG. 2d) operate as a continuum of homogeneous hosts on an interconnected peer-to-peer grid network. Each Node may execute a functionally equivalent Governance Layer (102b of FIG. 1, 202b of FIG. 2a, 6475 of FIG. 33) similar to an Operating System. Data may move between Digital-Businesses (8800 of FIG. 45) operating from peer Nodes or Digital-Businesses operating from the same Node.

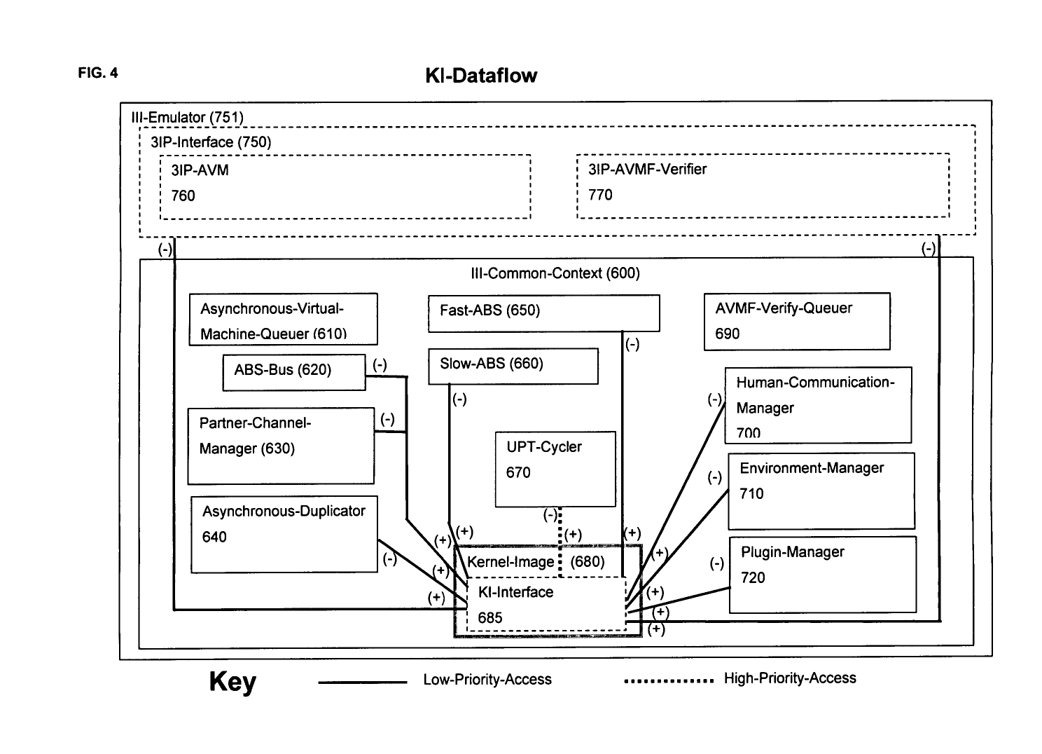

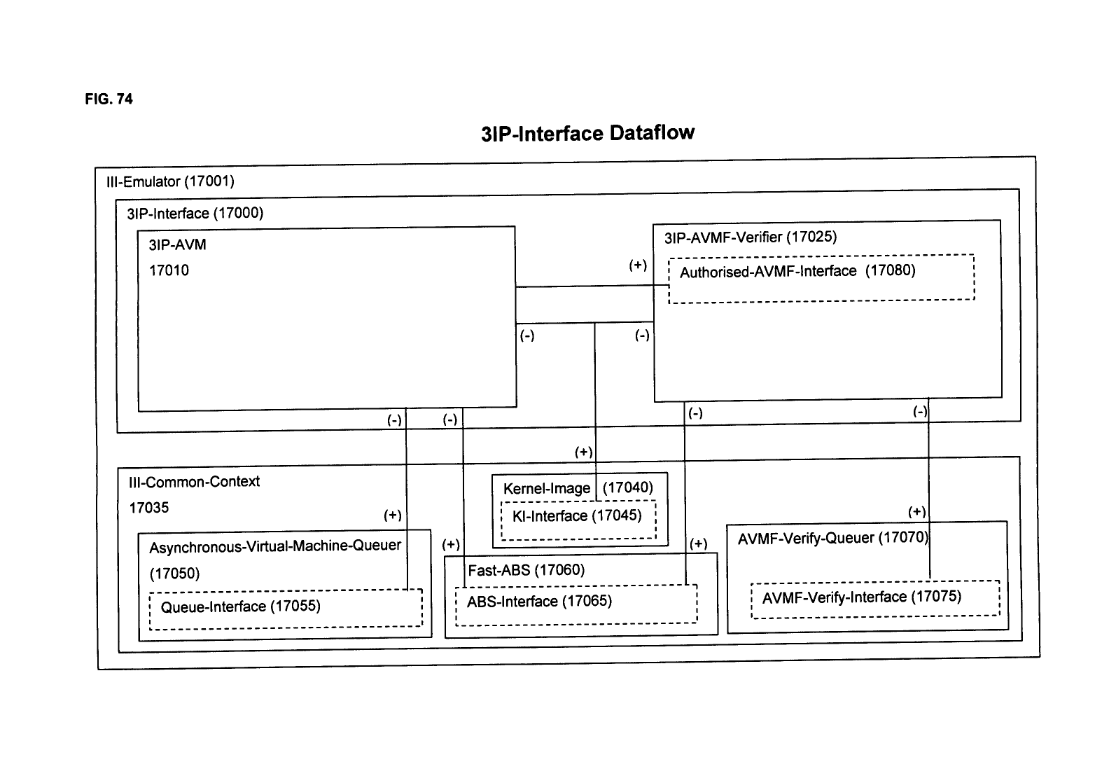

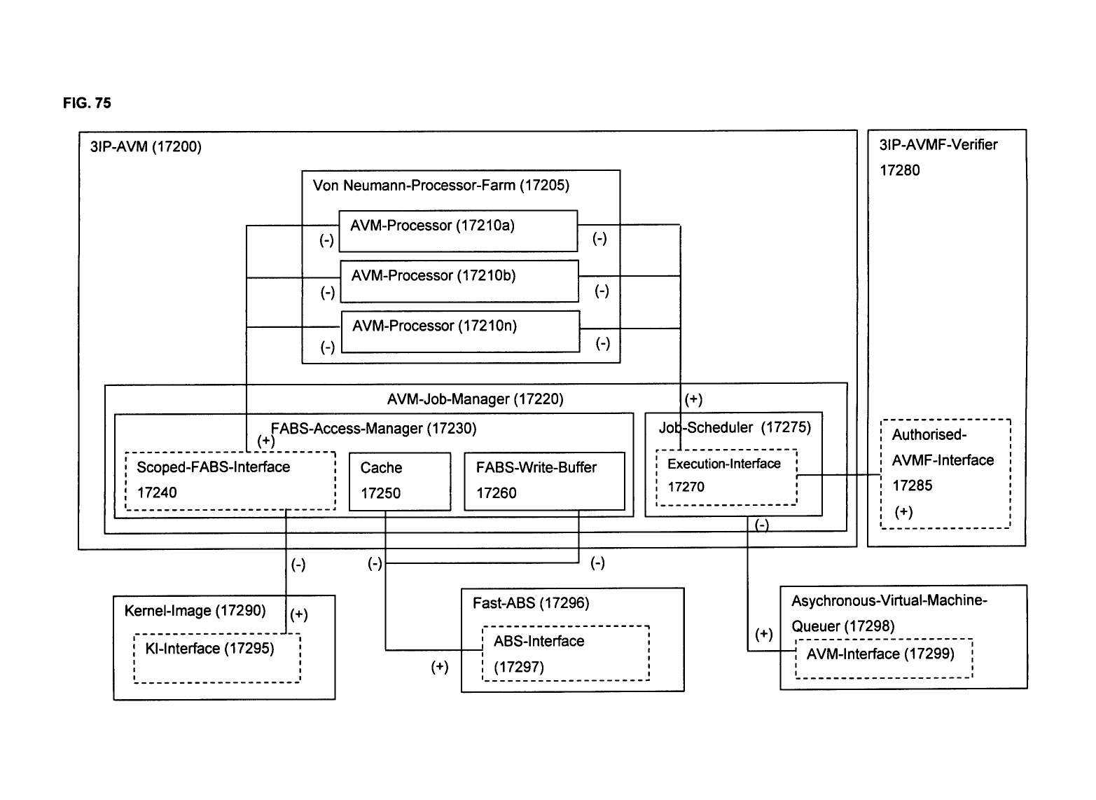

The invention can be extended in a narrow manner to enable a 3IP (see 3IP-Interface at 17000 of FIG. 74). A 3IP represents an extension of numerous processors of the von Neumann architecture. Code designed to run on the 3IP processors is derived from a series of Abstract Virtual Machine Instructions (AVMI) through a cross-compilation. An entire executable is comprised of a series of AVMIs to form the Asynchronous-Virtual-Machine-Format (AVMF) that is executed in the 3IP-AVM (17200 of FIG. 75). Interoperability is achieved when Digital-Businesses are converted into the correct mechanical format to operate on the desired 3IP Node platform. It is not in the scope of this patent to define the operation of the Node as the Governance Layer (102b of FIG. 1, 202b of FIG. 2a, 6475 of FIG. 33) may obtain almost any configuration although the Information Layer (101c of FIG. 1 and 202c of FIG. 2a) behaviour is managed by the Governance Layer it is effectively infinity open. The Governance Layer software and Digital-Businesses (8800 of FIG. 45) resident in the Information Layer must be driven directly by the computation arising from the invention and cannot be generated by an independent process or thread. Therefore, these two highest layers operate virtually to the Interoperability Layer (101a of FIG. 1 and 202a of FIG. 2a) within the universe of Sets that is contained in the Kernel-Image (680 of FIG. 4)—see Appendix G for further information as to how the Kernel-Image is constructed.

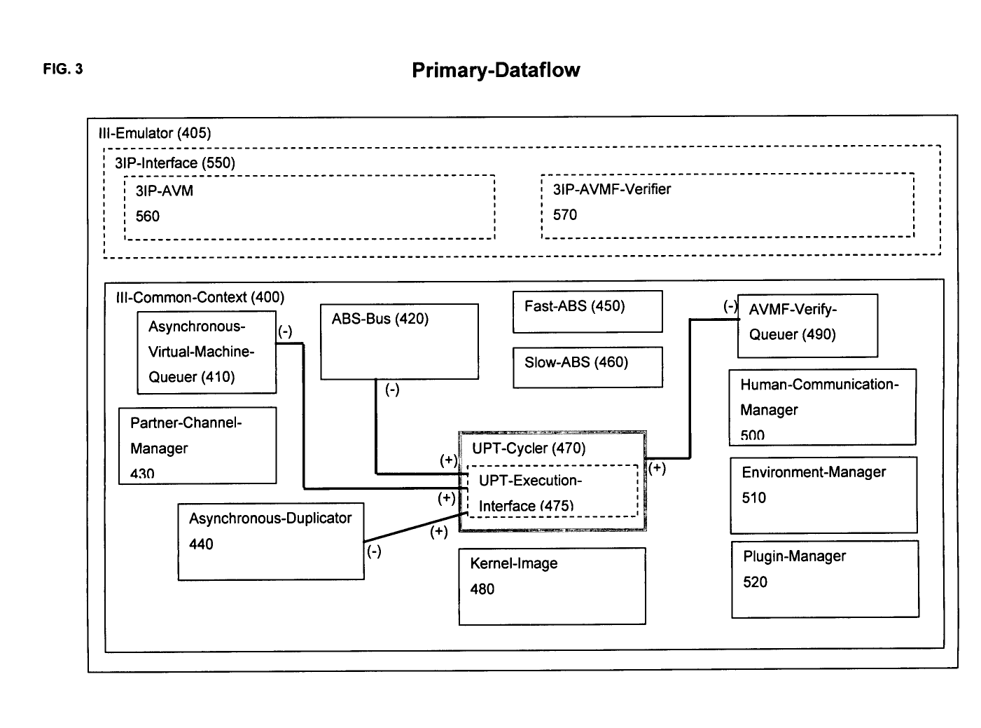

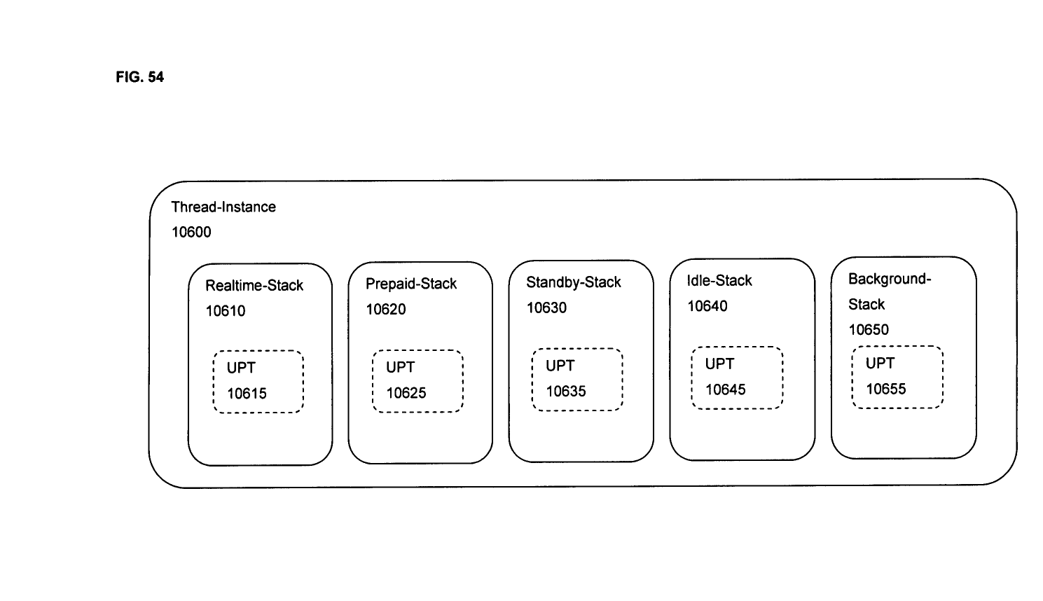

Information enters and leaves the invention as:
(1) Sets of data or information units referred to in this document as Manabars-Sets (see Appendix G) when Digital-Businesses (8800 of FIG. 45) on Node (200a-200e of FIG. 2a, 380 and 395 of FIG. 2d) partners on the peer-to-peer network move data to Digital-Businesses on the local Node.
(2) Digital-Businesses on Partner Nodes propagate new Digital-Businesses onto the local Node.
(3) Digital-Businesses on the local Node that move data to other local Digital-Businesses.
(4) From state changes delivered by every Digital-Business to the Realtime-Stack (10610 of FIG. 54), Prepaid-Stack (10620 of FIG. 54), Standby-Stack (10630 of FIG. 54), Idle-Stack (10640 of FIG. 54) or Background-Stack (10650 of FIG. 54) as driven by the UPT-Cycler (470 of FIG. 3) that includes activity generated by other Emulator-Components (FIGS. 3-8).
(5) From sources native to the implementation of the invention handled by the Environment-Manager (510 of FIG. 3)—for example, feedback relating to the availability of resources on the implementation platform.
(6) From sensory data compiled by the Human-Communication-Manager (500 of FIG. 3) as it interacts with the user. The data is made available to the virtual Governance Layer (101b of FIG. 1, 202b of FIG. 2 and 6475 of FIG. 33) and the appropriate Digital-Business (8800 of FIG. 45) in the Information Layer (101c of FIG. 1 and 202c in FIG. 2).
   High Level Architecture of the System

Below is a summary of every functional component of a Node (200a-e of FIG. 2a, 380 and 395 of FIG. 2d).

3IP-Interface

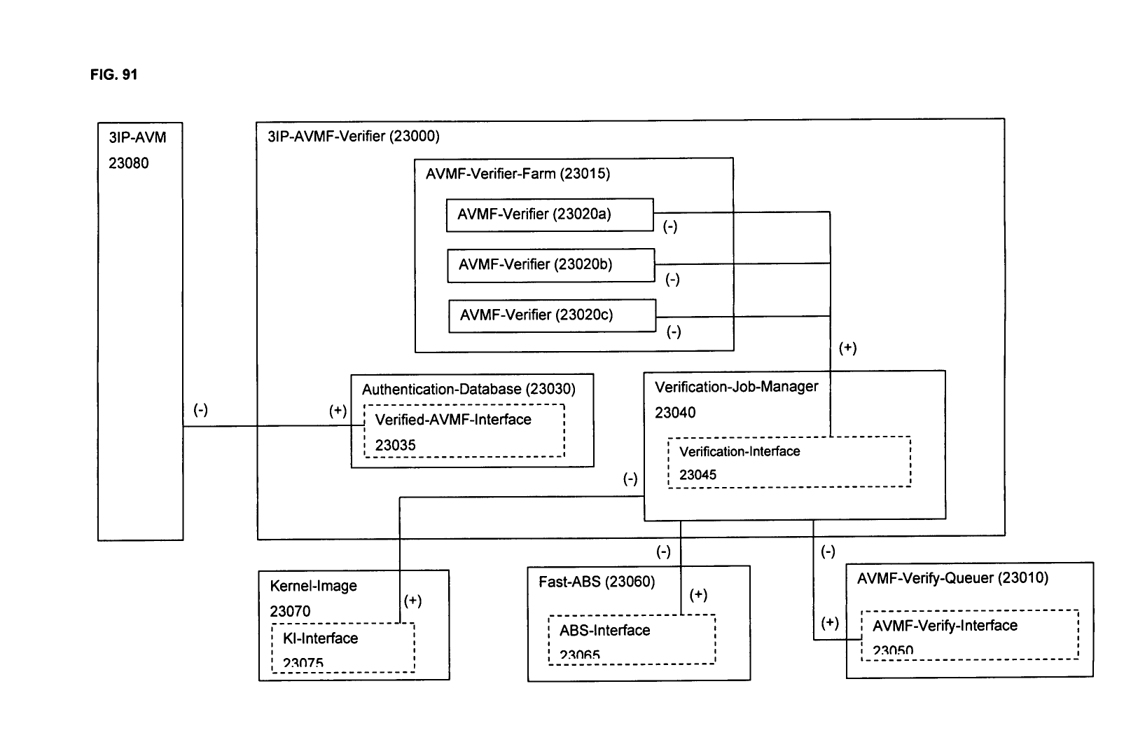

An abstract definition that allows for the construction of a 3IP. This III-Model. Candidate does not include a definition for the components that implement the 3IP-interface (17000 of FIG. 74). Any 3IP must implement the 3IP-Interface by fully implementing the III-Common-Context (400 of FIG. 3 and 17035 of FIG. 74) as well as a valid 3IP-AVM (17200 of FIG. 75) and corresponding 3IP-AVMF-Verifier (17025 of FIG. 74 and 23000 of FIG. 91).

III-Emulator

The III-Emulator assumes the role of the Interoperability Layer (101a of FIG. 1, 202a of FIG. 2a) and executes as a multi-threaded application on top of the Host Platform Layer (202z of FIG. 2). The components inside the III-Emulator are Emulator-Components (FIGS. 3-8) and are each able to operate in parallel. The III-Emulator is optimised for a physical implementation, such as in Field Programmable Gate Arrays (FPGA) as opposed to a software or logical implementation. However, III-Emulators for alternative software environments will; operate perfectly, albeit slower.

Host Platform Layer

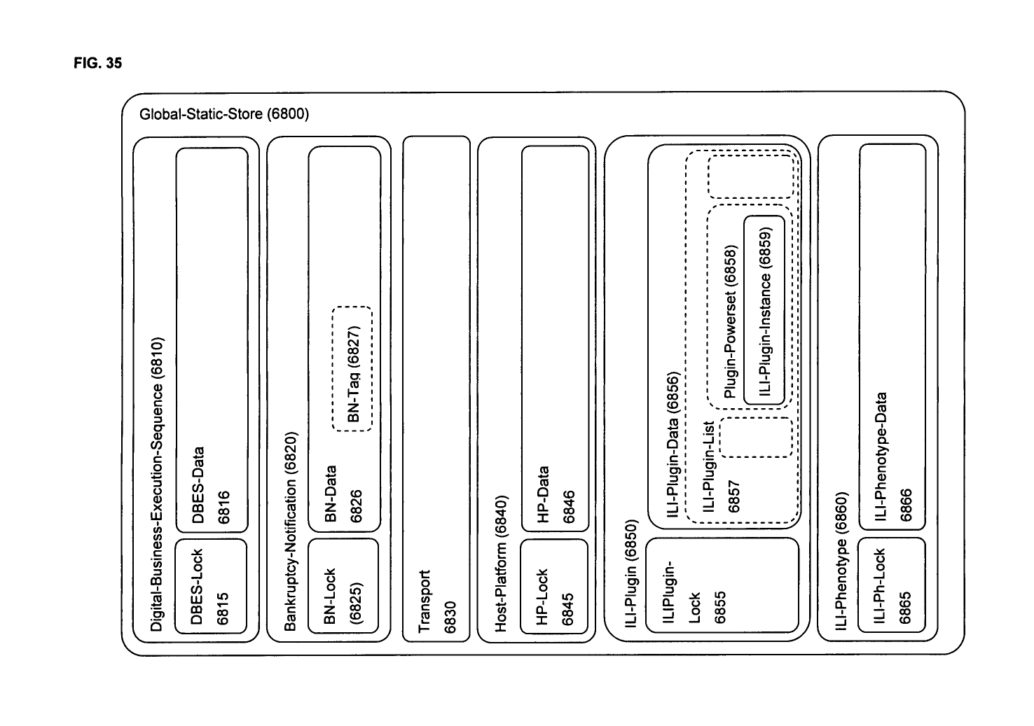

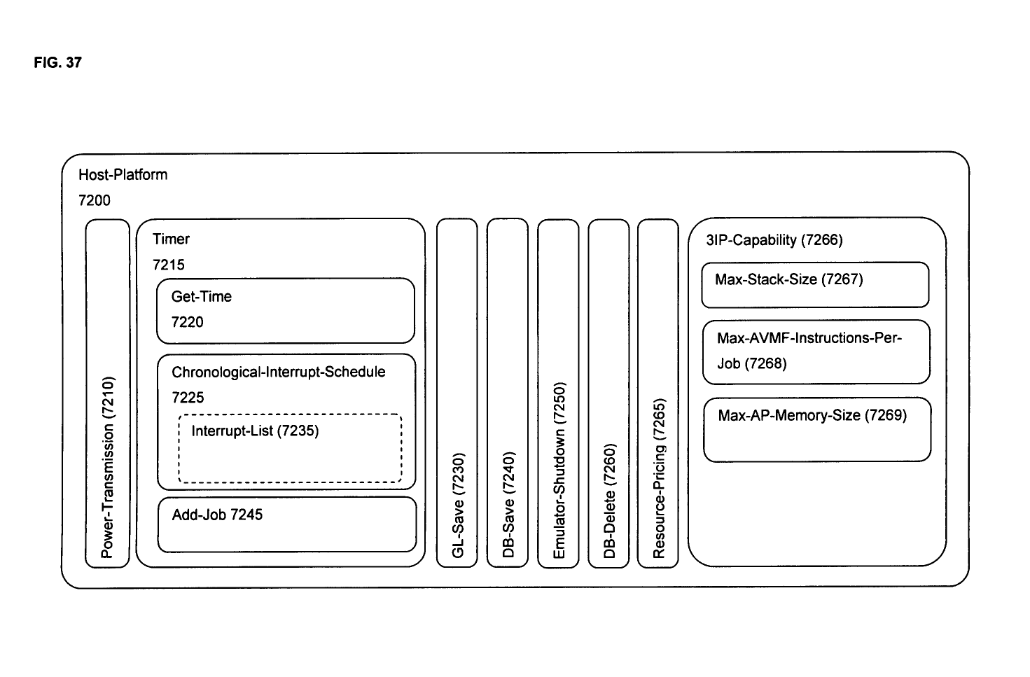

The Host Platform Layer (202z of FIG. 2) is the platform on which the III-Emulator executes. This may be hardware or software, the only requirement is that the Host Platform (6840 of FIG. 35 and 7200 of FIG. 37) is capable of computational completeness and has full-time network access to service Node (200a-e of FIG. 2a, 380 and 395 of FIG. 2d) partners.

Kernel-Image

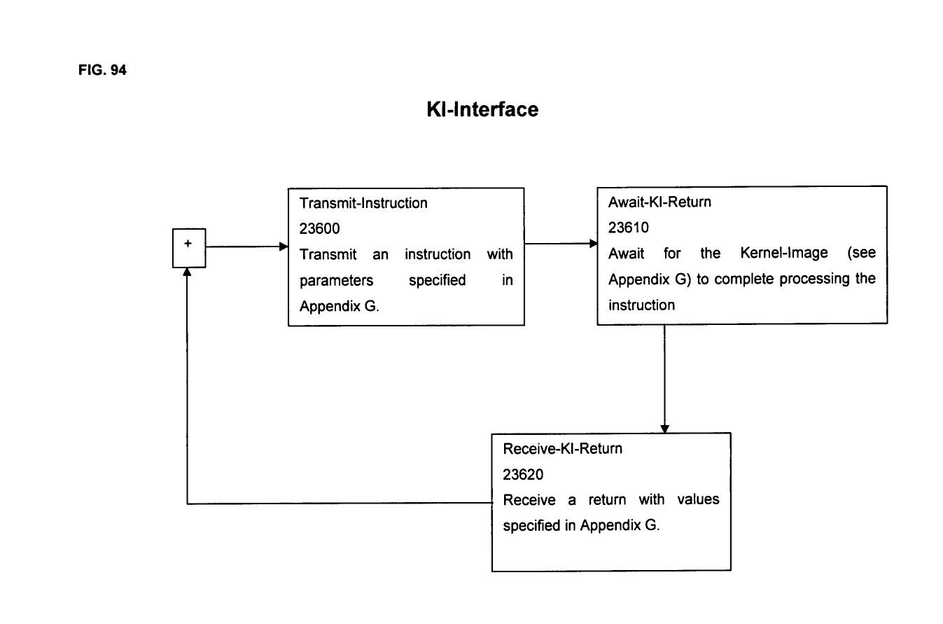

The Kernel-Image (see Appendix G) contains a persistent store of information units called Manabars-Sets. The Kernel-Image provides an interface called the KI-Interface (see FIG. 94) for the manipulation of information units.

Powerset

The Powerset (6400 of FIG. 33) is the outermost Manabars-Set (see Appendix G) contained within the Kernel-Image and contains every other Manabars-Set.

UPT-Cycler

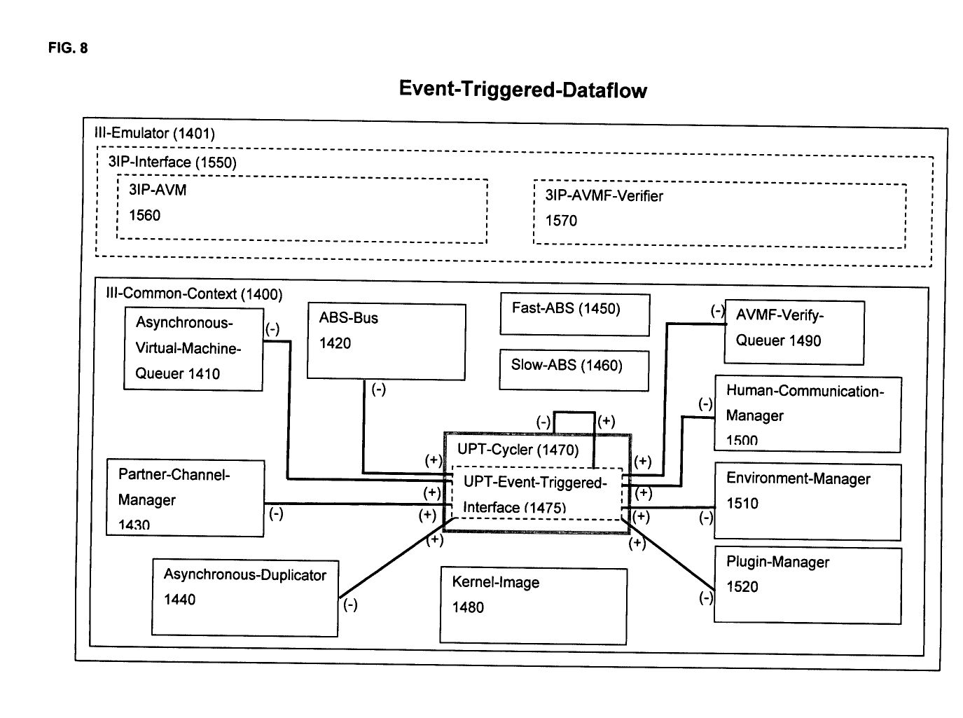

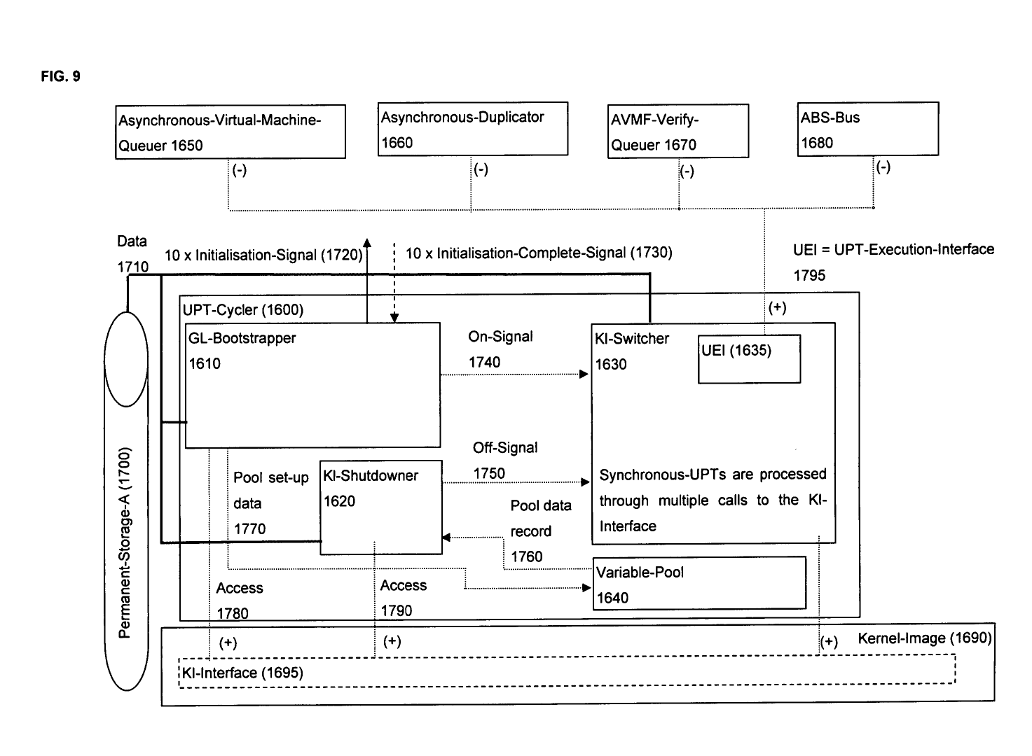

The UPT-Cycler (470 of FIG. 3, 1470 of FIG. 8 and 1600 of FIG. 9) uses the KI-Interface (see FIG. 94 and Appendix G) to manipulate special Manabars-Sets (see Appendix G) known as Universal-Process-Types or UPTs (see Appendix B) that enable computational completeness. The UPT-Cycler processes each UPT immediately, either through the KI-Interface synchronously, or for more complex UPTs by forwarding them to the Asynchronous-Virtual-Machine-Queuer (410 of FIG. 3), AVMF-Verify-Queuer (490 of FIG. 3), ABS-Bus (420 of FIG. 3) or the Asynchronous-Duplicator (440 of FIG. 3) by using the UPT-Execution-Interface (475 of FIG. 3, 1635 of FIG. 9 and Appendix C for the Interface-Definition). The UPT-Cycler will determine the actual execution speed or power rating of the III-Emulator, which is measured by the number of UPTs executed each second. This rate is also referred to as Digital-Business-Cycles per second (DBC/s). Digital-Businesses (8800 of FIG. 45) may be locked by these asynchronous Emulator-Components (FIGS. 3-8) to prevent corruption of data.

Asynchronous-Virtual-Machine-Queuer

The Asynchronous-Virtual-Machine-Queuer (410 of FIG. 3) stores a queue of executable jobs awaiting processing by the 3IP-AVM (17200 of FIG. 75).

3IP-AVM

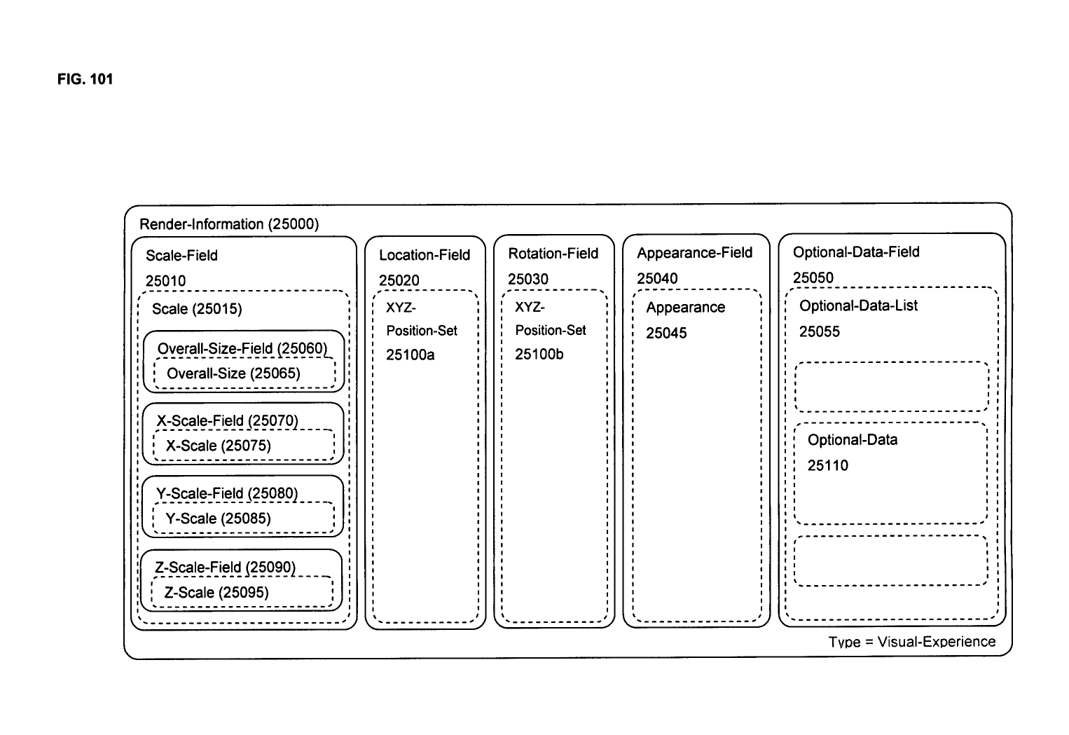

The 3IP-AVM is a virtual computing framework that enables the execution of the Asynchronous-Virtual-Machine-Format or AVMF (see Appendix E) that is optimised for implementation on generic and conventional 64-Bit chipset architectures. During run-time the AVMF uses Abstract-Virtual-Machine-Instructions (AVMIs) to transfer information between the 3IP-AVM and the Fast-ABS and to manipulate information within the 3IP-AVM through the utilisation of a stack and the PI-CPU. A related component called the AVMF-Verifier ( ) converts special UPTs used for compiling called AVMI-UPTs into instructions native to the Host Platform Layer (202z of FIG. 2 and 101z of FIG. 1) by using the UPT-AVMF-Verify UPT (see Appendix B).

AVMF-Verify-Queuer

The AVMF-Verify-Queuer (490 of FIG. 3 and 23010 of FIG. 91) queues jobs that verify the integrity of code that is to execute at some point on the 3IP-AVM (17200 of FIG. 75).

AVMF-Verifier

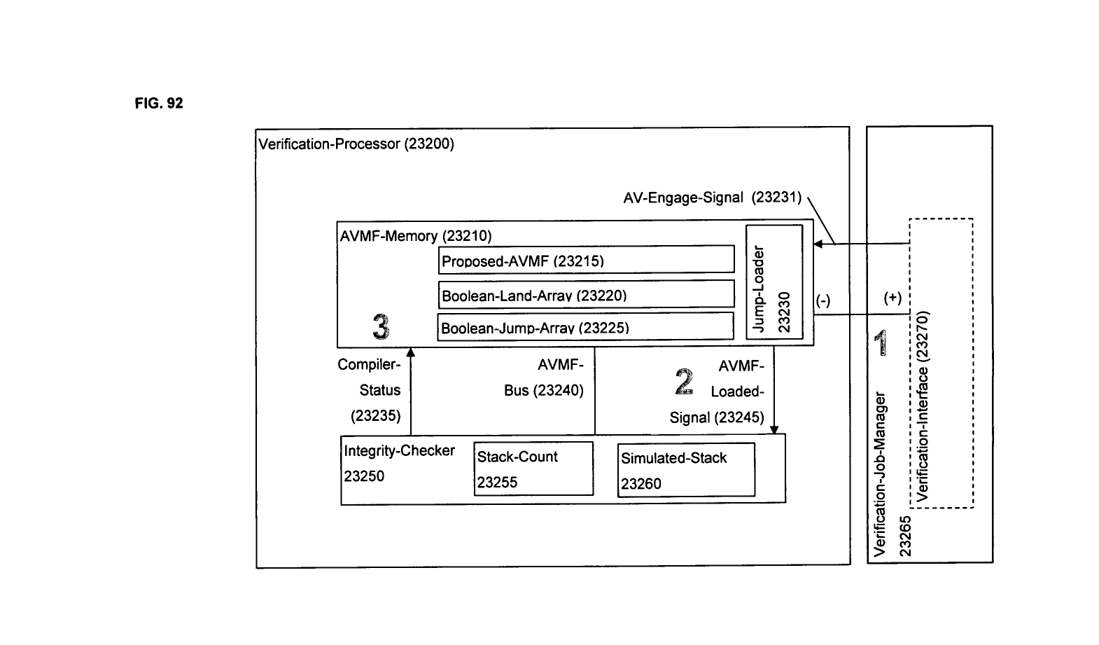

The AVMF-Verifier (23020a, 23020b, 23020c of FIG. 91 and 23200 of FIG. 92) converts Abstract-Virtual-Machine-Instructions or AVMIs (see Appendix E) into native binaries that are executable in the 3IP-AVM (560 of FIG. 3 and 17200 of FIG. 75). Executable jobs are queued in the Asynchronous-Virtual-Machine-Queuer (410 of FIG. 3) and await processing by the 3IP-AVM. AVMIs are symbols that represent an idealistic virtual computing framework and are analogous to machine instructions. Some implements in software environments may compile the Asynchronous-Virtual-Machine-Format (see Appendix E again) into native binaries as part of the verification process so as to reduce the latency during actual execution.

Partner-Channel-Manager

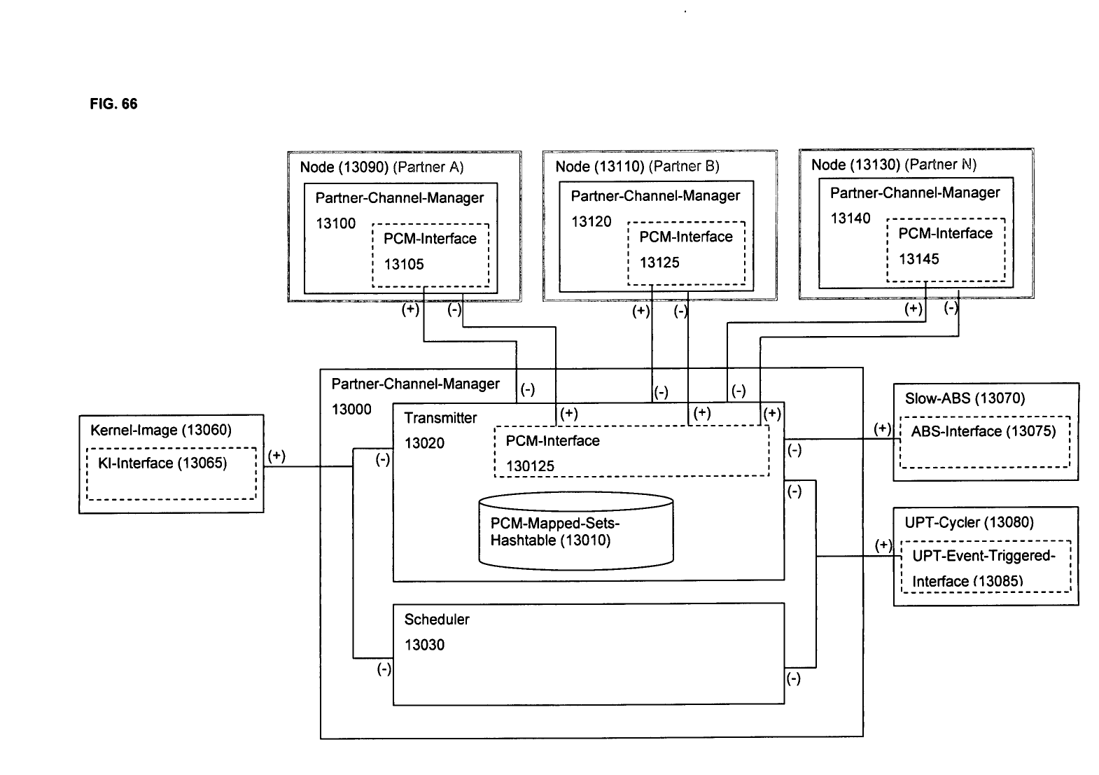

The Partner-Channel-Manager (430 of FIG. 3 and 13000 of FIG. 66) creates Digital-Businesses (8800 of FIG. 45) on adjacent Nodes (200a-e of FIG. 2a, 380 and 395 of FIG. 2d) enables communications between a Parent Digital-Business and its propagated Children. The protocol for this transmission is known as the PCM-Interface (130125 of FIG. 66), but its full implementation is not part of the specification. The security relating to the PCM-Interface implementation is managed both at a higher level by Digital-Businesses that are ultimately responsible for their own security and at a lower level by the Node that can obtain higher ratings by Routing-Agents if it secures the communication channel between Node partners. Routing-Agents are high level Digital-Businesses that trade navigational data and make recommendations about Node reliability and security to other Digital-Businesses. Digital-Businesses operating in the Information Layer (101c of FIG. 1 and 202c of FIG. 2) may choose to encrypt its transmission to other Digital-Businesses. Nodes may increase their security by physically securing the Host Platform Layer (101z of FIG. 1 and 202z of FIG. 2a) and avoiding insecure layers such as a vulnerable Operating System during a software implementation of the III-Emulator.

Human-Communication-Manager

The Human-Communication-Manager (500 of FIG. 3 and Appendix F) communicates with the user through an abstract human body. Inbound information is received as an abstract sensory experience while information generated by the user is encoded as an abstract sensory perception. The entire communication is machine independent and human specific. By not changing the way information is encoded, software can be both forwards and backwards compatible as the application and software that executes on it never change. There is no logical limit to the number of parallel sensory communications that may be processed by the Human-Communication-Manager.

Environment-Manager

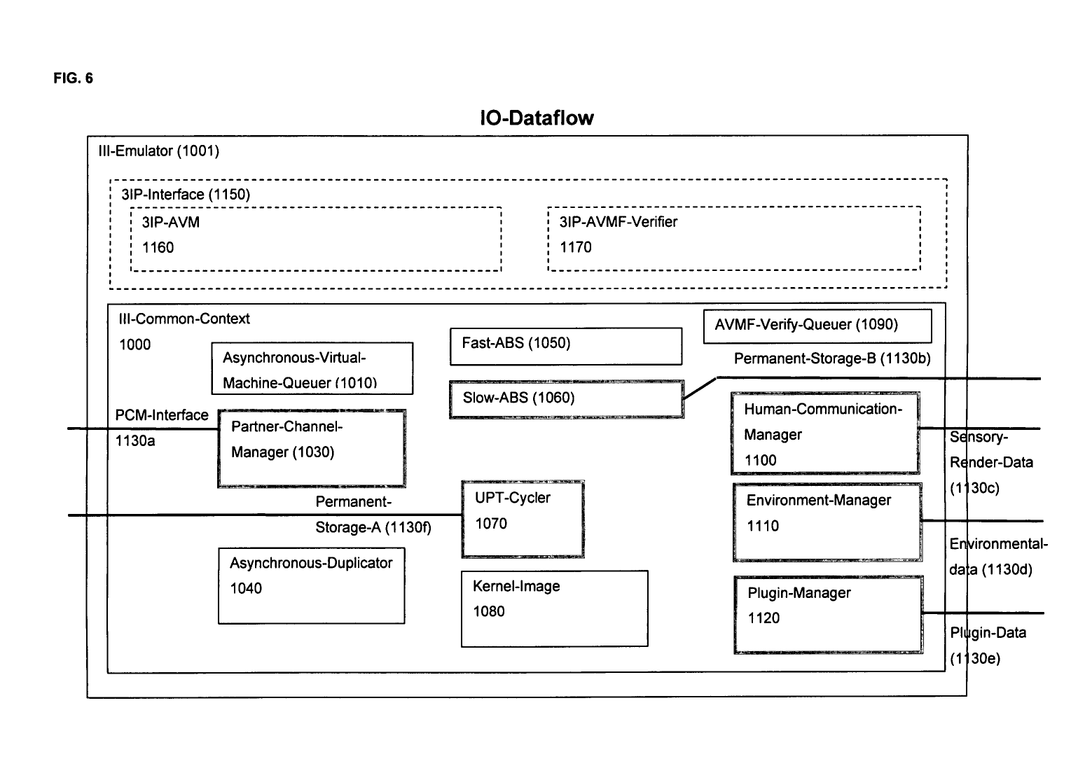

The Environment-Manager (510 of FIG. 3 and 710 of FIG. 4) senses and provides feedback for workload of the Permanent-Storage-A (113 of FIG. 6 and 1700 of FIG. 9), KI-Memory (see Appendix G), network bandwidth for the Partner-Channel-Manager (430 of FIG. 3 and 13000 of FIG. 66) and computational process for each Emulator-Component (FIGS. 3-8) that is made available by the Host Platform Layer (101z of FIG. 1 and 202z of FIG. 2).

Asynchronous-Duplicator

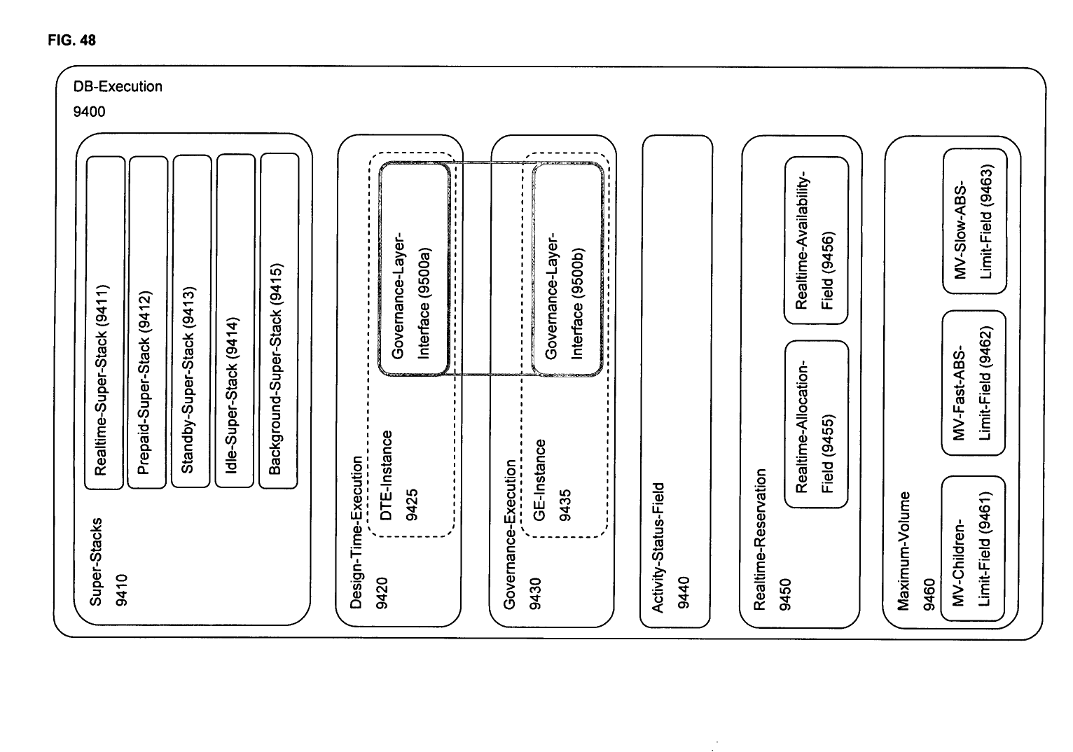

The Asynchronous-Duplicator (440 of FIG. 3) duplicates an entire Manabars-Set (see Appendix G) by temporarily freezing a Digital-Business (8800 of FIG. 45) so that its contents do not change while the duplication is in progress. Digital-Businesses are frozen by inserting a Child of Type Type-True into the Activity-Status-Field (9440 of FIG. 48) of a Digital-Business. Once the duplication is completed, execution of the Digital-Business is continued as normal.

There are numerous types of duplication:
1) Copying all Children with UPT-Copy-All-Children (see Appendix B).
2) Copying all Children and recursive grandchildren with UPT-Recursive-Copy (see Appendix B).
3) Exotic copies with UPT-Entangled-Recursive-Copy, UPT-Denatured-Recursive-Copy and UPT-Entangled-Denatured-Recursive-Copy (see Appendix B).
   Permanent-Storage

The Permanent-Storage-A (113 of FIG. 6 and 1700 of FIG. 9) is used by the UPT-Cycler (1470 of FIG. 8 and 1600 of FIG. 9) to store a permanent copy of every Digital-Business (8800 of FIG. 45) on the III-Emulator. During a system failure, it is this copy of a Digital-Business that will be resumed and not the copy executing in the KI-Memory (see Appendix G). Furthermore, Digital-Businesses will not all be resumed from the same point at which the failure occurred, but rather from the point at which they were individually saved, a function that is the responsibility of the individual Digital-Business and is likely to be committed by the Governance Layer (101b of FIG. 1, 202b of FIG. 2a and 6475 of FIG. 33) on behalf of the Digital-Business.

Node Partners

The Node (200a-200e of FIG. 2, 380 and 375 of FIG. 2d) partners are other instances of the invention or functional equivalent that execute with a Governance Layer (101b of FIG. 1, 202b of FIG. 2a and 6475 of FIG. 33) and Information Layer (101c of FIG. 1 and 202c of FIG. 2a). Collectively, these Node partners form the peer-to-peer network.

Data Flow

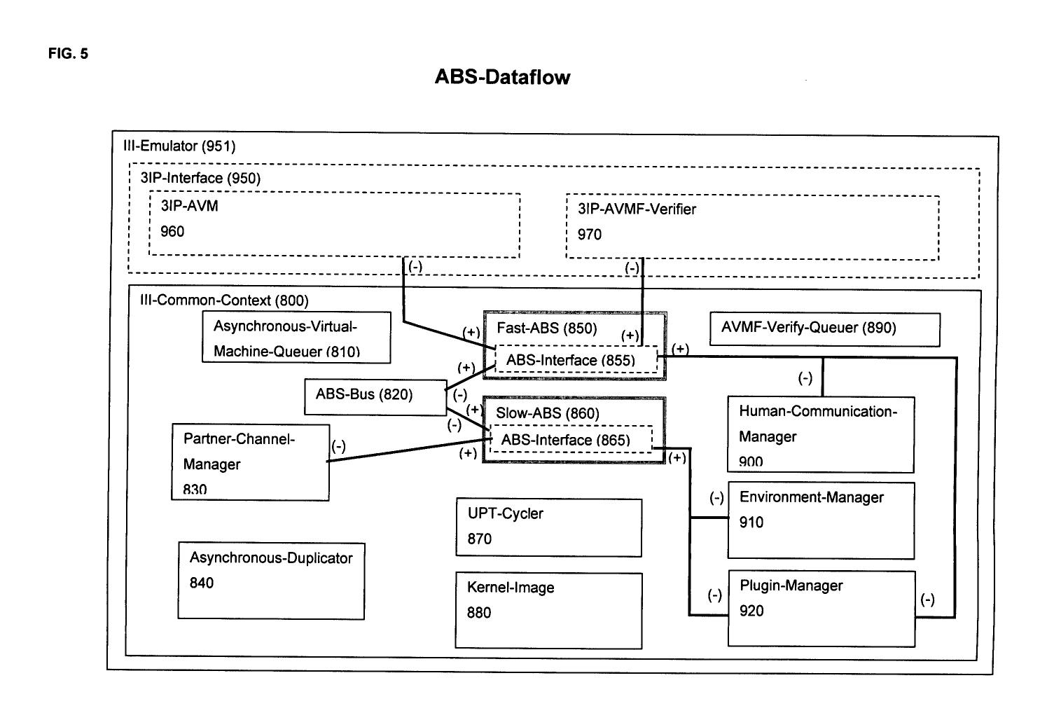

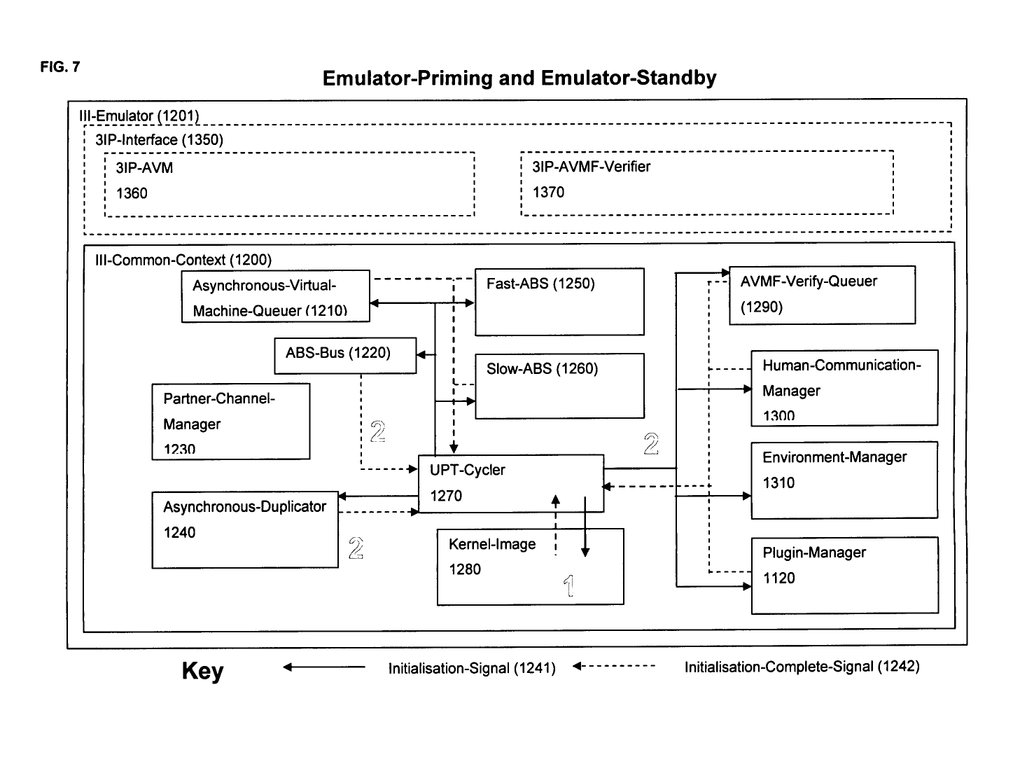

FIG. 3 shows the flow of information between Emulator-Components (FIGS. 3-8) in the III-Emulator (551 of FIG. 3, 751 of FIG. 4, 951 of FIG. 5, 1151 of FIG. 6, 1351 of FIG. 7, 1551 of FIG. 8 and 17001 of FIG. 74).

Primary-Dataflow

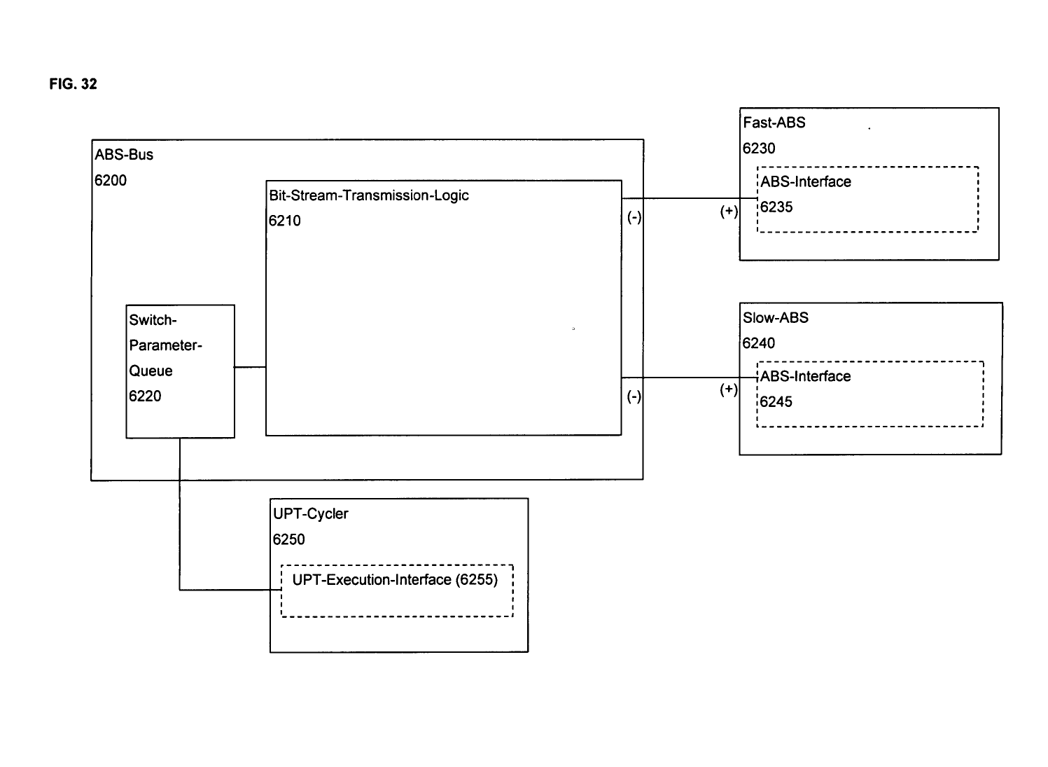

The Primary-Dataflow (see FIG. 3) is data generated by the UPT-Cycler (470 of FIG. 3, 1470 of FIG. 8 and 1600 of FIG. 9) as it enables computational completeness. The UPT-Cycler splits the information into Asynchronous-UPTs and Synchronous-UPTs. It is the Asynchronous-UPTs that are responsible for the Primary-Dataflow as they are processed in parallel by the asynchronous Emulator-Components. The UPT-Cycler establishes each Asynchronous-UPT process by using the UPT-Execution-Interface (see Appendix C for the Interface Definition). The Emulator-Components (FIGS. 3-8) involved in the Primary-Dataflow are the UPT-Cycler, Asynchronous-Virtual-Machine-Queuer (410 of FIG. 3), AVMF-Verify-Queuer (490 of FIG. 3), ABS-Bus (420 of FIG. 3 and 6200 of FIG. 32) and Asynchronous-Duplicator (440 of FIG. 3).

KI-Dataflow

The KI-Dataflow (see FIG. 4) involves every Emulator-Component and allows each to access the Kernel-Image (680 of FIG. 4 and Appendix G) via the KI-Interface. Once an Emulator-Component is processing an Asynchronous-UPT, it utilises a connection to the KI-Interface (see Appendix G) to manipulate information in the Kernel-Image (see Appendix G again). A single signal in the Primary-Dataflow will generate multiple calls to the KI-Interface by the Emulator-Components (FIGS. 3-8). Each Emulator-Component can be configured in a variety of ways, typically each has one or more dedicated connections to the KI-Interface most likely of low priority. The UPT-Cycler (1470 of FIG. 8 and 1600 of FIG. 9) can have numerous (typically six) high priority channels while the remaining connections by other Emulator-Components may be low priority.

ABS-Dataflow

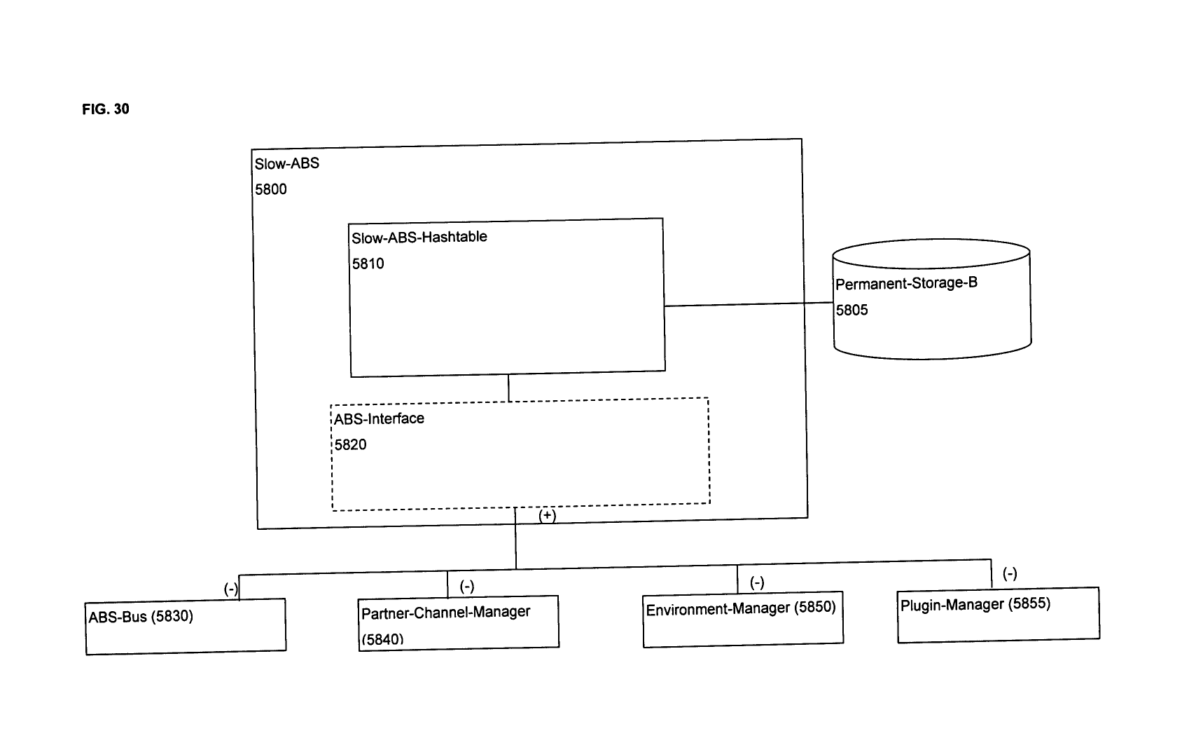

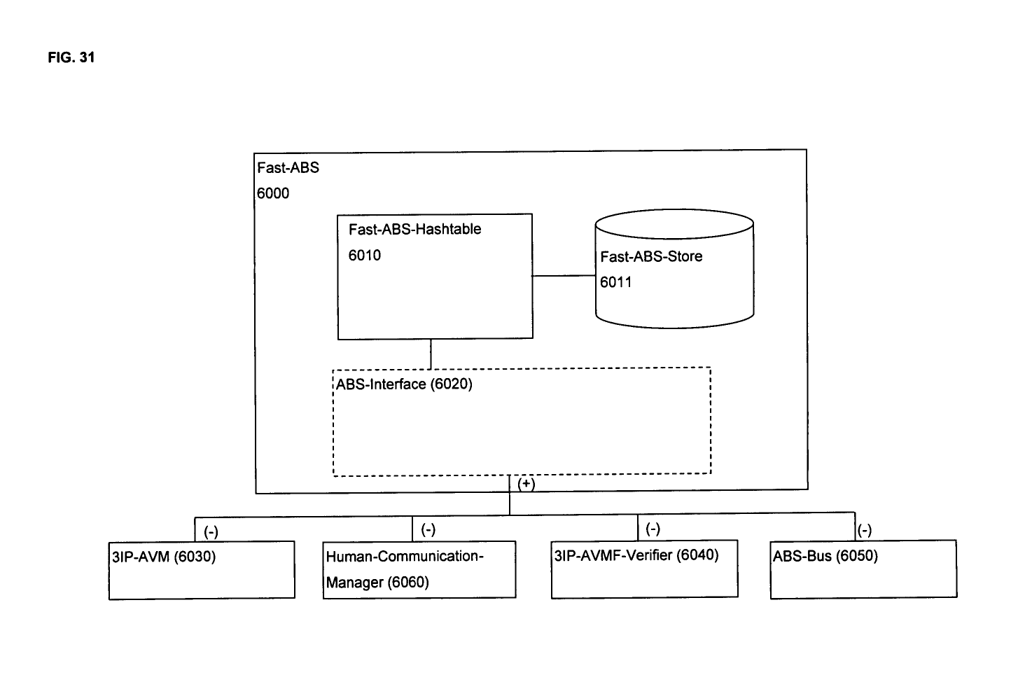

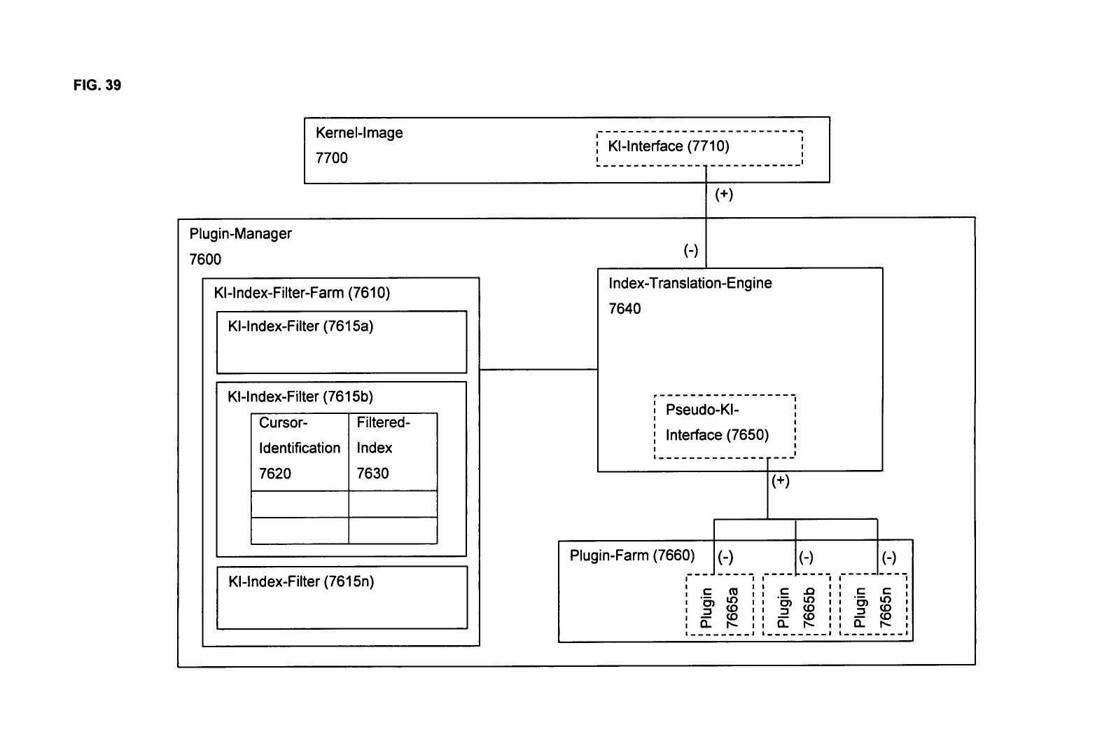

The Asynchronous-Bit-Streamer (ABS) dataflow or ABS-Dataflow (see FIG. 5) supports asynchronous data streams generated in parallel by both the Fast-ABS (850 of FIG. 5 and 6000 of FIG. 31) and the Slow-ABS (860 of FIG. 5 and 5800 of FIG. 30). The Slow-ABS involves the transfer of large quantities of data at a slower speed than the Fast-ABS. The Fast-ABS quickly transfers smaller quantities of data to components that are fast data processors including the UPT-Cycler (870 of FIG. 5, 1470 of FIG. 8 and 1600 of FIG. 9), 3IP-AVM (960 of FIG. 5 and 17200 of FIG. 75), 3IP-AVMF-Verifier (970 of FIG. 5, 17025 of FIG. 74 and 23000 of FIG. 91), Plugin-Manager (920 of FIG. 5 and 7600 of FIG. 39), ABS-Bus (820 of FIG. 5 and 6200 of FIG. 32) and the Human-Communication-Manager (900 of FIG. 5). The Slow-ABS is also used as a large-scale depository for data by various Emulator-Components (FIGS. 3-8). The Slow-ABS communicates with the Partner-Channel-Manager (830 of FIG. 5 and 13000 of FIG. 66) to manage data exchanges between Partners on the peer-to-peer network, the Environment-Manager (910 of FIG. 5 and 710 of FIG. 4) and the Plugin-Manager (920 of FIG. 5 and 7600 of FIG. 39). Digital-Businesses (8800 of FIG. 45) are able to access these Emulator-Components indirectly by storing data directly to the Fast-ABS or Slow-ABS by attaching files directly to Manabars-Sets (see Appendix G).

IO-Dataflow

The IO-Dataflow (see FIG. 6) captures all data entering and leaving the III-Emulator (551 of FIG. 3, 751 of FIG. 4, 951 of FIG. 5, 1151 of FIG. 6, 1351 of FIG. 7, 1551 of FIG. 8 and 17001 of FIG. 74) via the Host Platform Layer (101z of FIG. 1 and 202z of FIG. 2a).

The Human-Communication-Manager (1100 of FIG. 6) interfaces with the user via local display and capture equipment to obtain and transmit Sensory-Render-Data (1130c of FIG. 6). Environmental-Data (1130d of FIG. 6) is received from the Environment-Manager (710 of FIG. 4 and 1110 of FIG. 6). Plugin-Data (1130e of FIG. 6) data is received from the installed Plugins (7665a, 7665b and 7665n of FIG. 39) of the Plugin-Manager (1120 of FIG. 6 and 7600 of FIG. 39) and includes other forms of input such as mouse and keyboard events. The III-Emulator operates in a grid network where there are numerous 3Ips (see 3IP-Interface at 17000 of FIG. 74), each implemented by both building the III-Common-Context (400 of FIG. 3 and 17035 of FIG. 74) and extending the 3IP-Interface (1150 of FIG. 6) that may be of a unique design. The protocol for communicating with partners is undefined and is referred to as the PCM-Interface (1130a of FIG. 6 and 130125 of FIG. 66). The PCM-Interface (see Appendix C) is defined only by its behaviour and not its mechanics, so it is abstract. The Partner-Channel-Manager (1030 of FIG. 6 and 13000 of FIG. 66) is responsible for implementing the PCM-Interface (130125 of FIG. 66). The UPT-Cycler (1070 of FIG. 6 and 1600 of FIG. 9) moves information into the Permanent-Storage-A (1130f of FIG. 6 and 1700 of FIG. 9) whose encoding is arbitrary and beyond the scope of this patent. Permanent-Storage-A operates by serialising the Kernel-Image state so that it can be reproduced at start-up. The UPT-Cycler is able to reproduce the entire Powerset into the Kernel-Image (see Appendix G) from the Permanent-Storage-A. The Kernel-Image is not saved to the Permanent-Storage-A in a single iteration. Instead, each Digital-Business (8800 of FIG. 45) is reconstructed individually when each Digital-Business last saved itself.

Starting and Shutting Down the Invention

Start Up

The start-up sequence occurs in 4 stages:—

(1) Emulator-Priming

All Emulator-Components (FIGS. 3-8) remain dormant on powering up except for the UPT-Cycler (470 of FIG. 3 and 1600 of FIG. 9).

UPT-Cycler-Bootstrap

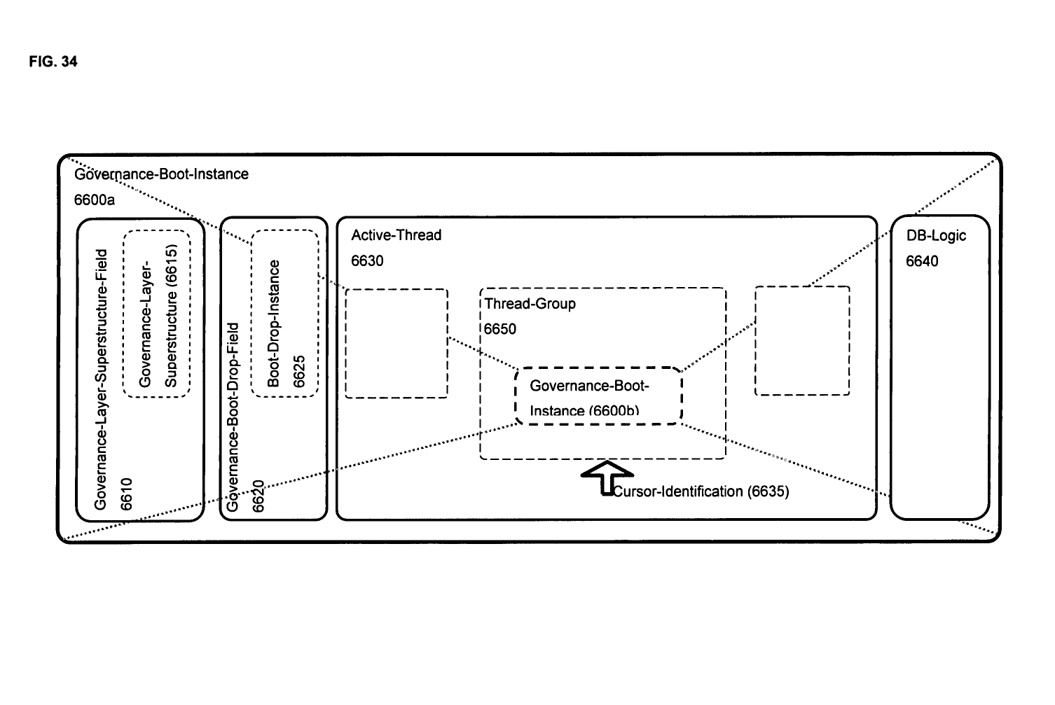

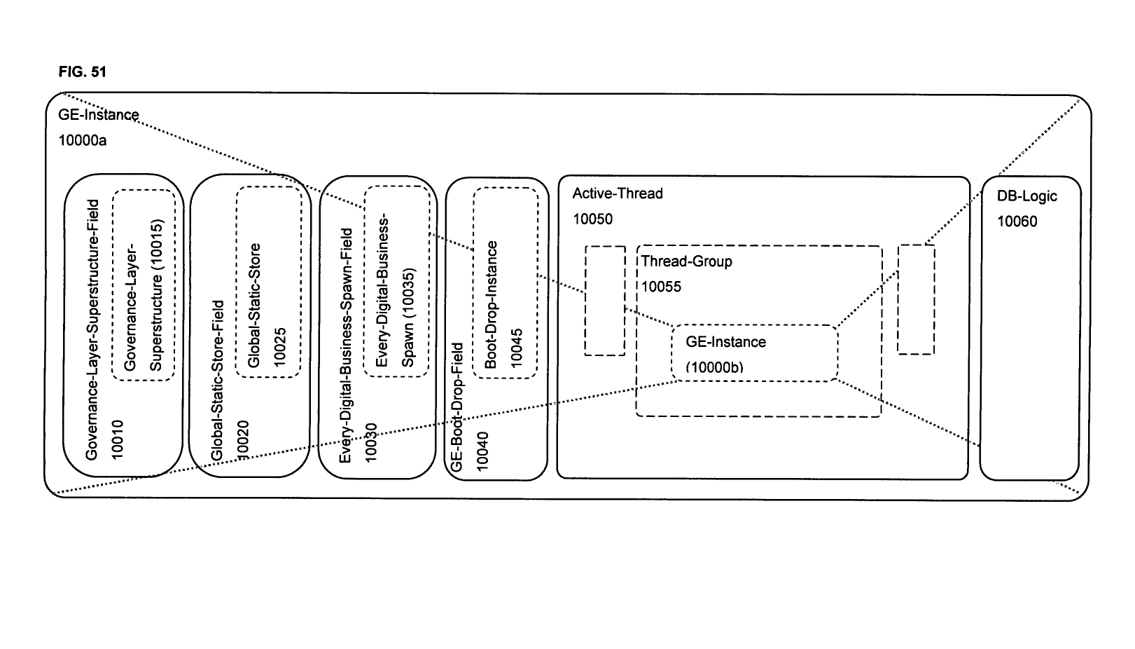

The UPT-Cycler starts the GL-Bootstrapper (1610 of FIG. 9), which clears (1 of FIG. 7) the Kernel-Image with the Reset KI-Interface method (see Appendix C for Interface-Definition). Once the Reset KI-Interface method has returned, data arrives in an implementation specific format from the Permanent-Storage-A (1130f of FIG. 6 and 1700 of FIG. 9) to the GL-Bootstrapper. The GL-Bootstrapper then loads the Powerset (6400 of FIG. 33) that contains the Governance-Layer-Superstructure (6615 of FIG. 34, 10015 of FIG. 51 and 6410 of FIG. 33) into the KI-Memory (see Appendix G) via the KI-Interface (see Appendix-C for Interface-Definition). Some implementations may choose to preload the Kernel-Image prior to start-up in order to accelerate the boot up process. The state of the KI-Memory is now set to a pre-configured Powerset image stored in the Permanent-Storage-A. If there was no pre-configured Powerset image stored in the Permanent-Storage-A then the III-Emulator (551 of FIG. 3, 751 of FIG. 4, 951 of FIG. 5, 1151 of FIG. 6, 1351 of FIG. 7, 1551 of FIG. 8 and 17001 of FIG. 74) is shutdown.

(1) Governance-Layer Loading

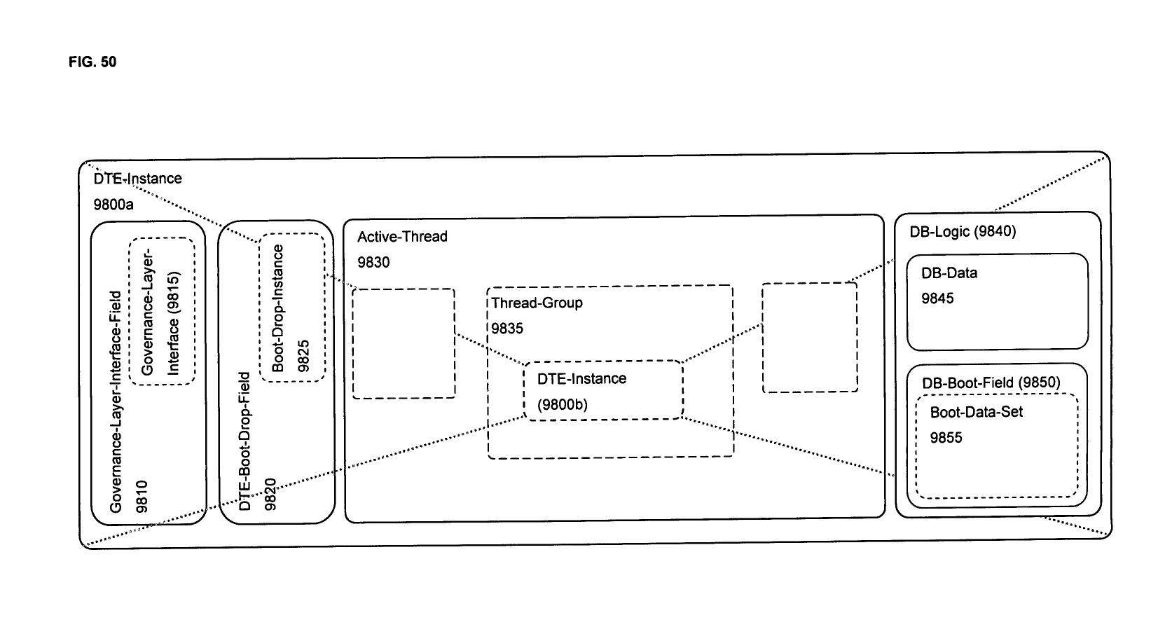

The state of the Governance-Layer-Superstructure (6615 of FIG. 34, 10015 of FIG. 51 and 6410 of FIG. 33) is almost identical to its state when it was last shutdown. The only difference is that the state of each Digital-Business (8800 of FIG. 45) within it is reconstructed using the last known state of each Digital-Business. These states were previously stored to the Permanent-Storage-A (1130f of FIG. 6 and 1700 of FIG. 9) at a time that was convenient for each Digital-Business. The Governance Layer (101b of FIG. 1, 202b of FIG. 2a and 6475 of FIG. 33) operates from a set structure known as the Governance-Execution (9430 of FIG. 48). The Digital-Business operates from a set structure known as the DTE-Instance (9800a and 9800b of FIG. 50). The entire Governance-Execution (9430 of FIG. 48) and part of the DTE-Instance holding the execution stacks known as the Active-Thread (6630 of FIG. 34, 9830 of FIG. 50 and 10050 of FIG. 51) are transient, so all information in these components are lost on system shutdown. Therefore, the last known state of the Digital-Business does not contain anything inside the Governance-Execution, and only contains the saved copy of the Design-Time-Execution (9420 of FIG. 48) up to the Active-Thread. As each Digital-Business is reconstructed it will be mapped to previous references held within the Governance-Layer-Superstructure (6410 of FIG. 33, 6615 of FIG. 34 and 10015 of FIG. 51). Any references inside the Governance-Layer-Superstructure to Digital-Businesses that no longer exist will be deleted.

(2) Emulator-Standby

Following a successful loading process, the GL-Bootstrapper (1610 of FIG. 9) sends the Initialisation-Signal (1241 of FIG. 7 and 1720 of FIG. 9) to all Emulator-Components (FIGS. 3-8). This signal generated via the KI-Interface (see Appendix C for Interface-Definition) to transmit the signal with the KI-Broadcast instruction (see Appendix G). The Emulator-Components require the Kernel-Image (see Appendix G again) to be loaded in order to complete their own initialisation routines. Once each of these Emulator-Components has completed its initialisation routine, they return from the KI-Broadcast KI-Interface method to generate the Initialisation-Complete-Signal (1242 of FIG. 7 and 1730 of FIG. 9). Once there is an Initialisation-Complete-Signal for each Initialisation-Signal issued, the Governance Layer (101b of FIG. 1, 202b of FIG. 2a and 6475 of FIG. 33) is booted by the UPT-Cycler (1470 of FIG. 8 and 1600 of FIG. 9).

(3) Governance-Boot

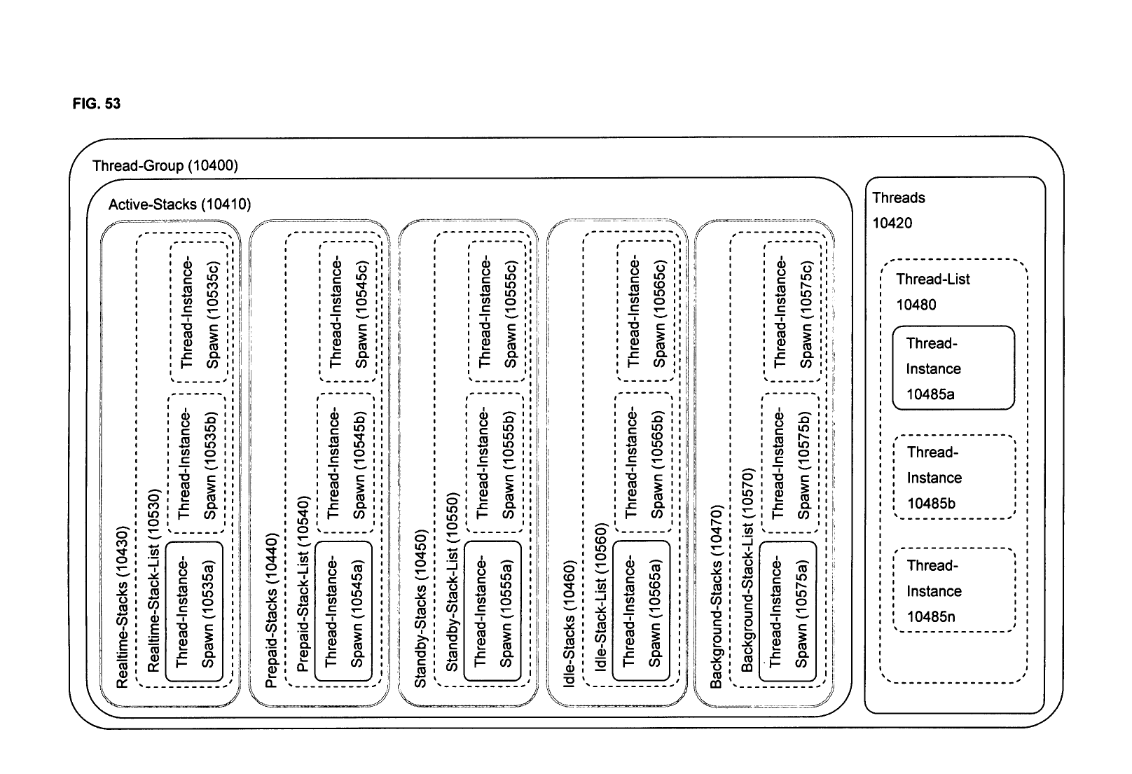

Each Governance-Boot-Instance (6498 of FIG. 33, 6600a and 6600b of FIG. 34) contained in Every-Governance-Boot (6460 of FIG. 33) is executed (see UPT-Cycler) in a series from Left to Right. Prior to normal operation all execution occurs virtually to the III-Emulator (551 of FIG. 3, 751 of FIG. 4, 951 of FIG. 5, 1151 of FIG. 6, 1351 of FIG. 7, 1551 of FIG. 8 and 17001 of FIG. 74) within the Kernel-Image (see Appendix G), with a series of foundation instructions known as Universal-Process-Types (UPTs), covered in Appendix B. A Governance-Boot-Instance is only executed once the Governance-Boot-Instance to the Left of it has completed execution. This occurs once all the Stacks inside the Thread-Instance (10485a, 10485b, 10485n of FIG. 53 and 10600 of FIG. 54) for the Governance-Boot-Instance are empty.

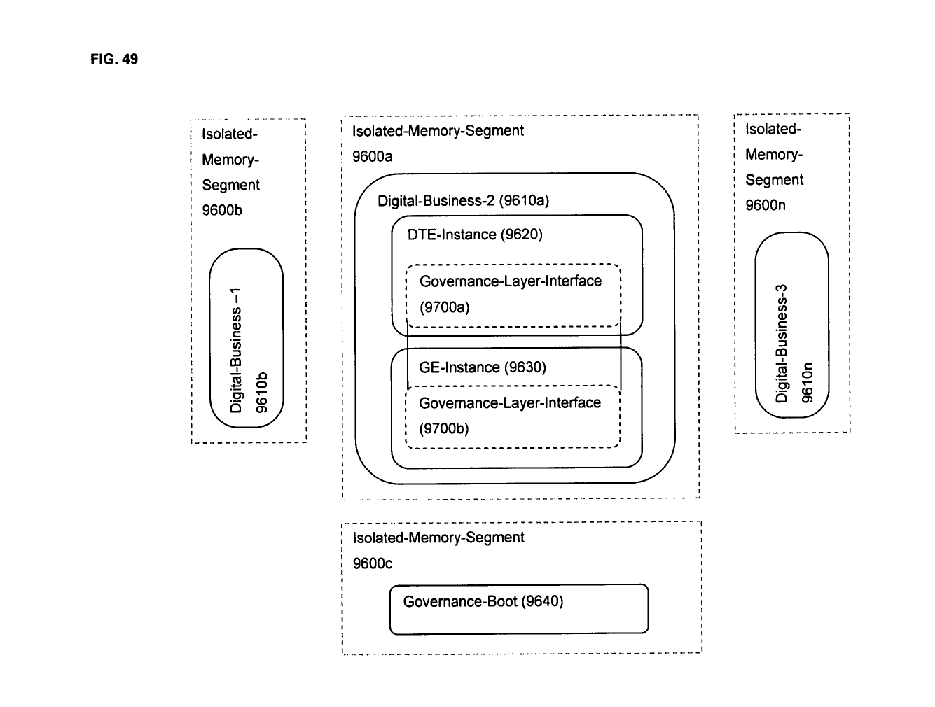

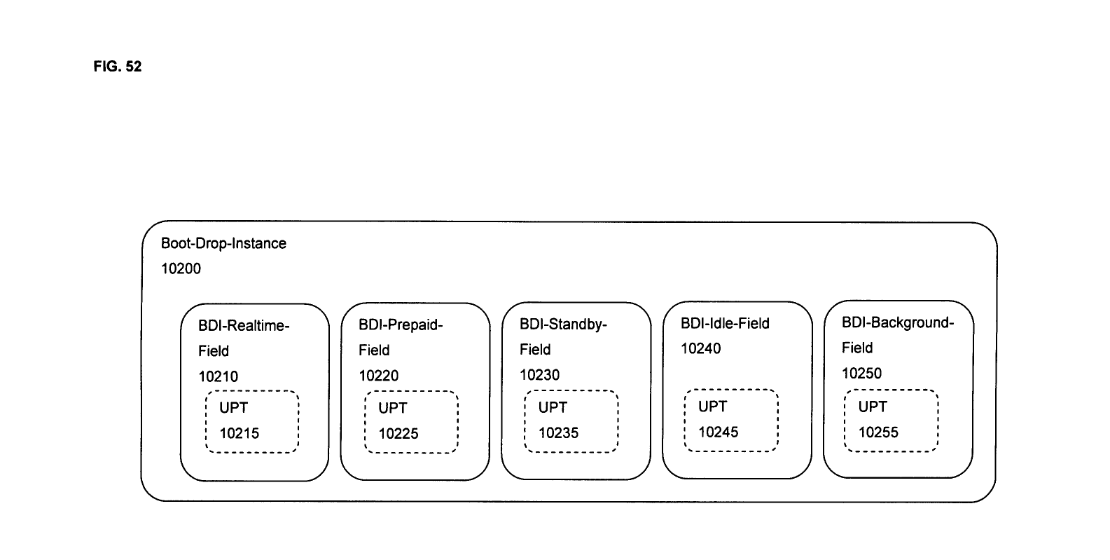

During the Governance-Boot (9640 of FIG. 49) process the Governance-Boot is responsible for:
(a) The cleanup of the Governance-Layer-Superstructure (6410 of FIG. 33, 6615 of FIG. 34 and 10015 of FIG. 51).
(b) Configuring Digital-Businesses (8800 of FIG. 45) contained in Every-Digital-Business (6450 of FIG. 33)—a process that includes resetting the state of the Digital-Business so that it is ready to be processed. This part of the Governance-Boot (9640 of FIG. 49) process is beyond the scope of this patent, however it is included here to assist in clarifying understanding of the III-Emulator operation. The Governance-Boot process:
   (i) Makes a recursive copy of the Governance-Layer (6475 of FIG. 33) into each Governance-Execution (9430 of FIG. 48).
   (ii) Install a reference to the Global-Static-Store (6440 of FIG. 33, 6800 of FIG. 35 and 10025 of FIG. 51) into the Global-Static-Store-Field (10020 of FIG. 51) inside the copies of the Governance-Layer (6475 of FIG. 33).
   (iii) Create a thread group in the DTE-Instance (9800a, 9800b of FIG. 50).
   (iv) Providing Object Orientated support through the creation of a Linker and Booter embedded in the GE-Instance (9435 of FIG. 48, 9630 of FIG. 49, 10000a of FIG. 51 and 10000b of FIG. 51). Locate the Boot-Drop-Instance (6625 of FIG. 34, 9825 of FIG. 50, 10045 of FIG. 51 and 10200 of FIG. 52) found within the GE-Boot-Drop-Field (10040 of FIG. 51), and the Thread-Instance (10600 of FIG. 54 and 10485a-10485n of FIG. 53), found in the Thread-Group (6650 of FIG. 34, 9835 of FIG. 50, 10400 of FIG. 53 and 10055 of FIG. 51), of the GE-Instance (9435 of FIG. 48, 9630 of FIG. 49, 10000a and 10000b of FIG. 51). Use UPT-Recursive-Copy (see Appendix B) to copy the Child of the BDI-Realtime-Field (10210 of FIG. 52), found in the Boot-Drop-Instance into the Realtime-Stack (10430 of FIG. 53 and 10610 of FIG. 54) of the Thread-Instance. Likewise insert the Child of the BDI-Prepaid-Field (10220 of FIG. 52) into the Prepaid-Stack (10440 of FIG. 53 and 10620 of FIG. 54), the Child of the BDI-Standby-Field (10230 of FIG. 52) into the Standby-Stack (10630 of FIG. 54), the Child of the BDI-Idle-Field (10240 of FIG. 52) into the Idle-Stack (10460 of FIG. 53 and 10640 of FIG. 54) and the Child of the BDI-Background-Field (10250 of FIG. 52) into the Background-Stack (10470 of FIG. 53 and 10650 of FIG. 54). Repeat the same Recursive-Copy for the Children of the fields of the Boot-Drop-Instance (6625 of FIG. 34, 10045 of FIG. 51 and 9825 of FIG. 50 and 10200 of FIG. 52) found within the DTE-Boot-Drop-Field (9820 of FIG. 50) into the stacks of the newly created Thread-Instance (10485a, 10485b, 10485n of FIG. 53 and 10600 of FIG. 54) inside the Thread-Group (6650 of FIG. 34, 10055 of FIG. 51, 10400 of FIG. 53 and 9835 of FIG. 50) of the DTE-Instance (9800a, 9800b of FIG. 50, 6476 of FIG. 33, 9425 of FIG. 48 and 9620 of FIG. 49).

(4) Emulator-Engagement

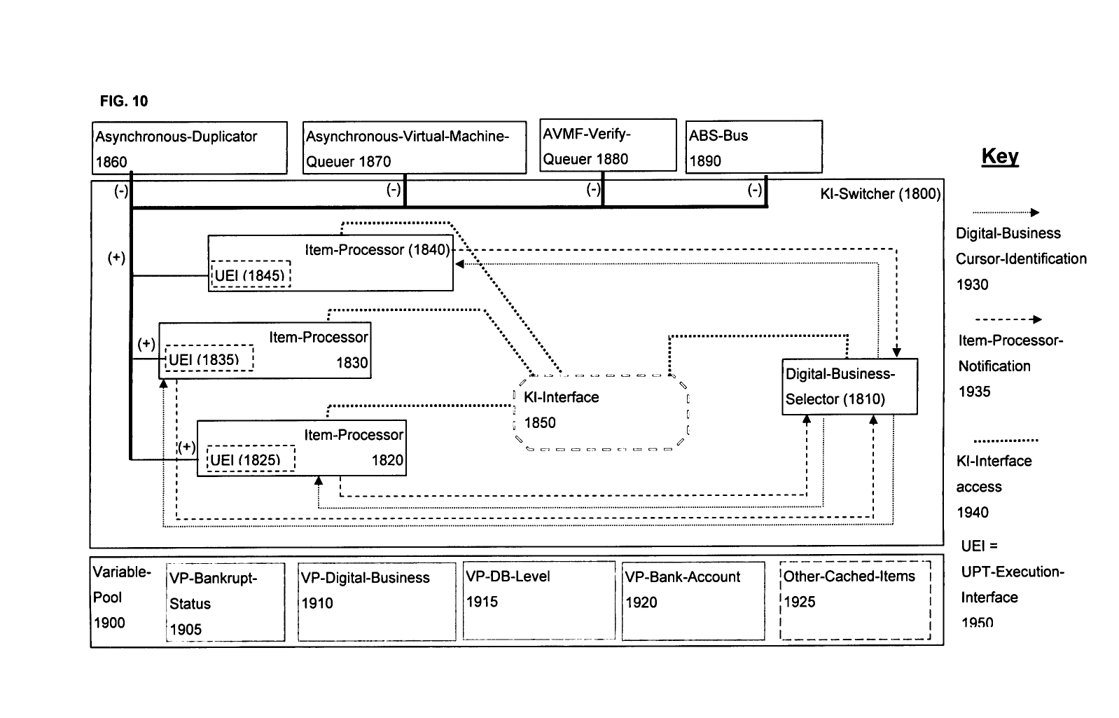

The GL-Bootstrapper (1610 of FIG. 9) transmits the On-Signal (1740 of FIG. 9) to the KI-Switcher (1630 of FIG. 9 and 1800 of FIG. 10). The KI-Switcher begins processing Digital-Business-Cycles until it is shutdown with the Off-Signal (1750 of FIG. 9) or if the Host Platform Layer (101z of FIG. 1 and 202z of FIG. 2) fails.

Shutdown

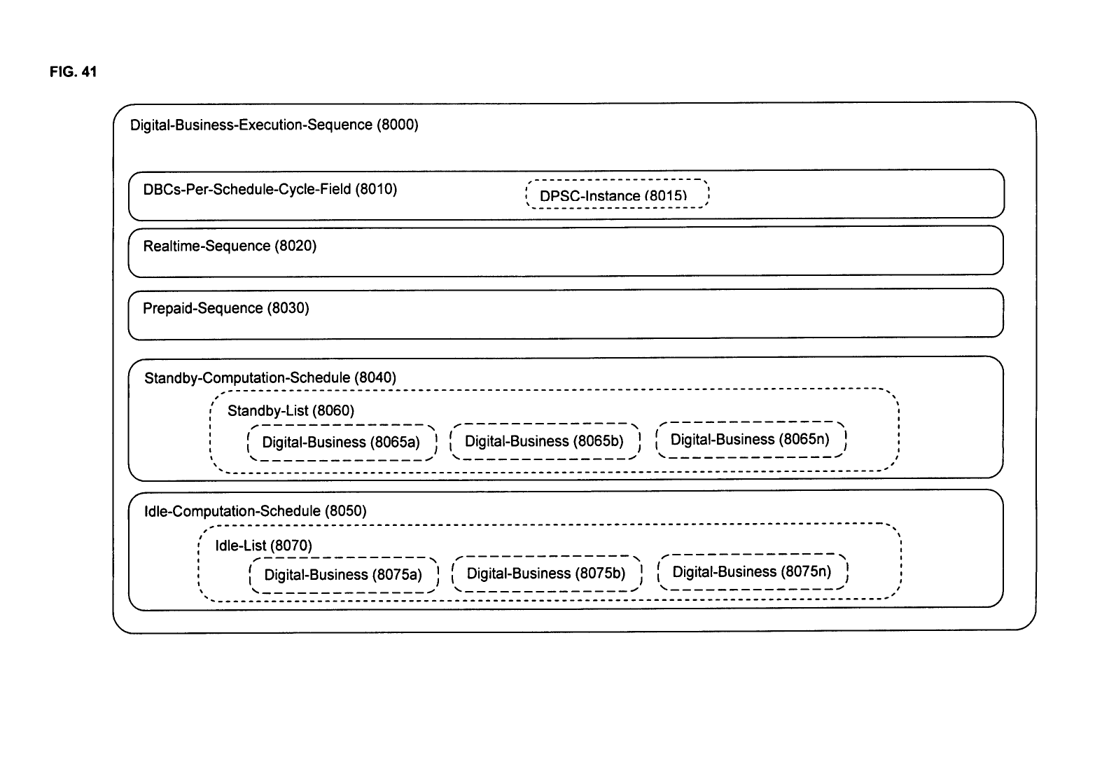

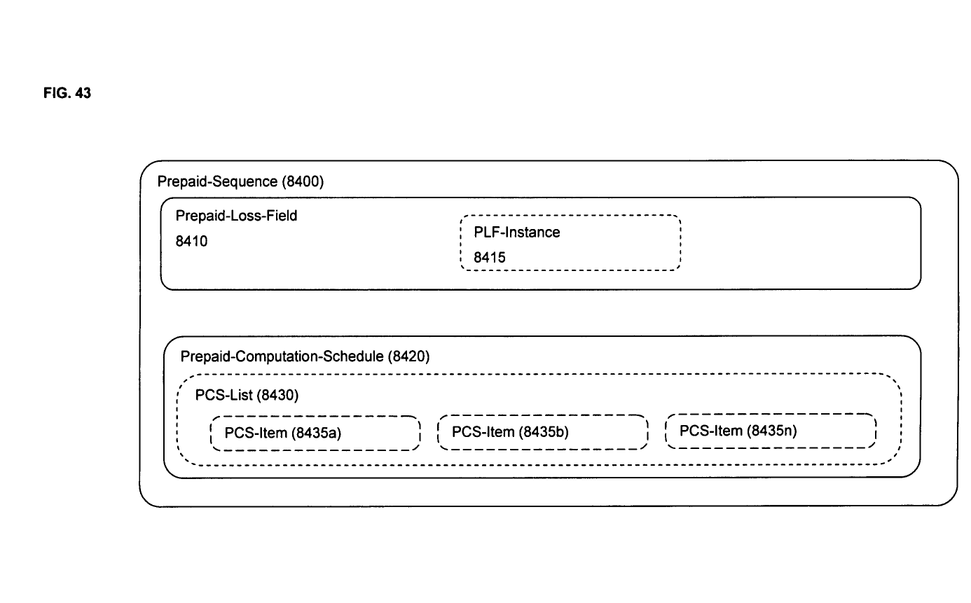

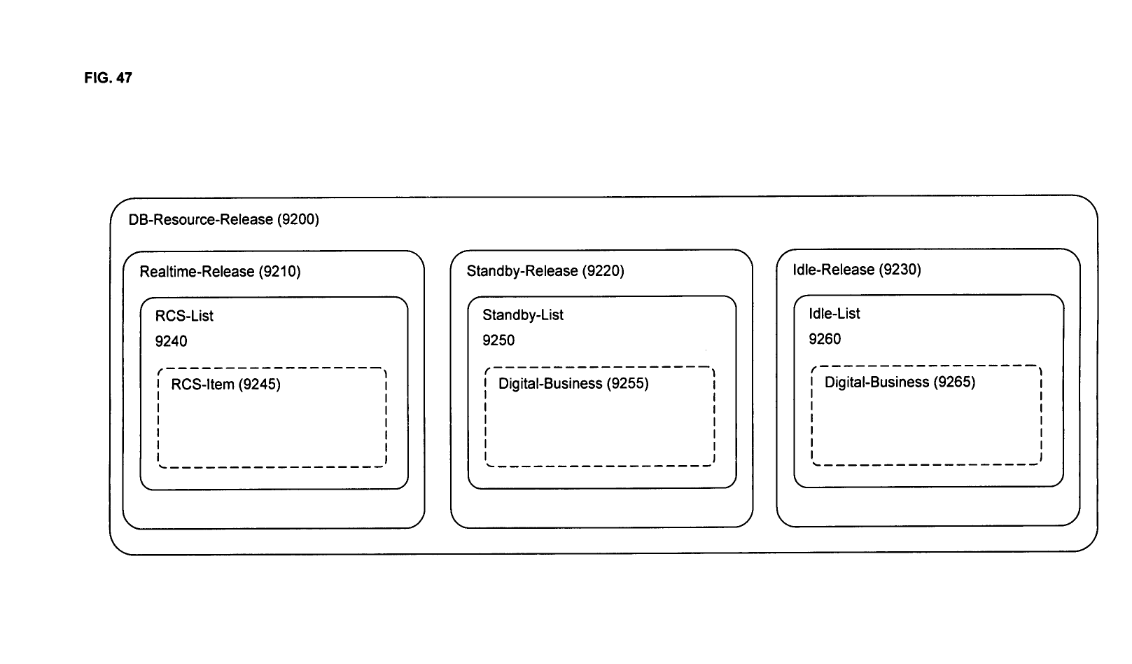

Shutdown of the invention can occur through 2 mechanisms.
(1) The Host Platform Layer (101z of FIG. 1 and 202z of FIG. 2) fails to support the invention, typically through hardware failure or loss of power. During the execution of the III-Emulator (551 of FIG. 3, 751 of FIG. 4, 951 of FIG. 5, 1151 of FIG. 6, 1351 of FIG. 7, 1551 of FIG. 8 and 17001 of FIG. 74), the Governance-Layer-Superstructure (6410 of FIG. 33, 6615 of FIG. 34 and 10015 of FIG. 51) and each Digital-Business (8800 of FIG. 45) is periodically saved. How these saves occur is explained further in UPT-Cycler (1470 of FIG. 8 and 1600 of FIG. 9). These periodic saves means that if the Host Platform Layer fails to support the invention then the start-up sequence is able to utilise the last known state of the Governance-Layer-Superstructure (6410 of FIG. 33, 6615 of FIG. 34 and 10015 of FIG. 51) and each Digital-Business (8800 of FIG. 45) when the III-Emulator is restarted.
(2) A controlled shutdown is directed from the Governance-Layer-Superstructure (6410 of FIG. 33, 6615 of FIG. 34 and 10015 of FIG. 51) and occurs when the Emulator-Shutdown (7250 of FIG. 37) has its Type set to Type-True. The UPT-Cycler (1470 of FIG. 8 and 1600 of FIG. 9) should monitor the Emulator-Shutdown for this event and reset the Type to Type-False. At this point the Off-Signal (1750 of FIG. 9) is sent to the KI-Switcher (1630 of FIG. 9 and 1800 of FIG. 10) and the entire Powerset (6400 of FIG. 33) should be saved, stopping at the Realtime-Computation-Schedule (9240 of FIG. 47), Prepaid-Computation-Schedule (8420 of FIG. 43), Standby-Computation-Schedule (8040 of FIG. 41 and 9250 of FIG. 47), Idle-Computation-Schedule (8050 of FIG. 41 and 9260 of FIG. 47) and Every-Digital-Business (6450 of FIG. 33). Each Digital Business (8800 of FIG. 45) held in Every-Digital-Business should also then be systematically saved, stopping at the Governance-Execution (9430 of FIG. 48) and the Active-Thread (9830 of FIG. 50, 6630 of FIG. 34 and 10050 of FIG. 51) of the DTE-Instance (6476 of FIG. 33, 9425 of FIG. 48, 9620 of FIG. 49 and 9800a and 9800b of FIG. 50). This ensures that the next time the III-Emulator (551 of FIG. 3, 751 of FIG. 4, 951 of FIG. 5, 1151 of FIG. 6, 1351 of FIG. 7, 1551 of FIG. 8 and 17001 of FIG. 74) is started, the last known state of the Governance. Layer (101b of FIG. 1, 202b of FIG. 2a and 6475 of FIG. 33) and each Digital-Business will be exactly as it was when it was shutdown.
   THE Manabars-Set

The Manabars-Set is a mechanism to represent Set Theory for a computational environment and is described in Appendix G as an additional patent.

UPT-Cycler

The UPT-Cycler (470 of FIG. 3, 1470 of FIG. 8 and 1600 of FIG. 9) is responsible for managing the structure of the Kernel-Image (see Appendix G) through the KI-Interface (see Appendix C for Interface-Definition). The UPT-Cycler maintains the context of the virtual data inside the Kernel-Image, specifically in how the Governance Layer (101b of FIG. 1, 202b of FIG. 2 and 6410 of FIG. 33) is presented. The UPT-Cycler is key to understanding the usefulness of the III-Emulator (551 of FIG. 3, 751 of FIG. 4, 951 of FIG. 5, 1151 of FIG. 6, 1351 of FIG. 7, 1551 of FIG. 8 and 17001 of FIG. 74), as it interacts with Manabars-Sets (see Appendix G) inside the Governance Layer. Primarily, the UPT-Cycler enables computational completeness by processing Universal-Process-Types or UPTs (see Appendix B) as instructions. Secondly, the UPT-Cycler configures the Governance Layer so that it behaves as an abstract Operating System that resides on the III-Emulator. The UPT-Cycler operates across the Global-Static-Store (6440 of FIG. 33, 6800 of FIG. 35 and 10025 of FIG. 51) whose superstructure is considered part of the invention, but the definition of Governance-Layer-Interface (9500a and 9500b of FIG. 48, 9700a, 9700b of FIG. 49 and 9815 of FIG. 50) is not. The Governance Layer is an adjacent layer to the invention (101a of FIG. 1 and 202a of FIG. 2a) and its full definition is dynamic and so is beyond the scope of this patent. However, the KI-Switcher (1630 of FIG. 9 and 1800 of FIG. 10), which defines the UPT-Cycler behaviour after the On-Signal (1740 of FIG. 9) and before the Off-Signal (1750 of FIG. 9) handles its interaction with the adjacent Governance Layer through the Global-Static-Store (6440 of FIG. 33, 6800 of FIG. 35 and 10025 of FIG. 51).

The UPT-Cycler constructs the Kernel-Image (see Appendix G) state on start up (see Starting and Shutting down the Invention), which includes the installation of the Governance-Layer (6475 of FIG. 33) as a previously stored image in Permanent-Storage-A (1130f of FIG. 6 and 1700 of FIG. 9) through the use of the GL-Bootstrapper (1610 of FIG. 9) during the Emulator-Priming, Emulator-Standby and Governance-Boot (9640 of FIG. 49) stages. Once the initial conditions have been established, the Emulator-Engagement stage begins, during which, the KI-Switcher (1630 of FIG. 9 and 1800 of FIG. 10) manipulates the KI-Memory (see Appendix G) in an orderly way, so as to produce computational completeness. The Variable-Pool (1900 of FIG. 10 and 1640 of FIG. 9) provides transient state information for the Kl-Switcher and behaves as an optimised fast memory cache (see Variable Pool of FIG. 9).

Asynchronous Processing

The KI-Switcher (1630 of FIG. 9 and 1800 of FIG. 10) processes UPTs, splitting the instructions into 2 groups. The first group are synchronous UPTs that can be completed immediately using the KI-Switcher. The second group are asynchronous UPTs that require additional processing by dedicated Emulator-Components (FIGS. 3-8). The asynchronous UPTs are delivered to the appropriate Emulator-Components by using the Primary-Dataflow (FIG. 3) by way of the UPT-Execution-Interface (475 of FIG. 3, 1635 of FIG. 9, 6255 of FIG. 32 and Appendix C for Interface-Definition). The asynchronous UPTs are transmitted to the Asynchronous-Virtual-Machine-Queuer (410 of FIG. 3), ABS-Bus (420 of FIG. 3 and 6200 of FIG. 32), Asynchronous-Duplicator (440 of FIG. 3) and the AVMF-Verify-Queuer (490 of FIG. 3). Therefore, no matter what the UPT, the KI-Switcher can be guaranteed of returning immediately and thus preserve the real-time properties of the III-Emulator (551 of FIG. 3, 751 of FIG. 4, 951 of FIG. 5, 1151 of FIG. 6, 1351 of FIG. 7, 1551 of FIG. 8 and 17001 of FIG. 74). The UPT-Cycler (1600 of FIG. 9 and 1470 of FIG. 8) makes these asynchronous instructions appear as if they are synchronous by blocking any further execution of the Digital-Business (8800 of FIG. 45) that is utilising a UPT that invokes the asynchronous instruction. The blocking of the Digital-Business is accomplished by inserting a new Child with its Type set to Type-Locked into the Activity-Status-Field (9440 of FIG. 48).

Saving the Digital-Businesses

Periodically, Digital-Businesses (8800 of FIG. 45) may make requests to preserve their state via the Governance-Layer-Interface (9500a and 9500b of FIG. 48, 9700a, 9700b of FIG. 49 and 9815 of FIG. 50). However, the Governance-Layer (6475 of FIG. 33) is likely to forward these requests to the Global-Static-Store (6440 of FIG. 33, 6800 of FIG. 35 and 10025 of FIG. 51) and is accessed directly by the UPT-Cycler (1600 of FIG. 9 and 1470 of FIG. 8) through the KI-Interface (see Appendix C for Interface-Definition). The Governance-Layer (6475 of FIG. 33) directs the UPT-Cycler to commit the save by inserting a reference to the Digital-Business (8800 of FIG. 45) directly into the DB-Save (7240 of FIG. 37). On detecting this (see Monitors), the UPT-Cycler locks the Digital-Business by inserting a Child with a Type of Type-Locked into the Neutral position of the Activity-Status-Field (9440 of FIG. 48) and then stores the entire state of the Design-Time-Execution (9420 of FIG. 48) to Permanent-Storage-A (1130f of FIG. 6 and 1700 of FIG. 9), in an implementation specific format that is beyond the scope of this patent, by using the KI-Interface (see Appendix C for Interface-Definition). The Governance-Execution (9430 of FIG. 48) is transient, so its state is not recorded. If the Activity-Status-Field (9440 of FIG. 48) has a Child already of Type Type-Locked, prior to the scheduled save, then it should be postponed until the status reflects unlocked. If the save did take place, then an additional Child of Type Type-Unlock should be inserted into the Neutral position of the Activity-Status-Field. The UPT-Cycler continues to process other Digital-Businesses during the save. Finally, it removes the Digital-Business reference from the DB-Save.

Saving the Governance Layer

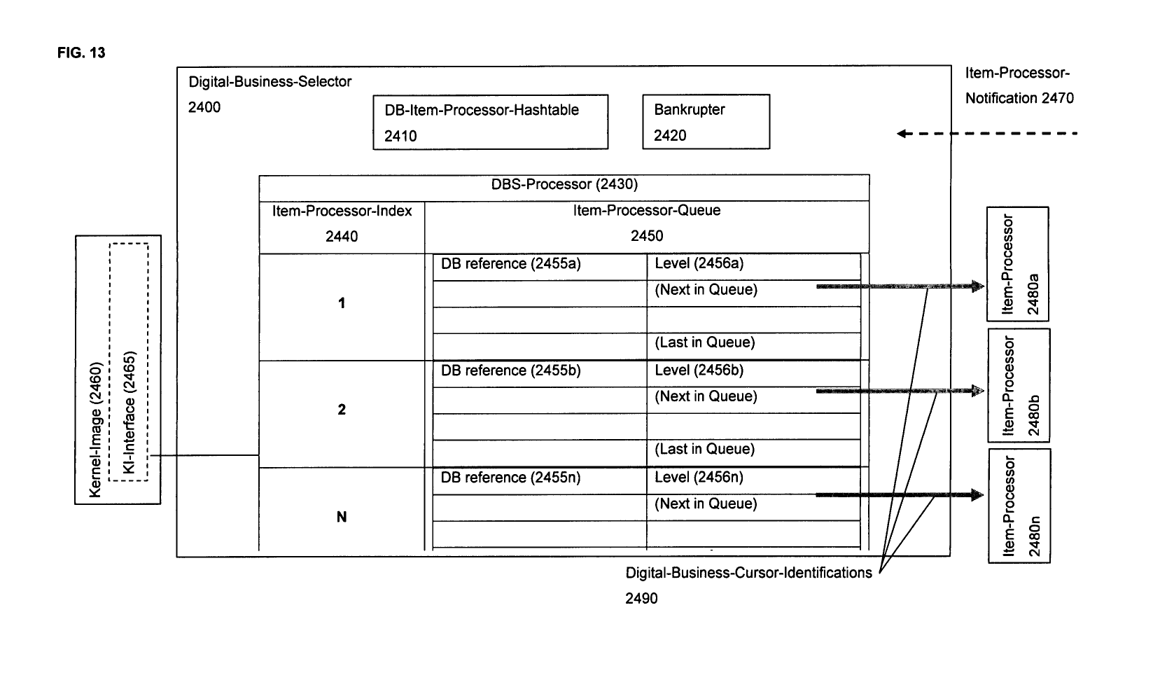

Periodically, the Governance-Layer (6475 of FIG. 33) may authorise its own saving by passing a Type-True to the GL-Save (7230 of FIG. 37). On detecting this, the UPT-Cycler (1470 of FIG. 8 and 1600 of FIG. 9) begins saving the Governance Layer. It does this in the following way.
(i) For the duration of the save, the Digital-Business-Selector (1810 of FIG. 10 and 2400 of FIG. 13) of the KI-Switcher (1630 of FIG. 9 and 1880 of FIG. 10) no longer processes UPTs from the GE-Instance (9435 of FIG. 48, 9630 of FIG. 49, 10000a and 10000b of FIG. 51) for any Digital-Business (8800 of FIG. 45) and substitutes these with UPTs (see Appendix B) from the DTE-Instance (9425 of FIG. 48, 9800a of FIG. 50) of Digital-Businesses instead.
(ii) This creates a temporary surge in DTE-Instance processing, but during this time, the Governance-Layer (6475 of FIG. 33) is saved. The Governance-Layer may compensate for the surge by clearing all prepaid contracts or reducing the load on the UPT-Cycler (1470 of FIG. 8 and 1600 of FIG. 9) to reduce the chip temperature in an FPGA fabric implementation. A lower chip temperature allows for a surge of processing to occur once the save has been completed in order to honour prepaid contracts. All references to any Digital-Business are saved but the Children inside the Digital-Business are not as these are replaced with the actual Digital-Business state that has previously been saved independently.
(iii) Once saved, as an optional step to improve performance, the Digital-Business-Selector (1810 of FIG. 10 and 2400 of FIG. 13) of the KI-Switcher (1630 of FIG. 9 and 1880 of FIG. 10) may statistically substitute DBCs destined for the DTE-Instance (10000a and 10000b of FIG. 51) and apply them to the GE-Instance (9800a and 9800b of FIG. 50) instead to make up for lost processing during the first step during the original save.
(iv) The Type-True is removed from the GL-Save (7230 of FIG. 37).
   Digital-Business Solvency

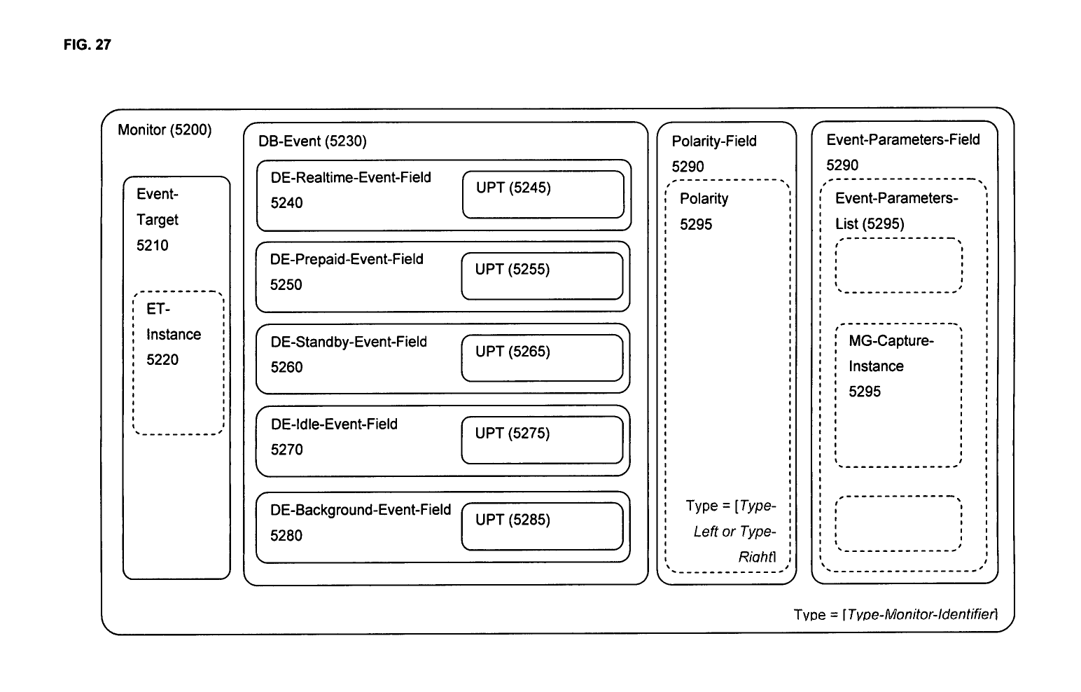

Occasionally a Digital-Business (8800 of FIG. 45) will become bankrupt. On this occasion the Bankrupter (2420 of FIG. 13 and see further below) will spawn the Cursor of Every-Digital-Business (6450 of FIG. 33) and insert a reference to the spawned Cursor inside the DB-Delete (7260 of FIG. 37). The UPT-Cycler (1470 of FIG. 8 and 1600 of FIG. 9) should have previously set a Monitor (5200 of FIG. 27) on the DB-Delete (7260 of FIG. 37) to detect this event and
(i) Delete any references to the Digital-Business in the Permanent-Storage-A (130f of FIG. 6 and 1700 of FIG. 9),
(ii) Use the spawned Cursor in DB-Delete to remove the Digital-Business from Every-Digital-Business.
(iii) Governance-Layer (6475 of FIG. 33) contracts for the insolvent Digital-Business are removed.
(iv) Any image of the insolvent Digital-Business is removed from Permanent-Storage-A.
   KI-Switcher

Although the III-Emulator (551 of FIG. 3, 751 of FIG. 4, 951 of FIG. 5, 1151 of FIG. 6, 1351 of FIG. 7, 1551 of FIG. 8 and 17001 of FIG. 74) has numerous Emulator-Components (FIGS. 3-8) that operate in parallel with various throughput, the KI-Switcher (1630 of FIG. 9 and 1800 of FIG. 10) is the core processor of the invention, and as such the specific processor power rating of the deployment can be measured indirectly by the sum of all Digital-Business-Cycles completed per second.

Digital-Business-Cycle

A Digital-Business-Cycle occurs when an Item-Processor (1820, 1830 and 1840 of FIG. 10 and 2480a, 2480b and 2480n of FIG. 13) attempts to process a single UPT (an instruction) from within a Digital-Business stack (10610, 10620, 10630, 10640 and 10650 of FIG. 54). A UPT will take a minimum of one Digital-Business-Cycle (DBC) to process but it may take an unknown number, such as in the case of the Type-UPT-Sequence (see Appendix B). Although the engagement of any one Item-Processor (2480a, 2480b, 2480n of FIG. 13 and 1840, 1830 and 1820 of FIG. 10) is considered a DBC, the true latency and response of the software will vary depending on how equally balanced each Emulator-Component (FIG. 3-8), is. The invention is optimised for a Field Programmable Gate Array (FPGA) implementation, where each Emulator-Component can expand its capacity as demand for the resource changes (see Resource-Model further below). For example, if the III-Emulator (551 of FIG. 3, 751 of FIG. 4, 951 of FIG. 5, 1151 of FIG. 6, 1351 of FIG. 7, 1551 of FIG. 8 and 17001 of FIG. 74) has limited capacity on the Asynchronous-Duplicator (440 of FIG. 3), there may be latency for asynchronous duplication processes, where this resource has not been previously reserved with the Prepaid-Marketplace (see Resource-Model again).

The power rating is measured as:—
P=C/T

Power rating=P

Digital-Business-Cycles=C

Time=T

KI-Switcher Configuration

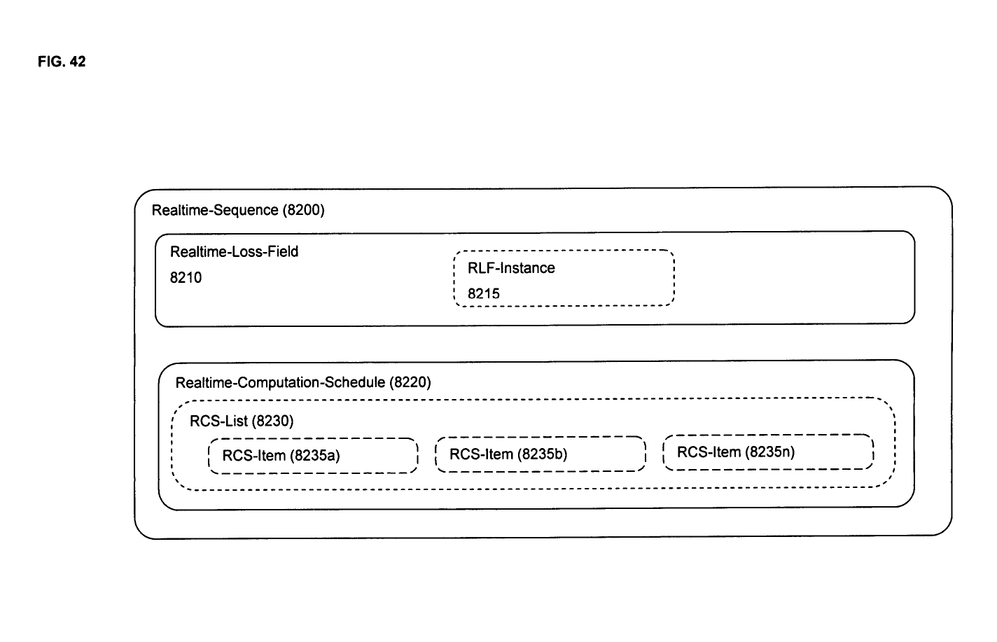

There are numerous ways the KI-Switcher (1630 of FIG. 9 and 1800 of FIG. 10) can be configured. FIG. 10 shows an exemplary configuration for an optimised implementation in silicon. This configuration is operating asynchronously but no Digital-Business (8800 of FIG. 45) is allowed to operate in parallel with itself. The Digital-Business-Selector (1810 of FIG. 10 and 2400 of FIG. 13) will choose a Digital-Business in a manner that is consistent with the 5 level Resource-Model of the invention. The Digital-Business is selected from either the Realtime-Computation-Schedule (8220 of FIG. 42), Prepaid-Computation-Schedule (8420 of FIG. 43), Standby-Computation-Schedule (8040 of FIG. 41 and 9250 of FIG. 47), the Idle-Computation-Schedule (8050 of FIG. 41 and 9260 of FIG. 47) or Every-Digital-Business (6450 of FIG. 33) based on a configuration determined by the virtual Governance-Layer (6475 of FIG. 33). Virtual software running in the Governance-Layer sets up the schedule that determines Digital-Business selection based on reservations made by the Digital-Businesses themselves that form part of the Prepaid-Marketplace (see Digital-Business-Selector at 2400 of FIG. 13). These schedules are stored in the Item-Processor-Queue (2450 of FIG. 13).

Stack Selection

The Item-Processor (2480a, 2480b, 2480n of FIG. 13 and 1840, 1830, 1820 of FIG. 13) will attempt to process a Universal-Process-Type or UPT (see Appendix B) from 1 of at least 15 stacks:
1) Five belonging to the Super-Stacks (9410 of FIG. 48) of the DTE-Instance (9425 of FIG. 48, 9800a and 9800b of FIG. 50) of a Digital-Business (8800 of FIG. 45).
2) Five belonging to the Super-Stacks of the GE-Instance (10000a and 10000b of FIG. 51, 9435 of FIG. 48).
3) There are 5 stacks for every Thread-Instance (10485a, 10485b, 10485n of FIG. 53 and 10600 of FIG. 54) of the GE-Instance.
4) There are 5 stacks for every Thread-Instance of the DTE-Instance.

The KI-Switcher (1630 of FIG. 9 and 1800 of FIG. 10) must have at least one Item-Processor (2480a, 2480b, 2480n of FIG. 13 and 1840, 1830, 1820 of FIG. 13) to process Digital-Businesses, but the design allows for as many as needed. Multiple Item-Processors enables Digital-Businesses to be processed in parallel. For each unique Digital-Business executed in parallel, an entry in the Variable-Pool (1640 of FIG. 9 and 1900 of FIG. 10) should retain the state information throughout its execution. Storing the information anywhere in the invention should be considered functionally equivalent to storing information in the Variable-Pool. The Item-Processor determines the stack to be processed in a certain order (see Item-Processor).

Universal-Process-Type (UPT)

The Manabars-Set (see Appendix G) has a special field called Type (see. Appendix G again), which gives it context amongst the multitude of other possible Manabars-Set structures. Although the 64-bit Type field may contain any integer value, there is a very narrow range of values that is used by the KI-Switcher (1630 of FIG. 9 and 1800 of FIG. 10) to enable a computationally complete platform. These special Children each respond in different ways when they are executed. The Type Field is the only context provider against a backdrop of identical Manabars-Sets, as each Child is otherwise identical. The arguments for the executing Universal-Process-Type (see Appendix B for a full listing of all UPTs) are themselves Children inside the executing Universal-Process-Type.

Resource-Model

Resources in the invention are managed by various Emulator-Components (FIGS. 3-8 and see table below). The Resource-Model can be applied to Emulator-Components in a number of ways. This exemplary embodiment contains an implementation for the UPT-Cycler (1470 of FIG. 8 and 1600 of FIG. 9) and the Partner-Channel-Manager (13000 of FIG. 66) while other Emulator-Components have been left unspecified. In a rigorous implementation, every resource on the III-Emulator (551 of FIG. 3, 751 of FIG. 4, 951 of FIG. 5, 1151 of FIG. 6, 1351 of FIG. 7, 1551 of FIG. 8 and 17001 of FIG. 74) may utilise the Resource-Model. All resources are measurable in both size (Volume Unit) and speed (Rate Unit). Below is a list of these resources and how they are measured. Digital-Businesses (8800 of FIG. 45) can purchase an unlimited number of resource contracts, providing they remain solvent. The Governance Layer (101b of FIG. 1 and 202b of FIG. 2a) is responsible for enabling the sale of contracts on the open network by Digital-Businesses. The Governance Layer converts contracts to a password and key so that they can be traded off the local Node (200a-200e of FIG. 2a and 380, 395 of FIG. 2d).

| Emulator- | | | |
|---|---|---|---|
| Component | Resource | Volume Unit | Rate Unit |
| PCM | Electricity | KW | KW/h |
| PCM | Bandwidth | MB | MB/s |
| UPT-Cycler | DBC | DBs | DBS/s |
| Slow-ABS | Mass-Storage | MB | NA |
| Fast-ABS | Volatile-Storage | MB | NA |
| AVM | Mass-Computation | Clock Cycles | GHz |
| AVM-Verifier | Mass-Computation- | MB | MB/s |
| | Verification | | |
| Asynchronous- | Set-Duplication | Sets | Set/s |
| Duplicator | | | |
| ABS Bus | Bus-Utility | MB | MB/s |
| Kernel-Image | KI-Garbage-Collector | Sets | Set/s |
| Kernel-Image | KI-Defragmentation | Sets | Set/s |
| Slow-ABS | SABS-Garbage-Collector | 64-Bit | 64-Bit/s |
| Slow-ABS | SABS-Defragmentation | 64-Bit | 64-Bit/s |
| Fast-ABS | FABS-Garbage-Collector | 64-Bit | 64-Bit/s |
| Fast-ABS | FABS-Defragmentation | 64-Bit | 64-Bit/s |

These Resources are processed according to a certain level of priority. There are 5 levels of priority, being:

(1) Realtime

(2) Prepaid

(3) Standby

(4) Idle

(5) Background.

For each level of priority there is a matching Marketplace:

(1) Realtime-Marketplace

(2) Prepaid-Marketplace

(3) Standby-Marketplace

(4) Idle-Marketplace

(5) Background-Marketplace.

This cluster of 5 marketplaces exist for each resource in the invention. The marketplaces are dynamic so that the pricing for each resource and for each priority changes over time as determined by supply and demand.

In order to ensure that the resource will be available when required, Digital-Businesses (8800 of FIG. 45) are able to book the resource in advance by utilising either the Prepaid-Marketplace or the Realtime-Marketplace. Each Emulator-Component (FIGS. 3-8) will always check the Realtime-Marketplace first.

Marketplace Properties

Each marketplace exhibits varying characteristics and the availability of resource.

Realtime-Marketplace

The Realtime-Marketplace guarantees the availability of a resource up to a fixed level of cover for a specific window of time and doesn't require reservation in advance. However, the cost of the premium to ensure this availability is reasonably high and the throughput fairly low, so generally mobile agents are likely to use it in emergencies only when unexpected utility demand arises and performance is critical—for example, the braking system on a bus. Realtime systems must preserve sufficient realtime resource to guarantee normal function. Standard behaviour should involve not restarting until realtime resource is sufficiently high. Otherwise, once the level of cover has been consumed, the system no longer guarantees resource availability. For example, the bus braking system would remain locked until realtime resource was re-established. At any point, the Governance Layer (101b of FIG. 1 and 202b of FIG. 2a) may choose to re-enable the entire level of cover at a time that is convenient for the Node. The Digital-Business agrees on a reimbursement price for which it is willing to accept the potential revoking of the contract. A Realtime-Marketplace contract can be converted into an ID and password so that it may be traded off site from the local Node (200a-200e of FIG. 2a and 380, 395 of FIG. 2d). The Governance Layer can reassign this contract to the Digital-Business that first presents the correct ID and password.

Prepaid-Marketplace

The Prepaid-Marketplace enables mobile agents to reserve resource up to a known level for a specific window of time. A Prepaid Contract can be either of continuous or erratic. The erratic option is likely to be more expensive, but guarantees the delivery of the resource at any point provided it is within the agreed window of time for the contract. The continuous option ensures that resource is delivered constantly, regardless of Node (200a-e of FIG. 2a and 380, 395 of FIG. 2d) loading for use in applications such as a phone call. Resource that is not utilised within the prepaid contract lifetime may be reimbursed by the Governance Layer (101b of FIG. 1 and 202b of FIG. 2a) at a lower rate—but it is effectively a lost opportunity for the Digital-Business (8800 of FIG. 45). When the Digital-Business purchases a resource contract from the Governance Layer it is likely to require a price at which the Digital-Business is prepared to lose the contract. The lower the cancel price, the better the rate for the resource is likely to be. However, the Governance Layer may cancel the contract and pay the cancel price in order to generate additional resource in order to satisfy realtime contracts. Like the Realtime-Marketplace, the Digital-Business may have its contract revoked at any point and be paid the reimbursement price that it originally set. Furthermore, the prepaid contract can be sold in a digital marketplace with an ID and password like the realtime contract.

Standby-Marketplace

Digital-Businesses (8800 of FIG. 45) can utilise resource at any point from the Standby-Marketplace that is similar to spot prices found within electricity marketplaces. Resource availability is erratic, as it comprises of the remainder when prepaid contracts and realtime contracts have been fully satisfied. The Standby-Marketplace posts a spot price for the resource at any point in time. Due to its unreliability, the Standby-Marketplace is more cost effective that the Prepaid-Marketplace and so is only suitable for certain types of jobs such as backup or 3D rendering.

Idle-Marketplace

The Idle-Marketplace is identical to the Standby-Marketplace, except it represents resource that can be utilised when no other marketplace requires it.

Background-Marketplace

The Background-Marketplace is the resource available after every marketplace has been satisfied. It is extremely unreliable but the most cost effective but characterised by large lulls in availability.

Implementation of Resource Model

As a developer building mobile agents for the invention, utilising the 5 priorities is easy. Processes simply request the level of priority that they require for a resource. At the implementation level the actual resource utilised may be different to that requested, providing that the resource availability matches or is better than the requested priority so applications can specify their minimum operating requirements.

As an implementer of the invention there are many opportunities to make further optimisations. Further to this, the Governance Layer (101b of FIG. 1 and 202b of FIG. 2a) provides the opportunity to make intelligent decisions at runtime on behalf of the Digital-Business (8800 of FIG. 45). For example, if a realtime resource is required, but the Digital-Business still has unutilised prepaid resource, then it makes sense for the implementation to utilise the prepaid resource first before using the premium realtime resource. The following rules are used as a guide when distributing the 5 priority levels of resource:

Realtime

If there is demand for a realtime resource then this Emulator-Component (FIGS. 3-8) is given the highest priority in obtaining it. The Emulator-Component will check if there is any background, idle, standby or prepaid resource available (in that order) for the Digital-Business (8800 of FIG. 45) prior to engaging the realtime resource. If there is alternative resource available, then that resource is utilised first. If there is not enough alternative resource to run the realtime process, then the Emulator-Component will use what it can from the alternative resource and take the rest from the realtime resource. If there is no alternative resource available to the Digital-Business then the realtime resource is utilised immediately.

Prepaid

If there is demand for a prepaid resource then the Emulator-Component (FIGS. 3-8) supplies it after realtime demand has been satisfied. If there is no demand for resource in the Realtime-Marketplace, then the Emulator-Component distributes the resource to the Prepaid-Marketplace, otherwise this resource is used to satisfy realtime demand. If there is no prepaid demand, then the Emulator-Component either reimburses the Digital-Business (8800 of FIG. 45) at an agreed rate or supplies the idle, standby or background marketplaces if demand exists there and it is more cost effective for the Digital-Business to do so instead of purchasing resource directly from these marketplaces.

Standby

If there is demand for standby resource then the Emulator-Component (FIGS. 3-8) will provide it after realtime and prepaid demand has been satisfied.

Idle

If there is demand for idle resource then the Emulator-Component (FIGS. 3-8) will provide it after realtime, prepaid and standby demand has been satisfied.

Background

If there is demand for background resource then the Emulator-Component (FIGS. 3-8) will provide it after realtime, prepaid, standby and idle demand has been satisfied.

Digital-Business-Selector

The Digital-Business-Selector (1810 of FIG. 10 and 2400 of FIG. 13) is an independent process in the KI-Switcher (1630 of FIG. 9 and 1800 of FIG. 10) that determines the ordering of Digital-Business (8800 of FIG. 45) processing. The Digital-Business-Selector contains an Item-Processor-Queue (2450 of FIG. 13) for each Item-Processor (1820, 1830 and 1840 of FIG. 10 and 2480a, 2480b, 2480n of FIG. 13) in the KI-Switcher. Each Item-Processor-Queue holds a list of Digital-Businesses that are ready to be processed. Once a Digital-Business has been assigned to an Item-Processor, it is placed into the same Item-Processor-Queue each time it is selected. This is to ensure that each Digital-Business can be assigned to a KI-Interface (see Appendix G) that accesses an Isolated-Memory-Segment (9600a-9600n of FIG. 49). This assists in enabling a scalable and parallel implementation in Field Programmable Gate Arrays (FPGA). The Kernel-Image (see Appendix G) has the capacity to access global memory, but the throughput is limited to the Backplane-Bus (see Appendix G again) that limits the loading capacity and is only accessed by the Governance-Layer (6475 of FIG. 33) when it utilised the Global-Static-Store (6440 of FIG. 33, 6800 of FIG. 35 and 10025 of FIG. 51) reference.

Each Item-Processor-Queue (2450 of FIG. 13) contains a Level (2456a-2456n of FIG. 13) and the Digital-Business reference (2455a-2455n of FIG. 13). The Level represents the number of Digital-Business-Cycles that the Digital-Business (8800 of FIG. 45) has been scheduled to undergo by the Governance Layer (101b of FIG. 1 and 202b of FIG. 2a). See Digital-Business-Selection below for further information on how each Item-Processor-Queue is allocated. When the Digital-Business-Selector (1810 of FIG. 10 and 2400 of FIG. 13) receives an Item-Processor-Notification (1935 of FIG. 10 and 2470 of FIG. 13) from an Item-Processor (2480a, 2480b, 2480n of FIG. 13 and 1840, 1830, 1820 of FIG. 10) it sends the next assailable Digital-Business (8800 of FIG. 45) in the form of a Digital-Business Cursor-ID (1930 of FIG. 10 and 2490 of FIG. 13) in the matching Item-Processor-Queue to the Item-Processor. The next Digital-Business (8800 of FIG. 45) to be processed is the first Digital-Business in the Item-Processor-Queue. If the Digital-Business is locked then the Digital-Business-Selector moves to the next Digital-Business in the Item-Processor-Queue. A Digital-Business is considered as locked when the Activity-Status-Field (9440 of FIG. 48) of the Digital-Business holds a Child with a Type of Type-Locked. Any Digital-Business that has a repeated entry in the queue can retain a single entry while increasing the Level by 1 for each repeated entry that is deleted. The Digital-Business-Selector (1810 of FIG. 10 and 2400 of FIG. 13) continues searching the Item-Processor-Queue in this manner until the next unlocked Digital-Business is located and sent to the Item-Processor. Once a Digital-Business-Cycle has been processed, the Level (2456a-2456n of FIG. 13) for that Digital-Business in the Item-Processor-Queue, is decreased by one. When any Level in the Item-Processor-Queue reaches zero, the entry for the Digital-Business is removed from the Item-Processor-Queue. The Digital-Business-Selector is running constantly in the background until any Item-Processor-Queue has reached its maximum capacity as determined by the implementation.

Digital-Business Selection

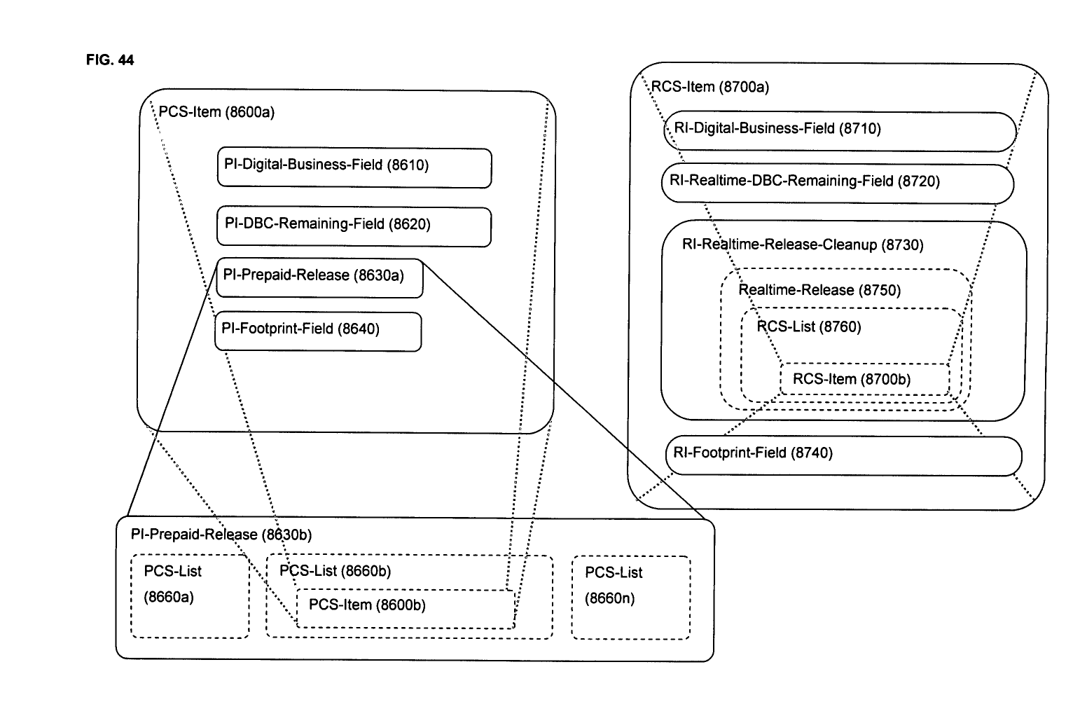

There are a total of six schedules that determine the Digital-Business (8800 of FIG. 45) execution ordering. The Digital-Business-Selector (1810 of FIG. 10 and 2400 of FIG. 13) cycles through these schedules to locate Digital-Businesses to process. These schedules are selected, in the following order:
a. The Realtime-Computation-Schedule (8200 of FIG. 42). All Digital-Businesses in this Schedule are held inside an RCS-Item (8235a-8235n of FIG. 42 and 8700a, 8700b of FIG. 44 and 9245 of FIG. 47).
b. The Prepaid-Computation-Schedule (8420 of FIG. 43). All Digital-Businesses in this Schedule are held inside a PCS-Item (8435a-8435n of FIG. 43 and 8600a and 8600b of FIG. 44).
c. The Standby-Computation-Schedule (8040 of FIG. 41 and 9250 of FIG. 47).
d. The Idle-Computation-Schedule (8050 of FIG. 41 and 9260 of FIG. 47).
e. Every-Digital-Business (6450 of FIG. 33).
f. Every-Sandbox-Digital-Business (6500 of FIG. 33).

The Digital-Business-Selector (1810 of FIG. 10 and 2400 of FIG. 13) works in one schedule at a time working from Left to Right. If at any time the Cursor reaches the rightmost boundary of any schedule then it is shifted back to the leftmost boundary. The Digital-Business-Selector will always give highest priority to the Realtime-Computation-Schedule (8200 of FIG. 42) and will always check this schedule first. However, in an exemplary configuration, the Digital-Business-Selector (1810 of FIG. 10 and 2400 of FIG. 13) may guarantee processing power to a certain number of Digital-Businesses (8800 of FIG. 45) within one cycle of the schedule. This would allow Digital-Businesses in schedules with lower priority to get more of a chance to be processed. The maximum number of Digital-Businesses selected in one cycle of the schedule would be specified by the Child of the DBCs-Per-Schedule-Cycle-Field (8010 of FIG. 41) and is set by the Governance Layer (101b of FIG. 1 and 202b of FIG. 2a). The Digital-Business-Selector tracks how many Digital-Businesses (8800 of FIG. 45) have been selected during the current cycle of the schedule. This is known as the Round-Accumulation. If there are any Digital-Businesses in the Realtime-Computation-Schedule (8220 of FIG. 42 and 9240 of FIG. 47) or the Prepaid-Computation-Schedule (8420 of FIG. 43) that have not been processed when the maximum number of Digital-Businesses per cycle of each schedule has been reached, then these schedules will have incurred a loss of computation known as a loss, in which case the following will occur:
a. The prepaid loss is retrieved through the Whole of the PLF-Instance (8415 of FIG. 43) of the Prepaid-Loss-Field (8410 of FIG. 43). The Round-Accumulation is then added to the prepaid loss and a Child is inserted into the Neutral position of the Prepaid-Loss-Field (8410 of FIG. 43) with its Whole set to the new prepaid loss.
b. The realtime loss is retrieved from the Whole of the Child of the Realtime-Loss-Field (8210 of FIG. 42). The Whole of the DPSC-Instance (8015 of FIG. 41) is deducted from the Round-Accumulation and the remainder is added to the realtime loss. A new Child is inserted into the Neutral position of the Realtime-Loss-Field (8210 of FIG. 42) with its Whole set to the new realtime loss.
c. No matter what the current schedule, the whole selection process will then begin again with the Realtime-Computation-Schedule (8220 of FIG. 42).

If, however, the maximum number of Digital-Businesses (8800 of FIG. 45) per cycle of the schedule has not been reached when the Cursor of the currently selected schedule is shifted back to the leftmost boundary, then the following could occur:
a. If a loss has been incurred then the loss will be retrieved from either the Realtime-Loss-Field (8210 of FIG. 42) if the currently selected schedule is the Realtime-Computation-Schedule (8220 of FIG. 42), or the Prepaid-Loss-Field (8410 of FIG. 43) if the currently selected schedule is the Prepaid-Computation-Schedule (8400 of FIG. 43). The Round-Accumulation will be deducted from the Whole of the DPSC-Instance (8015 of FIG. 41) and the remainder will then be deducted from the appropriate loss. A new Child with its Whole set to the new loss will be inserted into the relevant loss Field and the Digital-Business-Selector (1810 of FIG. 10 and 2400 of FIG. 13) will continue selecting Digital-Businesses (8800 of FIG. 45) from the same schedule.
b. Otherwise if there is no loss incurred then the Digital-Business-Selector (1810 of FIG. 10 and 2400 of FIG. 13) will start to select Digital-Businesses (8800 of FIG. 45) from the next schedule in order of priority.

The Digital-Business-Selector (1810 of FIG. 10 and 2400 of FIG. 13) cycles through the schedules, selecting Digital-Businesses (8800 of FIG. 45) until the Item-Processor-Queue (2450 of FIG. 13) is full. This means that a single Digital-Business can be inserted onto the Item-Processor-Queue more than once. The following steps outline how the Digital-Business-Selector determines execution order of Digital-Businesses and inserts an entry onto the Item-Processor-Queue:
(1) The Digital-Business-Selector (1810 of FIG. 10 and 2400 of FIG. 13) locates the Cursor of the RCS-List (8230 of FIG. 42 and 8760 of FIG. 44) found in the Realtime-Computation-Schedule (8220 of FIG. 42) and sets the Round-Accumulation to equal zero.
(2) The Digital-Business-Selector (1810 of FIG. 10 and 2400 of FIG. 13) checks if there are any Children in the schedule. If there are no Children in the schedule then the Digital-Business-Selector locates the Cursor of the next schedule (as described below) and repeats step (2). Otherwise if there are Children in the schedule then the Digital-Business-Selector will continue with step (3).
a. If the schedule currently selected is the Realtime-Computation-Schedule (8220 of FIG. 42), then the next schedule would be the Prepaid-Computation-Schedule (8420 of FIG. 43).
b. If the schedule currently selected is the Prepaid-Computation-Schedule (8420 of FIG. 43), then the next schedule would be the Standby-Computation-Schedule (8040 of FIG. 41 and 9250 of FIG. 47).
c. If the schedule currently selected is the Standby-Computation-Schedule (8040 of FIG. 41 and 9250 of FIG. 47), then the next schedule would be the Idle-Computation-Schedule (8050 of FIG. 41 and 9260 of FIG. 47).
d. If the schedule currently selected is the Idle-Computation-schedule (8050 of FIG. 41 and 9260 of FIG. 47), then the next schedule would be Every-Digital-Business (6450 of FIG. 33).
e. If the schedule currently selected is Every-Digital-Business (6450 of FIG. 33), then the next schedule would be the Every-Sandbox-Digital-Business (6500 of FIG. 33).
f. If the schedule currently selected is Every-Sandbox-Digital-Business (6500 of FIG. 33) then the whole selection process would begin again from step (1).
(2) Depending on which schedule is currently selected, the Digital-Business (8800 of FIG. 45) to be selected is identified through either:
a. The RI-Digital-Business-Field (8710 of FIG. 44) of the RCS-Item (8700a and 8700b of FIG. 44, 8235a-8235n of FIG. 42 and 9245 of FIG. 47), currently identified by the Cursor of the RCS-List (8230 of FIG. 42 and 8760 of FIG. 44) contained in the Realtime-Computation-Schedule (8220 of FIG. 42).
b. The PI-Digital-Business-Field (8610 of FIG. 44) of the PCS-Item (8600a and 8600b of FIG. 44 and 8435a-8435n of FIG. 43), currently identified by the Cursor of the PCS-List (8430 of FIG. 43, 8660a-n of FIG. 44) contained in the Prepaid-Computation-Schedule (8420 of FIG. 43).
c. The Digital-Business (8800 of FIG. 45) currently identified by either the Standby-List (8060 of FIG. 41) contained in the Standby-Computation-Schedule (8040 of FIG. 41 and 9250 of FIG. 47), Idle-List (8070 of FIG. 41) contained in the Idle-Computation-Schedule (8050 of FIG. 41 and 9260 of FIG. 47), Every-Digital-Business-List (6455 of FIG. 33) contained in Every-Digital-Business (6450 of FIG. 33) or Every-Sandbox-Digital-Business-List (6510 of FIG. 33) contained in Every-Sandbox-Digital-Business (6500 of FIG. 33).
(4) The Digital-Business (8800 of FIG. 45) is checked to see if it can be selected. If the Digital Business is unable to be selected then the Cursor of the current Schedule is shifted to the right as outlined above and, unless otherwise specified, selection carries on from step (3). Reasons for a Digital-Business not being able to be selected are as follows:
a. The Digital-Business has already been declared insolvent.
b. If the current schedule is the Realtime-Computation-Schedule (8220 of FIG. 42) and the Whole of the Child of RI-Realtime-DBC-Remaining-Field (8720 of FIG. 44) of the RCS-Item (8235a-8235n of FIG. 42, 8700a, 8700b of FIG. 44 and 9245 of FIG. 47) is less than or equal to the Whole of the Child of the RI-Footprint-Field (8740 of FIG. 44) of the RCS-Item then the Digital-Business is unable to be selected. The RCS-Item for this Digital-Business is then removed from the RCS-List (9240 of FIG. 47) in the Realtime-Computation-Schedule (8220 of FIG. 42). This is NOT done directly but instead the Child of the Realtime-Release (8750 of FIG. 44 and 9210 of FIG. 47) has its Child—the RCS-Item (8700b of FIG. 44)—deleted from the RCS-List (8760 of FIG. 44 and 8230 of FIG. 42). However, if there are no Children in the Realtime-Release, then the Governance Layer (101b of FIG. 1 and 202b of FIG. 2a) has made an error and the RCS-Item may be deleted directly from the RCS-List.
c. If the current schedule is the Prepaid-Computation-Schedule (8420 of FIG. 43) and the Whole of the Child of the PI-DBC-Remaining-Field (8620 of FIG. 44) of the PCS-Item (8600a and 8600b of FIG. 44 and 8435a, 8435b, 8435n of FIG. 43) is less than or equal to the Whole of the Child of the PI-Footprint-Field (8640 of FIG. 44) of the PCS-Item then the Digital-Business (8800 of FIG. 45) is unable to be selected.
(5) If the Digital-Business (8800 of FIG. 45) is selected then the Digital-Business-Selector (1810 of FIG. 10 and 2400 of FIG. 13) will search the DB-Item-Processor-Hashtable (2410 of FIG. 13) to see which Item-Processor-Queue (2450 of FIG. 13) the Digital-Business is to be inserted on. If the Digital-Business is being selected for the first time then it is assigned to the Item-Processor (1840, 1830, 1820 of FIG. 10 and 2480a-2480n of FIG. 13) that is least loaded at the time. The least loaded Item-Processor is ascertained through totalling all Levels (2456a-2456n of FIG. 13) in the Item-Processor-Queue. The Digital-Business is inserted into the DB-Item-Processor-Hashtable (2410 of FIG. 13) with a reference to the chosen Item-Processor-Queue. This ensures that each time the Digital-Business is subsequently selected it will always go to the same Item-Processor in order to avoid the Digital-Business being processed by two or more Item-Processors at the same time.
(6) Once the correct Item-Processor-Queue (1840, 1830, 1820 of FIG. 10 and 2480a-2480n of FIG. 13) has been located then the Digital-Business (8800 of FIG. 45) is inserted into the Item-Processor-Queue in the last position available with the Level (2456a-2456n of FIG. 13) set to either:
a. The Whole of the Child in the RI-Footprint-Field (8740 of FIG. 44) of an RCS-Item (8235a-n of FIG. 42, 8700a, 8700b of FIG. 44 and 9245 of FIG. 47) if the Digital-Business (8800 of FIG. 45) resides in the Realtime-Computation-Schedule (8220 of FIG. 42).
b. The Whole of the Child in the PI-Footprint-Field (8640 of FIG. 44) of a PCS-Item (8600a, 8600b of FIG. 44, 8435a-n of FIG. 43) if the Digital-Business resides in the Prepaid-Computation-Schedule (8420 of FIG. 43).
c. The value of 1 for any other schedule.
(7) If the currently selected schedule is either the Realtime-Computation-Schedule (8220 of FIG. 42) or the Prepaid-Computation-Schedule (8420 of FIG. 43) then the Digital-Business-Cycles (DBC) remaining is retrieved from the Whole of the Child of the PI-DBC-Remaining-Field (8620 of FIG. 44) of the PCS-Item (8600a, 8600b of FIG. 44 and 8435a-n of FIG. 43) or the RI-Realtime-DBC-Remaining-Field (8720 of FIG. 44) of the RCS-Item (8700a, 8700b of FIG. 44, 8235a-n of FIG. 42 and 9245 of FIG. 47). The value of the Whole of the Child of the RI-Footprint-Field (8740 of FIG. 44) of the RCS-Item or the PI-Footprint-Field (8640 of FIG. 44) of the PCS-Item is deducted from the DBC remaining and a new Child is inserted into the Neutral position of the PI-DBC-Remaining-Field (8620 of FIG. 44) or RI-Realtime-DBC-Remaining-Field (8720 of FIG. 44) with its Whole set to the new DBC remaining.
(8) The total of the Round-Accumulation is increased by the value of the Whole of the Child of either the RI-Footprint-Field or the PI-Footprint-Field (8640 or 8740 of FIG. 44) by 1—depending on the currently selected schedule. The cursor of the current schedule is then shifted to the Right as outlined above and the selection of Digital-Businesses (8800 of FIG. 45) carries on.
   Billing

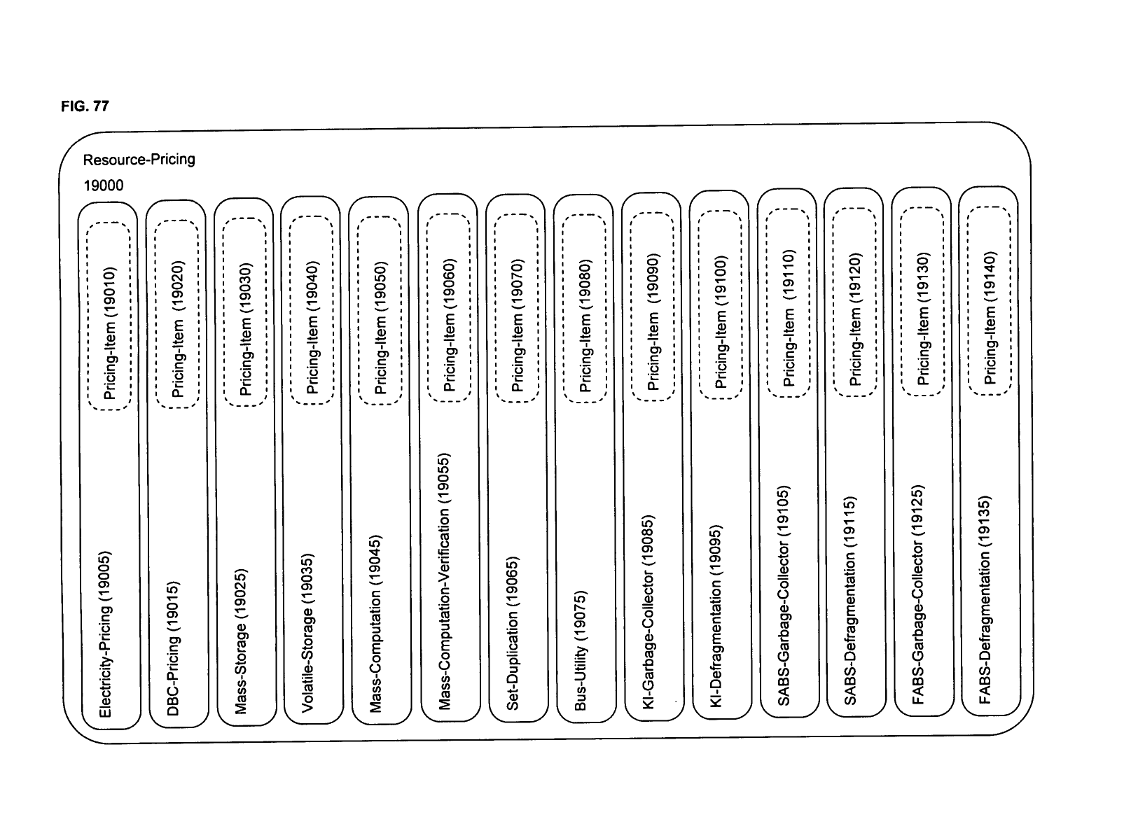

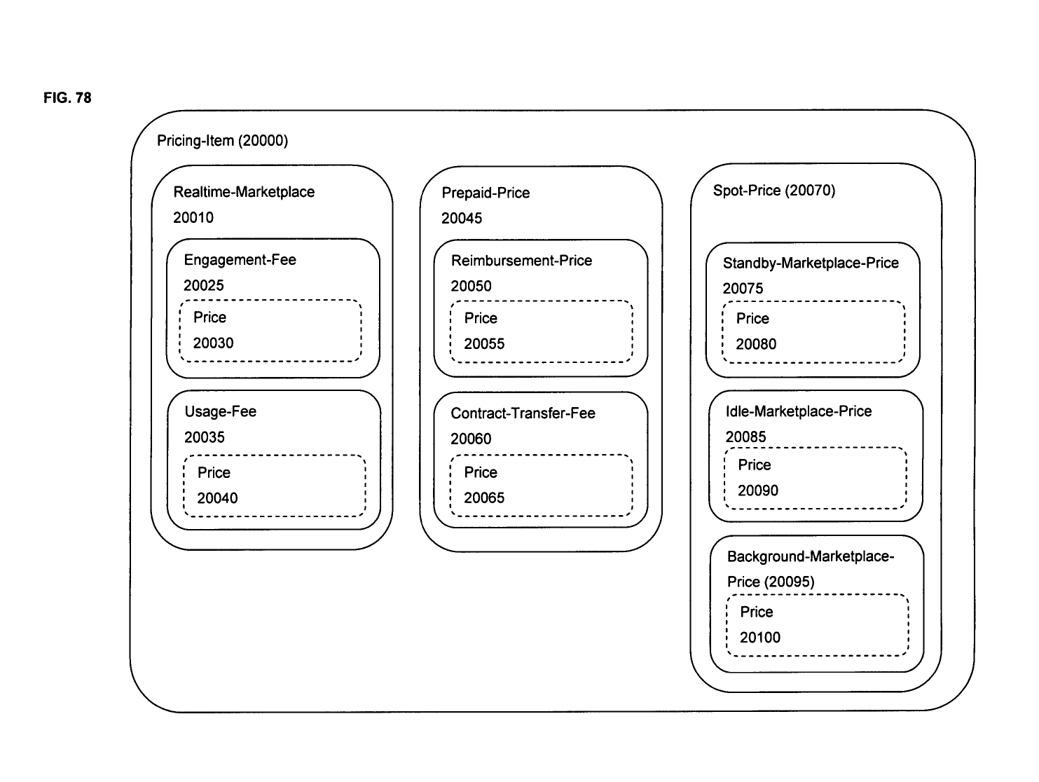

All prices for the Computation-Schedules are found in the Pricing-Item (19020 of FIG. 77 and 20000 of FIG. 78) located in the DBC-Pricing (19015 of FIG. 77) of the Resource-Pricing (7265 of FIG. 37 and 19000 of FIG. 77). These prices are set by the Governance Layer (101b of FIG. 1 and 202b of FIG. 2a). The Digital-Business (8800 of FIG. 45) is billed for the Realtime-Computation-Schedule (8220 of FIG. 42) and Prepaid-Computation-Schedule (8420 of FIG. 43) at the point at which the reservation is made from within the Governance Layer. However, the Digital-Business-Selector (1810 of FIG. 10 and 2400 of FIG. 13) charges the Digital-Business (8800 of FIG. 45) for every DBC processed via the Standby-Computation-Schedule (8040 of FIG. 41 and 9250 of FIG. 47) by the Float of the Price (20040 of FIG. 78) located in Standby-Marketplace-Price (20075 of FIG. 78). Every DBC processed via the Idle-Computation-Schedule (8050 of FIG. 41 and 9260 of FIG. 47) is charged by the Float of the Price (20090 of FIG. 78) located in Idle-Price-Price (20085 of FIG. 78). In the event that there are any additional Digital-Business-Cycles remaining after all the schedules have been processed, then these are directed to the Background-Marketplace. In this case, the bank account is deducted by the Float of the Price (20100 of FIG. 78) located in Background-Price-Price (20095 of FIG. 78) but is likely to be free of charge.

Distribution

It is the Governance Layer (101b of FIG. 1 and 202b of FIG. 2a) that determines the distribution for every RCS-Item (8235a-8235n of FIG. 42 and 8700a and 8700b of FIG. 44 and 9245 of FIG. 47) in the Realtime-Computation-Schedule (8220 of FIG. 42), PCS-Item (8435a-8435n of FIG. 43 and 8600a and 8600b of FIG. 44) in the Prepaid-Computation-Schedule (8420 of FIG. 43) or Digital-Business (8065a-8065n and 8075a-8075n of FIG. 41 and 8800 of FIG. 45) in both the Standby-Computation-Schedule (8040 of FIG. 41 and 9250 of FIG. 47) and Idle-Computation-Schedule (8050 of FIG. 41 and 9260 of FIG. 47). The resulting distribution is determined by Digital-Businesses that utilise the Governance-Layer-Interface (9500a, 9500b of FIG. 48, 9700a, 9700b of FIG. 49 and 9815 of FIG. 50) to purchase computational resource, although it is the Governance Layer that will authorise the timing. The reference to the Digital-Business is stored to the Variable-Pool (1640 of FIG. 9 and 1900 of FIG. 10) in the VP-Digital-Business (1910 of FIG. 10).

Solvency

The Bankrupter (2420 of FIG. 13) ensures that each Digital-Business (8800 of FIG. 45) is solvent. To check the solvency status of the applicable Digital-Business, the Bankrupter reads the Float of the Child of the Bank-Account-Field (8890 of FIG. 45) to ensure that that this value is greater than zero. The solvency status of the Digital-Business is stored to the VP-Bankrupt-Status (1905 of FIG. 10) where Type-True is solvent and Type-False is bankrupt. A reference to the Bank-Account-Field (8840 of FIG. 45) is stored to the VP-Bank-Account (1920 of FIG. 10).

Variable-Pool

The Variable-Pool (1640 of FIG. 9 and 1900 of FIG. 10) acts as an optional fast cache in that it stores key handles and status information to registers for each Digital-Businesses (8800 of FIG. 45) that is being executed. The Variable-Pool may be used to store stack references directly to reduce the number of KI-Interface (see Appendix G) calls made and decrease the time for a single DBC. There is one Variable-Pool for each Item-Processor (1840, 1830, 1820 of FIG. 10 and 2480a-n of FIG. 13). The Variable-Pool contains a cluster of Boolean registers and 64-bit registers. The 64-bit registers are each capable of storing a single Cursor-Identification (5030 of FIG. 26, 6635 of FIG. 34 and 7620 of FIG. 39). The most probable cache candidates are the VP-Bankrupt-Status (1905 of FIG. 10), VP-Digital-Business (1910 of FIG. 10), VP-DB-Level (1915 of FIG. 10) and VP-Bank-Account (1920 of FIG. 10). The Variable-Pool may be extended to hold any state information for any executing Digital-Business so that the execution process may be accelerated.

VP-Bankrupt-Status

The VP-Bankrupt-Status (1605 of FIG. 10) is a Boolean field that indicates whether this Digital-Business (8800 of FIG. 45) being processed by the Item-Processor (1840, 1830, 1820 of FIG. 10 and 2480a-n of FIG. 13) for this Variable-Pool (1640 of FIG. 9 and 1900 of FIG. 10) has been declared insolvent by another component.

VP-Digital-Business

The VP-Digital-Business (1910 of FIG. 10) holds a Cursor-Identification (5030 of FIG. 26, 6635 of FIG. 34 and 7620 of FIG. 39) to the Digital-Business (8800 of FIG. 45) that is currently being processed by this Item-Processor (1840, 1830, 1820 of FIG. 10 and 2480a-n of FIG. 13) and is located by the Digital-Business-Execution-Sequence (6810 of FIG. 35 and 8000 of FIG. 41).

VP-Bank-Account

The VP-Bank-Account for (1920 of FIG. 10) holds a Cursor-Identification (5030 of FIG. 26, 6635 of FIG. 34 and 7620 of FIG. 39) to the Bank-Account-Field (8890 of FIG. 45) for the executing Digital-Business (8800 of FIG. 45) that is used to check solvency.

Other-Cached-Items

Other-Cached-Items (1925 of FIG. 10) can hold any other state information associated with the Digital-Business (8800 of FIG. 45) being executed by this Item-Processor (1840, 1830, 1820 of FIG. 10 and 2480a-n of FIG. 13) that can be used to accelerate its execution.

Item-Processor

The function of the Item-Processor (1840, 1830, 1820 of FIG. 10 and 2480a-n of FIG. 13) is to execute UPTs (10615, 10625, 10635, 10645 and 10655 of FIG. 54) within the KI-Switcher (1630 of FIG. 9 and 1800 of FIG. 10 and 1630 of FIG. 9). On receiving the On-Signal (1740 of FIG. 9) from the GL-Bootstrapper (1610 of FIG. 9) Item-Processors transmit the Item-Processor-Notification (1935 of FIG. 10 and 2470 of FIG. 13) to the Digital-Business-Selector (1810 of FIG. 10 and 2400 of FIG. 13) whenever they are ready to execute the next UPT. The Item-Processor then receives the Cursor-Identification (5030 of FIG. 26, 6635 of FIG. 34 and 7620 of FIG. 39) of the Digital-Business (8800 of FIG. 45) that it is required to execute from the Digital-Business-Selector. From the Digital-Business reference alone, the Item-Processor is required to select a single stack from which it is to process a single UPT. This is known as a Digital-Business-Cycle (DBC). The Item-Processor will continue to transmit the Item-Processor-Notification (1935 of FIG. 10) to the Digital-Business-Selector each time it executes a UPT until the III-Emulator (551 of FIG. 3, 751 of FIG. 4, 951 of FIG. 5, 1151 of FIG. 6, 1351 of FIG. 7, 1551 of FIG. 8 and 17001 of FIG. 74) is Shutdown.

Stack Selection

Each Item-Processor (1840, 1830, 1820 of FIG. 10 and 2480a-n of FIG. 13) must determine the stack to process. If neither the Governance-Layer (6475 of FIG. 33), nor the Digital-Business (8800 of FIG. 45) are involved in a periodic save (see UPT-Cycler), the stacks are selected with a specific precedence by the Item-Processor. At each iteration, a new stack is selected. A stack with No-Children (see Appendix G) is ignored. The order of precedence is as follows:—
(1) The Realtime-Super-Stack (9411 of FIG. 48) of the DB-Execution (9400 of FIG. 48).
(2) The Prepaid-Super-Stack (9412 of FIG. 48) of the DB-Execution (9400 of FIG. 48).
(3) The Standby-Super-Stack (9413 of FIG. 48) of the DB-Execution (9400 of FIG. 48).
(4) The Idle-Super-Stack (9414 of FIG. 48) of the DB-Execution (9400 of FIG. 48).
(5) The Background-Super-Stack (9415 of FIG. 48) of the DB-Execution (9400 of FIG. 48).
(6) The next Realtime-Stack (10610 of FIG. 54) that contains UPTs (10615 of FIG. 54) from a round-robin of Thread-Instances (10485a-10485n of FIG. 53 and 10600 of FIG. 54) in the Realtime-Stack-List (10530 of FIG. 53) of the DTE-Instance (9425 of FIG. 48 and 9800a of FIG. 50).
(7) The next Realtime-Stack that contains UPTs from a round-robin of Thread-Instances (10485a-10485n of FIG. 53 and 10600 of FIG. 54) in the Realtime-Stack-List (10530 of FIG. 53) of the GE-Instance (9435 of FIG. 48 and 10000a of FIG. 51).
(8) The next Prepaid-Stack (10620 of FIG. 54) that contains UPTs (10625 of FIG. 54) from a round-robin of Thread-Instances (10485a-10485n of FIG. 53 and 10600 of FIG. 54) in the Prepaid-Stack-List (10540 of FIG. 53) of the DTE-Instance (9425 of FIG. 48 and 9800a of FIG. 50).
(9) The next Prepaid-Stack that contains UPTs from a round-robin of Thread-Instances (10485a-10485n of FIG. 53 and 10600 of FIG. 54) in the Prepaid-Stack-List (10540 of FIG. 53) of the GE-Instance (9435 of FIG. 48 and 10000a of FIG. 51).
(10) The next Standby-Stack (10630 of FIG. 54) that contains UPTs (10635 of FIG. 54) from a round-robin of Thread-Instances (10485a-10485n of FIG. 53 and 10600 of FIG. 54) in the Standby-Stack-List (10550 of FIG. 53) of the DTE-Instance (9425 of FIG. 48 and 9800a of FIG. 50).
(11) The next Standby-Stack that contains UPTs from a round-robin of Thread-Instances (10485a-10485n of FIG. 53 and 10600 of FIG. 54) in the Standby-Stack-List (10550 of FIG. 53) of the GE-Instance (9435 of FIG. 48 and 10000a of FIG. 51).
(12) The next Idle-Stack (10640 of FIG. 54) that contains UPTs (10645 of FIG. 54) from a round-robin of Thread-Instances (10485a-10485n of FIG. 53 and 10600 of FIG. 54) in the Idle-Stack-List (10560 of FIG. 53) of the DTE-Instance (9425 of FIG. 48 and 9800a of FIG. 50).
(13) The next Idle-Stack that contains UPTs from a round-robin of Thread-Instances (10485a-10485n of FIG. 53 and 10600 of FIG. 54) in the Idle-Stack-List (10560 of FIG. 53) of the GE-Instance (9435 of FIG. 48 and 10000a of FIG. 51).
(14) The next Background-Stack (10650 of FIG. 54) that contains UPTs (10655 of FIG. 54) from a round-robin of Thread-Instances (10485a-10485n of FIG. 53 and 10600 of FIG. 54) in the Background-Stack-List (10570 of FIG. 53) of the DTE-Instance (9425 of FIG. 48 and 9800a of FIG. 50).
(15) The next Background-Stack that contains UPTs from a round-robin of Thread-Instances (10485a-10485n of FIG. 53 and 10600 of FIG. 54) in the Background-Stack-List (10570 of FIG. 53) of the GE-Instance (9435 of FIG. 48 and 10000a of FIG. 51).

Thread-Instances (10485a-10485n of FIG. 53 and 10600 of FIG. 54) are located in the Thread-Group (9835 of FIG. 50, 10055 of FIG. 51 and 10400 of FIG. 53) for priorities 6-15 above of the Active-Thread (9830 of FIG. 50 and 10050 of FIG. 51). Active-Threads are found in both the DTE-Instance (9425 of FIG. 48 and 9800a of FIG. 50) and the GE-Instance (9435 of FIG. 48 and 10000a of FIG. 51). The structures of the Thread-Groups is the GE-Instance and the DTE-Instance are the same. The next stack that contains UPTs (10615, 10625, 10635, 10645 and 10655 of FIG. 54) in the Thread-Instance (10485a-10485n of FIG. 53 and 10600 of FIG. 54) is located through the Active-Stacks (10410 of FIG. 53) of the Thread-Group (10400 of FIG. 53).

Thread Creation

Each time a Thread-Instance (10485a-10485n of FIG. 53 and 10600 of FIG. 54) is inserted (see Monitors relating to Emulator-Components) into the Thread-List (10480 of FIG. 53) the following occurs:
a. The Cursor of the Thread-Instance (10600 of FIG. 54) is shifted to the Rightmost position and spawned, thereby ensuring that the spawned Cursor is pointing to the Realtime-Stack (10610 of FIG. 54). The spawned Cursor is then inserted into the Realtime-Stack-List (10530 of FIG. 53) of the Active-Stacks (10410 of FIG. 53).
b. The Cursor of the Thread-Instance (10600 of FIG. 54) is then moved to the Right and spawned again. This spawned Cursor is pointing to the Prepaid-Stack (10620 of FIG. 54) and the resulting spawned Cursor is inserted into the Prepaid-Stack-List (10540 of FIG. 53) of the Active-Stacks (10410 of FIG. 53).
c. The Cursor of the Thread-Instance (10600 of FIG. 54) is then moved to the Right and spawned again. This spawned Cursor is pointing to the Standby-Stack (10630 of FIG. 54) and the resulting spawned Cursor is inserted into the Standby-Stack-List (10550 of FIG. 53) of the Active-Stacks (10410 of FIG. 53).
d. The Cursor of the Thread-Instance (10600 of FIG. 54) is then moved to the Right and spawned again. This spawned Cursor is pointing to the Idle-Stack (10640 of FIG. 54) and the resulting spawned Cursor is inserted into the Idle-Stack-List (10560 of FIG. 53) of the Active-Stacks (10410 of FIG. 53).
e. The Cursor of the Thread-Instance (10600 of FIG. 54) is then moved to the Right and spawned again. This spawned Cursor is pointing to the Background-Stack (10650 of FIG. 54) and the resulting spawned Cursor is inserted into the Background-Stack-List (10570 of FIG. 53) of the Active-Stacks (10410 of FIG. 53).

The next Realtime-Stack (10610 of FIG. 54) that contains UPTs in the Thread-Instance (10485a-10485n of FIG. 53 and 10600 of FIG. 54) is located by shifting the Cursor of the Realtime-Stack-List (10530 of FIG. 53) to the Right and retrieving the Realtime-Stack from the Thread-Instance-Spawn (10535a-10535n of FIG. 53) of the Realtime-Stack-List. When the Cursor of the Realtime-Stack-List reaches the Rightmost position, it is then shifted back to the Leftmost position. The same process is repeated in order to locate
1) The next Prepaid-Stack (10620 of FIG. 54) that contains UPTs in the Prepaid-Stack-List (10540 of FIG. 53).
2) The next Standby-Stack (10630 of FIG. 54) that contains UPTs in the Standby-Stack-List (10550 of FIG. 53).
3) The next Idle-Stack (10640 of FIG. 54) that contains UPTs in the Idle-Stack-List (10560 of FIG. 53).
4) The next Background-Stack (10650 of FIG. 54) that contains UPTs in the Background-Stack-List (10570 of FIG. 53).

In an exemplary implementation, the Item-Processor ensures a homogenous distribution of processing by interleaving stack selection between the DTE-Instance (9425 of FIG. 48 and 9800a of FIG. 50) and the GE-Instance (9435 of FIG. 48 and 10000a of FIG. 51).

Item-Processor Operation

The exemplary KI-Switcher (1630 of FIG. 9 and 1800 of FIG. 10) utilises 3 Item-Processors (1820, 1830 and 1840 of FIG. 10) for the execution of software providing that no two Item-Processors operate on the same Digital-Business (8800 of FIG. 45) at the same time. Each of these Item-Processors is identical in function. There may be any number of Item-Processors within a single III-Emulator (551 of FIG. 3, 751 of FIG. 4, 951 of FIG. 5, 1151 of FIG. 6, 1351 of FIG. 7, 1551 of FIG. 8 and 17001 of FIG. 74) implementation. The primary function of the Item-Processor is to execute the UPT (10615, 10625, 10635, 10645 and 10655 of FIG. 54) in the Leftmost position of its applicable stack (10610, 10620, 10630, 10640 and 10650 of FIG. 54). If the Leftmost Child of a selected Stack is not a UPT, then it is ignored and removed from the Stack. Otherwise, processing is dependent on the Type of the Child being executed. Refer to Appendix B for a full listing of all executable UPTs.

Starting and Stopping Resource-Model Scheduling

Processing of stacks is attained while adhering to the Resource-Model. The Digital-Business-Selector (1810 of FIG. 10 and 2400 of FIG. 13) selects Digital-Businesses from the following Marketplaces:—
(1) The Realtime-Computation-Schedule (8220 of FIG. 42).
(2) The Prepaid-Computation-Schedule (8420 of FIG. 43).
(3) The Standby-Computation-Schedule (8040 of FIG. 41).
(4) The Idle-Computation-Schedule (8050 of FIG. 41).
(5) Every-Digital-Business (6450 of FIG. 33) and Every-Sandbox-Digital-Business (6500 of FIG. 33).

PCS-Items (8435a-8435n of FIG. 43 and 8600a of FIG. 44) are inserted onto the Prepaid-Computation-Schedule (8420 of FIG. 43) by the Governance Layer (101b of FIG. 1 and 202b of FIG. 2a) when the Digital-Business (8800 of FIG. 45) makes a booking for computational process. The Governance Layer is also responsible for removing the PCS-Item from the Prepaid-Computation-Schedule when it has expired.

RCS-Items (8235a-8235n of FIG. 42 and 8700a of FIG. 44) are created and inserted onto the Realtime-Computation-Schedule (8220 of FIG. 42) when a UPT is inserted onto an empty Realtime-Stack. Digital-Businesses (8065a-8065n, 8075a-8075n of FIG. 41 and 8800 of FIG. 45) are likewise inserted onto the Standby-Computation-Schedule (8040 of FIG. 41) and the Idle-Computation-Schedule (8050 of FIG. 41) when a UPT is inserted into the relative empty Standby-Stack (10630 of FIG. 54) or Idle-Stack (10640 of FIG. 54).

A waste of processing is prevented by removing either the RCS-Item (8235a-8235n of FIG. 42 and 8700a of FIG. 44) from the Realtime-Computation-Schedule (8220 of FIG. 42) or the Digital-Business (8065a-8065n, 8075a-8075n of FIG. 41 and 8800 of FIG. 45) from the Standby-Computation-Schedule (8040 of FIG. 41) or the Idle-Computation-Schedule (8050 of FIG. 41) when there is nothing to process at a specific level of priority as follows:
(1) In the event that there are no Children remaining in any of the Realtime-Stacks (10610 of FIG. 54) of the DTE-Instance (9425 of FIG. 48 and 9800a of FIG. 50) and the Realtime-Stacks of the GE-Instance (9435 of FIG. 48 and 10000a of FIG. 51), then each Child (9240 of FIG. 47) in the Realtime-Release (9210 of FIG. 47) has its currently selected Child—each an RCS-Item (9245 of FIG. 47) deleted. Once each of these Children is deleted, the RCS-List (9240 of FIG. 47) to which it belongs is deleted from the Realtime-Release (9210 of FIG. 47) until it is empty.
(2) If there are no Children remaining in any of the Standby-Stacks (10630 of FIG. 54) of the DTE-Instance (9425 of FIG. 48 and 9800a of FIG. 50) and the Standby-Stacks of the GE-Instance (9435 of FIG. 48 and 10000a of FIG. 51), and if there is a Child (9250 of FIG. 47) in the Standby-Release (9220 of FIG. 47), then it has its Child (9255 of FIG. 47) deleted and then the Standby-List (9250 of FIG. 37) itself is deleted from the Standby-Release (9220 of FIG. 47).

If there are no Children remaining in any of the Idle-Stacks (10640 of FIG. 54) of the DTE-Instance (9425 of FIG. 48 and 9800a of FIG. 50) and the Idle-Stacks of the GE-Instance (9435 of FIG. 48 and 10000a of FIG. 51), and if there is a Child (9260 of FIG. 47) in the Idle-Release (9230 of FIG. 47), then it has its Child (9265 of FIG. 47) deleted. The Idle-List (9260 of FIG. 47) itself is then deleted from the Idle-Release (9230 of FIG. 47).

The process of determining when a Realtime-Stack, Standby-Stack or Idle-Stack is empty, either before or after an insertion of a UPT, is managed through the use of Monitors which are attached to the relative Stacks through the Governance-Layer. This is outside the scope of this patent but may be accomplished through the use of the PI-Monitor-No-Child and the PI-Monitor-Has-Child.

Asynchronous-Bit-Sequences

An Asynchronous-Bit-Sequence (ABS) is a series of 64-bit blocks of variable length. All Asynchronous-Bit-Sequences are transmitted between Emulator-Components (FIGS. 3-8) via the ABS-Dataflow (FIG. 5) by using the ABS-Interface (5820 of FIG. 30, 6020 of FIG. 31, 6235, 6245 of FIG. 32). Although the Asynchronous-Bit-Sequences can be utilised or cached in any Emulator-Component, they can be stored permanently in the Slow-ABS (5800 of FIG. 30) or temporarily in the Fast-ABS (6000 of FIG. 31) until the Node (200a-e of FIG. 2a and 380, 395 of FIG. 2d) shuts down. Software that is comprised solely of UPTs can manage the Asynchronous-Bit-Sequences by:

(1) Attaching them directly to the Sets with the UPT-Create-ABS (see Appendix B).

(2) Creating Asynchronous-Bit-Sequences during the execution of AVMF.

(3) Creating Asynchronous-Bit-Sequences with an Emulator-Component (FIGS. 3-8).

Slow-ABS

The Slow-ABS (5800 of FIG. 30) is optimised for mass storage with slow transmission rates and supplies data to and from the Plugin-Manager (7600 of FIG. 39), Partner-Channel-Manager (430 of FIG. 3 and 13000 of FIG. 66) and the Fast-ABS (6000 of FIG. 31). These Emulator-Components (FIGS. 3-8) can generate large volumes of information from across the network or from the local host. The Slow-ABS is stored in the Permanent-Storage-B (1130b of FIG. 6 and 5805 of FIG. 30) enabling all Slow-ABS handles stored by the KI-Memory (see Appendix G) to be retained on shutdown.

Fast-ABS

The Fast-ABS (6000 of FIG. 31) provides fast but transient Asynchronous-Bit-Sequences to the 3IP-AVM (17200 of FIG. 75), 3IP-AVMF-Verifier (17200 of FIG. 75), ABS-Bus (6200 of FIG. 32). These Emulator-Components (FIGS. 3-8) operate at a high speed and require the fast delivery of 64-bit blocks. On shutdown, all Fast-ABS data is erased as well as the handles stored by the KI-Memory (see Appendix G) that refers to that data. Any sets that held the Fast-ABS will no longer hold those sequences on start-up.

ABS-Bus

Since the Fast-ABS (6000 of FIG. 31) is transient, it must first be loaded from the Slow-ABS (5800 of FIG. 30) prior to use via the ABS-Bus (6200 of FIG. 32). Furthermore, any data that requires persistence that is generated in the Fast-ABS needs to be stored to the Slow-ABS prior to shutdown. The ABS-Bus is part of the Primary-Dataflow as it receives direction from the UPT-Cycler (1470 of FIG. 8 and 1600 of FIG. 9) via the UPT-Execution-Interface (1795, 1635 of FIG. 9 and 1825, 1835, 1845, 1950 of FIG. 10) to move Asynchronous-Bit-Sequences between the Fast-ABS and the Slow-ABS.

ABS-Interface

The Fast-ABS (6000 of FIG. 31) and Slow-ABS (5800 of FIG. 30) are the cornerstones of the ABS-Dataflow. Both Asynchronous-Bit-Sequences are accessed via Cursor-Identification (5030 of FIG. 26, 6635 of FIG. 34 and 7620 of FIG. 39) handles that are logically stored on Manabars-Sets (see Appendix G) and are physically stored in the KI-Memory (see Appendix G).

Human-Communication-Manager

The Human-Communication-Manager or HCM (700 of FIG. 4 and 900 of FIG. 5) manages the ILI-Phenotype (6860 of FIG. 35) that is responsible for communication with the user. The ILI-Phenotype utilises a sensory model—the Mesh-Blueprint—where communication is channelled through an abstract human body (see Appendix F for an example as to how abstract human communication can be implemented using sets). The reasons and specification of the Mesh-Blueprint are beyond the scope of the patent—it is enough to say here that information may become both future and backwards compatible and is a fundamental property of a Universal Virtual Computer (UVC). Therefore, older software is able to communicate with the new III-Emulators and old III-Emulators (551 of FIG. 3, 751 of FIG. 4, 951 of FIG. 5, 1151 of FIG. 6, 1351 of FIG. 7, 1551 of FIG. 8 and 17001 of FIG. 74) are able to communicate with new software. The abstract human interface need never change while communication is limited to humankind. However, although the III-Emulator specification does not change, it may be expanded on to increase sensory resolution without affecting the context of the data that passes through it. For example, an early version of the specification may only describe communication with the retina and cochlea. A later specification may be updated to include olfactory information. Since the Mesh-Blueprint may change, a standard embodiment of the Human-Communication-Manager (700 of FIG. 4 and 900 of FIG. 5) is expected to emerge.

The Human-Communication-Manager is responsible for:
(1) Identifying versions of the Mesh-Blueprint.
(2) Projecting the sensory experience from an identified Manabars-Sets (see Appendix G) in the Mesh-Blueprint-Context (7830 of FIG. 40) and encoding a sensory perception that is generated from the human user back into the identified Manabars-Set.

Any mechanism to automatically update the Human-Communication-Manager (700 of FIG. 4 and 900 of FIG. 5) so that its can interpret newer versions of the Mesh-Blueprint are beyond the scope of this patent, but do not limit it.

Partner-Channel-Manager

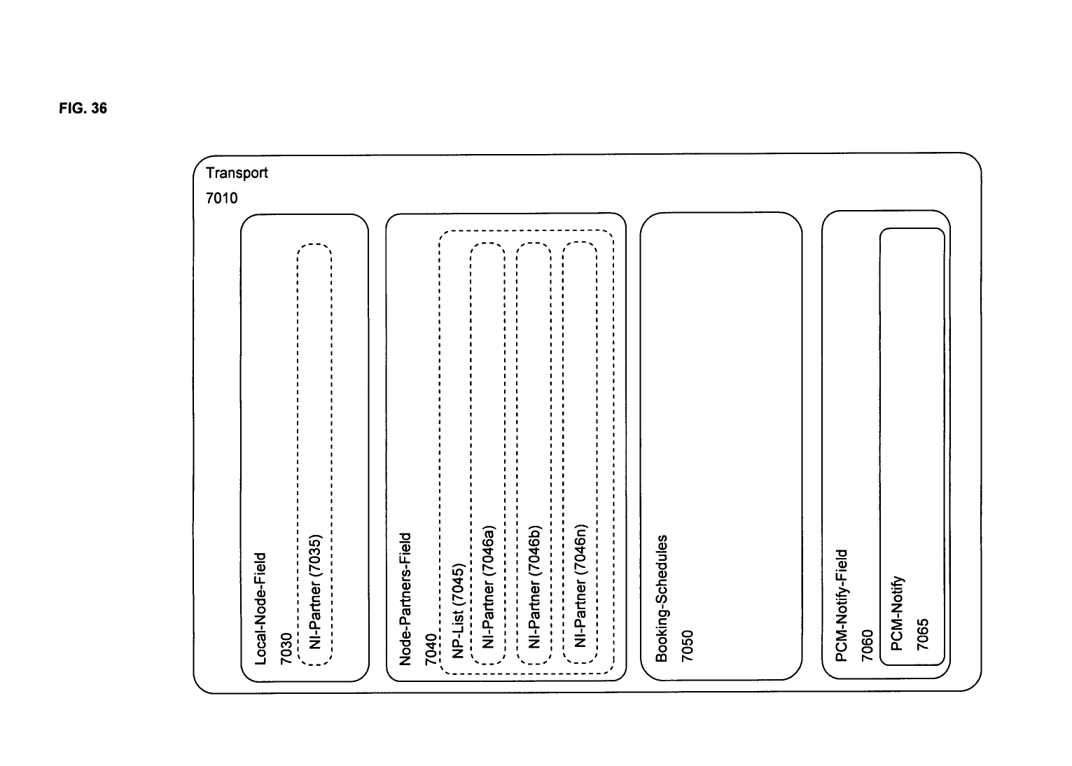

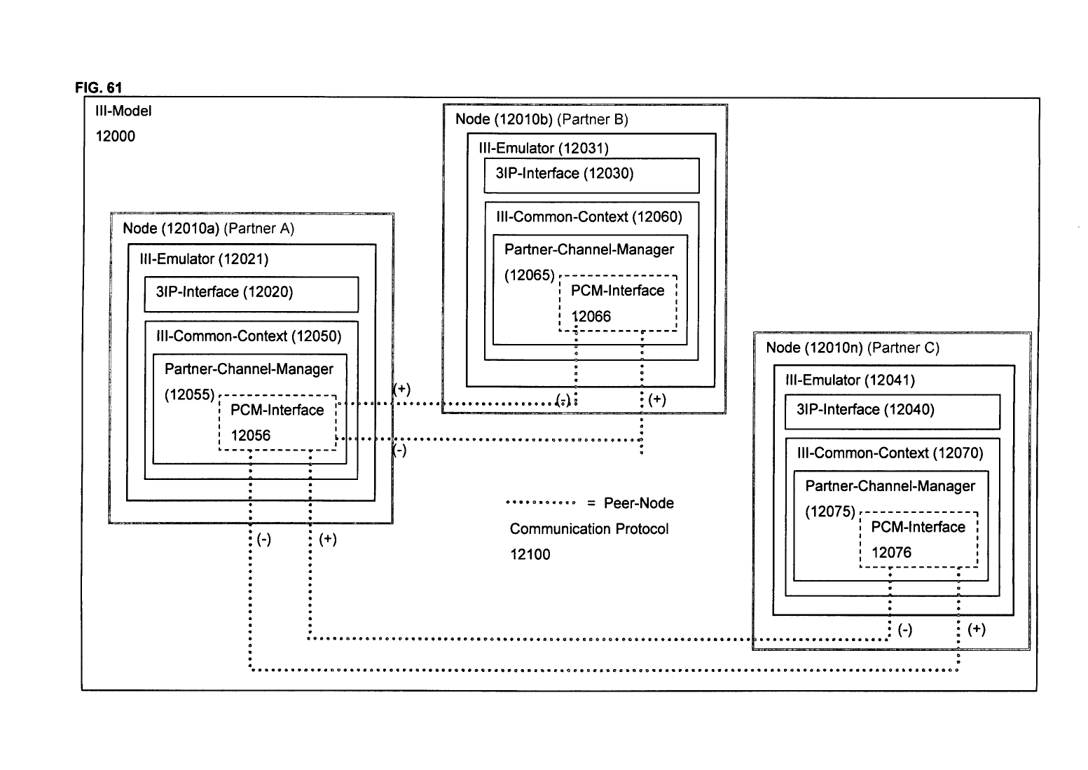

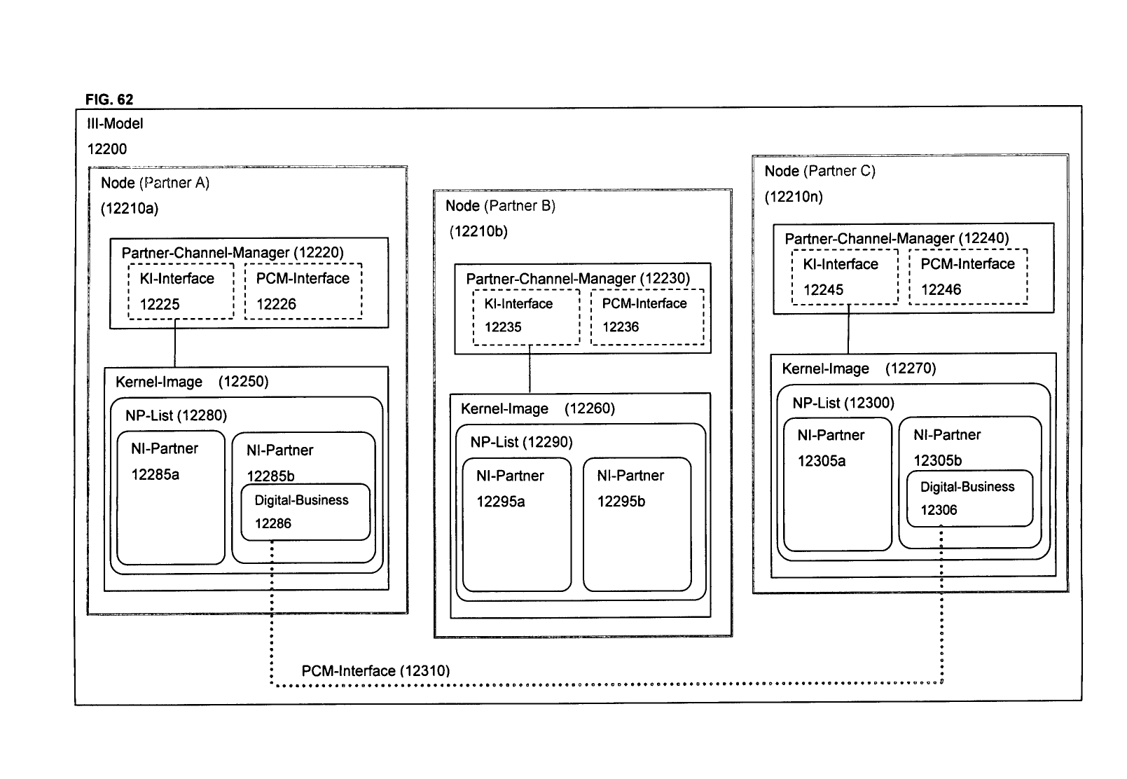

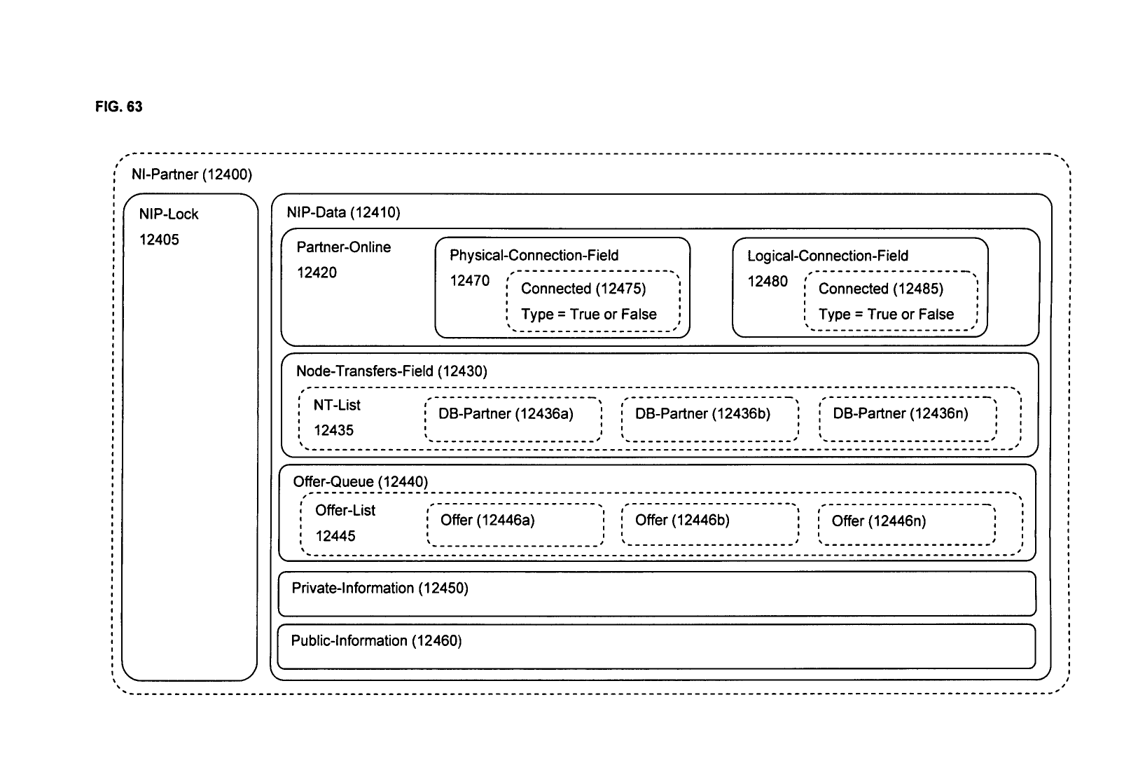

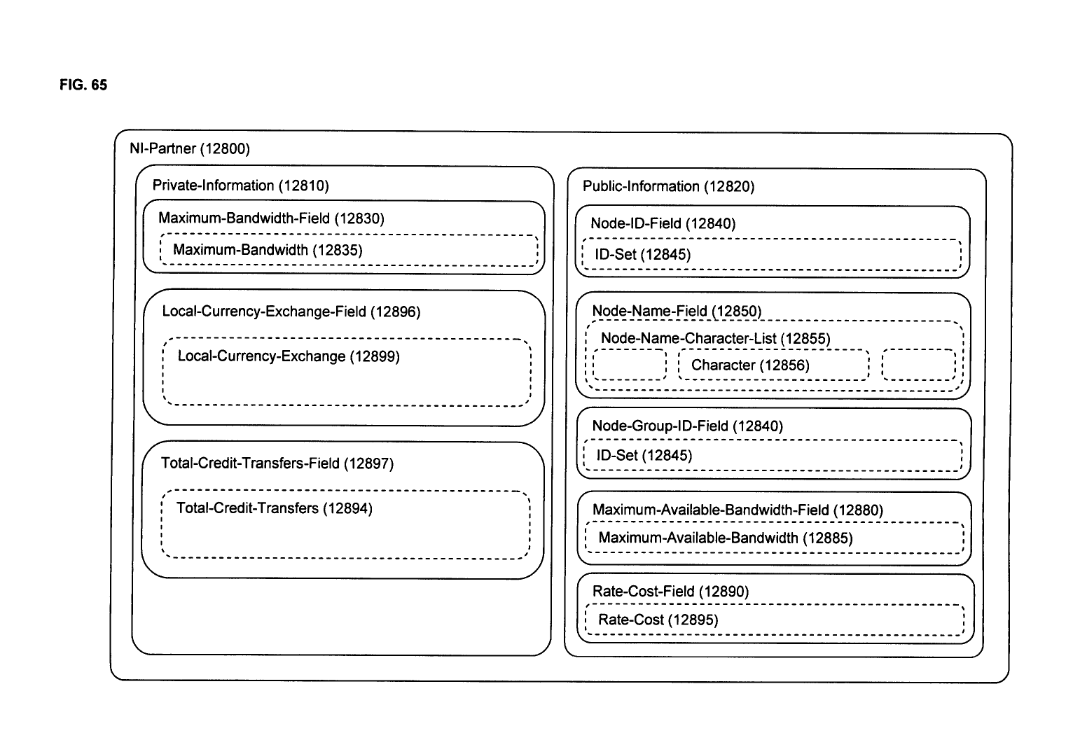

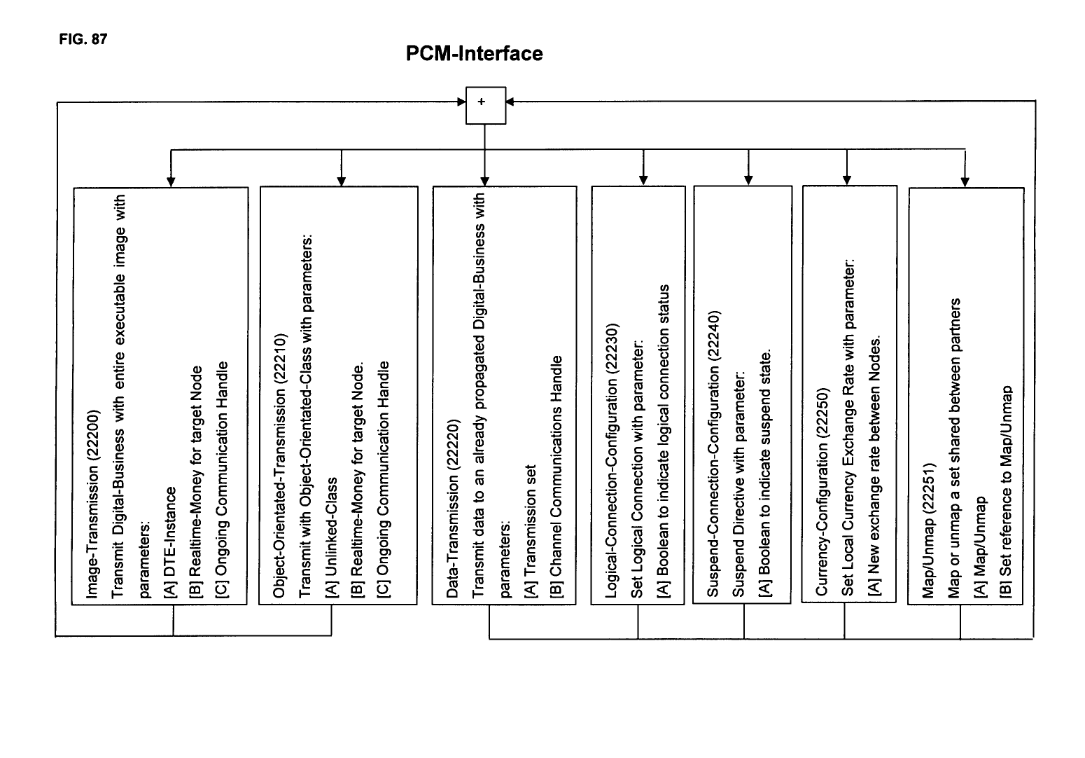

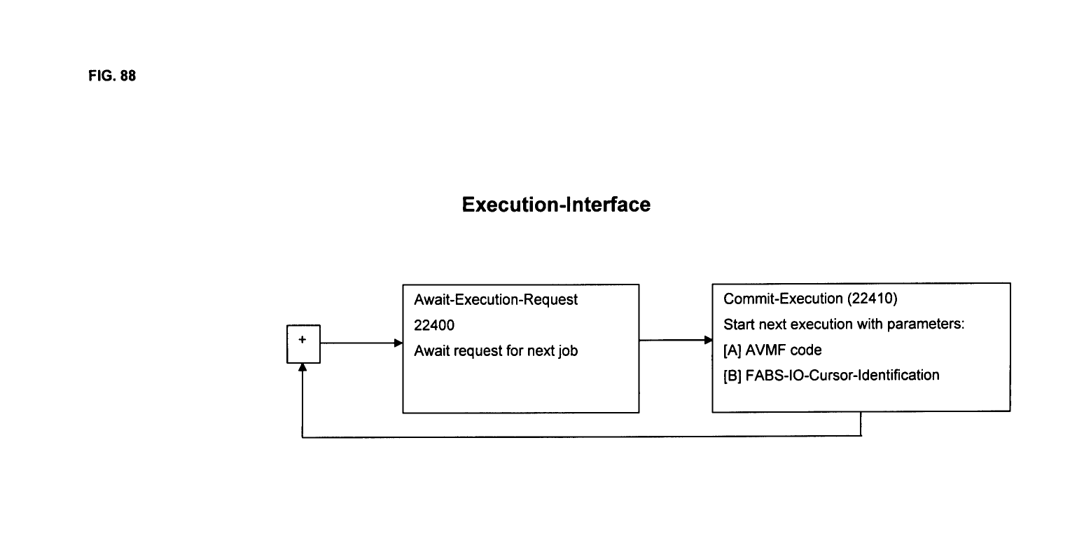

The Partner-Channel-Manager or PCM (430 of FIG. 3, 630 of FIG. 4, 830 of FIG. 5, 1030 of FIG. 6, 1230 of FIG. 7, 1430 of FIG. 8 and 13000, 13100, 13120 and 13140 of FIG. 66) Emulator-Component has 5 distinct roles as determined by the PCM-Interface (12056, 12066 and 12076 of FIG. 61, 12226, 12236 and 12246 of FIG. 62 and 13025, 13105, 13125 and 13145 of FIG. 66 and FIG. 87):—
(1) To set up connections between Nodes (200a-200e of FIG. 2a, 12010a-12010n of FIG. 61, 12210a-12210n of FIG. 62 and 13090, 13110 and 13130 of FIG. 66) thereby establishing the connection between Node partners. The process of linking Nodes is beyond the scope of this patent, as the implementation of the PCM-Interface can be performed in many ways and may use many transport layers such as TCP/IP, Frame Relay and point-to-point protocols.
(2) Project each Node partner by the creation of an NI-Partner (7046a-7046n of FIG. 36 and 12400 of FIG. 63). Each NI-Partner is inserted into the NP-List (7045 of FIG. 36 and 12280, 12290 and 12300 of FIG. 62).
(3) Transmit data between Digital-Businesses (8800 of FIG. 45) at a specific rate by performing deep scanning of the NI-Partners (12400 of FIG. 63 and 12285a, 12285b, 12295a, 12295b, 12305a and 12305b of FIG. 62) to transmit bandwidth in adherence to the Resource-Model.
(4) Perform a cross-compilation on the Slow-ABS (5800 of FIG. 30) primitive of any UPT-AVM-Verify (see Appendix B) that represents Asynchronous-Virtual-Machine-Format or AVMF (see Appendix E). The cross-compilation must ensure that all Asynchronous-Virtual-Machine-Instructions or AVMI (see Appendix E again) are able to execute on the destination Node (200a-e of FIG. 2a and 380, 395 of FIG. 2d) and represent a logically identical execution. A new Slow-ABS primitive that contains the cross-compilation is generated and replace as the original in the UPT-AVM-Verify (see Appendix B).
(5) Commit money transfers to and from Digital-Businesses (8800 of FIG. 45) on the Node partner (12010a, 12010b, 12010n of FIG. 61 and 12210a, 12210b, 12210n of FIG. 62). The total amount of money transferred to local Digital-Businesses (8800 of FIG. 45) on behalf of the Node partner (12010a, 12010b, 12010n of FIG. 61 and 12210a, 12210b, 12210n of FIG. 62) is stored to the Float primitive of the Total-Credit-Transfers-Field Child (12897 of FIG. 65). Transfers are always performed in local currency of the Node partner, so it needs to be converted to the local Node currency by multiplying it by the Local-Currency-Exchange (12899 of FIG. 65). It is the responsibility of the Node partners themselves to arrange the appropriate payment to clear unbalanced credit transfers in a similar way that a bank makes bulk transfers to cater for drifting surplus or deficit. Alternatively, some implementations may simply adjust the Local-Currency-Exchange-Field (12896 of FIG. 65) to enable the imbalance to self-correct.
   Connecting Nodes

The actual connection to Node partners (12010a-12010n of FIG. 61 and 12210a, 12210b, 12210n of FIG. 62) is an implementation specific function. In implementing the PCM-Interface (12056, 12066 and 12076 of FIG. 61, 12226, 12236 and 12246 of FIG. 62 and 130125, 13105, 13125 and 13145 of FIG. 66), the Partner-Channel-Manager (13000, 13100, 13120 and 13140 of FIG. 66) is required to manage NI-Partners (7046a-7046n of FIG. 36 and 12400 of FIG. 63) from the NP-List (7045 of FIG. 36) on:

1) By creating an NI-Partner on a new connection.

2) By deleting an NI-Partner if a connection has been removed.

The PCM-Interface is implemented in pairs (12056, 12066 and 12076 of FIG. 61), so there is a positive (+) and a negative (−) implementation for each Node partner corresponding to a single NI-Partner. Each NI-Partner structure presents a Node (12010a-12010n of FIG. 61) only when:

1) Both Node partner administrators have agreed to connect to each other.

2) The physical implementation of the PCM-Interface has enabled the connection.

For the Node partner to be fully online, the Children of the Physical-Connection-Field (12470 of FIG. 63) and the Logical-Connection-Field (12480 of FIG. 63) both need to have a Type set to Type-True. If the Child of the Physical-Connection-Field (12470 of FIG. 63) has its Type set to Type-True, then the connection is physically established, and this can only be set by the Partner-Channel-Manager (13000 of FIG. 66). The Governance Layer (101b of FIG. 1 and 202b of FIG. 2a) may reassign the Cursor of the Logical-Connection-Field to a Child with its Type set to Type-False if it wishes to prevent the logical connection to this partner, otherwise it is set to Type-True. A Child with its Type set to Type-False inside the Logical-Connection-Field (12480 of FIG. 63) is a suspend directive and prevents new Digital-Businesses (8800 of FIG. 45) from being formed in either direction by the Partner-Channel-Manager, as well as suspending any transmission between Digital-Businesses on the partner and the local host. However, there is nothing that limits a Digital-Business that is already established on the Partner from attempting to find another route to the local host during the suspend directive. While the Types of both the Children of the Physical-Connection-Field (12470 of FIG. 63) and the Logical-Connection-Field (12480 of FIG. 63) are set to Type-True all transmissions between the Nodes (12010a-12010n of FIG. 61 and 13090, 13110 and 13130 of FIG. 66) are then made through the PCM-Interface (12056, 12066 and 12076 of FIG. 61 and 13025, 13105, 13125 and 13145 of FIG. 66).

Presenting DB-Partners

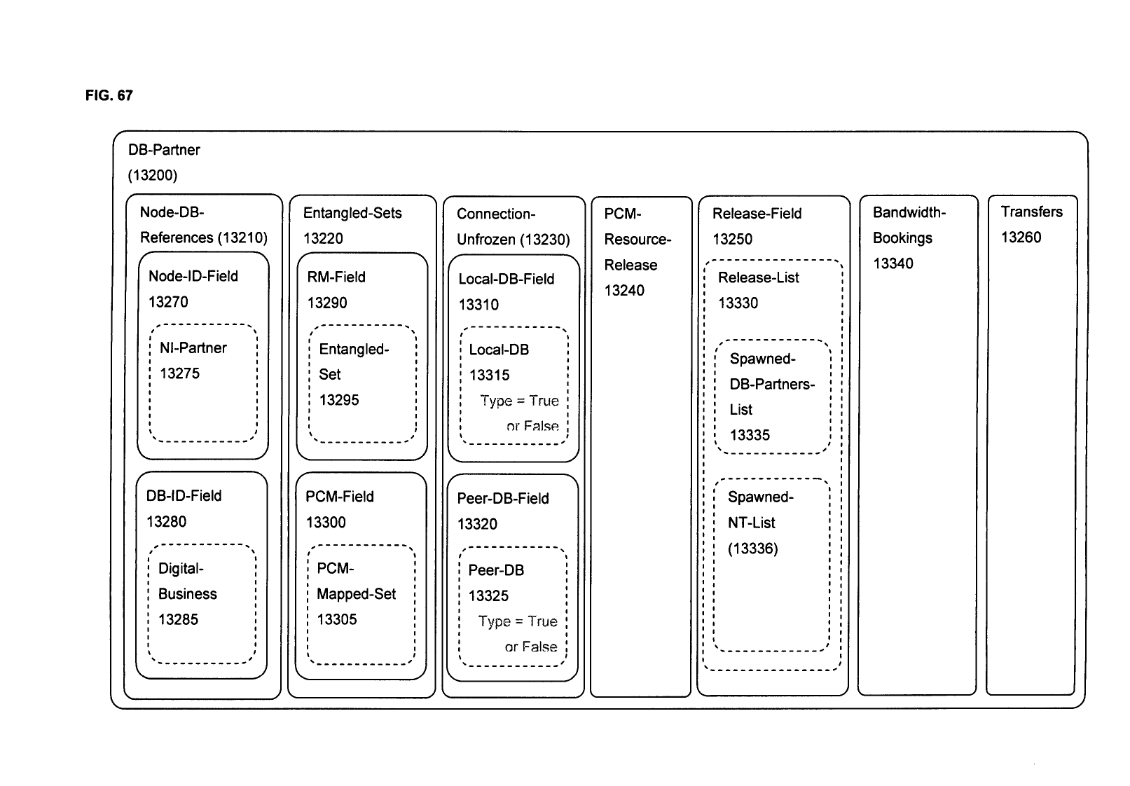

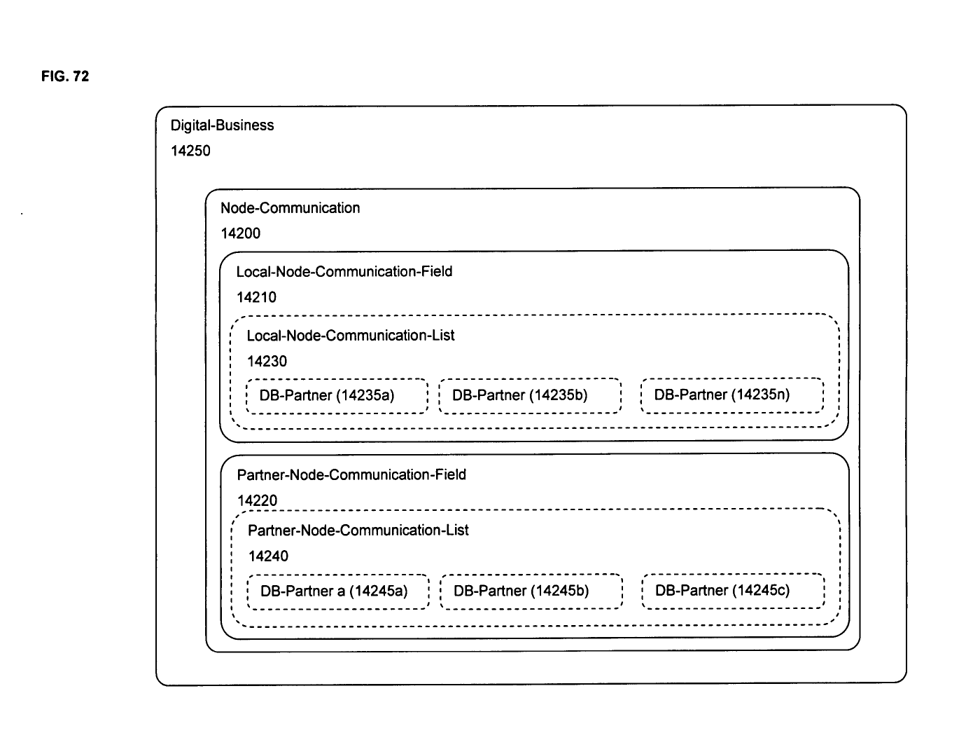

An NI-Partner (12400 of FIG. 63) keeps track of all information necessary to maintain a connection between two Node partners (12010a-12010n of FIG. 61 and 12210a, 12210b, 12210n of FIG. 62). A DB-Partner (13200 of FIG. 67) retains all information necessary to maintain a connection between two Digital-Businesses (8800 of FIG. 45). A single Digital-Business may propagate across to one or more Node partner. A single Digital-Business may also propagate across to a single Node partner one or more times. For each of the propagations that occur, a DB-Partner (12436a-12436n of FIG. 63 and 13200 of FIG. 67) is created (see Digital-Business Propagation below). A single Digital-Business stores each DB-Partner that it is connected to, in Node-Communication (8930 of FIG. 45 and 14200 of FIG. 72), no matter what Node (200a-e of FIG. 2a and 380, 395 of FIG. 2d) it resides on. A single NI-Partner (12400 of FIG. 63) stores a DB-Partner (12436a-12436b of FIG. 63) in the Node-Transfers-Field (12430 of FIG. 63) for each Digital-Business (8800 of FIG. 45) that has propagated across to the corresponding partner.

Digital-Business Propagation

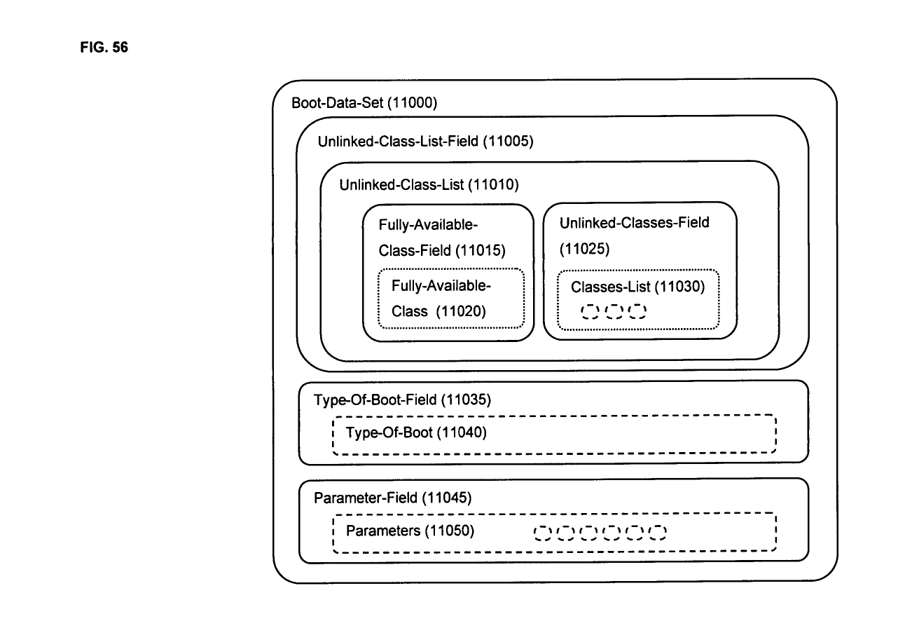

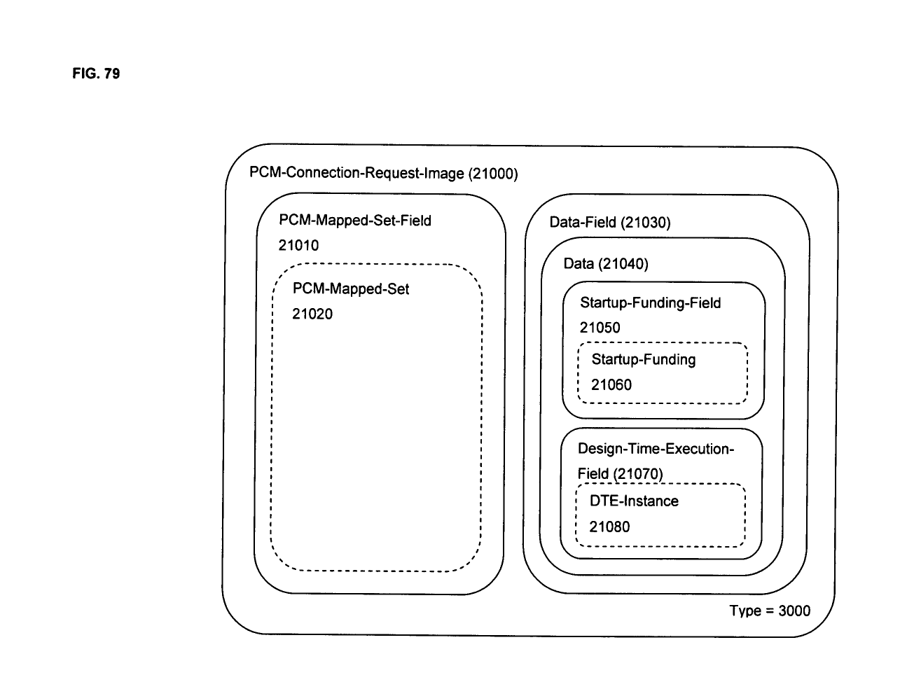

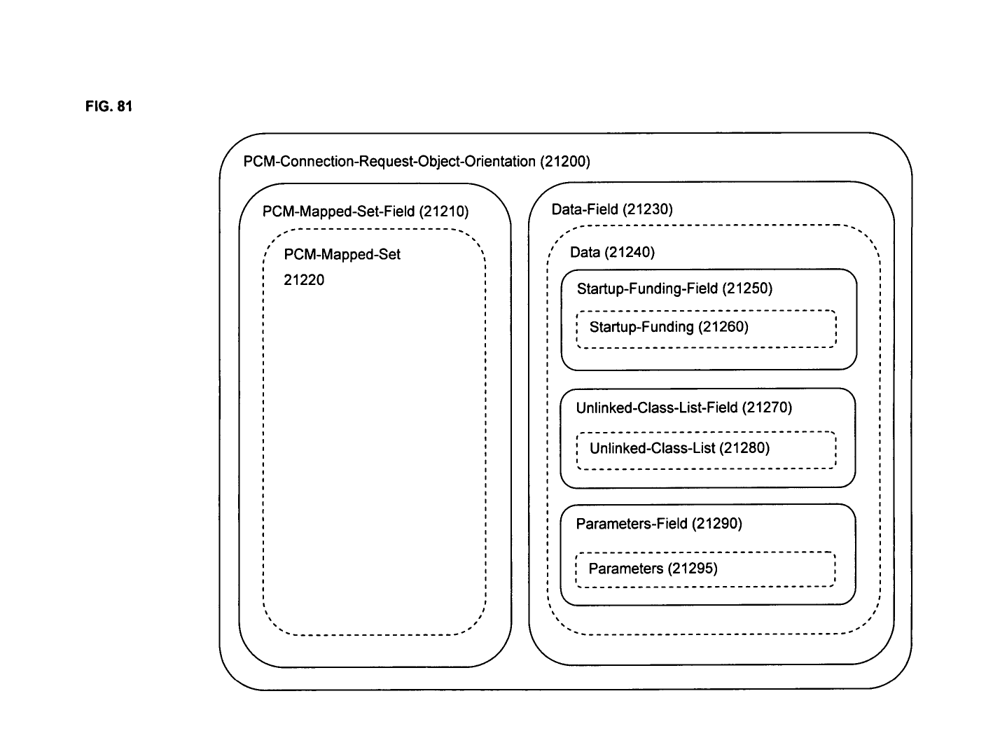

When a Digital-Business (8800 of FIG. 45) wants to propagate to either the Local Node (12010a-12010n of FIG. 61) or a Node partner the Governance Layer (101b of FIG. 1, 202b of FIG. 2a) will insert a PCM-Connection-Request (21000 of FIG. 79) into the Child of the PCM-Notify-Field (7060 of FIG. 36). How the propagation occurs is implementation specific, however, 2 possible configurations are:
a. PCM-Connection-Request-Image (21000 of FIG. 79) is the transmission of the entire executable image for the Digital-Business (8800 of FIG. 45). The PCM-Connection-Request contains only two Fields inside the Data (21040 of FIG. 79). These Fields hold the Startup-Funding-Field (21060 of FIG. 79) and the DTE-Instance (21080 of FIG. 79 and 9800a of FIG. 50) of the Digital-Business image to be executed on the target Node. On propagation the Float value of the Startup-Funding is added to the Float value of the Child of the Bank-Account-Field (8890 of FIG. 45) of the new Digital-Business (8800 of FIG. 45) on the target Node. Startup-Funding is specified in the target Node currency. The DTE-Instance is inserted into the Design-Time-Execution (9420 of FIG. 48) and the Digital-Business is inserted into Every-Digital-Business-List (6455 of FIG. 33).
b. PCM-Connection-Request-Object-Orientation (21200 of FIG. 81) allows the DTE-Instance (21080 of FIG. 79 and 9800a of FIG. 50) to be constructed utilising the Object-Orientation support of the invention. The PCM-Connection-Request-Object-Orientation has 3 Fields inside the Data (21240 of FIG. 81). These being the Startup-Funding-Field (21250 of FIG. 81), the Unlinked-Class-List-Field (21270 of FIG. 81) and the Parameters-Field (21290 of FIG. 81). The Float value of the Startup-Funding (21260 of FIG. 81) is added to the Float value of the Child of the Bank-Account-Field (8890 of FIG. 45) of the new Digital-Business (8800 of FIG. 45). The Unlinked-Class-List and the Parameters are used to construct the Boot-Data-Set (9855 of FIG. 50 and FIG. 56) that is then inserted into the DB-Boot-Field (9850 of FIG. 50) of the DB-Logic (9840 of FIG. 50) in the DTE-Instance (9800a of FIG. 50). It is the responsibility of the Governance Layer to ensure that the DTE-Instance (6475 of FIG. 33) of the DTE-Template-Field (6481 of FIG. 33) has suitable booting code to link the Object-Orientated structures contained in the Boot-Data-Set.

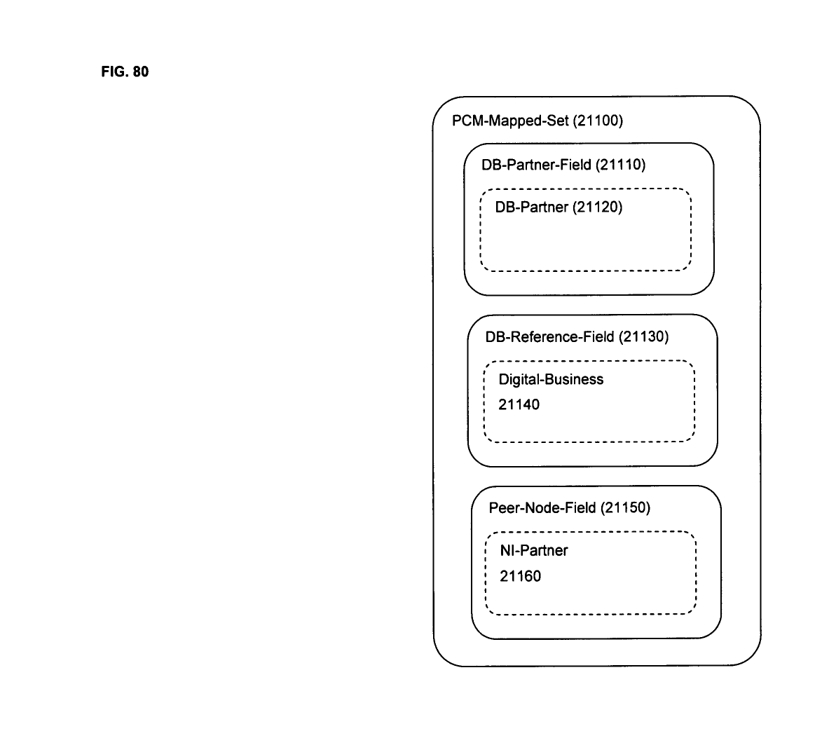

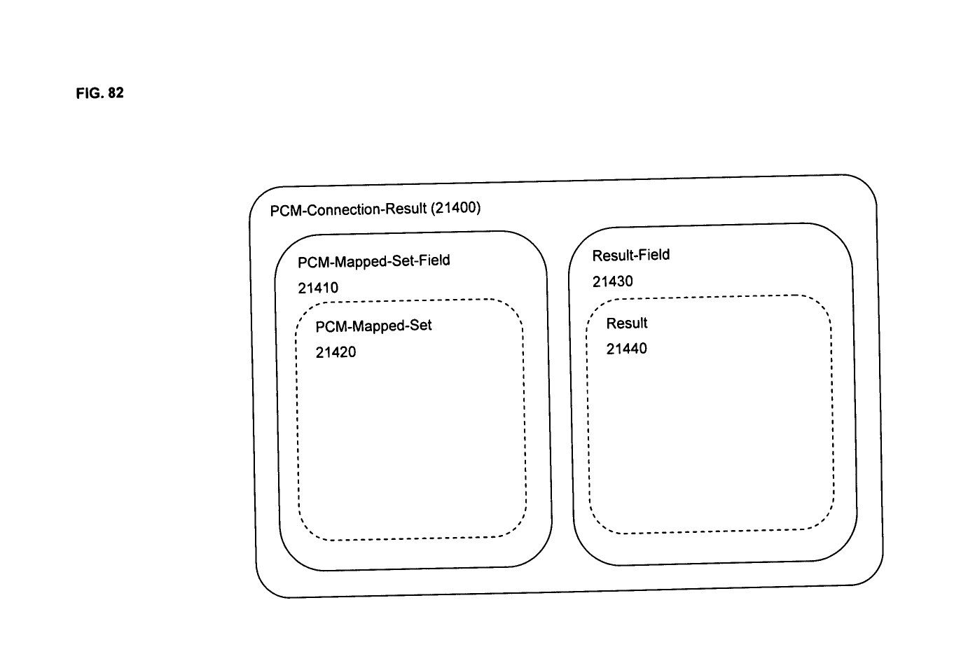

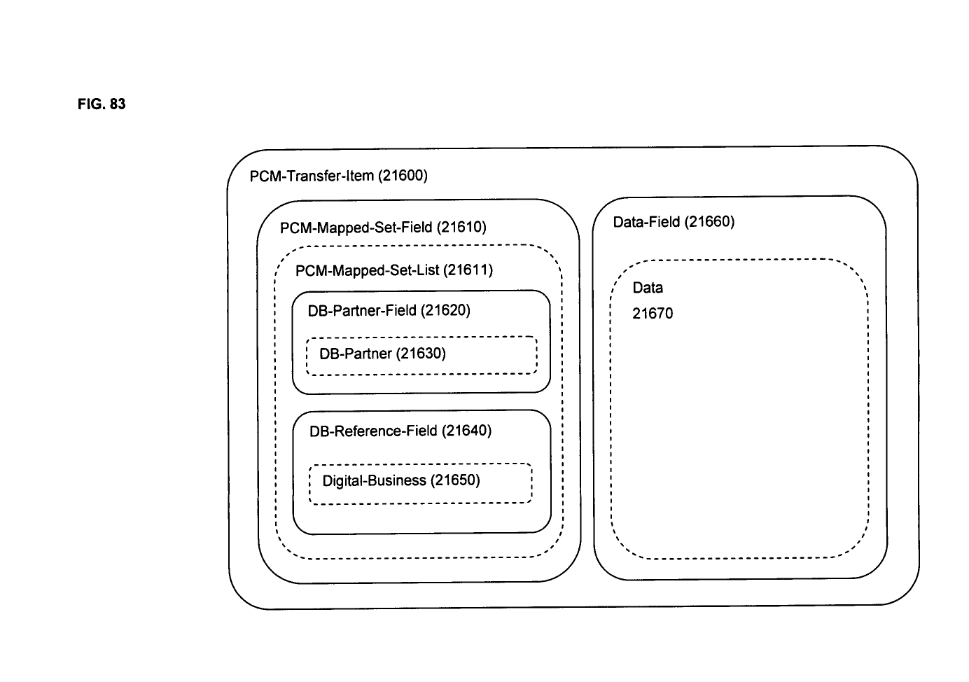

There are three main steps to propagation. Each step is performed by alternate Node partners (12010a, 12010b, 12010n of FIG. 61 and 12210a-12210n of FIG. 62). The three steps are:
(1) The Partner-Channel-Manager (13000 of FIG. 66) sets a Monitor (5200 of FIG. 27) on to PCM-Notify (7065 of FIG. 36) to listen for the instructions of a PCM-Connection-Request-Image (21000 of FIG. 79) or a PCM-Connection-Request-Object-Orientation (21200 of FIG. 81). When the Monitor is triggered, the following occurs:
a. The Partner-Channel-Manager (13000 of FIG. 66) creates a new DB-Partner (13200 of FIG. 67) and inserts it into the NT-List (12435 of FIG. 63) of the NI-Partner (12400 of FIG. 63), and the DB-Partners-Field (21110 of FIG. 80 and 21620 of FIG. 83) of the PCM-Mapped-Set (21100 of FIG. 80) of the relevant PCM connection request.
b. The PCM-Mapped-Set (21100 of FIG. 80) is then inserted into both the RM-Field (13290 of FIG. 67) and the PCM-Field (13300 of FIG. 67) located in the Entangled-Sets (13220 of FIG. 67) of the newly created DB-Partner (13200 of FIG. 67).
c. At this point in time the Local-DB-Field (13310 of FIG. 67) of Connection-Unfrozen (13230 of FIG. 67) will have a Child with its Type set to Type-True to indicate that the Digital-Business (8800 of FIG. 45) is ready to transmit on the Local Node (12210a-12210n of FIG. 62). However the Child of the Peer-DB-Field (13320 of FIG. 67) will have a Type of Type-False to indicate that the peer Digital-Business (8800 of FIG. 45) is unable to accept any transmissions.
d. The Node (12210a-12210n of FIG. 62) that the Digital-Business (8800 of FIG. 45) wants to propagate to is located through the Peer-Node-Field (21150 of FIG. 80) of the relevant PCM connection request.
e. The final step in setting up the DB-Partner (13200 of FIG. 67) before sending the relevant PCM connection request to the Node partner (12210a-12210n of FIG. 62) is to insert the DB-Partner into either the Local-Node-Communication-List (14230 of FIG. 72) or the Partner-Node-Communication-List (14240 of FIG. 72) of the Digital-Business (8800 of FIG. 45), depending on whether the Child of the Peer-Node-Field (21150 of FIG. 80) of the connection request is the Local-Node or a Node partner.
f. Although the actual transmission of the request to the Node partner (12210a-12210n of FIG. 62) is implementation specific and is therefore beyond the scope of this patent, part of the transmission will involve identifying PCM-Mapped-Sets (13305 of FIG. 67, 21020 of FIG. 79, 21100 of FIG. 80, 21220 of FIG. 81 and 21420 of FIG. 82) and locating a matching Set on the Node partner. If there is no existing matching Mapped-Set then one will be created (see UPT-Map and UPT-Unmap of Appendix B).
(2) On receipt of the relevant PCM connection request the Partner-Channel-Manager (13000 of FIG. 66) will:
a. Create a new Digital-Business (8800 of FIG. 45) signalled by the appropriate Data (21040 of FIG. 79) of the relevant PCM connection request to enable the Digital-Business to function, as previously specified.
b. Insert the newly created Digital-Business into Every-Digital-Business-List (6455 of FIG. 33).
c. Create a new DB-Partner (13200 of FIG. 67) and insert it into both the Node-Communication (8930 of FIG. 45 and 14200 of FIG. 72) of the Digital-Business (8800 of FIG. 45 and 14250 of FIG. 72), and the NT-List (12435 of FIG. 63) of the NI-Partner (12400 of FIG. 63).
d. Insert the newly created DB-Partner (13200 of FIG. 67) into the Founder-Communication-Field (8920 of FIG. 45) of the Digital-Business (8800 of FIG. 45) in order for the newly created Digital-Business to locate its parent Digital-Business.
e. The newly created DB-Partner (13200 of FIG. 67) is also inserted into the DB-Partner-Field (21110 of FIG. 80 and 21620 of FIG. 83) of the PCM-Mapped-Set (21100 of FIG. 80 and 21220 of FIG. 81).
f. The PCM-Mapped-Set (21100 of FIG. 80 and 21220 of FIG. 81) is inserted into the PCM-Field (13300 of FIG. 67) of the DB-Partner.
g. At this point in time the RM-Field (13290 of FIG. 67) will remain empty, as the newly created Digital-Business (8800 of FIG. 45) is unaware of the connection. Also at this point in time both the Local-DB-Field (13310 of FIG. 67) and the Peer-DB-Field (13320 of FIG. 67) of Connection-Unfrozen (13230 of FIG. 67) will have a Child with its Type set to Type-True inserted, to indicate that the Digital-Business (8800 of FIG. 45, 12286 and 12306 of FIG. 62) is ready to transmit on both Nodes (12210a and 12210n of FIG. 62).
h. Finally the Partner-Channel-Manager (13000 of FIG. 66) will send back to the Node partner (13090, 13110 or 13130 of FIG. 66) a PCM-Connection-Result (21400 of FIG. 82) with the Type of the Result (21440 of FIG. 82) set to Type-True or Type-False to represent whether it was a successful propagation.
(3) On receipt of a PCM-Connection-Result (21400 of FIG. 82) the Partner-Channel-Manager (13000 of FIG. 66) will:
a. Check the Type of the Child of the Result-Field (21430 of FIG. 82). If the Type is of Type-False then the Partner-Channel-Manager (13000 of FIG. 66) will delete all references to the DB-Partner (13200 of FIG. 67) using all spawned Cursor-Identifications listed in the Release-List (13330 of FIG. 67) of the DB-Partner.
b. If the Type is of Type-True then the Partner-Channel-Manager (13000 of FIG. 66) will insert a Child with its Type set to Type-True into the Peer-DB-Field (13320 of FIG. 67) of Connection-Unfrozen (13230 of FIG. 67) to indicate that the Peer Digital-Business (12286 and 12306 of FIG. 62) is ready to accept transmissions.
   Transmitter

The Transmitter (13020 of FIG. 66) is a component of the Partner-Channel-Manager (13000, 13100, 13120 and 13140 of FIG. 66) that is responsible for transmitting data between Nodes (13090, 13110 and 13130 of FIG. 66). Nodes are responsible for the management and reservation of outbound bandwidth only. The adjacent partners manage and reserve the inbound data. For a Digital-Business (12286 and 12306 of FIG. 62) to truly control its own inbound bandwidth, it will need to communicate with its peer Digital-Business and have it perform the reservation. Node owners are required to manage any financial imbalances with their partner for asymmetric costs on a channel.

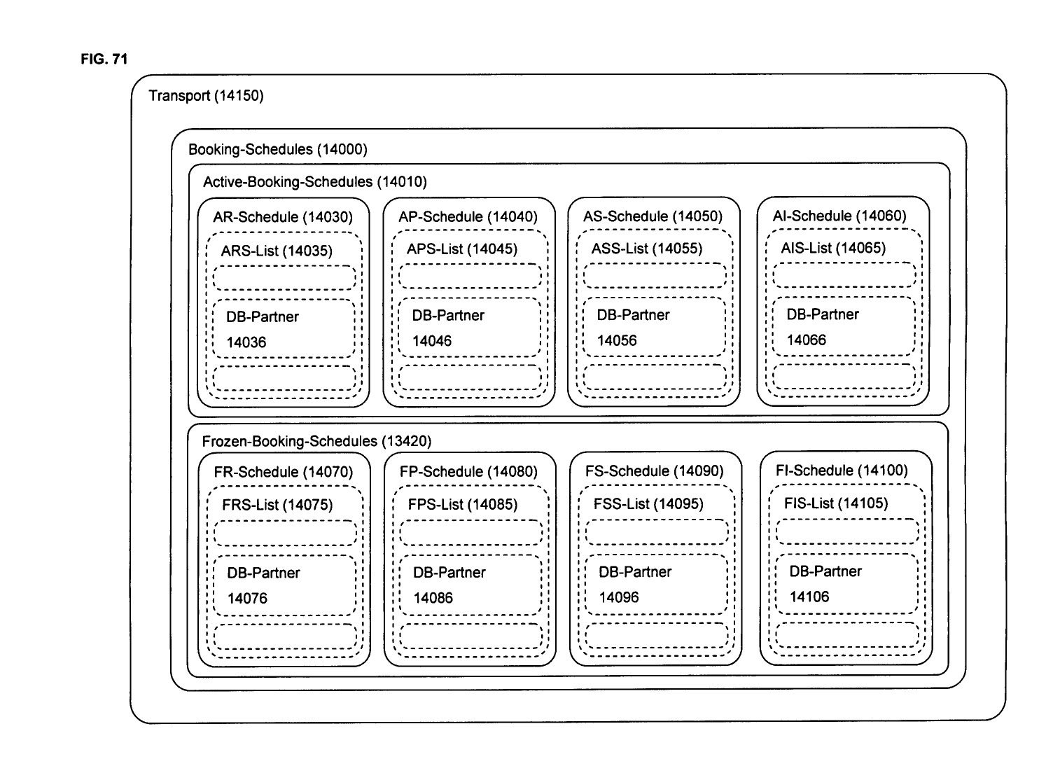

The management and reservation of bandwidth adheres to the rules of the Resource-Model when communicating between Node partners (12010a-12010n of FIG. 61). The 5 Marketplaces are located in the Active-Booking-Schedules (14010 of FIG. 71). These Marketplaces are:

1. AR-Schedule (14030 of FIG. 71).

2. AP-Schedule (14040 of FIG. 71).

3. AS-Schedule (14050 of FIG. 71).

4. AI-Schedule (14060 of FIG. 71).

5. Node-Transfers-Field (12430 of FIG. 63).

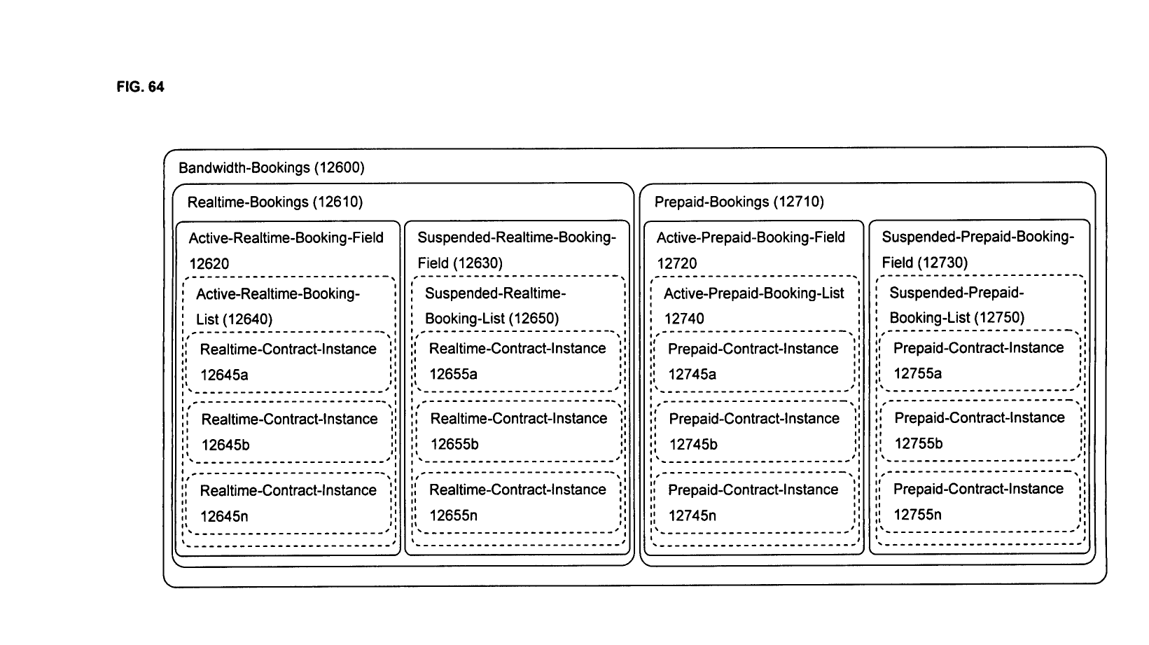

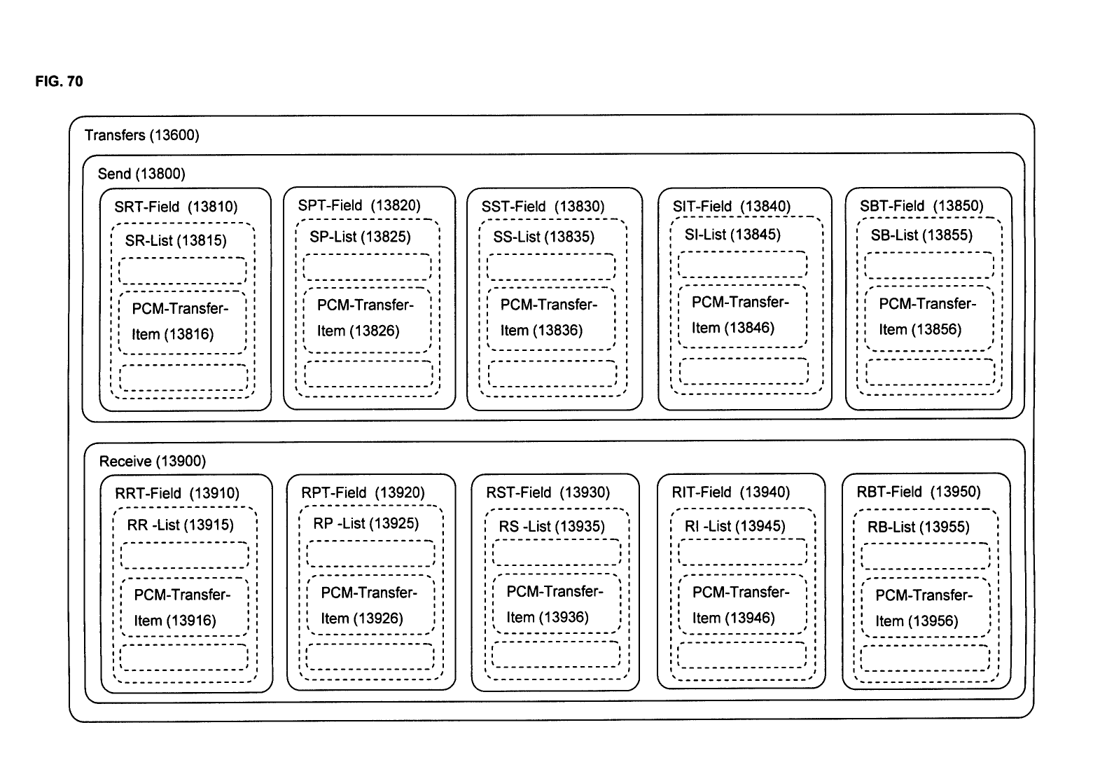

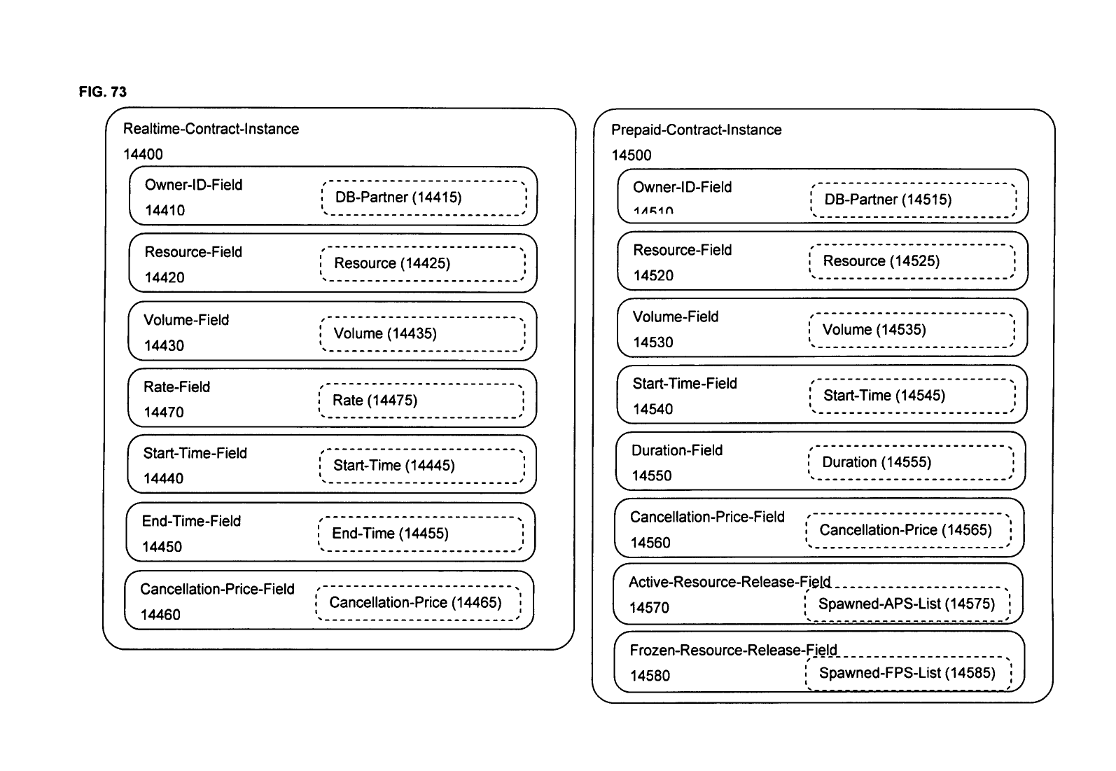

When a Digital-Business (12286 and 12306 of FIG. 62) wants to communicate with a peer Digital-Business (8800 of FIG. 45) the Governance Layer (101b of FIG. 1 and 202b of FIG. 2a) will insert a PCM-Transfer-Item (13816, 13826, 13836, 13846 and 13856 of FIG. 70) onto the relative List (13815, 13825, 13835, 13845 and 13855 of FIG. 70) located in Send (13800 of FIG. 70) of the corresponding DB-Partner (13200 of FIG. 67). The Transmitter (13020 of FIG. 66) regularly cycles through the Active-Booking-Schedules (14010 of FIG. 71) looking for PCM-Transfer-Items that are ready to be sent in the following order:
(1) The Transmitter searches all DB-Partners (14036 of FIG. 71 and 13200 of FIG. 67) from Left to Right in the AR-Schedule (14030 of FIG. 71) checking to see if the DB-Partner has any PCM-Transfer-Items (13816 of FIG. 70) in the SR-List (13815 of FIG. 70). If a PCM-Transfer-Item is found the Transmitter will check the Active-Prepaid-Booking-List (12740 of FIG. 64) to see if the DB-Partner has any Prepaid-Contract-Instances (12745a-12745n of FIG. 64). If it does then the PCM-Transfer-Item is transmitted utilising the Prepaid-Contract-Instance, otherwise the PCM-Transfer-Item is transmitted utilising a Realtime-Contract-Instance (12645a-12645n of FIG. 64) located in the Active-Realtime-Booking-List (12620 of FIG. 64).
(2) If no PCM-Transfer-Items (13816 of FIG. 70) are found in any of the SR-Lists (13815 of FIG. 70) of the DB-Partners in the AR-Schedule (14030 of FIG. 71) then the Transmitter (13020 of FIG. 66) will move to the AP-Schedule (14040 of FIG. 71). Each Prepaid-Contract-Instance (14046 of FIG. 71 and 14500 of FIG. 73) is located from Left to Right and the relative DB-Partner (13200 of FIG. 67) is found through the Owner-ID-Field (14510 of FIG. 73). The Transmitter will check the SR-List (13815 of FIG. 70), SP-List (13825 of FIG. 70), SS-List (13835 of FIG. 70), SI-List (13845 of FIG. 70) and SB-List (13855 of FIG. 70), in that order, for any PCM-Transfer-Items (13816, 13826, 13836, 13846 and 13856 of FIG. 70 and 21600 of FIG. 83). If a PCM-Transfer-Item is found it is transmitted using the Prepaid-Contract-Instance.
(3) If no PCM-Transfer-Items (13816 of FIG. 70) are found in any of the DB-Partners (13200 of FIG. 67) in the Prepaid-Contract-Instances (14046 of FIG. 71 and 14500 of FIG. 73) in the AP-Schedule (14040 of FIG. 71), the Transmitter (13020 of FIG. 66) will move to the AS-Schedule (14050 of FIG. 71) and, working from Left to Right, will check the SR-List (13815 of FIG. 70), SP-List (13825 of FIG. 70) and SS-List (13835 of FIG. 70), in that order, for any PCM-Transfer-Items.
(4) If no PCM-Transfer-Items (13816 of FIG. 70) are found in any of the DB-Partners (14056 of FIG. 71) in the AS-Schedule Schedule (14050 of FIG. 71) then the Transmitter (13020 of FIG. 66) will move to the AI-Schedule (14060 of FIG. 71) and, working from Left to Right, will check the SR-List (13815 of FIG. 70), SP-List (13825 of FIG. 70), SS-List (13835 of FIG. 70) and SI-List (13845 of FIG. 70), in that order, for any PCM-Transfer-Items.
(5) If no PCM-Transfer-Items (13816 of FIG. 70) are found in the AI-Schedule (14060 of FIG. 71) then the Transmitter (13020 of FIG. 66) will search for any PCM-Transfer-Items in the SR-List (13815 of FIG. 70), SP-List (13825 of FIG. 70), SS-List (13835 of FIG. 70), SI-List (13845 of FIG. 70) and SB-List (13855 of FIG. 70), in that order, for each DB-Partner (12436a-12436n of FIG. 63) in the Node-Transfers-Field (12430 of FIG. 63) in each and every NI-Partner (7046a-7046n of FIG. 36 and 12400 of FIG. 63).

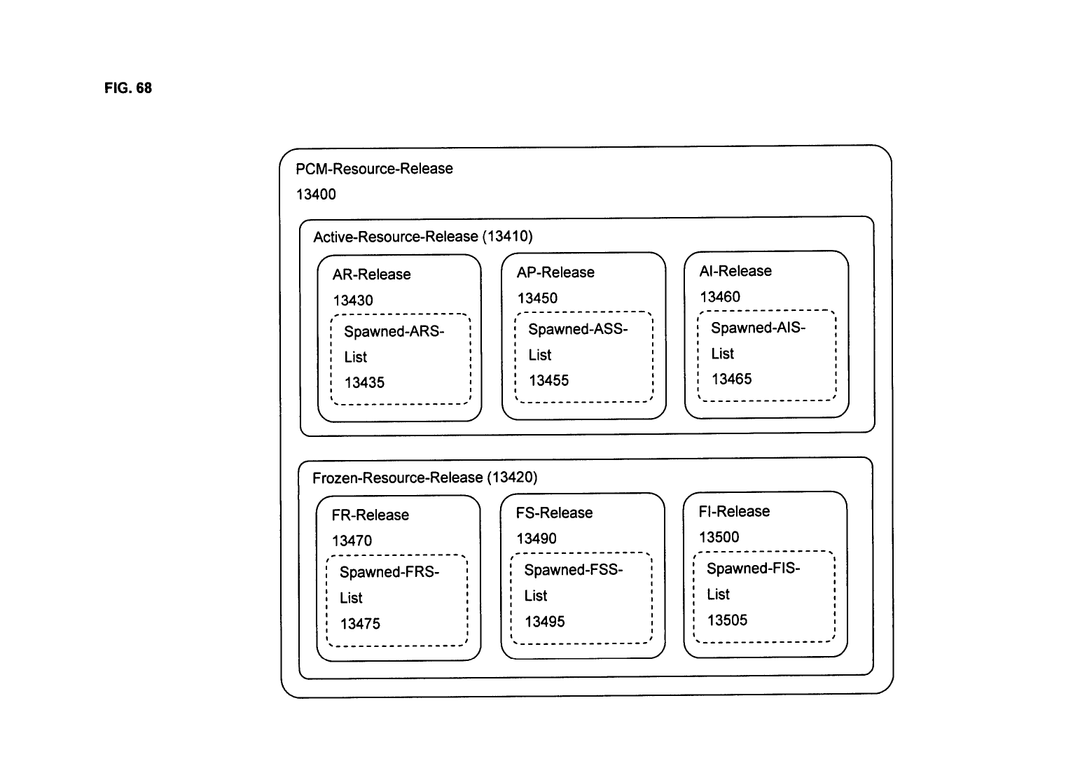

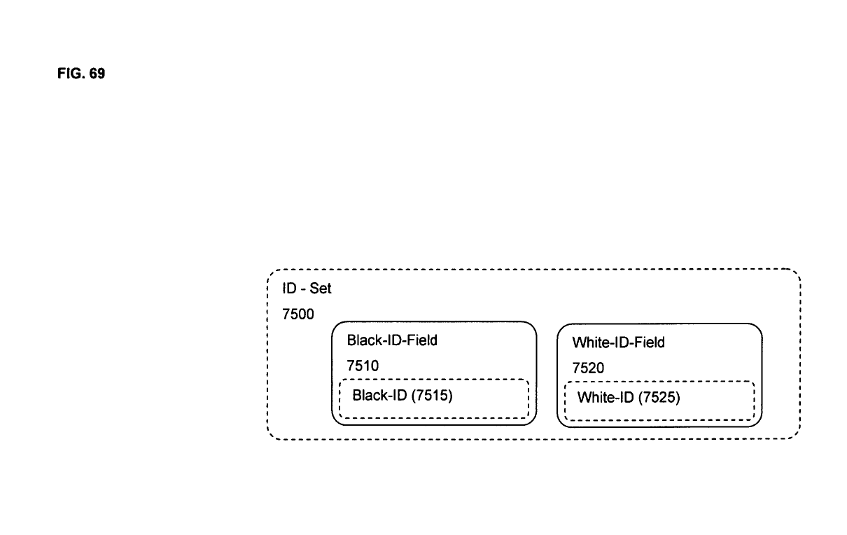

The actual transmission of the PCM-Transfer-Item (13816 of FIG. 70) via the PCM-Interface between Nodes (13090, 13110 and 13130 of FIG. 66) is implementation specific and is therefore beyond the scope of this patent. If at any time a Child with a Type of Type-False is inserted into either the Local-DB-Field (13310 of FIG. 67) or the Peer-DB-Field (13320 of FIG. 67) of the DB-Partner (13200 of FIG. 67), or the Physical-Connection-Field (12470 of FIG. 63) or the Logical-Connection-Field (12480 of FIG. 63) of the NI-Partner (12400 of FIG. 63), then all transmissions for the DB-Partner are frozen until all Fields hold a Child with its Type set to Type-True. This is accomplished by:
a. Removing the DB-Partner (13200 of FIG. 67 and 14036, 14056 and 14066 of FIG. 71) from any Active-Booking-Schedules (14010 of FIG. 71) using the spawned Cursor-Identifications in the Active-Resource-Release (13410 of FIG. 68), of the PCM-Resource-Release (13400 of FIG. 68).
b. Inserting the DB-Partner (13200 of FIG. 67 and 14076, 14096 and 14106 of FIG. 71) into the corresponding Frozen-Booking-Schedules (14020 of FIG. 71) using the KI-Insert-And-Spawn method.
c. The resulting spawned Cursor-Identification is then inserted into the corresponding Frozen-Resource-Release (13420 of FIG. 68) of the PCM-Resource-Release (13240 of FIG. 67 and 13400 of FIG. 68).
d. Searching through all Prepaid-Contract-Instances (12755a-12755n of FIG. 64 and 14500 of FIG. 73) of the DB-Partner (13200 of FIG. 67) and remove the Prepaid-Contract-Instance from the APS-List (14045 of FIG. 71) using the Spawned-APS-List (14575 of FIG. 73) held in the Active-Resource-Release-Field (14570 of FIG. 73).
e. Insert each Prepaid-Contract-Instance (12755a-12755n of FIG. 64 and 14500 of FIG. 73) into the FPS-List (14085 of FIG. 71) of the Frozen-Booking-Schedules (14020 of FIG. 71) using the KI-Insert-And-Spawn method.
f. Inserting the resulting Spawned-FPS-List (14585 of FIG. 73) into the Frozen-Resource-Release-Field (14580 of FIG. 73) of the Prepaid-Contract-Instance (14500 of FIG. 73).

When the DB-Partner (13200 of FIG. 67 and 14076, 14096 and 14106 of FIG. 71) is once more Unfrozen then the DB-Partner is removed from the Frozen-Booking-Schedules (14020 of FIG. 71) using the Frozen-Resource-Release (13420 of FIG. 68) and is once more inserted into the Active-Booking-Schedules (14010 of FIG. 71) using the spawned Cursor-Identifications found in the Active-Resource-Release (13410 of FIG. 68). All Prepaid-Contract-Instances (12755a-12755n of FIG. 64 and 14500 of FIG. 73) are also reinserted into the APS-List (14045 of FIG. 71) and deleted from the FPS-List (14085 of FIG. 71) using the Spawned-FPS-List (14585 of FIG. 73) of the Frozen-Resource-Release-Field (14580 of FIG. 73).

Scheduler

The Scheduler (13030 of FIG. 66) is a component of the Partner-Channel-Manager (13000, 13100, 13120 and 13140 of FIG. 66) that is responsible for the maintenance of Realtime-Contract-Instances (12645a-12645n and 12655a-12655n of FIG. 64 and 14400 of FIG. 73) and Prepaid-Contract-Instances (12745a-12745n and 12755a-12755n of FIG. 64 and 14500 of FIG. 73) in the Booking-Schedules (14000 of FIG. 71). Bookings for bandwidth are created for each individual DB-Partner (13200 of FIG. 67) through the Governance Layer (101b of FIG. 1 and 202b of FIG. 2a). This process is implementation specific and so cannot be defined through this patent but the result is a Prepaid-Contract-Instance or a Realtime-Contract-Instance being inserted into the correct place in Bandwidth-Bookings (13340 of FIG. 67 and 12600 of FIG. 64) of the DB-Partner. Each DB-Partner (13200 of FIG. 67) may have one or more bookings for bandwidth. Each Prepaid-Contract-Instance (14500 of FIG. 73) and Realtime-Contract-Instance (14400 of FIG. 73) contains a Start-Time (14445 and 14545 of FIG. 73) and a Duration (14455 and 14555 of FIG. 73) time. It is the responsibility of the Scheduler (13030 of FIG. 66) to cycle through the Bandwidth-Bookings (13340 of FIG. 67 and 12600 of FIG. 64), of each DB-Partner (12436a-12436n of FIG. 63 and 13200 of FIG. 67), of each NI-Partner (7046a-7046n of FIG. 36 and 12400 of FIG. 63), checking the Active-Realtime-Booking-List (12640 of FIG. 64), the Suspended-Realtime-Booking-List (12650 of FIG. 64), the Active-Prepaid-Booking-List (12740 of FIG. 64) and the Suspended-Prepaid-Booking-List (12750 of FIG. 64) looking for the following:
(1) While cycling through the Active-Realtime-Booking-List (12640 of FIG. 64) the Scheduler (13030 of FIG. 66) is checking for any Realtime-Contract-Instances (12645a-12645n of FIG. 64 and 14400 of FIG. 73) whose Duration (14455 of FIG. 73) time has expired. Realtime-Contract-Instances are inserted into the Active-Realtime-Booking-List in the order of their duration expiry time. The Scheduler stops cycling the lists once a valid booking is encountered. Any Realtime-Contract-Instances that have expired will be deleted from the Active-Realtime-Booking-List.
(2) While cycling through the Active-Prepaid-Booking-List (12740 of FIG. 64) the Scheduler (13030 of FIG. 66) is checking for any Prepaid-Contract-Instances (12745a-12745n of FIG. 64 and 14500 of FIG. 73) whose Duration (14555 of FIG. 73) time has expired. Prepaid-Contract-Instances are inserted into the Active-Prepaid-Booking-List in order of when their duration expiry time. The Scheduler stops cycling the lists once a valid booking is encountered. Any Prepaid-Contract-Instances that have expired will be deleted from the APS-List (14045 of FIG. 71) using the Spawned-APS-List (14575 of FIG. 73) before also being deleted from the Active-Prepaid-Booking-List.
(3) While cycling through the Suspended-Realtime-Booking-List (12650 of FIG. 64) the Scheduler (13030 of FIG. 66) is checking for any Realtime-Contract-Instances (12655a-12655n of FIG. 64 and 14400 of FIG. 73) whose Start-Time (14445 of FIG. 73) has been reached. These Realtime-Contract-Instances are then inserted into the correct position in the Active-Realtime-Booking-List (12640 of FIG. 64) depending on the duration (14455 of FIG. 73) time of the Realtime-Contract-Instance. These Realtime-Contract-Instances are then deleted from the Suspended-Realtime-Booking-List List (12650 of FIG. 64). Realtime-Contract-Instances are placed in the Suspended-Realtime-Booking-List in order of when the Start-Time is reached. The Scheduler stops cycling the lists once a valid booking is encountered.
(4) While cycling through the Suspended-Prepaid-Booking-List (12750 of FIG. 64) the Scheduler (13030 of FIG. 66) is checking for any Prepaid-Contract-Instances (12755a-12755n of FIG. 64 and 14500 of FIG. 73) whose Start-Time (14545 of FIG. 73) has been reached. These Prepaid-Contract-Instances are then inserted into the correct position in the Active-Prepaid-Booking-List (12740 of FIG. 64) depending on the Duration (14555 of FIG. 73) time of the Prepaid-Contract-Instance. These Prepaid-Contract-Instances are then deleted from the Suspended-Prepaid-Booking-List (12750 of FIG. 64). Prepaid-Contract-Instances are placed in the Suspended-Prepaid-Booking-List in order of when the Start-Time is reached. The Scheduler stops cycling the lists once a valid booking is encountered. Finally the Prepaid-Contract-Instance is inserted into the APS-List (14045 of FIG. 71) in the Rightmost position using the KI-Insert-And-Spawn (see Appendix G) method with the resulting Spawned-APS-List (14575 of FIG. 73) being inserted into the Active-Resource-Release-Field (14570 of FIG. 73) of the Prepaid-Contract-Instance. A single Prepaid-Contract-Instance may only be inserted onto the APS-List once.

A DB-Partner (14036 of FIG. 71 and 13200 of FIG. 67) is inserted onto the ARS-List (14035 of FIG. 71) of the Active-Booking-Schedules (14010 of FIG. 71) when a PCM-Transfer-Item (21600 of FIG. 83) is inserted onto the SR-List (13815 of FIG. 70) of the Send (13800 of FIG. 70) in Transfers (13260 of FIG. 67 and 13600 of FIG. 70), only if the DB-Partner has bookings for Realtime-Bandwidth. A DB-Partner is also inserted onto the ASS-List (14055 of FIG. 71) and AIS-List (14065 of FIG. 71) of the Active-Booking-Schedules (14010 of FIG. 71) when PCM-Transfer-Items are inserted onto either the SS-List (13835 of FIG. 70) or SI-List (13845 of FIG. 70) of the Send in Transfers. A DB-Partner is deleted from the ARS-List (14035 of FIG. 71), ASS-List (14055 of FIG. 71) or AIS-List (14065 of FIG. 71) of the Active-Booking-Schedules s (14010 of FIG. 71) when the corresponding SR-List (13815 of FIG. 70), SS-List (13835 of FIG. 70) or SI-List (13845 of FIG. 70) has been emptied.

Asynchronous-Duplicator

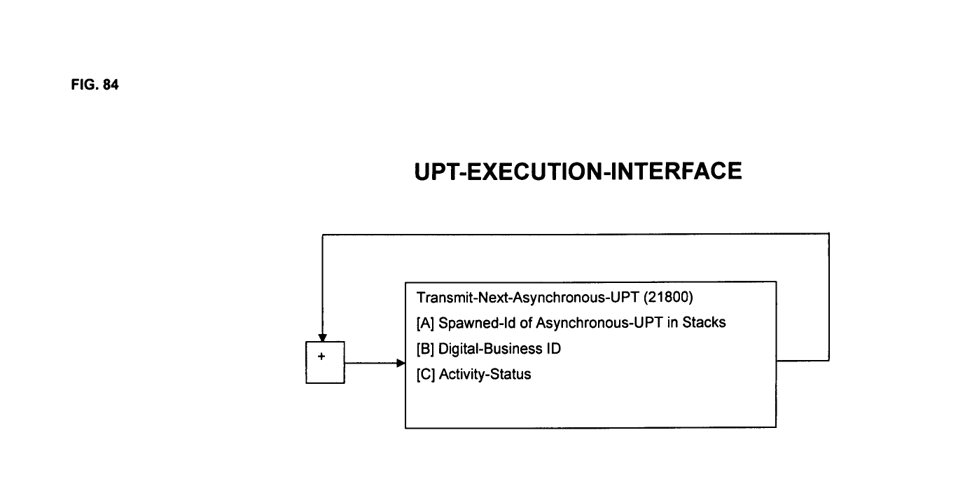

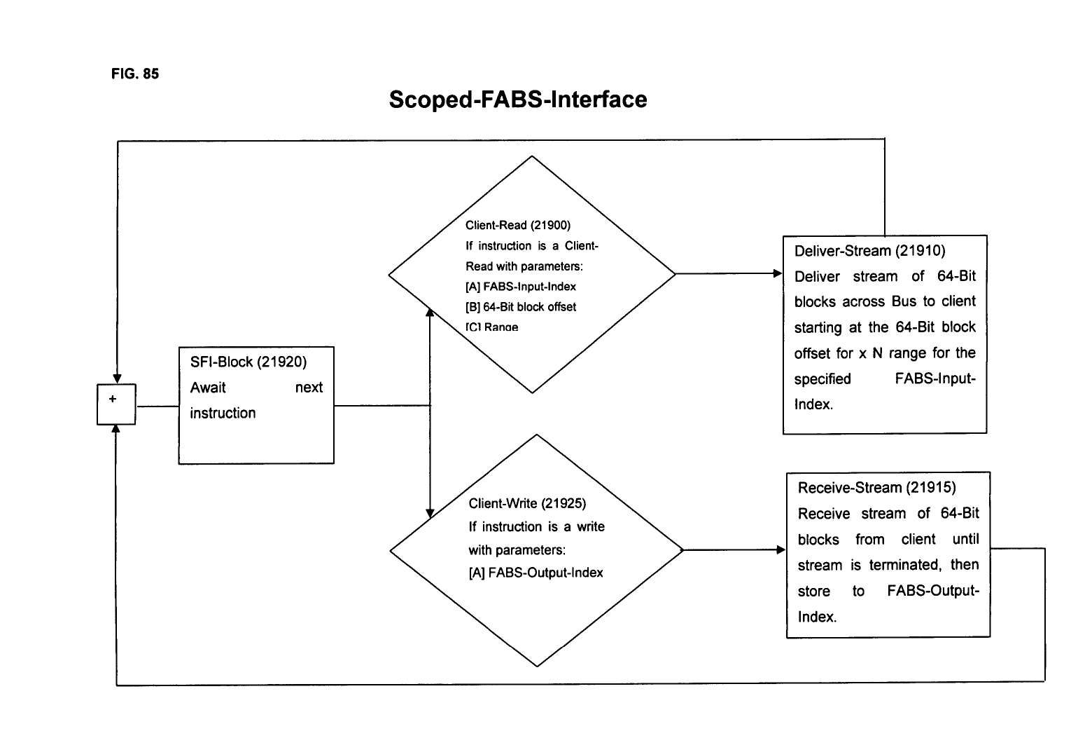

The Asynchronous-Duplicator (400 of FIG. 3 and 1660 of FIG. 9) is responsible for the duplication of a single Child by implementing the UPT-Execution-Interface (475 of FIG. 3, 6255 of FIG. 32 and FIG. 84) and uses the KI-Interface (see Appendix G) to perform the actual duplication. The Asynchronous-Duplicator interprets the UPT (see Appendix B) provided by the spawned stack reference listed as parameter [A] in the UPT-Execution-Interface (21800 of FIG. 84). This UPT may be of Type:
(a) Type-UPT-Recursive-Copy copies each Child including all their respective Children recursively so that the result represents a perfect copy (see UPT-Recursive-Copy of Appendix B).
(b) Type-UPT-Denatured-Recursive-Copy copies a set while denaturing it (see UPT-Denatured-Recursive-Copy of Appendix B).
(c) Type-UPT-Copy-All-Children only copies each Child and will not step into each of their Children, so represents only a partial or flat copy (see UPT-Copy-All-Children of Appendix B).
(d) Type-UPT-Entangled-Recursive-Copy copies a set while preserving its entangled properties (see UPT-Entangled-Recursive-Copy of Appendix B).
(e) Type-UPT-Entangled-Denatured-Recursive-Copy copies a set while both preserving its entangled properties and denaturing it (see UPT-Entangled-Denatured-Recursive-Copy of Appendix B).

The Asynchronous-Duplicator (400 of FIG. 3 and 1660 of FIG. 9) doesn't process the duplication instructions in the order that they arrive. Instead, it utilises a realtime schedule and prepaid schedule that can be implemented in many ways, providing that it is consistent with the Resource-Model of the invention. See UPT-Cycler (1470 of FIG. 8 and 1600 of FIG. 9) and Partner-Channel-Manager (13000 of FIG. 66) for exact examples for as to how the Resource-Model can be implemented.

This preserves consistent operation for all Digital-Businesses (8800 of FIG. 45) that may want to use the Asynchronous-Duplicator (400 of FIG. 3 and 1660 of FIG. 9). By enabling managed access to the Asynchronous-Duplicator by using the Resource-Model, it prevents a single Digital-Business from overloading the Asynchronous-Duplicator.

Once the duplication has been achieved, a Child with its Type set to Type-Unlock (see Appendix A) is inserted into the Neutral position of the Activity-Status-Field (9440 of FIG. 48) in order to release this Digital-Business (8800 of FIG. 45) and the UPT is removed from the stack.

The Asynchronous-Duplicator (400 of FIG. 3 and 1660 of FIG. 9) must retain state information for tracking which Children have already been duplicated, so as to prevent infinite recursive looping. Sufficient memory for this function should be allocated to handle most recursive structures. As memory begins to become loaded, the price for duplication should be increased proportionally, so as to discourage its use as per the Resource-Model. Alternatively, an additional field can be assigned to each set in the Kernel-Image (see Appendix G) to track the duplication status. The end result should be an identical structure, complete with Cursor-Identifications (5030 of FIG. 26, 6635 of FIG. 34 and 7620 of FIG. 39) in the same positions as the source.

Plugin-Manager

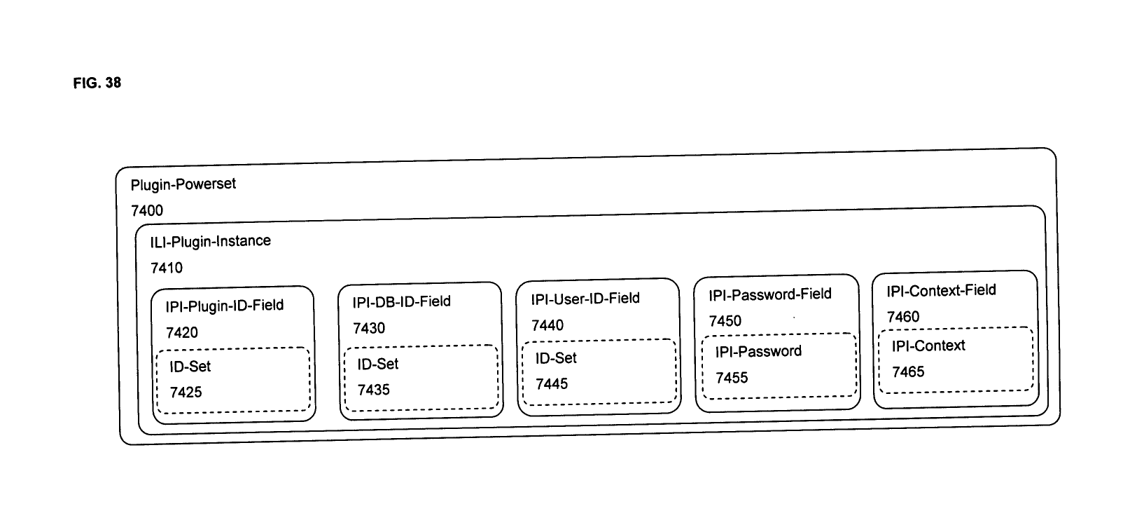

The Plugin-Manager (7600 of FIG. 39) allows for hardware components that are not trusted to interact with the III-Emulator while maintaining its integrity. This prevents the need for reviewing the security of the III-Emulator whenever a new Plugin architecture is installed. The Plugin (7665a, 7665b, 7665n of FIG. 39) is unable to access Cursor-Identification (6635 of FIG. 34 and 7620 of FIG. 39) handles directly like conventional Emulator-Components (FIG. 3-8). Instead, it utilises a relative indexing mechanism that maintains a separate list of Cursor-Identifications for every Child created by the Plugin. The KI-Index-Filter (7615a, 7615b, 7615n of FIG. 39) exposes a Pseudo-KI-Interface (7650 of FIG. 39) to the Plugins. The Pseudo-KI-Interface is identical to the KI-Interface (see Appendix G) except that:
(1) All indexes, Cursor-Identifications (6635 of FIG. 34 and 7620 of FIG. 39), Fast-ABS primitive handles and Slow-ABS primitive handles are translated into a relative addressing system to prevent Plugins (7665a, 7665b, 7665n of FIG. 39) from accessing handles outside of its scope.
(2) KI-Get-Governance-Layer (see Appendix G) is not supported.
(3) KI-Get-Parent-Identification (see Appendix G) is not supported.
(4) KI-Get-Powerset (see Appendix G) does not return the actual Powerset (6400 of FIG. 33) but the Plugin-Powerset (7400 of FIG. 38). The KI-Index-Filter (7615a, 7615b, 7615n of FIG. 39) operates by managing a mapping between the actual Cursor-Identifications (6635 of FIG. 34 and 7620 of FIG. 39) and the Filtered-Index (7630 of FIG. 39), which acts as the relative reference for the Pseudo-KI-Interface (7650 of FIG. 39). Each time the Pseudo-KI-Interface is used to retrieve a new reference, then a new entry is added to this mapping table. If a new Child is created it is simply assigned a new entry as well. At no point does the Pseudo-KI-Interface have a Cursor-Identification without a mapping.

Any Digital-Business (8800 of FIG. 45) can connect to any Plugin (7665a, 7665b, 7665n of FIG. 39) within the Plugin-Manager (7600 of FIG. 39) by utilising the Governance-Layer-Interface (9500a, 9500b of FIG. 48, 9700a, 9700b of FIG. 49 and 9815 of FIG. 50)—located in the Governance-Layer-Interface-Field (9810 of FIG. 50) and set up by the Governance Layer (101b of FIG. 1 and 202b of FIG. 2a). The Governance Layer itself may connect to any Plugin (7665a, 7665b, 7665n of FIG. 39) in the Plugin-Manager (7600 of FIG. 39) by utilising the ILI-Plugin (6850 of FIG. 35) of the Global-Static-Store (6440 of FIG. 33, 10025 of FIG. 51 and 6800 of FIG. 35). The Governance Layer creates a Plugin-Powerset (6858 of FIG. 35 and 7400 of FIG. 38) for the Plugin. This Child contains an ILI-Plugin-Instance (6859 of FIG. 35 and 7410 of FIG. 38). The Governance Layer then inserts the Plugin-Powerset into the ILI-Plugin. The Plugin-Manager has a Monitor installed on the ILI-Plugin to detect incoming Children. On receiving the Plugin-Powerset, the Plugin-Manager authorises the call with the appropriate Plugin. The Plugin is specified by the Whole of the Child of the IPI-Plugin-ID-Field (7420 of FIG. 38). The Whole of the Child for both the IPI-User-ID-Field (7440 of FIG. 38) and the IPI-Password-Field (7450 of FIG. 38) are used for authorisation if appropriate. The Whole of the IPI-User-ID-Field is used to identify the calling Digital-Business (8800 of FIG. 45). The actual mechanism that the Plugin-Manager (7600 of FIG. 39) uses to communicate this authorisation process to the Plugins (7665a, 7665b, 7665n of FIG. 39) is beyond the scope of this patent, as this is an implementation issue. If authorisation is successful, then the Plugin-Manager enables the KI-Index-Filter (7615a, 7615b, 7615n of FIG. 39) for the specified channel for that Plugin. If unsuccessful, then the Plugin-Manager inserts a Child of Type Type-Fail into the IPI-Context (7465 of FIG. 38) instead. The Child may contain any error information.

Monitors

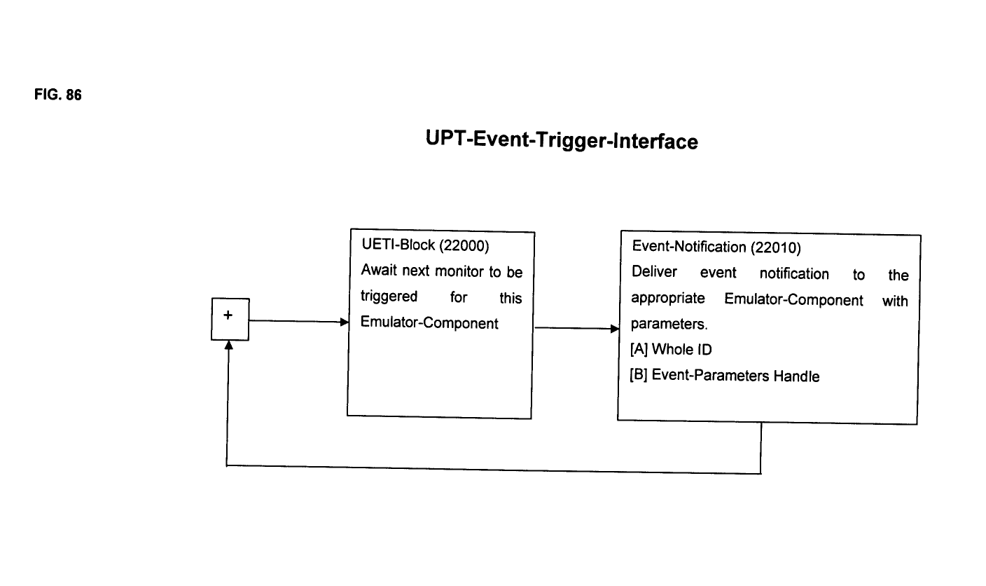

Monitors allow Emulator-Components or software executing as UPTs to receive events when characteristics of a set are modified during a KI-Interface method call or UPT that modifies a set structure. The invention utilises the Kernel-Image (see Appendix G) to create a UPT-Monitor-Generator (see Appendix B), which is placed on the stack. The UPT-Monitor-Generator processes a captured instant in time when the characteristic was changed and triggers off every appropriate event associated with that Monitor. The UPT-Monitor-Generator triggers the UPT-Cycler (470 of FIG. 3) to either:
1) Execute code in triggering the event for UPT software.
2) Transmit a signal via the Event-Triggered-Dataflow (see FIG. 8) by using the UPT-Event-Triggered-Interface (see FIG. 86) for Emulator-Components.
   Monitor Lifecycle

For a Monitor to be triggered, the following steps must occur:
1) Either a UPT software or an Emulator-Component requires a Monitor.
2) A Monitor (5200 of FIG. 27) is created.
3) The Monitor is attached to the Manabars-Set that is to be watched by using:
   i. UPT-Add-Monitor (see Appendix B) for UPT software.
   ii. KI-Add-Monitor (see Appendix G) for Emulator-Components.
4) The Monitor is triggered by the Kernel-Image (see Appendix G), which captures the state of the Manabars-Set at the point where the Monitor was generated and returns a UPT-Monitor generator, which is placed on the stack.
5) The UPT-Monitor-Generator is processed by the UPT-Cycler to trigger the event.
6) The Monitor may be removed by using:
   i. UPT-Remove-Monitor (see Appendix B) for UPT software.
   ii. KI-Remove-Monitor (see Appendix G) for Emulator-Components.
      Asynchronous-Virtual-Machine-Queuer

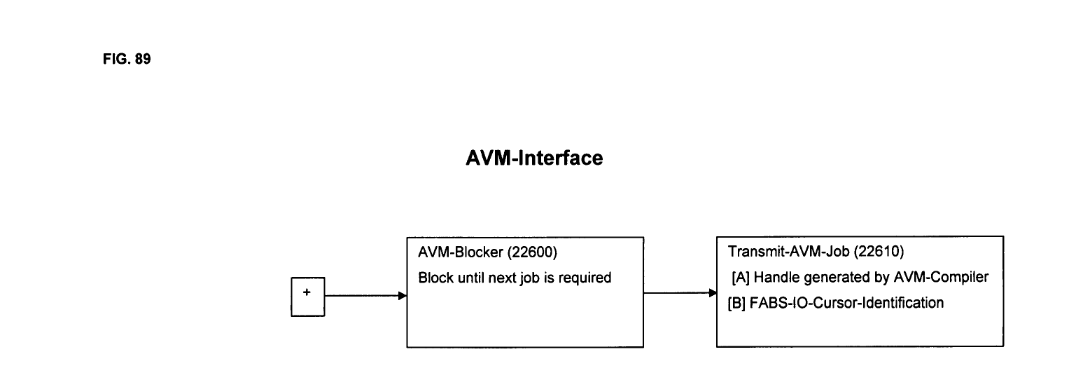

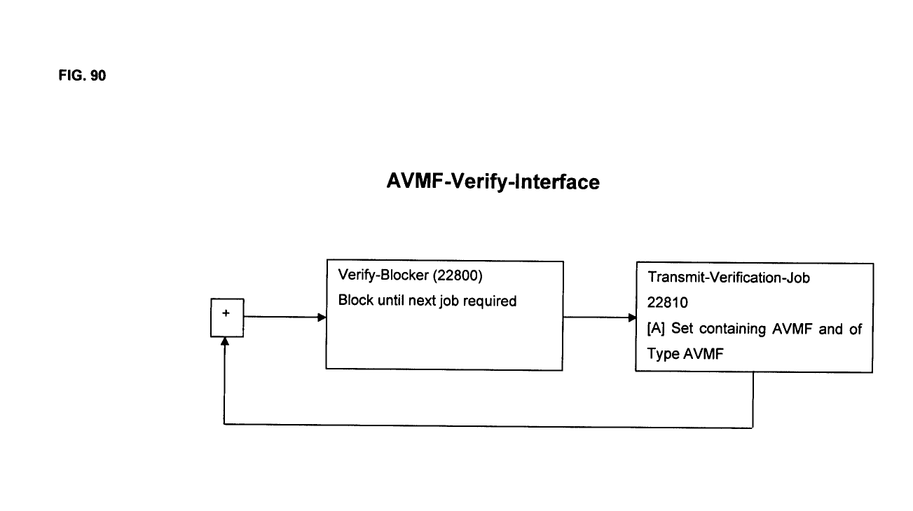

The Asynchronous-Virtual-Machine-Queuer (410 of FIG. 3) operates as a simple queue for executable jobs destined for the 3IP-AVM (17200 of FIG. 75) for the III-Emulator (551 of FIG. 3, 751 of FIG. 4, 951 of FIG. 5, 1151 of FIG. 6, 1351 of FIG. 7, 1551 of FIG. 8 and 17001 of FIG. 74). The only requirement is that the Partner-Channel-Manager (13000 of FIG. 66) must cross-compile AVMF into the correct format of the destination Partner Node (see Partner-Channel-Manager). The 3IP-AVM makes requests to the Asynchronous-Virtual-Machine-Queuer for new executable jobs via the AVM-Interface (see Appendix C and FIG. 89).

3IP-AVM

The 3IP-AVM (17200 of FIG. 75) provides mass computation for the III-Emulator (551 of FIG. 3, 751 of FIG. 4, 951 of FIG. 5, 1151 of FIG. 6, 1351 of FIG. 7, 1551 of FIG. 8 and 17001 of FIG. 74) by engaging numerous processors in the von Neumann-Processor-Farm (17205 of FIG. 75). To enable the greatest range of deployments, the full implementation of the 3IP-AVM (17200 of FIG. 75) is unspecified. By keeping part of the III-Emulator unspecified, it enables chip capability to be expanded without introducing incompatibilities. This enigma is possible because the III-Emulator provides a foundation architecture to enable cross-compilation via the Partner-Channel-Manager or PCM (13000 of FIG. 66) for new 3IP architectures. Preventing incompatibilities is essential in the deployment of a homogeneous grid platform with heterogeneous Node (200a-e of FIG. 2a and 380, 395 of FIG. 2d) architectures. The 3IP-AVM manages the loading of this Emulator-Component (FIGS. 3-8) by adhering to the Resource-Model and charging accordingly.

Methodology

It is the cross-compilation aspect of the 3IP (17000 of FIG. 74) that enables the super-conductive transcoding of Digital-Business (8800 of FIG. 45) across heterogeneous networks that makes a truly open grid possible. The computing model to enable cross-compilation is minimal and is orientated around the traditional von Neumann architecture primarily for reasons of efficiency, but also to leverage on the vast base of knowledge that has accumulated around this single mechanism.

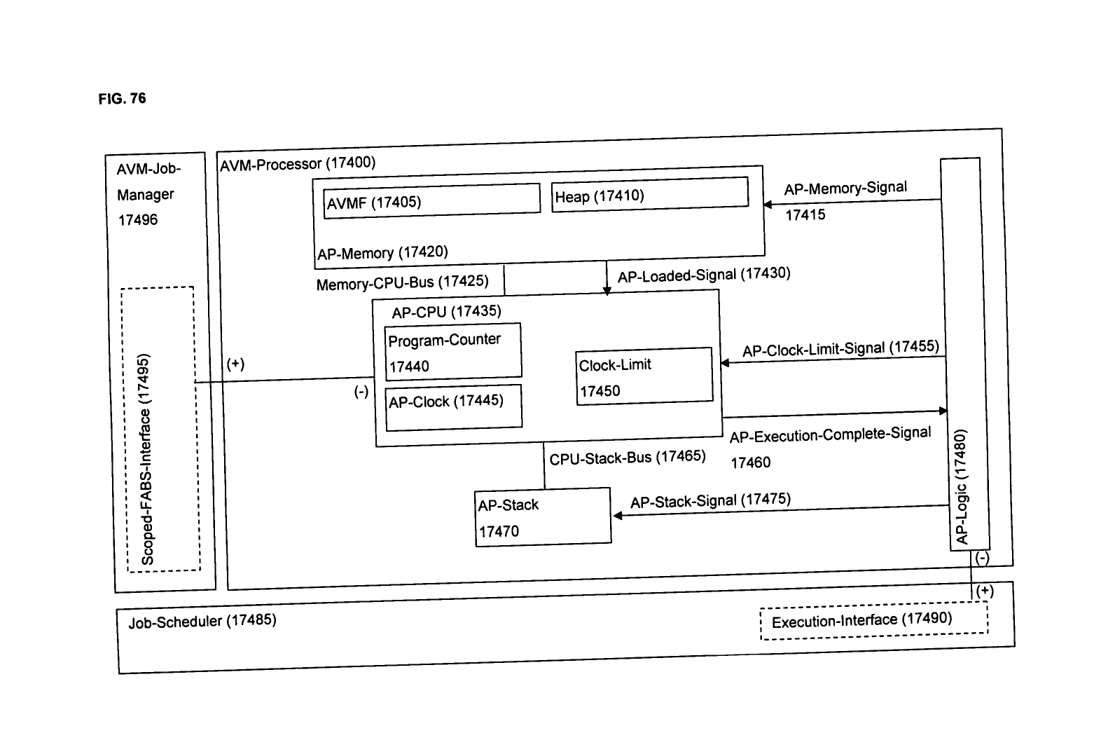

The 3IP-AVM (17200 of FIG. 75) as a component of the III-Emulator (551 of FIG. 3, 751 of FIG. 4, 951 of FIG. 5, 1151 of FIG. 6, 1351 of FIG. 7, 1551 of FIG. 8 and 17001 of FIG. 74) is actualised in hardware, so has both a logical and physical capability. The logical capability is expressed as the type of Asynchronous-Virtual-Machine-Format or AVMF (see Appendix E) managed by the 3IP and hence dictates the format required for executing code. The physical capability is the processing speed and size of memory components of the AVM-Processor (17210a, 17210b, 17210n of FIG. 75 and 17400 of FIG. 76) and the speed of the Scoped-FABS-Interface (17240 of FIG. 75 and 17495 of FIG. 76). It is the physical capability of the 3IP-AVM that is integrated into the Resource-Model (see mass computation of the Resource-Model).

3IP-AVM Architecture

The 3IP-AVM (17200 of FIG. 75) attempts to load each AVM-Processor (17210a, 17210b, 17210n of FIG. 75 and 17400 of FIG. 76) on start up. The Job-Scheduler (17275 of FIG. 75) loads each job via the AVM-Interface (17299 of FIG. 75). For each job the AVMF sequence is stored as a Fast-ABS primitive entry on the UPT-AVM (see Appendix B) in the Leftmost Child as the AVMF-Sequence (see UPT-AVM Parameter Name of Appendix B) and is loaded via the Scoped-FABS-Interface (17240 of FIG. 75 and 17495 of FIG. 76). The native executable code is loaded from the 3IP-AVMF-Verifier (17280 of FIG. 75) via the Verified-AVMF-Interface (17285 of FIG. 75) where it may have been compiled into a more efficient form. For example, in a Java implementation, the AVMF may be compiled directly into a Java Class file. If the code has not been verified correctly, then the job is ignored. Otherwise, each job is forwarded to an awaiting AVM-Processor (17210a, 17210b, 17210n of FIG. 75 and 17400 of FIG. 76) by using the Execution-Interface (17490 of FIG. 76). During execution the AVM-Processors read and write Fast-ABS primitive data to the FABS-Access-Manager (17230 of FIG. 75) by using the Scoped-FABS-Interface (17495 of FIG. 76) via a reference parameter set up by the Digital-Business (8800 of FIG. 45) software known as the FABS-Parameters (see UPT-AVM Parameter Name of Appendix B). Once the UPT-AVM (see Appendix B) has been processed, the 3IP-AVM unlocks the Digital-Business by inserting Child with its Type to Type-Unlock into the Activity-Status-Field (9440 of FIG. 48) of the Digital-Business.

Asynchronous-Virtual-Machine-Format

The Asynchronous-Virtual-Machine-Format (AVMF) is a framework provided by the III-Emulator (551 of FIG. 3, 751 of FIG. 4, 951 of FIG. 5, 1151 of FIG. 6, 1351 of FIG. 7, 1551 of FIG. 8 and 17001 of FIG. 74) that provides a foundation von Neumann architecture that can be extended with new instructions. Appendix E contains a list of mandatory instructions to be included in any 3IP so as to provide a basis to ensure cross-compiler success regardless of the 3IP architecture of the target Node (200a-e of FIG. 2a and 380, 395 of FIG. 2d). These base instructions can be used in clusters to emulate the behaviour of any new instruction that a Partner-Channel-Manager (13000 of FIG. 66) may need when generating the cross-compilation of an AVMF sequence that is attached to an UPT-AVM (see Appendix B).

The AVMF is constituted from a series of abstract virtual machine instructions. Each instruction performs an operation on either the AP-Stack (17470 of FIG. 76) or the Scoped-FABS-Interface (17240 of FIG. 75 and 17495 of FIG. 76) by utilising the AP-CPU (17435 of FIG. 76).

AVM-Processor

Collectively the AVM-Processor (see FIG. 75 and FIG. 76) performs the majority of measurable work within the invention. Each AVM-Processor (17210a, 17210b, 17210n of FIG. 75 and 17400 of FIG. 76) is an idealistic abstract processor, capable of being implemented efficiently on traditional chipset architectures during the III-Emulator (551 of FIG. 3, 751 of FIG. 4, 951 of FIG. 5, 1151 of FIG. 6, 1351 of FIG. 7, 1551 of FIG. 8 and 17001 of FIG. 74) simulation or harnessing a single CPU core.

The AVM-Processor (17210a, 17210b, 17210n of FIG. 75 and 17400 of FIG. 76) has 3 main components:

(A) The AP-Memory (17420 of FIG. 76).

(B) The AP-CPU (17435 of FIG. 76).

(C) The AP-Stack (17470 of FIG. 76).

AP-Memory

The AP-Memory (17420 of FIG. 76) is indexed in 64-Bit blocks and connects to the AP-CPU (17435 of FIG. 76) across a 64-Bit bus known as the Memory-CPU-Bus (17425 of FIG. 76). The AP-Stack (17470 of FIG. 76) operates across the CPU-Stack-Bus (17465 of FIG. 76) to deliver and store values as requested by the AP-CPU (17435 of FIG. 76. The AP-Memory (17420 of FIG. 76) has 2 sub-components:
(1) The AVMF-Memory (17420 of FIG. 76) contains the AVMF code to be executed for this UPT-AVM (see Appendix B) that originated at the UPT-Cycler (1470 of FIG. 8 and 1600 of FIG. 9) and was forwarded to the Asynchronous-Virtual-Machine.
(2) The Heap (17410 of FIG. 76) where there is no actual division in the 64-Bit memory array as these components are all indexed directly by the AP-CPU (17435 of FIG. 76) with an offset.
   AP-CPU

The AP-CPU (17435 of FIG. 76) contains a 64-Bit Program-Counter to indicate the next instruction for the AP-CPU (17435 of FIG. 76) to execute. The AP-CPU will only execute a fixed number of instructions that is stored in the Clock-Limit (17450 of FIG. 76), that is set by the Governance Layer (101b of FIG. 1 and 202b of FIG. 2a) and transmitted at the beginning of each execution as the AP-Clock-Limit-Signal (17455 of FIG. 76). The AP-CPU tracks the number of instructions executed since the start of the program in the AP-Clock (17445 of FIG. 76). The AP-CPU processes each instruction by moving information across either the CPU-Stack-Bus (17465 of FIG. 76), Memory-CPU-Bus (17425 of FIG. 76) or the Scoped-FABS-Interface (17495 of FIG. 76 and 17240 of FIG. 75). Execution ends when the AVMI-Exit (see Appendix E) instruction is encountered or the AP-Clock (17445 of FIG. 76) reaches the Clock-Limit (17450 of FIG. 76).

AP-Stack

The AP-Stack (17470 of FIG. 76) performs the role of registers in the von Neumann architecture, but it is more scalable and can have a varying number of elements on the AP-Stack (17470 of FIG. 76), up to a limit of Max-Stack-Size (7267 of FIG. 37).

Execution

Execution starts once the AP-Loaded-Signal (17430 of FIG. 76) and the AP-Clock-Limit-Signal (17455 of FIG. 76) have been received by the AP-CPU (17435 of FIG. 76). This is a result of the previous execution transmitting the AP-Execution-Complete-Signal (17460 of FIG. 76) that causes the AP-Logic (17480 of FIG. 76) to load the current job via the AP-Memory-Signal (17415 of FIG. 76), the AP-Clock-Limit-Signal (17455 of FIG. 76) and the AP-Stack-Signal (17475 of FIG. 76), which it transmits simultaneously.

Some implementations may be optimised in a variety of ways—for example: The Job-Scheduler (17275 of FIG. 75) may determine which AVM-Processor (17210a, 17210b, 17210n of FIG. 75 and 17400 of FIG. 76) will become available next by tracking the remainder of the Clock-Limit (17450 of FIG. 76). In this case, to load the AVMF into a standby cache on board the Job-Scheduler. Otherwise, in the standard implementation, the AP-Memory-Signal (17415 of FIG. 76) forwards the AVMF to be executed in the AP-Memory (17420 of FIG. 76). The AP-Memory responds by loading the AVMF into the memory starting at address 0000 and setting all remaining addresses to zero.

AVMF-Verify-Queuer

The AVMF-Verify-Queuer (490 of FIG. 3) operates as a queue for executable code waiting to be authorised for execution. Some implementations may assume all AVMF is valid and ignore this module and the associated 3IP-AVMF-Verifier (17280 of FIG. 75, 17025 of FIG. 76 and 23000 of FIG. 91) entirely by executing AVMF natively. A direct execution would simply exit if the AVM-Processor (17210a, 17210b, 17210n of FIG. 75 and 17400 of FIG. 76) crashed. However, it is included in the standard implementation because it may not be ideal to allow the AVM-Processor to crash. Furthermore, some III-Emulators (551 of FIG. 3, 751 of FIG. 4, 951 of FIG. 5, 1151 of FIG. 6, 1351 of FIG. 7, 1551 of FIG. 8 and 17001 of FIG. 74) may require a formal step to compile the AVMF into a more optimised format. All software utilising the UPT-AVM (see Appendix B) must formally call the UPT-AVMF-Verify (see Appendix B). Even on native implementations, failure to do this results in an ignored UPT-AVM so as to preserve a homogeneous behaviour.
3IP-AVMF-Verifier

The 3IP-AVMF-Verifier (17025 of FIG. 76, 23000 of FIG. 91 and 17280 of FIG. 75) ensures that the proposed AVMF is correctly formed to prevent the AVM-Processor (17210a, 17210b, 17210n of FIG. 75 and 17400 of FIG. 76) from crashing. At some point after verification has occurred the 3IP-AVM (see Appendix B) is likely to attempt to execute the AVMF sequence via the Verified-AVMF-Interface (23035 of FIG. 91 and 17285 of FIG. 75).

The 3IP-AVMF-Verifier uses the Verification-Job-Manager (23040 of FIG. 91) to co-ordinate the verification. It inserts the 64-Bit AVMF data sequence into the next available Verification-Processor (23200 of FIG. 92). The data sequence contains a series of Abstract-Virtual-Machine-Instructions or AVMI (see Appendix E) that are streamed from the Fast-ABS primitive—identified by the only parameter of the UPT-AVMF-Verify (see Appendix B) and was passed in from the AVMF-Verify-Interface (23050 of FIG. 91) to the 3IP-AVMF-Verifier (17025 of FIG. 74 and 23000 of FIG. 91).

After the verification and regardless of the outcome, the 3IP-AVMF-Verifier (17025 of FIG. 74 and 23000 of FIG. 91) deletes the UPT-AVMF-Verify (see Appendix B) from the stack and finally unlocks the Digital-Business (8800 of FIG. 45) by setting the Activity-Status-Field (9440 of FIG. 48) by inserting a Child of Type-Unlock into the Neutral position.

Verification-Processor

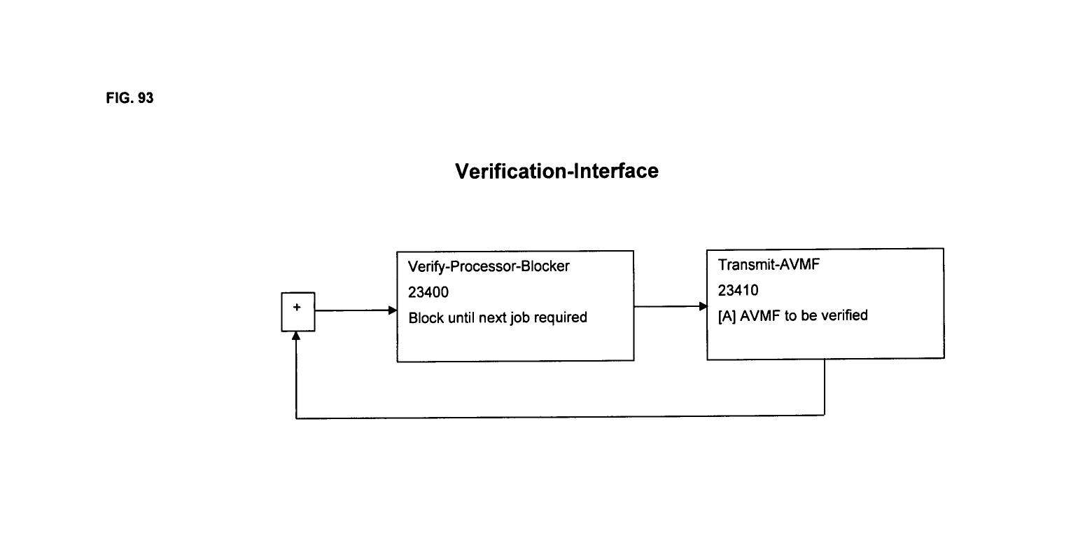

The Verification-Processor (23200 of FIG. 92) ensures that an AVMF execution sequence is correctly formed. The AVMF-Memory (23210 of FIG. 92) accepts the next queued verification job made available from the Verification-Job-Manager (23040 of FIG. 91) by using the Verification-Interface (23270 of FIG. 93). The AVMF-Memory (23210 of FIG. 92) contains:
1) The Proposed-AVMF (23215 of FIG. 92), which contains the executable sequence.
2) Boolean-Land-Array (23220 of FIG. 92) that indicates if at least one branching instruction is directed to this AVMI.
3) The Boolean-Jump-Array (23225 of FIG. 92) that indicates if this instruction branches to another AVMI.

The Verification-Processor (23200 of FIG. 92) performs the following steps upon receiving the AV-Engaged-Signal (23231 of FIG. 92) that is part of the Verification-Interface (23270 of FIG. 92):

Initialisation

1. Every Boolean in both the Boolean-Land-Array (23220 of FIG. 92) and the Boolean-Jump-Array (23225 of FIG. 92) is set to false. The Jump-Loader (23230 of FIG. 92) of the AVMF-Memory (23210 of FIG. 92) retrieves the Proposed-AVMF (23215 of FIG. 92) originally from the Fast-ABS primitive. Once the Boolean-Land-Array and the Boolean-Jump-Array have been cleared, the Jump-Loader configures the bits on the Boolean-Land-Array and the Boolean-Jump-Array to create an executable signature for the AVMF so that it can be evaluated in the next stage.

The Jump-Loader (23230 of FIG. 92) uses the following algorithm:
a. The Jump-Loader steps through each AVMI.
b. If the AVMI is a branching instruction, it marks the Boolean-Jump-Array (23225 of FIG. 92) at the same index as the AVMI in the AVMF sequence for that instruction as true, otherwise it remains false.
c. If the instruction was branching, the Jump-Loader locates all AVMI indexes (index for the Program-Counter of 17440 of FIG. 76) where the instruction could branch to and marks those indexes in the Boolean-Land-Array (23220 of FIG. 92) as true.

2. Once the AVMF-Memory (23210 of FIG. 92) is configured, it transmits the AVMF-Loaded-Signal (23245 of FIG. 92) to the Integrity-Checker (23250 of FIG. 92). In some implementations the AVMF-Loaded-Signal (23245 of FIG. 92) maybe transmitted prior to the actual completion of the loading in order to accelerate processing time. The Integrity-Checker sets the Stack-Count ( ) to zero and clears the Simulated-Stack (23260 of FIG. 92) and then begins confirming that the proposed AVMF sequence is legitimate by transferring the AVMF across the AVMF-Bus (23240 of FIG. 92).

Integrity Verification

Every AVMI is transferred across the AVMF-Bus (23240 of FIG. 92), starting at the first index and ending at the last. Each time an instruction modifies the stack, the changes are reflected in the Simulated-Stack (23260 of FIG. 92) and the Stack-Count (23255 of FIG. 92). For each AVMI transferred, 2 associated bits are also transferred that indicates:
(1) A bit from the Boolean-Land-Array (23220 of FIG. 92) indicates if a branching instruction points to the AVMI.
(2) A bit from the Boolean-Jump-Array (23225 of FIG. 92) indicates if the execution flow branches to another AVMI.

As each AVMI is received, a number of tests are conducted in parallel.

Type-Error Checking

There are 4 Stack-Types for data in the Asynchronous-Virtual-Machine:

(1) A Whole that is a 64-Bit signed whole number.

(2) A Float that is a 64-Bit signed floating-point number.

(3) An array of Float.

(4) An array of Whole.

It is critical that the instructions operate with AP-Stack (17470 of FIG. 76) items of the correct stack type. For example, AVMI-W-Add (see Appendix E) takes Wholes from the AP-Stack and replaces them with their addition, which is also a Whole. Since the native representation of the Whole and Float are implementation specific, it is meaningless to allow them to interchange freely. To achieve a conversion between two types such as from a Float to a Whole, a cast can be performed with the AVMI-F-to-W instruction, or a Whole to a Float with the AVMI-W-to-F instruction.

The process of type error checking involves simulating a run-time AP-Stack (17470 of FIG. 76) in the Simulated-Stack (23260 of FIG. 92) during the processing of each AVMI sequence. Instead of an actual value, the simulated stack holds only the stack type information. Each time an instruction is processed, the Verification-Processor (23200 of FIG. 92) compares the type data on the Simulated-Stack (23260 of FIG. 92) to ensure that it matches the required AVMI types. In this way, the simulation can preemptively match the next instruction with the correct type on the AP-Stack (17470 of FIG. 76), prior to the actual execution (see Stack Type Behaviour of Appendix E).

Stack Overflow and Underflow Checking

Stack overflow and underflow errors are checked to ensure that regardless of the conditional logic, the AP-Stack (17470 of FIG. 76) will not continue to grow unchecked or reach a point where there are insufficient 64-bit stack blocks left to process an AVMI. Each time an AVMI is processed, the Stack-Count is adjusted to reflect the alteration to the stack (see Stack-Change of Appendix E). Checking occurs by ensuring that the Stack-Count (23255 of FIG. 92) always synchronises at zero whenever a Boolean-Jump-Array (23225 of FIG. 92) or Boolean-Land-Array (23220 of FIG. 92) bit is True.

Branch Code Checking

Branch code checking occurs as each AVMI is processed to ensure that a branching statement moves the Program-Counter (17440 of FIG. 76) to a valid AVMI. This check is performed by simply ensuring that the AVMI points to a legitimate instruction whenever the Boolean-Land-Array (23220 of FIG. 92) bit is True. Some implementations may combine this check with Type-Checking, which also manages branching.

Job Unloading

Once this checking process is complete, the Integrity-Checker (23250 of FIG. 92) transmits the Compiler-Status (23235 of FIG. 92) to the AVMF-Memory (23210 of FIG. 92) that is forwarded to the 3IP-AVMF-Verifier (23000 of FIG. 91) via the Verification-Interface (23270 of FIG. 92) that can be:
(A) Successful.
(B) Compilation failed at a particular instruction.
(C) The Stack failed at a particular instruction.
(D) The UPT-AVM (see Appendix B) exceeds the maximum number of AVMIs allowed.

If the Compiler-Status (23235 of FIG. 92) is (A) successful, then the Proposed-AVMF (23215 of FIG. 92) is formally sanctioned to the Authentication-Database (23030 of FIG. 91) via the 3IP-AVMF-Verifier (23000 of FIG. 91).

Governance Layer

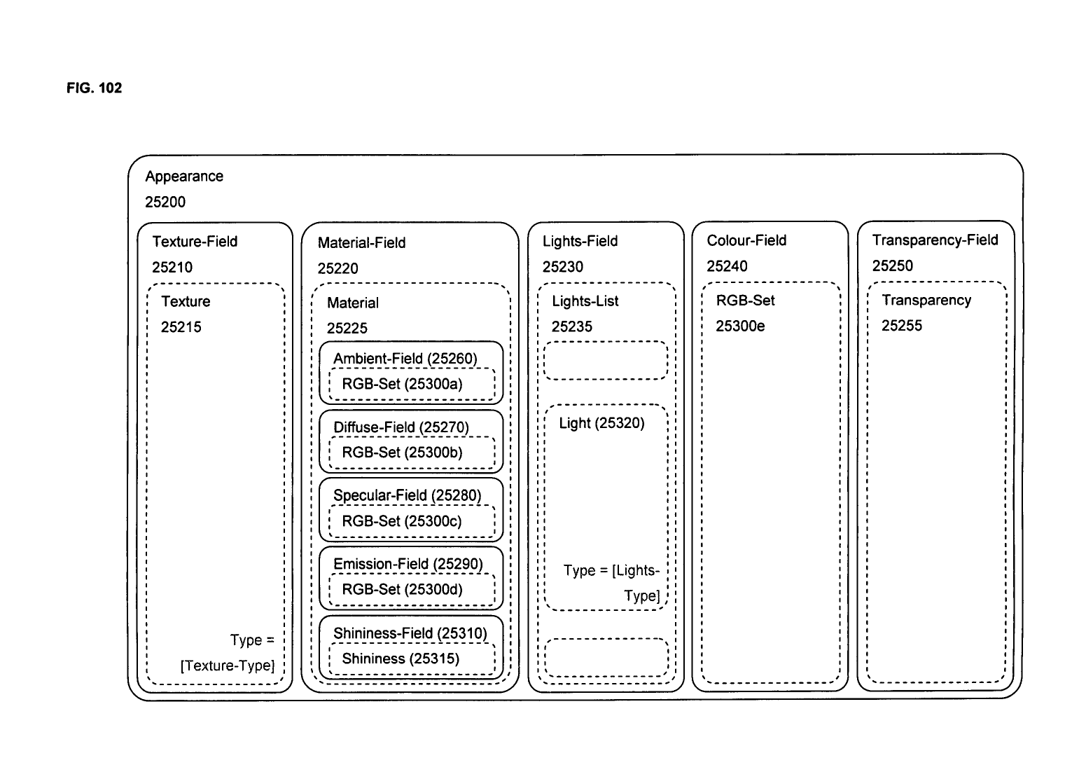

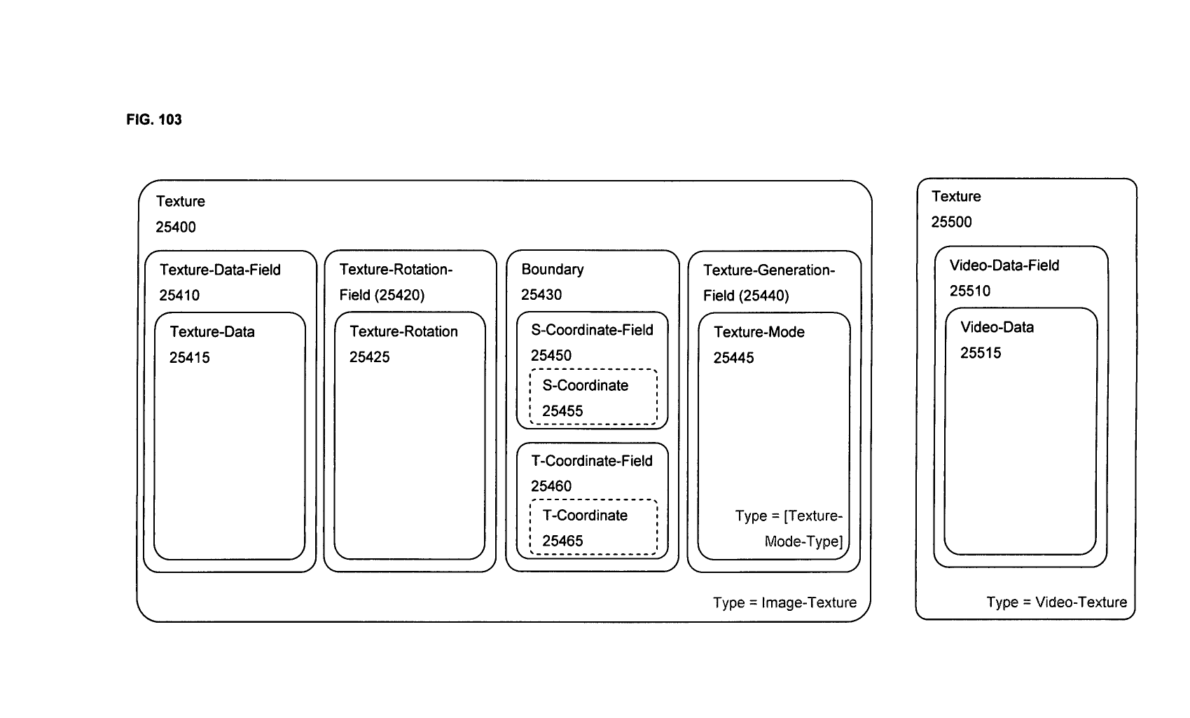

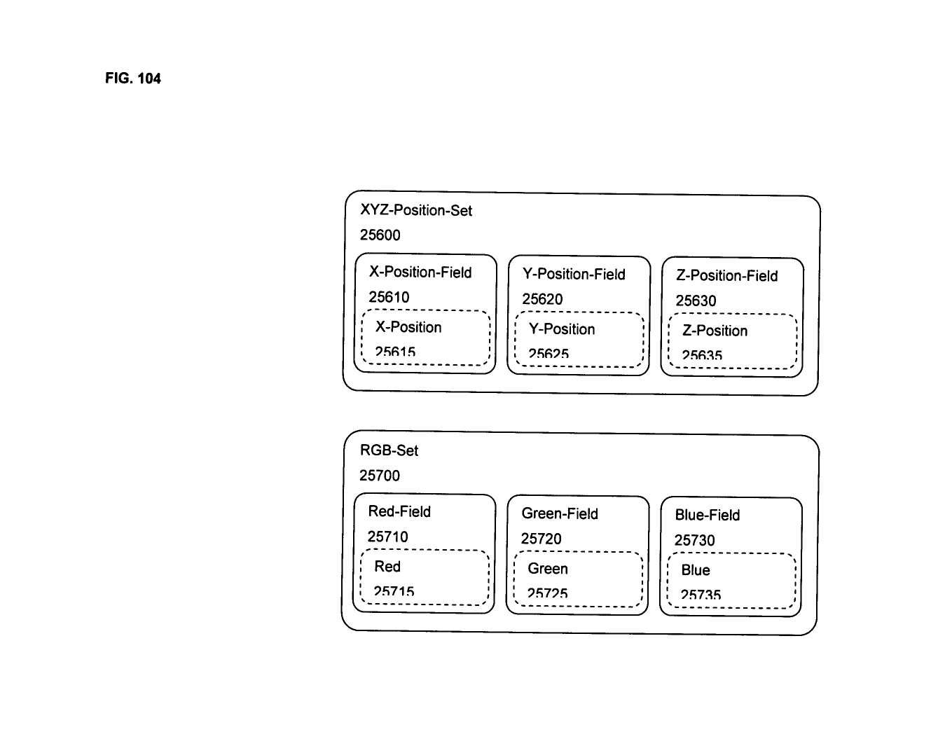

The Governance Layer (101b of FIG. 1 and 102b of FIG. 2) is the adjacent layer to the invention. The invention occupies the Interoperability Layer (101a of FIG. 1 and 102a of FIG. 2) and functionally provides the infrastructure for the Digital-Businesses (8800 of FIG. 45) that are found in the Information Layer (101c of FIG. 1 and 102c of FIG. 2). Therefore, the function of Governance Layer is beyond the scope of the III-Emulator (551 of FIG. 3, 751 of FIG. 4, 951 of FIG. 5, 1151 of FIG. 6, 1351 of FIG. 7, 1551 of FIG. 8 and 17001 of FIG. 74). However, the communication between the invention and the Governance Layer is defined.

Powerset-Binding

To maximise the security of the invention, the Governance-Layer (6475 of FIG. 33) should be located as the Powerset's (6400 of FIG. 33) only Child so that the Governance-Layer is bound to the Powerset and hence occupies the highest level of scope. This prevents the possibility of any unpredictable process that may be loaded within this scope, which would otherwise enable this process to access the Governance-Layer and its associated Digital-Businesses (8800 of FIG. 45).

Access to Computation

The III-Emulator (551 of FIG. 3, 751 of FIG. 4, 951 of FIG. 5, 1151 of FIG. 6, 1351 of FIG. 7, 1551 of FIG. 8 and 17001 of FIG. 74) enables computational completeness virtually in the Kernel-Image (see Appendix G) in a context where the other Emulator-Components (FIGS. 3-8) are real. The Governance Layer (101b of FIG. 1, 202b of FIG. 2a) is virtual software operating within this framework in an identical manner as any Digital-Business (8800 of FIG. 45) does in the Information Layer (101c of FIG. 1 and 202c of FIG. 2a). For the Governance Layer to attain access to computation, it is required to represent its various functions as pseudo Digital-Businesses, so that the invention may operate on it. The Governance Layer resides in the GE-Instance (9435 of FIG. 48, 9630 of FIG. 49 and 10000a, 10000b of FIG. 51) for each Digital-Business. It is most probable that the Governance Layer will operate in a distributed fashion across multiple Nodes (200a-200e of FIG. 2a and 380, 395 of FIG. 2d) on a peer-to-peer network to enable an homogeneous Operating System capable of enabling global compliance of trade and communication.

Accountability of Governance Layer Services

The Governance Layer (101b of FIG. 1, 202b of FIG. 2a) is expected to ensure that the DTE-Instance (6476 of FIG. 33, 9425 of FIG. 48, 9620 of FIG. 49 and 9800a, 9800b of FIG. 50) and the GE-Instance (9435 of FIG. 48, 9630 of FIG. 49, 10000a, 10000b of FIG. 51) share an identical Manabars-Set (see Appendix G) to enable communication between the Governance Layer and the Information Layer (101c of FIG. 1, 202c of FIG. 2a) for each Digital-Business. This shared set is inserted into the Governance-Layer-Interface-Field (9810 of FIG. 50) by software executing in the GE-Instance. The Reference-Membrane (outside the scope of this patent) as invented by Dr Fielden is a mechanism to enable secure communication across this shared level of scope and prevents its exploitation by malicious software running in the DTE-Instance.

Where in the foregoing description reference has been made to specific components or integers of the invention having known equivalents, then such equivalents are incorporated herein as if individually set forth. The invention is not limited to the specific embodiments disclosed herein and it is to be understood that many modifications or improvements may be made without departing from the scope of the invention.

APPENDIX A
EMULATOR SPECIFIC TYPES
The following is a list of Types that are used by the III-Emulator,
however, the actual ID and names are irrelevant and can be
substituted with any arbitrary equivalent.

| | UPT |
|---|---|
| 001 | Type-UPT-Comparison |
| 002 | Type-UPT-Or |
| 003 | Type-UPT-Xor |
| 004 | Type-UPT-And |
| 005 | Type-UPT-Not |
| 006 | Type-UPT-Reference-Comparison |
| 007 | Type-UPT-Assignment |
| 008 | Type-UPT-Delete-All-Children |
| 009 | Type-UPT-Recursive-Delete |
| 010 | Type-UPT-Delete-Child |
| 011 | Type-UPT-Copy-Child |
| 012 | Type-UPT-Copy-All-Children |
| 013 | Type-UPT-Recursive-Copy |
| 014 | Type-UPT-Get-Boundary-Cursor-Identification |
| 015 | Type-UPT-Get-Child |
| 016 | Type-UPT-Get-Index |
| 017 | Type-UPT-Get-Number-Children |
| 018 | Type-UPT-Get-Number-Cursors |
| 019 | Type-UPT-Get-Number-Shared-Cursor-Identifications |
| 020 | Type-UPT-Insert-Child |
| 021 | Type-UPT-New-Child |
| 022 | Type-UPT-Shift-Cursor |
| 023 | Type-UPT-Shift-Cursor-To-Boundary |
| 024 | Type-UPT-Spawn-Cursor-Identification |
| 025 | Type-UPT-Sequence |
| 026 | Type-UPT-Entangled |
| 027 | Type-UPT-If |
| 028 | Type-UPT-Evaluate |
| 029 | Type-UPT-Start |
| 030 | Type-UPT-Stop |
| 031 | Type-UPT-Unentangled |
| 032 | Type-UPT-Insert-And-Spawn |
| 033 | Type-UPT-AVM |
| 034 | Type-UPT-AVMF-Verify |
| 035 | Type-UPT-Entangled-Recursive-Copy |
| 036 | Type-UPT-ABS-Bus |
| 037 | Type-UPT-Create-ABS |
| 041 | Type-UPT-Denatured-Recursive-Copy |
| 042 | Type-UPT-Monitor-Generator |
| 043 | Type-UPT-Entangled-Denatured-Recursive-Copy |
| 044 | Type-UPT-This-Stack |
| 045 | Type-UPT-Add-Monitor |
| 046 | Type-UPT-Remove-Monitor |
| 047 | Type-UPT-This-Thread |
| 048 | Type-UPT-Get-DTE-Instance |
| 049 | Type-UPT-Map |
| 050 | Type-UPT-Unmap |
| 051 | Type-UPT-Get-Whole-Hashkey |
| 052 | Type-UPT-Get-Float-Hashkey |
| 053 | Type-UPT-Get-Fast-ABS-Hashkey |
| 054 | Type-UPT-Get-Slow-ABS-Hashkey |
| 055 | Type-UPT-Monitor-Sequence |
| 056 | Type-UPT-Get-Event-Parameters |
| 061 | Type-UPT-Create-Manabars-Set |
| 063 | Type-UPT-Super-Sequence |
| | Child-Identification-Monitors |
| 101 | Type-CHI-Monitor-Child-Delete |
| 102 | Type-CHI-Monitor-Child-Terminate-Right |
| 103 | Type-CHI-Monitor-Child-Terminate-Left |
| 104 | Type-CHI-Monitor-Child-Links-Right |
| 105 | Type-CHI-Monitor-Child-Links-Left |
| 106 | Type-CHI-Monitor-Child-Inserts-Left |
| 107 | Type-CHI-Monitor-Child-Inserts-Right |
| 108 | Type-CHI-Monitor-Child-Deletes-Left |
| 109 | Type-CHI-Monitor-Child-Deletes-Right |
| 110 | Type-CHI-Monitor-Cursor-Identification-Shifted-Onto-Child |
| 111 | Type-CHI-Monitor-Cursor-Identification-Shifted-Off-Child |
| 112 | Type-CHI-Monitor-No-Cursor-Identification |
| 113 | Type-CHI-Monitor-Number-Sharing-Cursor-Identifications- |
| | Queried |
| | Parent-Identification-Monitors |
| 131 | Type-PI-Monitor-Cursor-Identification-Inserted-Into-Parent |
| 132 | Type-PI-Monitor-No-Child |
| 133 | Type-PI-Monitor-Has-Child |
| 134 | Type-PI-Monitor-Inserts-Child |
| 135 | Type-PI-Monitor-Deletes-Child |
| 136 | Type-PI-Monitor-Bad-Index |
| 137 | Type-PI-Monitor-Good-Index |
| 138 | Type-PI-Monitor-Cursor-Leftmost |
| 139 | Type-PI-Monitor-Cursor-Rightmost |
| 140 | Type-PI-Monitor-Child-Leftmost |
| 141 | Type-PI-Monitor-Child-Rightmost |
| 143 | Type-PI-Monitor-Number-Children-Queried |
| 144 | Type-PI-Monitor-Number-of-Cursors-Queried |
| 146 | Type-PI-Monitor-Type-Changed |
| 147 | Type-PI-Monitor-Float-Changed |
| 148 | Type-PI-Monitor-Whole-Changed |
| 149 | Type-PI-Monitor-Fast-ABS-Changed |
| 150 | Type-PI-Monitor-Slow-ABS-Changed |
| | Cursor-Identification-Monitors |
| 163 | Type-CUI-Monitor-Cursor-At-Boundary |
| 164 | Type-CUI-Monitor-Cursor-At-Leftmost |
| 165 | Type-CUI-Monitor-Cursor-At-Rightmost |
| 169 | Type-CUI-Monitor-Cursor-Retrieved |
| 170 | Type-CUI-Monitor-Index-Queried |
| | Symbols |
| −6 | Type-No-Type |
| 201 | Type-True |
| 202 | Type-False |
| 203 | Type-Left |
| 204 | Type-Right |
| 205 | Type-Neutral |
| 206 | Type-Lock |
| 207 | Type-Unlock |
| 208 | Type-Emulator-Component |
| 209 | Type-Blank-PSI |
| 210 | Type-Error |
| 212 | Type-Monitor |
| 213 | Type-Child |
| 214 | Type-Field |
| | Operators |
| 301 | Type-Addition |
| 302 | Type-Subtraction |
| 303 | Type-Multiplication |
| 304 | Type-Division |
| 305 | Type-Greater-Than |
| 306 | Type-Greater-Than-Or-Equal-To |
| 307 | Type-Less-Than |
| 308 | Type-Less-Than-Or-Equal-To |
| 309 | Type-Equals |
| 310 | Type-Fixed-Operation |
| 311 | Type-Dynamic-Operation |
| 312 | Type-Remainder |
| | Content |
| 401 | Type-Whole |
| 402 | Type-Float |
| 403 | Type-Array-Of-Whole |
| 404 | Type-Array-Of-Float |
| 405 | Type-Fast-ABS |
| 406 | Type-Slow-ABS |
| 407 | Type-Type |
| | Object Orientation |
| 058 | Type-UPT-Method-Call-Item |
| 059 | Type-UPT-Method |
| 060 | Type-UPT-This-Object |
| 062 | Type-UPT-Locate-Variable |
| 501 | Type-Inputs-Field |
| 502 | Type-Locals-Field |
| 503 | Type-Outputs-Field |
| 504 | Type-Global-Field |
| 505 | Type-Static-Field |
| 510 | Type-UME-Unengaged |
| 511 | Type-UME-Standby |
| 512 | Type-UME-Engaged |
| 513 | Type-UME-Engaging |

TYPES FOR PARTNER-CHANNEL-MANAGER

| | |
|---|---|
| | Monitor-Trigger-Types |
| 3000 | PCM-Connection-Request |
| 3001 | PCM-Connection-Confirmation |
| 3020 | PCM-Connection-Request-Image |
| 3021 | PCM-Connection-Request-Object-Orientation |

TYPES FOR HUMAN-COMMUNICATION-MANAGER

| | |
|---|---|
| | Sensory-Perception-Type |
| 40001 | Type-Vocal-Perception |
| 40002 | Type-Move-Perception |
| 40003 | Type-Point-Perception |
| 40004 | Type-Action-Perception |
| 40005 | Type-Anger-Perception |
| 40006 | Type-Focus-Perception |
| | Sensory-Experience-Type |
| 40100 | Type-Visual-Experience |
| 40101 | Type-Sound-Experience |
| 40102 | Type-Smell-Experience |
| | Primitive-Type |
| 40200 | Type-Primitive-Strip |
| 40201 | Type-Primitive-Fan |
| 40202 | Type-Primitive-Hexatone |
| 40203 | Type-Primitive-Polygon |
| 40204 | Type-Primitive-Lathe |
| | Texture-Type |
| 40301 | Type-Image-Texture |
| 40302 | Type-Video-Texture |
| | Texture-Mode-Type |
| 40400 | Type-Object-Texture-Mode |
| 40410 | Type-Eye-Texture-Mode |
| 40420 | Type-Sphere-Texture-Mode |
| 40430 | Type-Normal-Texture-Mode |
| 40440 | Type-Reflection-Texture-Mode |
| | Lights-Type |
| 40500 | Type-Ambient-Light |
| 40510 | Type-Point-Light |
| 40520 | Type-Spot-Light |
| 40530 | Type-Directional-Light |

APPENDIX B
UNIVERSAL PROCESS TYPES
UPT-ABS-Bus

| | |
|---|---|
| Type | 036 |
| Description | The UPT-ABS-Bus is a UPT that transfers Slow-ABS to Fast-ABS and visa-versa, utilising the Emulator-component known as the |
| | ABS-Bus. The Asynchronous-Bit-Sequences (ABS) are 64-bit blocks of data that can be used by other Emulator-Components. |
| | There are 2 types of Asynchronous-Bit-Sequences: |
| | (1) Fast-ABS which is transient and erased on shutdown. |
| | (2) Slow-ABS which is permanently stored until deleted by the garbage collector removes it when it is no longer attached to a |
| | Manabars-Set. |
| Behaviour | If the Type of the Destination-Orientation-Field Value is Type-Fast-ABS then this UPT will assign the Slow-ABS of the Source-Field |
| | Value to the Fast-ABS for each Child in the Destination-Field Value, so a single source can alter any number of Children in the |
| | destination. Otherwise, if the Type is Type-Slow-ABS, then the UPT will assign the Fast-ABS of the Source-Field Value to the Slow-ABS |
| | for each Child in the Destination-Field Value. |

| Child Location | Parameter Name | Description |
|---|---|---|
| 1 | Source-Field | The Value contains Slow-ABS or Fast-ABS primative that is to be transferred. |
| 2 | Destination-Field | The Value contains a list of Children that will have their Slow-ABS or Fast-ABS primitives replaced |
| | | with that on the Source-Field Value. |
| 3 | Destination-Orientation-Field | The Value determines the if the transfer is from Slow-ABS to Fast-ABS or from Fast-ABS to |
| | | Slow-ABS. |

UPT-Add-Monitor

| | |
|---|---|
| Type | 045 |
| Description | The UPT-Add-Monitor engages the KI-Add-Monitor KI-Interface method. |
| Behaviour | This UPT sends the Target-Monitor-Field Value and the Monitor-Field Value through to the KI-Add-Monitor (see Appendix G) as the |
| | 1^{st} and 2^{nd} method call parameters respectively. The KI-Add-Monitor will return a key that is used to locate the Monitor (5200 of FIG. 27) |
| | inside a Monitor-Event (see Appendix G). This key is a Cursor-Identification that is a spawn of the Monitor-Event with the |
| | spawned Cursor pointing to the Monitor and is inserted into the Neutral position as the Key-Field Value. |

| Child Location | Parameter Name | Description |
|---|---|---|
| 1 | Target-Monitor-Field | Contains the Cursor-Identification that identifies the Cursor, Parent or Child to be monitored. |
| 2 | Monitor-Field | Contains the Cursor-Identification of a Monitor. |
| 3 | Key-Field | Contains the key that locates the Monitor. |

UPT-And

| | |
|---|---|
| Type | 004 |
| Description | The UPT-And is one of a number of UPTs that operates on a common Logic-List shared by each operator in a single |
| | algorithm. The UPT-And performs a logical And on the Leftmost two Children found in the Logic-List and replaces them with the result. |
| Behaviour | This UPT retrieves the first 2 Children found in the list of primitives inside the Logic-List. The UPT-And checks the Type of |
| | both Leftmost Children before removing them from the list. If the Types of both Children are Type-True, or if the Types of |
| | both Children are Type-False then a new Child is inserted into the list in the Leftmost position with its Type set to Type- |
| | True. Otherwise if the type of one Child is Type-True and the type of the other Child is Type-False, then a new Child is |
| | inserted into the list in the Leftmost position with its Type set to Type-False. Any other Type will insert Type-False into the |
| | Leftmost position of the Logic-List. |

| Child Location | Parameter Name | Description |
|---|---|---|
| 1 | Logic-List | This list holds the input and output parameters for an algorithm and should be of Type-True or Type-False |

UPT-Assignment

| | |
|---|---|
| Type | 007 |
| Description | The UPT-Assignment structure will copy the Fast-ABS, Slow-ABS, Float, Whole & Type primitives from a single Child to a list of |
| | Children. The exact primitives copied are determined by the Modifier-Field. |
| Behaviour | If the Type of the Modifier-Field Value is Type-Type, Type-Fast-ABS, Type-Slow-ABS, Type-Float or Type-Whole then |
| | the UPT-Assignment will copy only that respective primative from the Source-Field Value to each Child of the Assignment- |
| | List. If the Type of the Child of the Modifier-Field is of Type-No-Type then the Type is not copied over, but all of the Fast-ABS, |
| | Slow-ABS, Float & Whole of the Child in the Source-Field will be copied to each Child of the Assignment-List. Otherwise, if there is no |
| | recognized Type, the UPT is ignored. |

| Child Location | Parameter Name | Description |
|---|---|---|
| 1 | Source-Field | The Value identifies the Parent whose primitives are to be copied. |
| 2 | Assignment-List-Field | Lists the Children whose primitives are to be updated. |
| 3 | Modifier-Field | Governs the actions of the assignment by the Type primative of its Value with a Type of Type-Fast-ABS, Type- |
| | | Slow-ABS, Type-Float, Type-Whole, Type-Type or Type-No-Type. |

UPT-AVM

| | |
|---|---|
| Type | 033 |
| Description | Executes an AVMF sequence. The UPT-AVMF-Verify must be utilised prior to the UPT-AVM. |
| Behaviour | The UPT-Cycler (1600 of FIG. 9) forwards the UPT-AVM to the 3IP-AVM where the AVMF sequence that is attached to the Fast-ABS |
| | of the AVMF-Sequence parameter. All input is located in the FABS-Input-List-Field and output is directed to the FABS-Output-List-Field |
| | attached to Children in the FABS-Parameters. |

| Child Location | Parameter Name | Description |
|---|---|---|
| | AVMF-Sequence-Field | Contains the AVMF-Sequence to execute as Fast-ABS. |
| | FABS-Input-List-Field | Contains the input Children for this execution. |
| | FABS-Output-List-Field | Holds the output Children for this execution. |

UPT-AVMF-Verify

| | |
|---|---|
| Type | 034 |
| Description | Verifies an AVMF sequence prior to execution with the UPT-AVM. |
| Behaviour | The UPT-Cycler forwards the UPT-AVMF-Verify to the 3IP-AVMF-Verifier, so as to ensure that the AVMF sequence will not crash |
| | during execution and is correctly formed. |

| Child Location | Parameter Name | Description |
|---|---|---|
| | AVMF-Sequence-Field | Contains the AVMF sequence to verify. |
| | Number-Of-FABS-Parameters-Field | The number of input parameters for this execution. |

UPT-Break

| | |
|---|---|
| Type | 064 |
| Description | The UPT-Break is used to stop execution of certain UPTs that are contained within a loop such as a while loop or a for loop. |
| | High-level languages with the use of UPT-Sequences create these loops. There will be one specific UPT-Sequence that will |
| | reinsert the UPT-Sequence that restarts the loop again. The UPT-Break may be positioned anywhere in the loop, including |
| | in additional UPT-Sequences contained in previous UPT-Sequences, which have been added to the stack. The job of the |
| | UPT-Break is to locate the UPT-Sequence that restarts the loop and delete all UPTs on the execution stack between the UPT-Break |
| | on the stack and the located sequence. |
| Behaviour | The Source-Field Value holds the UPT-Sequence that restarts the loop. The UPT-Break uses the Cursor of the stack to locate |
| | the UPT-Sequence that has been identified by the Source-Field Value. If the Rightmost UPT in the located UPT-Sequence |
| | is the UPT-Sequence that restarts the loop then the UPT-Sequence is deleted from the stack and processing carries on as normal. Otherwise |
| | the Cursor of the stack is spawned and the resulting spawned Cursor is shifted to the Right. The next UPT is checked to see if it is: |
| | (1) A UPT-Sequence and |
| | (2) The Rightmost UPT is the UPT-Sequence that restarts the Loop. |
| | If neither of these conditions is filled then the UPT is deleted from the stack utilising the spawned Cursor, the spawned Cursor is then |
| | shifted to the Right. This process is repeated until both conditions are true in which case the start of the loop has been located. Both the |
| | located UPT-Sequence and the UPT-Sequence that holds the UPT-Break are deleted from the stack. The final step of the |
| | UPT-Break is to shift the Cursor of the UPT-Sequence that restarts the loop to the Right. |

| Child Location | Parameter Name | Description |
|---|---|---|
| 1 | Source-Field | Contains the Cursor-Identification that identifies the UPT-Sequence that restarts a loop. |

UPT-Cast

| | |
|---|---|
| Type | 68 |
| Description | The UPT-Cast retrieves either a Whole, Float, Type or String depending on the Type of the Source-Field and returns a new |
| | Set with the value retrieved as either a Whole, Float, Type or String depending on the Type of the Target-Field. |
| Behaviour | The UPT-Cast may not be able to be completed within one Digital-Business-Cycle therefore the UPT-Cast will not be |
| | deleted from the stack until it has finished. The value to be cast is retrieved using the Cursor-Identification inside the Source-Field. |
| | (1) If the Type of the Source-Field is of Type-Whole then the 64-Bit Whole value is retrieved. |
| | (2) If the Type of the Source-Field is of Type-Float then the 64-Bit Float value is retrieved. |
| | (3) If the Type of the Source-Field is of Type-Type then the Type is retrieved as a 64-Bit Whole value. |
| | (4) If the Type of the Source-Field is of Type-String then the Source inside the Source-Field will contain an unknown |
| | number of Children whose Whole values are retrieved and converted to either a Whole or a Float. |
| | The retrieved value is then converted to the required value, as determined by the Type of the Target-Field. If the Type of the |
| | Target-Field is Type-Whole or Type-Type then a 64-Bit Whole value is required. If the retrieved value is a 64-Bit Float |
| | value then it is converted to a 64-Bit Whole value by cropping anything after the decimal point. |
| | A Target is created to store the required value. |
| | a. If the Type of the Target-Field is of Type-Whole then the Whole value of the Target is set to the retrieved value. |
| | b. If the Type of the Target-Field is of Type-Float then the Float value of the Target is set to the retrieved value. |
| | c. If the Type of the Target-Field is of Type-Type then the Type of the Target is set to the retrieved value. |
| | d. If the Type of the Target-Field is Type-String then a Manabars-Set is created in the Target for each Character in the String. The Whole |
| | of the newly created Manabars-Set is set to the Unicode value of the Character. |
| | Once the retrieved value has been successfully converted the Target is inserted into the Target-Field before the UPT-Cast is deleted from |
| | the Stack. |

| Child Location | Parameter Name | Description |
|---|---|---|
| 1 | Source-Field | Has a Type of Type-Whole, Type-Float, Type-Type or Type-String to indicate which value to retrieve from |
| | | the Cursor-Identification held as the Value. |
| 2 | Target-Field | Has a Type of Type-Whole, Type-Float, Type-Type or Type-String to indicate which value is set on the new |
| | | Child to be inserted into this Field. |
| 3 | State-Information-Field | Holds internal processing information by the UPT-Cycler. Contains a Value with a Type of Type-Error if |
| | | there was a problem during the cast. |

UPT-Comparison

| | |
|---|---|
| Type | 001 |
| Description | The UPT-Comparison-Float is a branching structure that compares two float numbers (Left-Value-Field & the Right-Value-Field using |
| | Number-Precedence) against the Operator (<, <=, >, >=, =). |
| Behaviour | This UPT retrieves the Left and Right numbers from the Left-Value-Field and the Right-Value-Field. If either of these numbers are |
| | Whole numbers then they are cast to a Float number. These numbers are then compared using the Operator, located in the |
| | Operator-Field as a basis for the Comparison. If the result is True then a new Child is created with a Type of Type-True, otherwise the |
| | new Child has a Type of Type-False. This new Child is then inserted into the Leftmost position of the list held inside the Logic-List-Field. |

| Child Location | Parameter Name | Description |
|---|---|---|
| 1 | Left-Value-Field | This Field has a Type of Type-Whole or Type-Float that identifies the number to be compared occurring to the Left |
| | | of the operator. |
| 2 | Right-Value-Field | This Field has a Type of Type-Whole or Type-Float that identifies the number to be compared occurring to the |
| | | Right of the operator. |
| 3 | Operator-Field | The Value determines the nature of the comparison and has a Type of Type-Greater-Than, Type-Greater-Than-Or- |
| | | Equal-To, Type-Less-Than, Type-Less-Than-Or-Equal-To or Type-Equals. |
| 4 | Logic-List-Field | The Value is the Logic-List for which the UPT-Comparison will operate on. |

UPT-Continue

| | |
|---|---|
| Type | 065 |
| Description | The UPT-Continue is used to restart certain UPTs that are contained within a loop such as a while loop or a for loop. These |
| | loops are created with the use of UPT-Sequences. There is a specific UPT-Sequence that reinserts the UPT-Sequence onto |
| | the Stack to restarts the loop again. The UPT-Continue may be positioned anywhere in the loop, including inside additional |
| | UPT-Sequences contained in previous UPT-Sequences, which have been added to the stack. The job of the UPT-Continue |
| | is to locate the UPT-Sequence that restarts the loop and delete all UPTs between the UPT-Continue and the located UPT-Sequence |
| | on the stack. |
| Behaviour | The Source-Field of the UPT-Continue holds the UPT-Sequence that restarts the loop. The UPT-Continue uses the Cursor of |
| | the stack that is currently being processed to locate the UPT-Sequence that contains the UPT-Continue. If the Rightmost |
| | UPT in the located UPT-Sequence is the UPT-Sequence that restarts the loop then the Cursor of the located UPT-Sequence |
| | is shifted to the UPT-Sequence that restarts the loop, and processing carries on as normal. Otherwise the Cursor of the stack |
| | is spawned and the resulting spawned Cursor is shifted to the Right. The next UPT is checked to see if it is: |
| | (a) A UPT-Sequence and |
| | (b) The Rightmost UPT is the UPT-Sequence that restarts the Loop. |
| | If neither of these conditions is filled then the UPT is deleted from the stack utilising the spawned Cursor, the spawned Cursor is then |
| | shifted to the Right. This process is repeated until both conditions are true, in which case the start of the loop has been located. The Cursor |
| | of the located UPT-Sequence will be shifted to the UPT-Sequence that restarts the loop and the UPT-Continue will be deleted from |
| | the stack. |

| Child Location | Parameter Name | Description |
|---|---|---|
| 1 | Source-Field | Contains the Cursor-Identification that identifies the UPT-Sequence that started a loop. |

UPT-Copy-All-Children

| | |
|---|---|
| Type | 012 |
| Description | The UPT-Copy-All-Children copies all the Children within a Parent. |
| Behaviour | As the amount of Children to be copied is variable and may be a large number, this UPT-Copy-All-Children will be processed through the |
| | Asynchronous-Duplicator. The Children that are to be copied are found in the Child of the Source-Field. For each Child to be copied |
| | a new Child is created with the Type, Whole and Float copied from the original Child. These new Children will then be inserted into the |
| | Target Field Value in the same order as the original Children of the Source-Field Value. If the Type of the Lock-Mode-Field Value is of |
| | Type-Lock then the Cursor-Identification contained in the Target-Field Value will remain on the Child that it is currently pointing to. |
| | Otherwise, the Cursor-Identification will move to the copied Child that is farthest from its starting position. The Type of the Child of the |
| | Action-Trilarity-Field determines whether all the Children are copied to the Left or Right of the Child that the Cursor-Identification is |
| | currently pointing to, or whether all the Children replace the Child that the Cursor-Identification is currently pointing to. |

| Child Location | Parameter Name | Description |
|---|---|---|
| 1 | Source-Field | Contains the Cursor-Identification that identifies the Parent whose Children are copied. |
| 2 | Target-Field | Contains the Cursor-Identification that identifies the Parent that the newly copied Child are inserted into. |
| 3 | Action-Trilarity-Field | The Value determines the action trilarity using the Action-Trilarity-Resolution. |
| 4 | Lock-Mode-Field | The Value determines the Lock-Mode using Lock-Mode-Resolution. |

UPT-Copy-Child

| | |
|---|---|
| Type | 011 |
| Description | The UPT-Copy-Child reproduces a single Child. |
| Behaviour | A new Child is created with the Type, Whole and Float copied from the Source-Field Value. This new Child is then inserted into the |
| | Target-Field Value using the action trilarity, located as the Action-Trilarity-Field Value, and lock mode, located as the Lock-Mode-Field |
| | Value. |

| Child Location | Parameter Name | Description |
|---|---|---|
| 1 | Source-Field | Contains the Child that is copied. |
| 2 | Target-Field | Contains the Cursor-Identification that identifies the Parent that the newly copied Child is inserted into. |
| 3 | Action-Trilarity-Field | The Value determines the action trilarity using the Action-Trilarity-Resolution. |
| 4 | Lock-Mode-Field | The Value determines the lock mode using Lock-Mode-Resolution. |

UPT-Create-ABS

| | |
|---|---|
| Type | 037 |
| Description | The UPT-Create-ABS transfers data as Float or Whole directly into either Fast-ABS or Slow-ABS. |
| Behaviour | The UPT-Create-ABS creates a new Asynchronous-Bit-Sequence (ABS) in either the Fast-ABS or the Slow-ABS, depending on the Type |
| | of the ABS-Type-Field Value. The UPT-Create-ABS then systematically steps through the list of Children in the Source-Field Value |
| | retrieving the Type and relative number primitive from each Child. If the Type is of Type-Whole or Type-Float then the number is |
| | converted to a 64-Bit block and added to the newly created Asynchronous-Bit-Sequence. If the Type of the Child is of |
| | Type-Fast-ABS or Type-Slow-ABS, the value is already an Asynchronous-Bit-Sequence primitive; it is concatenated to the |
| | newly created Asynchronous-Bit-Sequence. The newly created Asynchronous-Bit-Sequence primitive is then assigned to |
| | the Parent contained in the Target-Field Value. If the Type of the Child is neither Type-Whole, Type-Float, Type-Fast-ABS |
| | or Type-Slow-ABS then the UPT is ignored. |

| Child Location | Parameter Name | Description |
|---|---|---|
| 1 | Source-Field | Contains a list of Children that each represents a 64-Bit segment of an Asynchronous-Bit-Sequence (ABS). |
| | | The Type determines the primitive transferred. It can be of Type Type-Whole, Type-Float, Type-Fast-ABS or Type- |
| | | Slow-ABS. |
| 2 | Target-Field | Contains the Cursor-Identification that identifies the Parent that is to have the ABS Content assigned. |
| 3 | ABS-Type-Field | The Type of the Child of this Field determines which ABS is formed. If the Type is Type-Fast-ABS then a |
| | | Fast-ABS primitive is formed, else a Slow-ABS primitive is formed. |

UPT-Create-Manabars-Set

| | |
|---|---|
| Type | 061 |
| Description | The UPT-Create-Manabars-Set establishes a new Manabars-Set and inserts it as the Target Field Value. |
| Behaviour | This UPT-Create-Manabars-Set inserts a new Child in the Neutral position of the Target-Field. |

| Child Location | Parameter Name | Description |
|---|---|---|
| 1 | Type-Field | The Value identifies the Type for the new Child using Type-Resolution. |
| 2 | Target-Field | This Field will contain the newly created Manabars-Set. |

UPT-Debug-Output

| Type | 069 | |
|---|---|---|
| Description | Enables the debugging output stream of the Emulator to be turned on or off. | |
| Behaviour | The UPT-Debug-Output toggles the Emulator debug output stream. Debugging output can include anything from individual UPTs status | |
| | information to III-Emulator errors. Mature III-Emulator builds are likely to ignore this UPT entirely. | |
| Child Location | Parameter Name | Description |
| 1 | Polarity-Field | Determines if the debugging stream should be turned on or off. If the Polarity-Field Value has a Type of Type-True, |
| | | then the debugging output stream is turned on, otherwise it is turned off. |

UPT-Delete-All-Children

| | |
|---|---|
| Type | 008 |
| Description | The UPT-Delete-All-Children removes each Child within the Source-Field Value. |
| Behaviour | The UPT-Delete-All-Children is not removed from the stack until every Child has been removed. Each time it is executed, the |
| | Item-Processor deletes as many Children as it can before the time remaining for the DBC expires. No state information is required to be |
| | stored by the Item-Processor as the Children themselves indicate the operations remaining. |

| Child Location | Parameter Name | Description |
|---|---|---|
| 1 | Source-Field | Contains the Cursor-Identification that identifies the Parent whose Children are deleted. |

Delete-Child

| | |
|---|---|
| Type | 010 |
| Description | The Delete-Child engages the KI-Delete-Child KI-Interface (see Appendix G) method. |
| Behaviour | This UPT-Delete-Child deletes the Child that the Cursor-Identification is currently pointing to the Parent in the Source-Field Value. Once |
| | the Child is deleted the Cursor-Identification shifts depending on the Type of the Action-Polarity-Field Value. |

| Child Location | Parameter Name | Description |
|---|---|---|
| 1 | Source-Field | Contains the Cursor-Identification that identifies the Parent whose Child is to be deleted. |
| 2 | Action-Polarity-Field | The Value determines the action polarity for the KI-Interface method and is of Type Type-Right or Type-Left. |

UPT-Denatured-Recursive-Copy

| | |
|---|---|
| Type | 041 |
| Description | The UPT-Denatured-Recursive-Copy is identical in function to the UPT-Recursive-Copy except that all UPTs with a Type between the |
| | ranges of 0-100 are replaced with Type Type-No-Type. |
| Behaviour | Is used to denature software to prevent it from being executed, but enables it to retain its data storage capability. This UPT-Denatured- |
| | Recursive-Copy will call the Asynchronous-Duplicator, which starts by copying the Child contained within the Source-Field. It |
| | systematically reproduces an identical copy by recursively copying its Child. All copied Cursors are in the same positions as the original |
| | and every primitive is restored. If the Type of the Child being copied is between the range of 0-100 then the Type of the copied Child |
| | will be set to Type-No-Type otherwise the Type will be copied over as well. All Monitors, Fast-ABS and Slow-ABS are not copied over. |
| | Once the copy is done, it is inserted as the Target-Field Value in the position specified by the Action-Trilarity-Field Value, with the |
| | Cursor-Identification either locked in its current position or shifted to the newly copied Child depending on the Type of the |
| | Lock-Mode-Field Value. |

| Child Location | Parameter Name | Description |
|---|---|---|
| 1 | Source-Field | Contains the Child that is copied. |
| 2 | Target-Field | Contains the Cursor-Identification that identifies the Parent that the newly copied Child is inserted into. |
| 3 | Action-Trilarity-Field | The Value determines the action trilarity using the Action-Trilarity-Resolution. |
| 4 | Lock-Mode-Field | The Value determines the lock mode using Lock-Mode-Resolution. |

UPT-Entangle

| | |
|---|---|
| Type | 026 |
| Description | The UPT-Entangle is a powerful mechanism that takes full advantage of Set Theory to encapsulate information. A Manabars-Set that has |
| | been entangled has effectively 2 forms. Its first form is the original form prior to its being entangled. Children can be added to the first |
| | form as a conventional set. The entangled set achieves its second form when it undergoes a UPT-Entangled-Recursive-Copy or |
| | UPT-Entangled-Denatured-Recursive-Copy. During these copies, its second form that is effectively an independent Manabars-Set capable |
| | of storing its own Children and primitives replaces the entangled set. The entangled set can achieve its original form when it undergoes |
| | an additional entangled recursive copy. This mechanism allows software to reference information without actually having access to it. |
| Behaviour | The Asynchronous-Duplicator has a hashtable that keeps references of all Entangled Cursor-Identifications associated with certain keys. |
| | The hashtable has Parent-Identifications as hashtable keys and Cursor-Identifications as hashtable values. The Parent-Identification |
| | is used so that all Spawned-Cursor-Identifications that share the same Cursor-Identification contained as the Source-Field Value |
| | are treated as an entangled set. The Hashtable value is always the original Cursor-Identification, set up via the UPT-Entangle. |
| | This UPT-Entangle retrieves the hashtable that matches the key in the Key-Field. The UPT-Entangle then creates a new Child |
| | and adds 2 new entry pairs to the retrieved hashtable. The first entry pair has the Parent-Identification of the source, contained |
| | as the Source-Field Value and is used as the hashtable key and the Cursor-Identification of the newly created Child as the hashtable value. |
| | The second entry pair will contain the Parent-Identification of the newly created Child and is used as the hashtable key, and the Cursor- |
| | Identification contained in the Source-Field as the hashtable value. If the hashtable already contains the Parent-Identification of the |
| | source, then the UPT-Entangle is ignored, as the Set is already entangled with another Manabars-Set. A Manabars-Set must be |
| | unentangled first before it can be entangled with another. |

| Child Location | Parameter Name | Description |
|---|---|---|
| 1 | Key-Field | Contains the key that is used to locate all entangled Cursor-Identifications for the hashtable key. |
| 2 | Source-Field | Contains the source Cursor-Identification to be entangled. |

UPT-Entangled-Denatured-Recursive-Copy

| | |
|---|---|
| Type | 043 |
| Description | The UPT-Entangled-Denatured-Recursive-Copy works exactly like a UPT-Entangled-Recursive-Copy in that it reproduces an entire Child |
| | including all its recursive Children, with the extra functionality of checking for entangled Cursor-Identifications against a valid key. |
| | Furthermore, it will also remove all Types that are between the Values of 0 and 100. |
| Behaviour | This UPT-Entangled-Denatured-Recursive-Copy will call the Asynchronous-Duplicator, which starts by copying the Source-Field |
| | Value. It recursively copies the Source-Field Value. If any entangled Cursor-Identifications are encountered and if the Type of the |
| | Polarity-Field Value is Type-True then the Asynchronous-Duplicator inserts the corresponding entangled Cursor-Identification into |
| | the copy instead of copying the source Child. Otherwise, if the Type of the Polarity-Field Value is Type-False then the entangled |
| | Cursor-Identification itself will be inserted. All copied Cursors are in the same positions as the original and all primitives are restored. |
| | If the Type of the Child being copied is between the range of 0-100 then the Type of the copied Child is set to Type-No-Type, otherwise, |
| | the Type will be copied over as well. No Monitors are copied over. When the copied Child is an exact replica of the Source-Field Value |
| | then it is inserted as the Target-Field Value, in the position specified by the Action-Trilarity-Field Value, with the Cursor-Identification |
| | either locked in its current position or shifted to the newly copied Child depending on the Type of the Lock-Mode-Field Value. |

| Child Location | Parameter Name | Description |
|---|---|---|
| 1 | Key-Field | Contains the key that is used to locate any entangled Cursor-Identifications. |
| 2 | Source-Field | Contains the Child that is copied. |
| 3 | Target-Field | Contains the Parent that the newly copied Child is inserted into. |
| 4 | Action-Trilarity-Field | The Value determines the action trilarity using the Action-Trilarity-Resolution. |
| 5 | Lock-Mode-Field | The Value determines the lock mode using Lock-Mode-Resolution. |
| 6 | Polarity-Field | The Value has a Type of Type-True or Type-False that determines which entangled Cursor-Identification to |
| | | use. |

UPT-Entangled-Recursive-Copy

| | |
|---|---|
| Type | 035 |
| Description | The UPT-Entangled-Recursive-Copy works exactly like a UPT-Recursive-Copy in that it reproduces an entire Child including all |
| | its recursive Children, with the extra functionality of checking for entangled Cursor-Identifications if the Key-Field holds a valid Key. |
| Behaviour | This UPT-Entangled-Recursive-Copy will call the Asynchronous-Duplicator, which starts by copying the Child contained within the |
| | Source-Field. It makes a recursive copy of the Source-Field Value. If any entangled Cursor-Identifications are encountered and if the Type |
| | of the Polarity-Field Value is Type-True, then the Asynchronous-Duplicator inserts the corresponding entangled Cursor-Identification into |
| | the copy instead of copying the Child. Otherwise, if the Type of the Polarity-Field Value is Type-False, then the entangled Cursor- |
| | Identification itself is inserted. All copied Cursors will be in the same positions and the original primitives restored. No Monitors are |
| | copied. Once copied, it is inserted into the Target-Field Value, in the position specified by the Action-Trilarity-Field Value, with the |
| | Cursor-Identification either locked in its current position or shifted to the newly copied Child depending on the Type of the |
| | Lock-Mode-Field Value. |

| Child Location | Parameter Name | Description |
|---|---|---|
| 1 | Key-Field | Contains the key that is used to locate any entangled Cursor-Identifications. |
| 2 | Source-Field | Contains the Child that is copied. |
| 3 | Target-Field | Contains the Parent that the newly copied Child is inserted into. |
| 4 | Action-Trilarity-Field | The Value determines the action trilarity using the Action-Trilarity-Resolution. |
| 5 | Lock-Mode-Field | The Value determines the lock mode using Lock-Mode-Resolution. |
| 6 | Polarity-Field | The Value has a Type of Type-True or Type-False that determines which entangled Cursor-Identification to |
| | | use. |

UPT-Evaluate

| | |
|---|---|
| Type | 028 |
| Description | The UPT-Evaluate will compute an algorithm as a series of numbers and operators being multiplication, division, addition and subtraction. |
| | The Whole or the Float of the Operations-List-Field carries the current value of the calculation and is dependent on the Type of the |
| | Answer-Field. |
| Behaviour | The UPT-Evaluate may take numerous Digital-Business-Cycles to complete; therefore, the UPT-Evaluate will not be deleted from the |
| | stack until it has finished. The UPT-Evaluate retrieves either the Whole value or the Float value of the Operations-List-Field, depending |
| | on the Type of the Answer-Field and store the value as the answer. When the UPT-Evaluate is first begun, this value should be 0. The |
| | UPT will then systematically step through the list contained in the Operations-List-Field, retrieving each Child from the Left to the Right. |
| | The UPT carries out a calculation as explained further in UPT-Fixed-Operation, using the answer as the value to the Left of the operator. |
| | If the UPT runs out of time when the DBC is complete, then the answer is stored to either the Whole or Float of the Operations-List-Field, |
| | depending on the Type of the Answer-Field, ready to be retrieved the next time this UPT is executed. The Cursor of the list inside the |
| | Operations-List-Field is used to locate the position of the Child the UPT last processed. If the UPT is finished, then a new Child with the |
| | answer assigned as the Whole value or Float value, dependent on the Type of the Answer-Field, is inserted into the Answer-Field. |

| Child Location | Parameter Name | Description |
|---|---|---|
| 1 | Operations-List-Field | Contains a list of numbers and operators that are evaluated from Left to Right. |
| 2 | Answer-Field | Contains the answer once the UPT has been executed. The answer is represented as a Float if its Type is |
| | | Type-Float and as a Whole if its Type is Type-Whole. |

UPT-Fixed-Operation

| | |
|---|---|
| Type | 310 |
| Description | The UPT-Fixed-Operation structure holds an operator and a number to be used in evaluating an algorithm. |
| Behaviour | The value to the Left of the Operator is the answer from the last UPT-Fixed-Operation. The UPT-Evaluate that is using the UPT-Fixed- |
| | Operation performs a calculation on the answer based on the Type of the Operator-Field Value and the number retrieved from the |
| | Value-Field Value. If the Type of the Value-Field is Type-Float then the Float number of the Value-Field Value is retrieved, otherwise, |
| | the Whole number f the Value-Field Value is retrieved. |

| Child Location | Parameter Name | Description |
|---|---|---|
| 1 | Operator-Field | The Value must have a Type of Type-Addition, Type-Subtraction, Type-Multiplication, Type-Division |
| | | or Type-Remainder. |
| 2 | Value-Field | Contains the parameter for this operator. If this operator is of Type Type-Whole then the Whole value is use. |
| | | If the Type is of Type-Float, then the Float is used. |

UPT-Get-Boundary-Cursor-Identification

| | |
|---|---|
| Type | 014 |
| Description | The UPT-Get-Boundary-Cursor-Identification engages the KI-Get-Boundary-Cursor-Identification KI-Interface (see Appendix G) method. |
| Behaviour | The UPT-Get-Boundary-Cursor-Identification retrieves the Leftmost or Rightmost Cursor-Identification of the Source-Field Value, |
| | depending on the Type of the Polarity-Field Value. The retrieved Cursor-Identification is then inserted into the Target-Field in the position |
| | specified by the Type of the Trilarity-Field Value, and the Type of the Lock-Mode-Field Value. |

| Child Locaton | Parameter Name | Description |
|---|---|---|
| 1 | Source-Field | Contains the Cursor-Identification that identifies the Parent for which the Leftmost Cursor-Identification is required. |
| 2 | Polarity-Field | The Value has a Type of Type-Left or Type-Right, which determines if it is the Leftmost or Rightmost Cursor- |
| | | Identification that is required. |
| 3 | Target-Field | The Value is to contain the result of the Get-Boundary-Cursor-Identification KI-Interface method call. |
| 4 | Trilarity-Field | The Value determines if the Child is to be inserted into the Left, Right or Neutral position using Action-Trilarity- |
| | | Resolution. |
| 5 | Lock-Mode-Field | The Value determines how the Child is inserted using Lock-Mode-Resolution. |

UPT-Get-Child

| | |
|---|---|
| Type | 015 |
| Description | The UPT-Get-Child engages the KI-Get-Child KI-Interface (see Appendix G) method. |
| Behaviour | The UPT-Get-Child obtains the Cursor-Identification of the Child of the Parent that is contained in the Source-Field. The Cursor- |
| | Identification is inserted as the Target-Field Value in the position specified by the Type of the Trilarity-Field Value and the Type of the |
| | Lock-Mode-Field Value. |

| Child Location | Parameter Name | Description |
|---|---|---|
| 1 | Source-Field | Contains the Cursor-Identification that identifies the Parent whose Child is to be retrieved. |
| 2 | Target-Field | The Child that is to contain the retrieved Child. |
| 3 | Trilarity-Field | The Value determines if the retrieved Child is to be inserted into the Left, Right or Neutral position using Action- |
| | | Trilarity-Resolution. |
| 4 | Lock-Mode-Field | The Value determines how the Child is inserted using Lock-Mode-Resolution. |

UPT-Get-DTE-Instance

| | |
|---|---|
| Type | 048 |
| Description | The UPT-Get-DTE-Instance will get the DTE-Instance of the Digital-Business that is currently being processed. |
| Behaviour | The UPT-Get-DTE-Instance will access the Item-Processor to retrieve the DTE-Instance of the Digital-Business that is currently being |
| | processed. The UPT will spawn the Cursor-Identification of the DTE-Instance and insert the spawned Cursor-Identification into the Target- |
| | Field. |

| Child Location | Parameter Name | Description |
|---|---|---|
| 1 | Target-Field | The Child that is to contain the spawned DTE-Instance Cursor-Identification. |

UPT-Get-Event-Parameters

| | |
|---|---|
| Type | 056 |
| Description | The UPT-Get-Event-Parameters is used in conjunction with Monitors. Each Monitor may be triggered more than once at the same time. |
| | The UPT-Get-Event-Parameters retrieves the correct Event-Parameters, gathered through the event that triggered the Monitor. The UPT- |
| | Get-Event-Parameters will only return a result if it is processed through a UPT-Monitor-Sequence. |
| Behaviour | The UPT-Get-Event-Parameters retrieves the Event-Parameters found via the Event-Parameters-Field of the UPT-Monitor-Sequence. |
| | It then inserts the Event-Parameters into the Target-Field. If the UPT-Get-Event-Parameters is not located through the Pseudo- |
| | Stack-Field of an UPT-Monitor-Sequence then nothing is inserted into the Target-Field. |

| Child Location | Parameter Name | Description |
|---|---|---|
| 1 | Target-Field | Contains the Event-Parameters once the UPT-Get-Event-Parameters has been processed. |

UPT-Get-Fast-ABS-Hashkey

| | |
|---|---|
| Type | 053 |
| Description | The UPT-Get-Fast-ABS-Hashkey engages the KI-Get-Fast-ABS-Hashkey KI-Interface method (see Appendix G). |
| Behaviour | The UPT-Get-Fast-ABS-Hashkey retrieves the Fast-ABS-Hashkey of the Source-Field Value. A new Child with its Whole primitive set to |
| | the retrieved Fast-ABS-Hashkey is inserted into the Neutral position of the Target-Field. |

| Child Location | Parameter Name | Description |
|---|---|---|
| 1 | Source-Field | Contains the Cursor-Identification that identifies the Parent whose Fast-ABS-Hashkey is retrieved. |
| 2 | Target-Field | The Child that is to contain the Child with the retrieved Fast-ABS-Hashkey set as its Whole. |

UPT-Get-Float-Hashkey

| | |
|---|---|
| Type | 052 |
| Description | The UPT-Get-Float-Hashkey engages the KI-Get-Float-Hashkey KI-Interface (see Appendix G) method. |
| Behaviour | The UPT-Get-Float-Hashkey retrieves the Float-Hashkey of the source that is contained in the Source-Field. A new Child with its Whole |
| | value set to equal the retrieved Float-Hashkey is inserted into the Neutral position of the Target-Field. |

| Child Location | Parameter Name | Description |
|---|---|---|
| 1 | Source-Field | Contains the Cursor-Identification that identifies the Parent whose Float-Hashkey is retrieved. |
| 2 | Target-Field | The Child that is to contain the Child with the retrieved Float-Hashkey set as its Whole. |

UPT-Get-GE-Instance

| | |
|---|---|
| Type | 066 |
| Description | The UPT-Get-GE-Instance retrieves the GE-Instance (10000a of FIG. 51) of the Digital-Business that is currently being processed. This |
| | UPT is ignored by the Item-Processor if it is encountered on a DTE-Instance (9800a of FIG. 50) stack, so as to preserve the |
| | Governance-Layer (6475 of FIG. 33) scope Over Digital-Businesses. |
| Behaviour | The UPT-Get-GE-Instance accesses the Item-Processor to retrieve the GE-Instance of the Digital-Business that is currently being |
| | processed. The UPT will spawn the Cursor-Identification of the GE-Instance and insert the spawned Cursor-Identification into the Target- |
| | Field. |

| Child Location | Parameter Name | Description |
|---|---|---|
| 1 | Target-Field | The Child that contains the spawned GE-Instance Cursor-Identification. |

UPT-Get-Index

| | |
|---|---|
| Type | 016 |
| Description | The UPT-Get-Index engages the KI-Get-Index KI-Interface (see Appendix G) method. |
| Behaviour | It is possible for the UPT-Get-Index to not be completed in one Digital-Business-Cycle, therefore it will not be deleted from the stack |
| | until it is finished. An index is a count of how far away a Child is from the boundary, where an index of 1 means that the Child is on |
| | the boundary. The UPT-Get-Index retrieves the index of the Child that the Cursor-Identification contained in the Source-Field is pointing |
| | to. The index can be determined from either the Left or Right boundary as specified by the Type of the Action-Polarity-Field Value. A |
| | new Child with its Whole value set to the retrieved index is inserted into the Target-Field in the position specified by the Type of the |
| | Trilarity-Field Value and the Type of the Lock-Mode-Field Value. |

| Child Location | Parameter Name | Description |
|---|---|---|
| 1 | Source-Field | Contains the Cursor-Identification whose Index is required. |
| 2 | Action-Polarity-Field | The Value indicates the frame of reference for the index being Left or Right, where the Type is Type-Left |
| | | or Type-Right. |
| 3 | Target-Field | The Child that contains the result of the KI-Get-Index KI-Interface method call. |
| 4 | Trilarity-Field | The Value determines if the Child is inserted into the Left, Right or Neutral position using Action-Trilarity- |
| | | Resolution. |
| 5 | Lock-Mode-Field | The Value determines how the Child is inserted using Lock-Mode-Resolution. |

UPT-Get-Number-Children

| | |
|---|---|
| Type | 017 |
| Description | The UPT-Get-Number-Children engages the KI-Get-Number-Children KI-Interface (see Appendix G) method. |
| Behaviour | The UPT-Get-Number-Children retrieves a whole value that represents how many Children are inside the Source-Field Value. A new |
| | Child is created with its Whole primitive set to the retrieved number of Children. The newly created Child is then inserted into the Target- |
| | Field in the position specified by the Type of the Trilarity-Field Value and the Type of the Lock-Mode-Field Value. |

| Child Location | Parameter Name | Description |
|---|---|---|
| 1 | Source-Field | Contains the Cursor-Identification that identifies the Parent for which the number of Children is required. |
| 2 | Target-Field | The Child that contains the result of the KI-Interface method call as a Whole. |
| 3 | Trilarity-Field | The Value determines if the Child is inserted into the Left, Right or Neutral position using Action-Trilarity- |
| | | Resolution. |
| 4 | Lock-Mode-Field | The Value determines how the Child is inserted using Lock-Mode-Resolution. |

UPT-Get-Number-Cursors

| | |
|---|---|
| Type | 018 |
| Description | The UPT-Get-Number-Cursors engages the KI-Get-Number-Cursors KI-Interface (see Appendix G) method. |
| Behaviour | This UPT-Get-Number-Cursors retrieves a Whole number that represents how many Cursors are contained in the Source-Field Value. A |
| | new Child is created with its Whole primitive set to the number of Cursors. The newly created Child is then inserted into the Target-Field |
| | in the position specified by the Type of the Trilarity-Field Value and the Type of the Lock-Mode-Field Value. |

| Child Location | Parameter Name | Description |
|---|---|---|
| 1 | Source-Field | Contains the Cursor-Identification that identifies the Parent for which the number of Cursors is required. |
| 2 | Target-Field | The Child that contains the result of the KI-Interface method call as a Whole. |
| 3 | Trilarity-Field | The Value determines if the Child is inserted into the Left, Right or Neutral position using Action-Trilarity- |
| | | Resolution. |
| 4 | Lock-Mode-Field | The Value determines how the Child is inserted using Lock-Mode-Resolution. |

UPT-Get-Number-Shared-Cursor-Identifications

| | |
|---|---|
| Type | 019 |
| Description | The UPT-Get-Number-Shared-Cursor-Identifications engages the KI-Get-Number-Shared-Cursor-Identifications KI-Interface (see |
| | Appendix G) method. |
| Behaviour | The UPT-Get-Number-Shared-Cursor-Identifications retrieves a Whole number that represents how many Cursors are pointing to the |
| | same Child as the Cursor-Identification contained in the Source-Field. A new Child is created with its Whole primitive set to the number |
| | of shared Cursors. The newly created Child is then inserted into the Target-Field in the position specified by the Type of the Trilarity-Field |
| | Value and the Type of the Lock-Mode-Field Value. |

| Child Location | Parameter Name | Description |
|---|---|---|
| 1 | Source-Field | Contains the Cursor-Identification for which the number of shared Cursor-Identification is required. |
| 2 | Target-Field | The Child that contains the result of the KI-Interface method call as a Whole. |
| 3 | Trilarity-Field | The Value determines if the Child is inserted into the Left, Right or Neutral position using Action-Trilarity- |
| | | Resolution. |
| 4 | Lock-Mode-Field | The Value determines how the Child is inserted using Lock-Mode-Resolution. |

UPT-Get-Slow-ABS-Hashkey

| | |
|---|---|
| Type | 054 |
| Description | The UPT-Get-Slow-ABS-Hashkey engages the KI-Get-Slow-ABS-Hashkey KI-Interface (see Appendix G) method. |
| Behaviour | The UPT-Get-Slow-ABS-Hashkey retrieves the Slow-ABS-Hashkey of the source that is contained in the Source-Field. A new Child with |
| | its Whole primitive is set to the retrieved Slow-ABS-Hashkey is inserted into the Neutral position of the Target-Field. |

| Child Location | Parameter Name | Description |
|---|---|---|
| 1 | Source-Field | Contains the Cursor-Identification that identifies the Parent whose Slow-ABS-Hashkey is retrieved. |
| 2 | Target-Field | The Value is to contain the Child with the retrieved Slow-ABS-Hashkey set as its Whole. |

UPT-Get-Whole-Hashkey

| | |
|---|---|
| Type | 051 |
| Description | The UPT-Get-Whole-Hashkey engages the KI-Get-Whole-Hashkey KI-Interface (see Appendix G) method. |
| Behaviour | The UPT-Get-Whole-Hashkey retrieves the Whole hashkey of the source that is contained in the Source-Field. A new Child with its Whole |
| | primitive set to the Whole hashkey is inserted into the Neutral position of the Target-Field. |

| Child Location | Parameter Name | Description |
|---|---|---|
| 1 | Source-Field | Contains the Cursor-Identification that identifies the Parent whose Whole |
| | | hashkey is retrieved. |
| 2 | Target-Field | The Value to contain the Child with the retrieved Whole hashkey set as its |
| | | Whole. |

UPT-If

| | |
|---|---|
| Type | 027 |
| Description | The UPT-If performs a conditional branch dependant upon the Logic-List-Field and deletes the Leftmost Child. |
| Behaviour | The UPT-If retrieves the Leftmost Child held in the Logic-List contained in the Logic-List-Field before deleting the Child |
| | from the Logic-List. If the Type of the retrieved Child is of Type-True then the UPT-If inserts the True-Field Value onto the |
| | Stack, otherwise the UPT-If inserts the False-Field Value onto the stack. This insertion is made to the Right of the UPT-If with the Cursor |
| | of the stack locked onto the UPT-If. |

| Child Location | Parameter Name | Description |
|---|---|---|
| 1 | Logic-List-Field | Contains a Logic-List. The Type of the Leftmost Child of the Logic-List |
| | | determines the conditional boolean logic. |
| 2 | True-Field | Contains the UPT to execute if the Leftmost Child in the Logic-List-Field is of |
| | | Type-True. |
| 3 | False-Field | Contains the UPT to execute if the Leftmost Child in the Logic-List-Field is of |
| | | Type-False. |

UPT-Insert-And-Spawn

| | |
|---|---|
| Type | 032 |
| Description | The UPT-Insert-And-Spawn inserts a Child into a Parent using a spawned Cursor-Identification. |
| Behaviour | The UPT-Insert-And-Spawn retrieves and spawns the Cursor-Identification of the Target-Field Value by using the KI-Insert- |
| | And-Spawn method (see Appendix G). The UPT-Insert-And-Spawn then inserts the Source-Field Value into the Target- |
| | Field Value using the spawned Cursor-Identification. This insertion is made in the position specified by the Type of the |
| | Trilarity-Field Value and the Type of the Lock-Mode-Field Value. The spawned Cursor-Identification is then inserted into the Result-Field |
| | in the Neutral position with the Cursor-Identification of the Result-Field locked. |

| Child Location | Parameter Name | Description |
|---|---|---|
| 1 | Source-Field | Contains the Child that is inserted. |
| 2 | Target-Field | Contains the Cursor-Identification that identifies the Parent for which a new |
| | | Cursor is spawned and the Child is inserted into. |
| 3 | Result-Field | Contains the newly spawned Cursor. |
| 4 | Trilarity-Field | The Value determines if the Child is inserted into the Left, Right or Neutral |
| | | position using Action-Trilarity-Resolution. |
| 5 | Lock-Mode-Field | The Value determines how the Child is inserted using Lock-Mode-Resolution. |

UPT-Insert-Child

| | |
|---|---|
| Type | 020 |
| Description | The UPT-Insert-Child engages the KI-Insert-Child KI-Interface (see Appendix G)method. |
| Behaviour | The UPT-Insert-Child inserts the Source-Field Value into the Target-Field Value in the position specified by the Type of the Trilarity-Field |
| | Value and the Type of the Lock-Mode-Field Value. |

| Child Location | Parameter Name | Description |
|---|---|---|
| 1 | Source-Field | The Child for which a new reference is created. |
| 2 | Target-Field | The Child that contains the result of the KI-Interface method call. |
| 3 | Trilarity-Field | The Value determines if the Child is inserted into the Left, Right or Neutral |
| | | position using Action-Trilarity-Resolution. |
| 4 | Lock-Mode-Field | The Value determines how the Child is inserted using Lock-Mode-Resolution. |

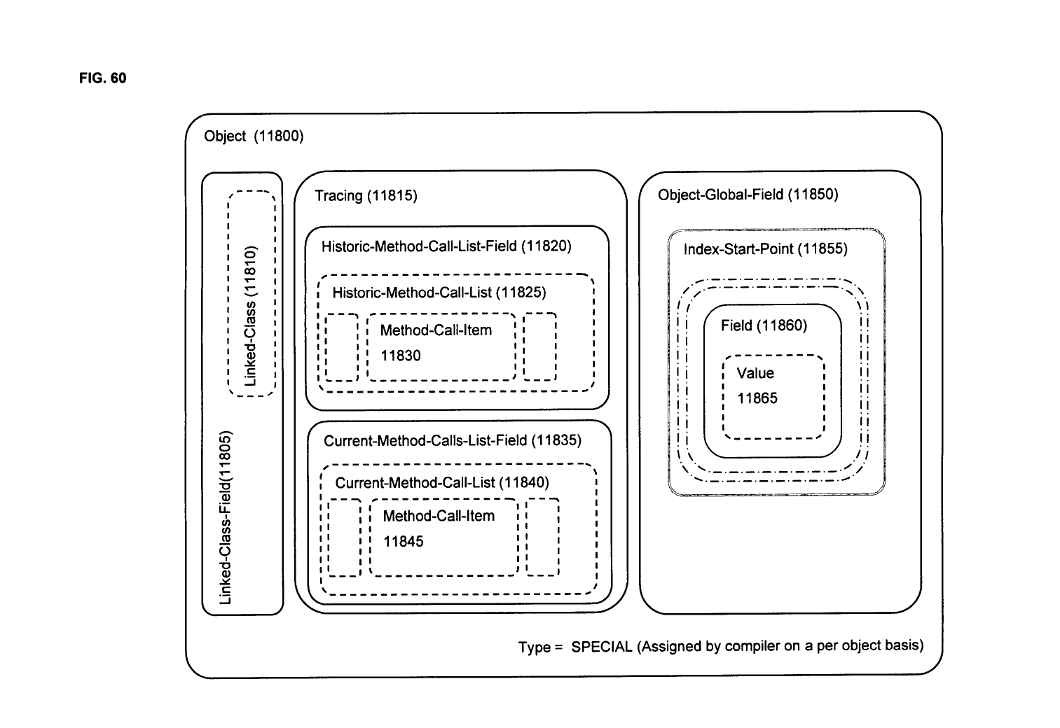

UPT-Locate-Variable

| | |
|---|---|
| Type | 062 |
| Description | The UPT-Locate-Variable is used in conjunction with Object-Orientation support. It is used when accessing static variables |
| | and global variables within a method frame by using Method-Frame-Indexing. |
| Behaviour | The UPT-Locate-Variable locates the Index-Start-Point of the method frame index via the Object located in the Object- |
| | Field. If there is no Object (11800 of FIG. 60) and the Type of the Sync-Field is Type-Global-Field then this UPT-Locate- |
| | Variable is removed from the stack. Otherwise, if there is no Object and the Type of the Sync-Field is of Type-Static-Field |
| | then the Index-Start-Point is located through the Linked-Class found in the Linked-Class-Field (11805 of FIG. 60). Once the |
| | Index-Start-Point is located, the UPT-Locate-Variable will retrieves the variable found by using method frame indexing with |
| | the index being the Whole number of the Sync-Field Value. The resulting variable is inserted into the Target-Field, or if |
| | there is another Sync-Field inside the Target-Field then the resulting variable is inserted into the Method-Frame-Index located through the |
| | extra Sync-Field. |

| Child Location | Parameter Name | Description |
|---|---|---|
| 1 | Sync-Field-Field | The Value is a Sync-Field, with a Type of Type-Static-Field or Type-Global- |
| | | Field, and a Whole value that identifies the index that holds the variable using |
| | | the Method-Frame-Index. |
| 2 | Object-Field | Holds the Object through which the variable may be found. |
| 3 | Linked-Class-Field | If the Object-Field is empty and the Type of the Sync-Field is Type-Static-Field |
| | | then the variable may be found via the Value. |
| 4 | Target-Field | Contains the located variable. |

UPT-Map

| | |
|---|---|
| Type | 049 |
| Description | The UPT-Map is similar to the UPT-Entangle in that it is used to make a reference to a particular Cursor-Identification at a |
| | certain point. The difference being that UPT-Map is used in situations where an absolute reference is physically unable to be |
| | used. An example of a UPT-Map scenario is during transfers from one Digital-Business to its peer Digital-Business on |
| | another Node. The transfer of sets from one Node to a Node partner (12010a, 12010b, 12010n of FIG. 61) involves creating |
| | new sets on the Node partner. Absolute references are unable to be passed across to the Node partner as the Cursor- |
| | Identification on one Node is a different Cursor-Identification on another Node. There are certain situations where a set on |
| | one Node has a matching set on the Node partner. A mapped set can be used to link these sets in the same way as an |
| | entangled Set does. The Partner-Channel-Manager has a hashtable that keeps references of all mapped sets associated with |
| | certain keys. The hashtable holds references to the Parent-Identification of the Cursor-Identification held in the Source- |
| | Field, and a unique key that will be passed across to a Node partner. The Node partner is able to use the key to locate the |
| | matching Cursor-Identification, and therefore inserts the existing Child instead of creating a new one. |
| Behaviour | When a UPT-Map is processed, it creates two new additions to the hashtable: |
| | (a) An entry with the Parent-Identification as the Hashtable key and the unique key as a Hashtable value so as to locate |
| | the mapped set when sending. |
| | (b) An entry with the unique key as a hashtable key and the Parent-Identification as the hashtable value so as to locate |
| | the Parent-Identification when receiving. If the hashtable already contains the Parent-Identification of the source the UPT-Map is ignored, |
| | as the set is already mapped with another set. |

| Child Location | Parameter Name | Description |
|---|---|---|
| 1 | Key-Field | Contains the key that is used to locate all mapped sets. |
| 2 | Source-Field | Contains the source, which is the Cursor-Identification that is to be mapped. |

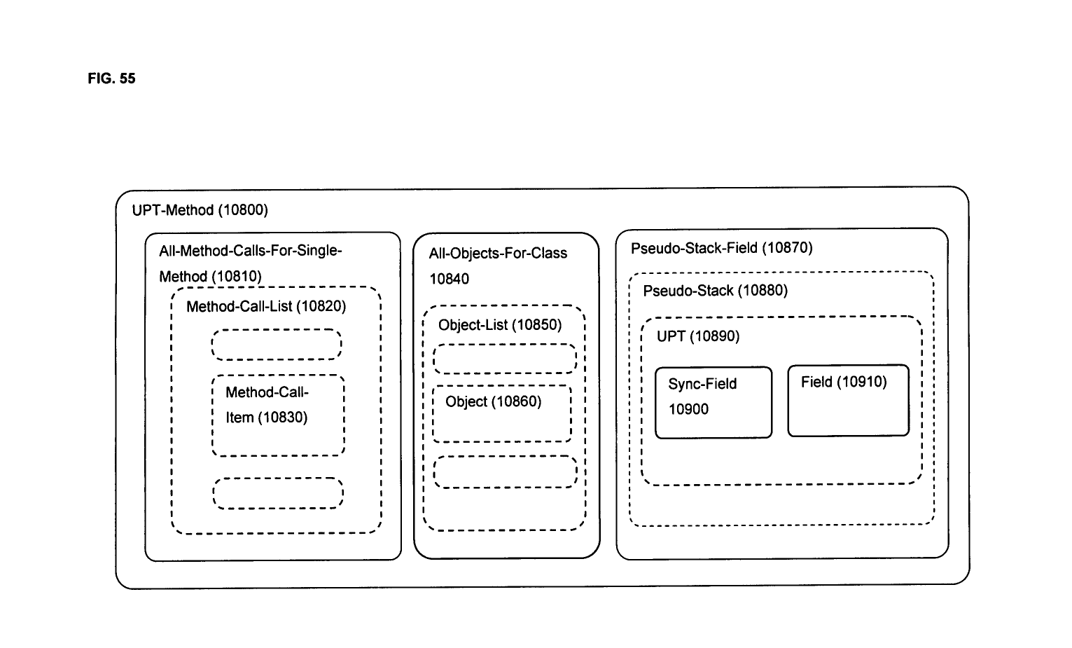

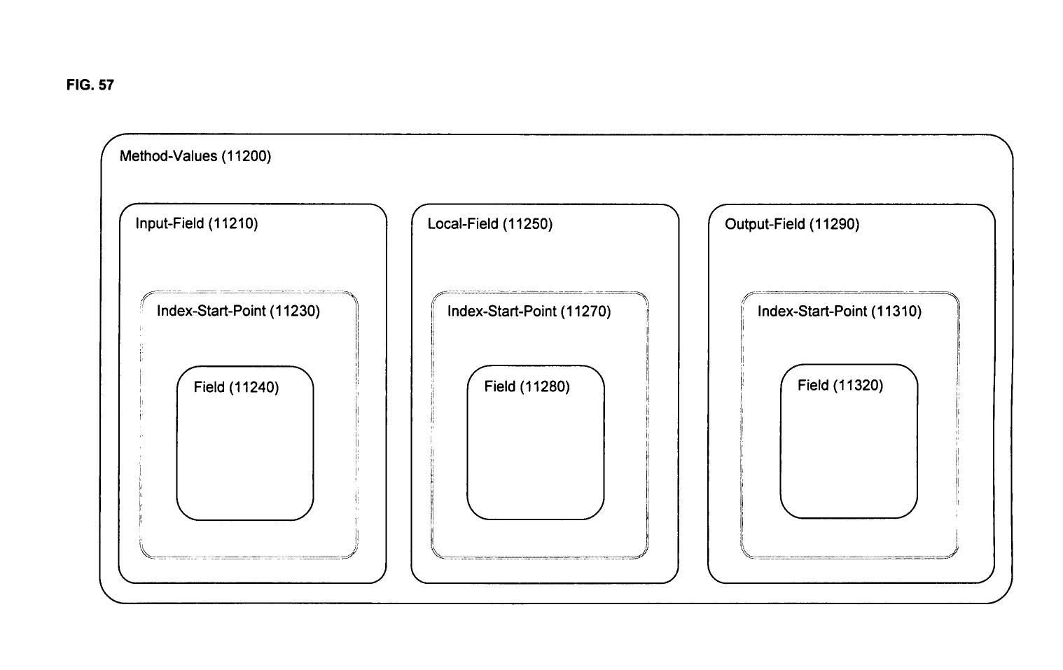

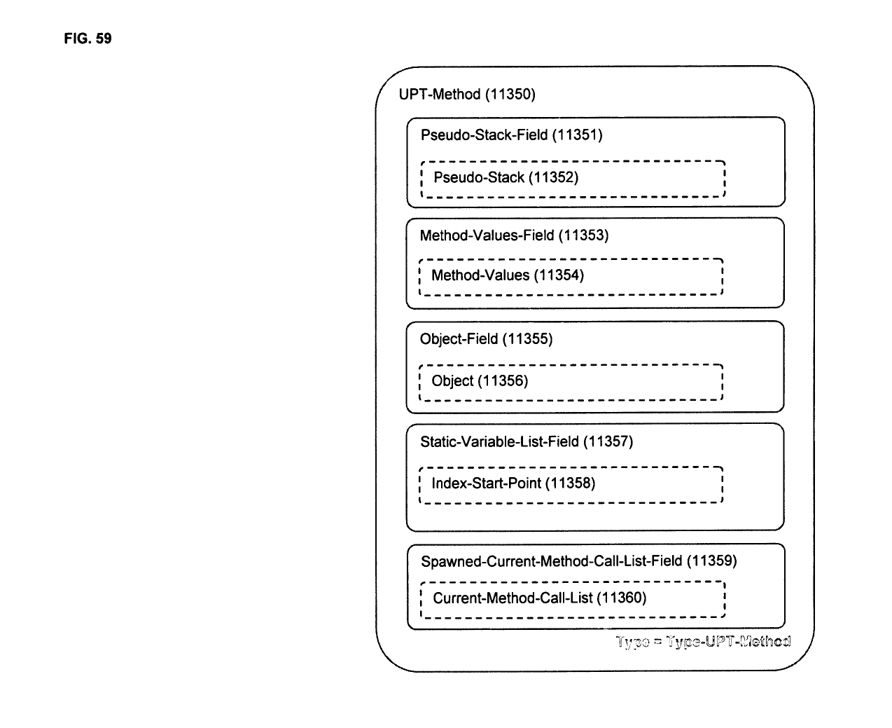

UPT-Method

| | |
|---|---|
| Type | 059 |
| Description | The core mechanism that provides procedural method frame support is the UPT-Method. When the UPT-Method is |
| | executed, the Item-Processor continues execution from the Pseudo-Stack (11352 of FIG. 59) contained in the Pseudo-Stack- |
| | Field (11351 of FIG. 59) instead of a conventional stack-such as the Realtime-Stack (10615 of FIG. 54), Prepaid-Stack |
| | (10625 of FIG. 54), Standby-Stack (10635 of FIG. 54), Idle-Stack (10645 of FIG. 54) or Background-Stack (10655 of FIG. |
| | 54). The Item-Processor executes UPTs identically, except that a Field may contain a Method-Frame-Index instead of the |
| | Value. The Method-Frame-Index allows the Item-Processor to look up the specific variable each time a method is called- |
| | thereby allowing the variable value to change with each call. These Method-Field-Indexes have special Types and Whole |
| | primitives, which direct the Item-Processor to the correct Value. |
| Behaviour | The Item-Processor locates the Psuedo-Stack of the UPT-Method and processes the UPTs normally with the exception that |
| | each Field of the processing UPT is checked for Method-Frame-Indexes before retrieving the Value of the Field. If there is |
| | a Method-Frame-Index located inside the stack, then the Type of the Method-Frame-Index is used to perform the correct |
| | Value lookup. If the Type of the Method-Frame-Index is of Type-Method-Global then the Index-Start-Point (11855 of FIG. |
| | 60) is found through the Object-Global-Field (11850 of FIG. 60) of the Object (11800 of FIG. 60), located as the Child |
| | selected by the Cursor of the Object-List (10850 of FIG. 55) of the UPT-Method. If the Type of the Method-Frame-Index is |
| | of Type-Static-Variable, then the Index-Start-Point (11358 of FIG. 59) is found via the Static-Variables-List-Field (11357 of |
| | FIG. 59). Otherwise, the Index-Start-Point is located through the Method-Values (11354 of FIG. 59 and 11200 of FIG. 57) |
| | contained in the Method-Values-Field (11353 of FIG. 59). If the Type of the Method-Frame-Index is of Type Type- |
| | Method-Input, then the Index-Start-Point is found in the Input-Field (11210 of FIG. 57) of the Method-Values. If the Type |
| | of the Method-Frame-Index is of Type Type-Method-Local, then the Index-Start-Point is found in the Local-Field (11250 of |
| | FIG. 57) of the Method-Values. Otherwise, if the Type of the Method-Frame-Index is of Type Type-Method-Output, then |
| | the Index-Start-Point is found in the Output-Field (11290 of FIG. 57) of the Method-Values. When the Psuedo-Stack is |
| | empty, the Post-Method-Drop-UPT found in the Post-Method-Drop-Field, is inserted onto the Psuedo-Stack and deleted |
| | from the Post-Method-Drop-Field. Once the Psuedo-Stack is empty, the Method-Call-Item that created the UPT-Method is |
| | deleted from the Current-Method-Call-List of the Object. This is accomplished with the Cursor-Identification that is found through the |
| | Spawned-Current-Method-Call-List-Field. |

| Child Location | Parameter Name | Description |
|---|---|---|
| 1 | Pseudo-Stack-Field | Contains the Pseudo-Stack that operates as the new stack. |
| 2 | Method-Values-Field | Contains the Method-Values (11200 of FIG. 57) that are used to locate specific |
| | | variable Value for the Method call |
| 3 | Object-Field | Contains the Object (11800 of FIG. 60) that holds all the global variable Values |
| | | for the Method call. |
| 4 | Static-Variable-Field | Contains the Index-Start-Point for all the Static-Variable-Values of the Class. |
| 5 | Spawned-Current-Method-Call-List-Field | Contains a Spawned-Cursor-Identification of the Current-Method-Call-List |
| | | (11840 of FIG. 60) of the Object that is pointing to the UPT-Method-Call-Item |
| | | that created this particular UPT-Method. |
| 6 | Post-Method-Drop-Field | Contains a sequence, is inserted onto the Psuedo-Stack, that holds all UPTs |
| | | required for returning values. |

UPT-Method-Call-Item

| | |
|---|---|
| Type | 058 |
| Description | The UPT-Method-Call-Item is used to create a method and results in a UPT-Method being inserted onto the stack. Before |
| | this happens, the UPT-Method-Call-Item ensures that the UPT-Method is not being processed in parallel with other methods |
| | that may cause conflicts. This enables a configurable mechanism to block method execution to prevent data corruption |
| | during parallel thread calls (see Appendix D for an overview of Object Orientated support). |
| Behaviour | The first step of the UPT-Method-Call-Item is to ensure that it will not run in parallel with another UPT-Method-Call-Item |
| | that has been configured against executing with an already executing method. This is accomplished by locating, and |
| | spawning, the Current-Method-Call-List of the Object (11800 of FIG. 60) in the Object-Field. The Spawned-Current- |
| | Method-Call-List is shifted to the Leftmost child and inserted into the Current-Method-Call-List-Spawn-Cursor-Field. As |
| | this UPT-Method-Call-Item may take several Digital-Business-Cycles to complete, the Spawned-Current-Method-Call-List |
| | is used to locate the UPT-Method-Call-Item that the processing UPT-Method-Call-Item is checking. |
| | The processing UPT-Method-Call-Item locates, and spawns the Parallel-Exclusion-List of the Method-Signature-Item of the |
| | UPT-Method-Call-Item that the Spawned-Current-Method-Call-List is pointing to. This Spawned-Parallel-Exclusion-List is |
| | shifted to the Leftmost child and inserted into the Current-Parallel-Exclusion-List-Spawn-Cursor-Field of the processing |
| | UPT-Method-Call-Item. The Parent-Identification of each Method-Signature-Item is compared to the Parent-Identification |
| | of the Method-Signature-Item of the processing UPT-Method-Call-Item. If a matching Method-Signature-Item is found then |
| | the processing UPT-Method-Call-Item must wait until the conflicting UPT-Method-Call-Item is complete. |
| | Certain implementations may choose to process the conflicting UPT-Method-Call-Item to speed up the process and not |
| | waste the Digital-Business-Cycle. Once all Method-Signature-Items have been checked then the Spawned-Parallel- |
| | Exclusion-List is deleted from the Current-Parallel-Exclusion-List-Spawn-Cursor-Field and the Spawned-Current-Method- |
| | Call-List is shifted to the Right. Once the Spawned-Current-Method-Call-List has checked each UPT-Method-Call-Item then |
| | a UPT-Method is created by: |
| | (1) Creating a new Pseudo-Stack and inserting the UPTs in the Utilised-Method-Stack-Drop-UPT-Field (11337 of FIG. |
| | 58) and the Method-Startup-UPT-Field onto the Pseudo-Stack in the Leftmost position. |
| | (2) Creating a new Method-Values-Field with new Index-Start-Points for the Input-Field, Local-Field and Output-Field. |
| | (3) Inserting the Object of the UPT-Method-Call-Item into the Object-Field. |
| | (4) Insert the processing UPT-Method-Call-Item into the Current-Method-Call-List using the Spawned-Current-Method- |
| | Call-List. The Spawned-Current-Method-Call-List is then inserted into the Spawned-Current-Method-Call-List-Field |
| | of the UPT-Method and the currently processing stack is inserted into the Stack-Field of the processing UPT- |
| | Method-Call-Item. |
| | (5) Inserting the Post-Method-Drop-UPT found in the Post-Method-Drop-Field of the UPT-Method-Call-Item into the |
| | Post-Method-Drop-Field of the UPT-Method. Finally the UPT-Method is inserted onto the Leftmost position of the stack and the UPT- |
| | Method-Call-Item is deleted from the stack. |

| Child Location | Parameter Name | Description |
|---|---|---|
| 1 | Post-Method-Drop-Field | Contains a UPT-Sequence that sets up UPTs to handle any returns from the |
| | | method. |
| 2 | Method-Signature-Item-Field | Contains a Method-Signature-Item to be compared with other Method- |
| | | Signature-Items of UPT-Method-Call-Items contained in the Current-Method- |
| | | Call-List of the Object. If this Field is empty, then the UPT carries on with the |
| | | next step. |
| 3 | Stack-Field | The stack that holds the UPT-Method-Call-Item is inserted into this Field. |
| 4 | Method-Startup-UPT-Field | Contains the contents of the Psuedo-Stack (11352 of FIG. 59) that is inserted |
| | | during the creation of the UPT-Method. If this Field is empty then a new Child |
| | | is inserted. |
| 5 | Utilised-Method-Stack-Drop-UPT-Field- | The Value contains another Field that holds the Utilised-Method-Stack-Drop- |
| | Field | UPT that is inserted onto the Psuedo-Stack. This Field may be empty. |
| 6 | Static-Variables-Field | Contains the Index-Start-Point through which all the Static-Variables can be |
| | | located. |
| 7 | Object-Field | Contains the Object to which the UPT-Method-Call-Item refers If this Field is |
| | | empty then the UPT-Method-Call-Item is deleted from the stack. |
| 8 | Current-Method-Call-List-Spawn- | A spawned Cursor-Identification of the Current-Method-Call-List of the Object |
| | Cursor-Field | is inserted into this Field and is used to locate the UPT-Method-Call-Item that |
| | | the processing UPT-Method-Call-Item is currently checking to verify if it can |
| | | run in parallel. This Spawned-Cursor-Identification will eventually be used to |
| | | insert the currently processing UPT-Method-Call-Item into the Method-Call- |
| | | List. |
| 9 | Current-Parallel-Exclusion-List-Spawn- | A spawned Cursor-Identification of the Parallel-Exclusion-List located in the |
| | Cursor-Field | Method-Signature-Item of the UPT-Method-Call-Item that the Spawned-Cursor- |
| | | Identification contained in the Current-Method-Call-List-Spawn-Cursor-Field is |
| | | currently pointing to. |

UPT-Monitor-Generator

| | |
|---|---|
| Type | 042 |
| Description | The UPT-Monitor-Generator is created by the Kernel-Image (see Appendix G). The UPT-Monitor searches for Monitors |
| | that require triggering caused by a single KI-Interface method call. The UPT-Monitor-Generator consists of a MG-Capture- |
| | Field that holds a list of MG-Capture-Instances, and a MG-Monitor-Event. Each MG-Capture-Instance contains up to 4 |
| | Parameter-Fields depending on the Type of Monitor. These Parameter-Fields hold the Parameters for the matching |
| | Monitors. The MG-Capture-Instances represent all the state information, both prior to and post execution, for each event that |
| | occurs throughout the execution of the KI-Interface method call. |
| Behaviour | When the UPT-Monitor-Generator is executed, it steps through the MG-Capture-List, found in the MG-Capture-Field, |
| | retrieving each MG-Capture-Instance and locating all matching Monitors found in the MG-Monitor-Events. Each MG- |
| | Capture-Instance has a Type that is identical to the Type of the matching Monitors that are to be triggered. For each MG- |
| | Capture-Instance one of six possible Monitor-Events is searched: |
| | (1) Monitors triggered through changes made to the Parent-Identification of the Cursor-Identification passed through to |
| | the KI-Interface are found in the PI-Monitor-Event in the Parent-Monitor-Field. These Monitors include all |
| | Monitors with a Type of PI-Monitor. |
| | (2) Monitors triggered through changes made to the Child-Identification passed through to the KI-Interface that the |
| | Cursor-Identification was pointing to before the changes were made are found in the CHI-Monitor-Event in the |
| | Current-Child-Monitor-Field. These Monitors include: |
| | a. CHI-Monitor-Child-Delete |
| | b. CHI-Monitor-Cursor-Identification-Shifted-Off-Child |
| | c. CHI-Monitor-No-Cursor-Identification |
| | d. CHI-Monitor-Number-Sharing-Cursor-Identifications-Queried. |
| | (3) Monitors triggered through changes made to the Child-Identification to the Left of the Child-Identification that the |
| | Cursor-Identification that was passed through to the KI-Interface was pointing to before the changes were made, are |
| | found in the CHI-Monitor-Event in the Left-Child-Monitor-Field. These Monitors include: |
| | a. CHI-Monitor-Child-Terminate-Right |
| | b. CHI-Monitor-Child-Links-Right |
| | c. CHI-Monitor-Child-Inserts-Right |
| | d. CHI-Monitor-Child-Deletes-Right. |
| | (4) Monitors triggered through changes made to the Child-Identification to the Right of the Child-Identification that the |
| | Cursor-Identification was pointing to before the changes were made, are found in the CHI-Monitor-Event in the |
| | Right-Child-Monitor-Field. These Monitors include: |
| | a. CHI-Monitor-Child-Terminate-Left |
| | b. CHI-Monitor-Child-Links-Left |
| | c. CHI-Monitor-Child-Inserts-Left |
| | d. CHI-Monitor-Child-Deletes-Left. |
| | (5) Monitors triggered through the Cursor-Identification that was passed through to the KI-Interface shifting to a new |
| | Child, are found in the CHI-Monitor-Event in the New-Child-Monitor-Field. These Monitors all have a Type of |
| | CHI-Monitor-Cursor-Identification-Shifted-Onto-Child. |
| | (6) Monitors triggered through changes made to the Cursor-Identification that was passed through to the KI-Interface are |
| | found in the CUI-Monitor-Event in the Cursor-Monitor-Field. These Monitors include: |
| | a. CUI-Monitor-Cursor-At-Boundary |
| | b. CUI-Monitor-Cursor-At-Leftmost |
| | c. CUI-Monitor-Cursor-At-Rightmost |
| | d. CUI-Monitor-Cursor-Retrieved |
| | e. CUI-Monitor-Index-Queried. |
| | If the relevant Monitor-Event-Field is empty or there is no matching Monitor inside the Monitor-Event, then the MG- |
| | Capture-Instance is ignored and the next MG-Capture-Instance is retrieved. Once a Monitor has been located it is triggered |
| | as outlined below and the UPT-Monitor-Generator will then continue searching the Monitor-Event until all matching |
| | Monitors have been located. |
| | How a Monitor is triggered depends on whether the Monitor was constructcd by an Emulator-Component or a Digital- |
| | Business. This is ascertained in the following manner: |
| | (1) If the Type of the ET-Instance, located inside the Event-Target of the Monitor, is of Type-Emulator-Component then |
| | the Monitor was created by an Emulator-Component. The Float value of the ET-Instance is used to determine the |
| | source Emulator-Component that is waiting on this event and 64-Bit Whole, attached to the ET-Instance, and the |
| | MG-Capture-Instance are transmitted to the Emulator-Component via the KI-Broadcast method call (see Appendix |
| | G). The following values are mapped directly to Emulator-Components: |
| | (1.0) Asynchronous-Duplicator |
| | (2.0) Kernel-Image |
| | (3.0) Environment-Manager |
| | (4.0) UPT-Cycler |
| | (5.0) Partner-Channel-Manager |
| | (6.0) Plugin-Manager |
| | (7.0) ABS-Bus |
| | (8.0) Slow-ABS |
| | (9.0) Fast-ABS |
| | (10.0) Asynchronous-Virtual-Machine |
| | (11.0) AVM-Compiler |
| | (12.0) Human-Communication-Manager. |
| | (2) A Monitor created by a Digital-Business contains a Thread-Instance as the ET-Instance inside the Event-Target. |
| | Located in the DB-Event of the Monitor are the DE-Realtime-Event-Field, DE-Prepaid-Event-Field, DE-Standby- |
| | Event-Field, DE-Idle-Event-Field and the DE-Background-Event-Field. Each of these Event-Fields holds a UPT that |
| | is to be inserted onto the corresponding Stack inside the Thread-Instance. These UPTs must be able to access the |
| | Event-Parameters. Since the Monitor may be processed in parallel, a UPT-Monitor-Sequence is constructed for each |
| | UPT when the Monitor is triggered and inserted onto the appropriate stack. The UPT is inserted onto the Pseudo- |
| | Stack of the UPT-Monitor-Sequence and the matching MG-Capture-Instance is inserted into the Event-Parameters- |
| | List of the Monitor, in the Rightmost position using the KI-Insert-And-Spawn method call. The resulting spawned |
| | Event-Parameters-List is inserted into the Event-Parameters-Field of the UPT-Monitor-Sequence. The UPT- |
| | Monitor-Sequence is finally inserted onto the corresponding stack in the Thread-Instance, in the Leftmost or |
| | Rightmost position as identified via the Type of the Polarity-Field Value in the Monitor. See UPT-Monitor-Sequence for how this UPT- |
| | Monitor-Sequence is subsequently processed. |

| Child Location | Parameter Name | Description |
|---|---|---|
| 1 | MG-Capture-Field | Contains a list of MG-Capture-Instances that captures all relevant state |
| | | information to process the UPT-Monitor. Each of these MG-Capture-Instances |
| | | has a type that matches the Monitor that it is to search for and trigger. |
| 2 | MG-Monitor-Events | Contains 6 Monitor-Event-Fields that each hold a Monitor-Event. The Monitor- |
| | | Event is checked to see if it contains a monitor that matches an event contained |
| | | within the MG-Capture-Field. These Monitor-Event-Fields may be empty. |

UPT-Monitor-Sequence

| | |
|---|---|
| Type | 055 |
| Description | The UPT-Monitor-Sequence operates as a Pseudo-Stack (11352 of FIG. 59) in order to keep track of all UPTs associated |
| | with a Monitor that has been triggered. The UPT-Monitor-Sequence is created as a result of a Monitor being triggered |
| | through a UPT-Monitor-Generator. As each Monitor may be triggered more than once at the same time, each resulting UPT- |
| | Monitor-Sequence holds a reference to the correct set of Event-Parameters that originally triggered the Monitor. |
| Behaviour | The UPT-Monitor-Sequence processes one a single UPT held in the Pseudo-Stack, found in the Pseudo-Stack-Field, each |
| | time the UPT-Monitor-Sequence is processed. This continues until the Pseudo-Stack is empty, in which case the UPT- |
| | Monitor-Sequence is deleted. If any UPT-Get-Event-Parameters are found while processing the UPT-Monitor-Sequence |
| | then the Event-Parameters are returned. The Event-Parameters are located via the Cursor-Identification of the Event-Parameters-Field. |

| Child Location | Parameter Name | Description |
|---|---|---|
| 1 | Pseudo-Stack-Field | The Value is treated as a normal stack and holds UPTs that are waiting to be |
| | | executed. |
| 2 | Event-Parameters-Field | The Value holds a spawned Cursor of the Event-Parameters-List in the Monitor. |
| | | The spawned Cursor is pointing to the correct set of Event-Parameters related to |
| | | this particular UPT-Monitor-Sequence |

UPT-New-Child

| | |
|---|---|
| Type | 021 |
| Description | The UPT-New-Child engages the KI-New-Child KI-Interface (see Appendix G) method. |
| Behaviour | The UPT-New-Child will creates a new Child in the Parent held in the Target-Field in the position specified by the type of |
| | the Trilarity-Field Value and the Type of the Lock-Mode-Field Value. The Type of the newly created Child is the same as |
| | the Type of the Type-Field Value. The newly created Child is inserted into the New-Child-Field in the Neutral position with the Cursor |
| | of the New-Child-Field locked. |

| Child Location | Parameter Name | Description |
|---|---|---|
| 1 | Type-Field | The Value identifies the Type for the new Child using Type-Resolution. |
| 2 | Target-Field | Contains the Cursor-Identification that identifies the Parent that the new Child is |
| | | inserted into. |
| 3 | Trilarity-Field | The Value determines the Action-Trilarity-Resolution. |
| 4 | Lock-Mode-Field | The Value determines how the Child is inserted using Lock-Mode-Resolution. |
| 5 | New-Child-Field | Contains the newly created Child inserted into the Neutral position |

UPT-Not

| | |
|---|---|
| Type | 005 |
| Description | The UPT-Not performs a logical NOT on a single Child found in the Logic-List-Field Value and replaces it with the result |
| Behaviour | The UPT-Not retrieves the Leftmost Child of the Logic-List contained in the Logic-List-Field. if the Type of the retrieved |
| | Child is Type-False then the UPT-Not will insert a new Child into the list in the Neutral position with a Type of Type-True. |
| | Otherwise, if the Type of the retrieved Child is Type-True then the UPT-Not will insert a new Child into the Logic-List in |
| | the Neutral position with a Type of Type-False. The new Child is inserted into the Logic-List in the Neutral position to effectively replace |
| | the old Leftmost Child. |

| Child Location | Parameter Name | Description |
|---|---|---|
| 1 | Logic-List-Field | Contains a list that holds the input and output parameters by using Boolean- |
| | | Resolution. |

UPT-Or

| | |
|---|---|
| Type | 002 |
| Description | The UPT-Or performs a logical Or on the two Leftmost UPTs found in the Logic-List-Field and replaces them with a single boolean result. |
| Behaviour | The UPT-Or retrieves the Type of the Leftmost Child of the Logic-List contained in the Logic-List-Field and the Type of the Child to |
| | the Right of the Leftmost Child. These two Children are both removed from the list. The two Types are either Type-True or Type-False. |
| | If either or both of these two Types are of Type-True then a new Child is inserted into the Leftmost position of the Logic-List with its |
| | Type set to Type-True. Otherwise, if both of the Types are of Type-False then a new Child is inserted into the Leftmost position of |
| | the Logic-List with its Type set to Type-False. |

| Child Location | Parameter Name | Description |
|---|---|---|
| 1 | Logic-List-Field | Contains a Logic-List that will hold the input and output parameters by using Boolean-Resolution. |

UPT-Recursive-Copy

| | |
|---|---|
| Type | 013 |
| Description | The UPT-Recursive-Copy reproduces an entire Child including all its recursive Children. |
| Behaviour | The UPT-Recursive-Copy will call the Asynchronous-Duplicator, which makes a complete copy of the Source-Field Value. All copied |
| | Cursors are in the same positions as the original and primitives are preserved. No Monitors are copied. The copied Child is inserted as the |
| | Target-Field Value, in the position specified by the Action-Trilarity-Field Value, with the Cursor-Identification either locked in its current |
| | position or shifted to the newly copied Child depending on the Type of the Lock-Mode-Field Value. |

| Child Location | Parameter Name | Description |
|---|---|---|
| 1 | Source-Field | Contains the Child that is copied. |
| 2 | Target-Field | Contains the Cursor-Identification that identifies the Parent that the newly copied Child is inserted into. |
| 3 | Action-Trilarity-Field | The Value determines the action trilarity using the Action-Trilarity-Resolution. |
| 4 | Lock-Mode-Field | The Value determines the lock mode using Lock-Mode-Resolution. |

UPT-Recursive-Delete

| | |
|---|---|
| Type | 009 |
| Description | The UPT-Recursive-Delete deletes all the Children of the Source-Field Value and their respective Children recursively. |
| Behaviour | This UPT-Recursive-Delete may not be able to be completed within one Digital-Business cycle and therefore must keep track of the Child |
| | that was last processed. The UPT-Recursive-Delete remains on the stack until there are no more Children contained in any Manabars-Set |
| | that may have contained at any level of scope by the Source-Field Value. |

| Child Location | Parameter Name | Description |
|---|---|---|
| 1 | Source-Field | Contains the Children that are to be deleted recursively. |

UPT-Reference-Comparison

| | |
|---|---|
| Type | 006 |
| Description | The UPT-Reference-Comparison compares a Logic-List of Children to verify if they are the same set by reference. |
| Behaviour | The UPT-Reference-Comparison retrieves the Leftmost Child of the Comparison-List, which is contained in the Comparison-List-Field by |
| | shifting the Cursor to the Leftmost position. The UPT-Reference-Comparison then iteratively shifts the Cursor of the Comparison-List to |
| | the Right, retrieves the next Child and compares it to the first Child. If the two Children are the same then the process will carry on, |
| | otherwise a new Child with its Type set to Type-False is inserted into the Leftmost position of the Logic-List contained in the Logic-List- |
| | Field and the process is halted. The UPT may take multiple Digital-Business-Cycle attempts to complete the UPT. If all of the Children in |
| | the Comparison-List are indeed the same Child, then a new Child with its Type set to Type-True is inserted into the Leftmost position of |
| | the Logic-List. The Children are compared using the Parent-Identification of the Manabars-Set as the Children may be referenced using a |
| | spawned Cursor. If the two Children have the same Parent-Identification then they are the same Manabars-Set. |

| Child Location | Parameter Name | Description |
|---|---|---|
| 1 | Comparison-List-Field | Contains a list of Children to be compared to each other. |
| 2 | Logic-List-Field | Awaits the result of the comparison which is of Type Type-True or Type-False. The result is inserted |
| | | into the Leftmost position of the Logic-List. |

UPT-Remove-Monitor

| | |
|---|---|
| Type | 046 |
| Description | The UPT-Remove-Monitor engages the KI-Remove-Monitor KI-Interface (see Appendix G) method. |
| Behaviour | The UPT-Remove-Monitor uses the Key-Field Value to locate the required Monitor and delete it from the Monitor-Event. |

| Child Location | Parameter Name | Description |
|---|---|---|
| 1 | Key-Field | Contains the key to locate the Monitor to be deleted. |

UPT-Sequence

| | |
|---|---|
| Type | 025 |
| Description | The UPT-Sequence is inserted into a UPT-Super-Sequence, which allows the UPT-Sequence to be processed as a pseudo stack, with the |
| | exception that the UPTs contained in the UPT-Sequence are not deleted as they are on a normal pseudo stack. |
| Behaviour | The UPT-Sequence spawns its own Cursor-Identification and shifts that Spawned-Cursor to the Leftmost boundary. A new UPT-Super- |
| | Sequence is created with the Spawned-Cursor inserted into the Pseudo-Stack-Field of the UPT-Super-Sequence. The UPT-Super-Sequence |
| | is then inserted onto the same stack that holds the UPT-Sequence while the UPT-Sequence is removed. |

| Child Location | Parameter Name | Description |
|---|---|---|
| 1 | NA | Immediate UPT to execute |
| 2 | NA | Next UPT to execute |
| N | NA | Last UPT to execute |

UPT-Shift-Cursor

| | |
|---|---|
| Type | 022 |
| Description | The UPT-Shift-Cursor engages the KI-Shift-Cursor KI-Interface (see Appendix G) method. |
| Behaviour | This UPT-Shift-Cursor shifts the Cursor-Identification of the Source-Field Value in the direction specified by the Type of the Polarity- |
| | Field Value. |

| Child Location | Parameter Name | Description |
|---|---|---|
| 1 | Source-Field | Contains the Cursor-Identification that is shifted. |
| 2 | Polarity-Field | The Value determines if the Cursor-Identification is shifted to the Left or Right via Action-Polarity-Resolution. |

UPT-Shift-Cursor-To-Boundary

| | |
|---|---|
| Type | 023 |
| Description | The UPT-Shift-Cursor-To-Boundary engages the KI-Shift-Cursor-To-Boundary KI-Interface (see Appendix G) method. |
| Behaviour | The UPT-Shift-Cursor-To-Boundary shifts the Cursor-Identification of the Source-Field Value to the boundary, in the direction specified |
| | by the Type of the Polarity-Field Value. |

| Child Location | Parameter Name | Description |
|---|---|---|
| 1 | Source-Field | Contains the Cursor-Identification that is shifted to the boundary. |
| 2 | Polarity-Field | Determines if the Child is shifted to the Leftmost or Rightmost boundary via the Action-Polarity-Resolution. |

UPT-Start

| | |
|---|---|
| Type | 029 |
| Description | The UPT-Start indicates to the corresponding UPT-Stop to delete itself thereby continuing normal processing of the stack. |
| Behaviour | The UPT-Start must have a corresponding UPT-Stop that holds the same Manabars-Set as the Child of the Corresponding-Stop-Field. |
| | When the UPT-Start is processed, the Type of the Child of the Corresponding-Stop-Field is set to Type-True before the UPT-Start is |
| | deleted from the stack. This indicates to the UPT-Stop to delete itself from the stack thereby continuing processing further UPTs on the |
| | stack as normal. |

| Child Location | Parameter Name | Description |
|---|---|---|
| 1 | Corresponding-Stop-Field | The Value has a Type of either Type-True or Type-False and is the same Manabars-Set as the one |
| | | contained in the Corresponding-Start-Field of the corresponding UPT-Stop. |

UPT-Stop

| | |
|---|---|
| Type | 030 |
| Description | The UPT-Stop will pause the execution of any UPTs situated to the Right of the UPT-Stop on the Stack. |
| Behaviour | The UPT-Stop must have a corresponding UPT-Start that holds the same Manabars-Set as the Child of the Corresponding-Start-Field. If |
| | this Child has a Type of Type-True it means that the corresponding UPT-Start has been processed and the UPT-Stop is deleted from the |
| | stack, thereby allowing the next UPT to be processed. Otherwise, if the Child of the Corresponding-Start-Field has a Type of Type-False, |
| | then the stack blocks any processing until the UPT-Stop is deleted. |

| Child Location | Parameter Name | Description |
|---|---|---|
| 1 | Corresponding-Start-Field | The Child of this Field will have a Type of either Type-True or Type-False and is the same Manabars-Set |
| | | as the one contained in the Corresponding-Stop-Field of the corresponding UPT-Start. |

UPT-Spawn-Cursor-Identification

| | |
|---|---|
| Type | 024 |
| Description | The UPT-Spawn-Cursor-Identification engages the KI-Spawn-Cursor-Identification KI-Interface(see Appendix G) method. |
| Behaviour | This UPT-Spawn-Cursor-Identification retrieves the Cursor-Identification contained in the Source-Field, spawns the Cursor-Identification |
| | then inserts the spawned Cursor-Identification into the Target-Field in the position specified by the Types of the Trilarity-Field Value and |
| | the Lock-Mode-Field Value. |

| Child Location | Parameter Name | Description |
|---|---|---|
| 1 | Source-Field | Contains the Cursor-Identification that is spawned and for which a new reference is created. |
| 2 | Target-Field | The Child that contains the newly spawned Cursor-Identification. |
| 3 | Trilarity-Field | The Value determines if the Child is inserted into the Left, Right or Neutral position using Action-Trilarity- |
| | | Resolution. |
| 4 | Lock-Mode-Field | The value determines how the Child is inserted using Lock-Mode-Resolution. |

UPT-Super-Sequence

| | |
|---|---|
| Type | 063 |
| Description | The UPT-Super-Sequence operates as a psuedo stack with the exception that the UPTs are not deleted. |
| Behaviour | The UPT-Super-Seqeunce locates the spawned Cursor of the UPT-Sequence contained in the Pseudo-Stack-Field. The spawned Cursor is |
| | pointing to the UPT that currently needs to be executed. As this UPT may take several Digital-Business-Cycles to complete it may break |
| | out at any stage. The spawned Cursor tracks the UPT-Super-Sequence progress. All UPTs contained in the UPT-Sequence are processed |
| | normally, with the exception that they are not deleted from the UPT-Sequence when completed. Instead, the spawned Cursor will be |
| | shifted to the Right. Only when the spawned Cursor reaches the Rightmost boundary, is the UPT-Super-Sequence deleted from the stack. |
| | Several UPTs are affected by the UPT-Super-Sequence and exhibit altered behaviour: |
| | (1) UPT-If: Instead of inserting the located True or False UPT-Sequences they are inserted to the Left of the Cursor of the stack that |
| | holds the UPT-Super-Sequence. |
| | (2) Any UPTs that need to be inserted onto a stack will be inserted to the Left of the UPT-Super-Sequence with the Cursor of the stack |
| | locked onto the UPT-Super-Sequence. |

| Child Location | Parameter Name | Description |
|---|---|---|
| 1 | Pseudo-Stack-Field | Contains the UPT-Sequence that created the UPT-Super-Sequence. |

UPT-This-Object

| | |
|---|---|
| Type | 060 |
| Description | The UPT-This-Object locates the Object (11800 of FIG. 60) contained in a UPT-Method. The retrieved Object can then be used to locate |
| | global information related to the UPT-Method that called the UPT-This-Object. |
| Behaviour | The UPT-This-Object is only able to operate if it resides in the Pseudo-Stack (11352 of FIG. 59) of a UPT-Method. The UPT-This-Object |
| | shifts the Cursor of the UPT-Method to the Object-Field and retrieves the Object-Field Value. The retrieved Object is inserted into the |
| | Target-Field in the Neutral position. If there is no Object contained in the Object-Field then the Target-Field of this UPT-This-Object will |
| | remain empty. |

| Child Location | Parameter Name | Description |
|---|---|---|
| 1 | Target-Field | The Value is the Object for which the current method was called from. The Object is inserted into the Neutral |
| | | position. |

UPT-This-Stack

| | |
|---|---|
| Type | 044 |
| Description | The UPT-This-Stack locates the stack that is currently being processed, and then returns the spawned Cursor-Identification of the stack, so |
| | as to prevent the reference from disrupting execution if the Cursor is moved. |
| Behaviour | This UPT-This-Stack retrieves and spawns the Cursor-Identification of the stack that the UPT-This-Stack is being executed on, from the |
| | Item-Processor. The newly spawned Cursor-Identification is then inserted into the Target-Field in the Neutral position. |

| Child Location | Parameter Name | Description |
|---|---|---|
| 1 | Target-Field | The Value holds the spawned reference to the stack and is inserted into the Neutral position. |

UPT-This-Thread

| | |
|---|---|
| Type | 047 |
| Description | The UPT-This-Thread locates the Thread-Instance (10600 of FIG. 54) that holds the stack that is currently being processed, and then |
| | returns the spawned Cursor-Identification of the Thread-Instance. |
| Behaviour | The UPT-This-Thread retrieves and spawns the Cursor-Identification of the Thread-Instance that the UPT-This-Thread is being executed |
| | by the Item-Processor. The newly spawned Cursor-Identification is then inserted into the Target-Field in the Neutral position. |

| Child Location | Parameter Name | Description |
|---|---|---|
| 1 | Target-Field | The Value that will hold the spawned reference to the Thread-Instance and is inserted into the Neutral position. |

UPT-Try-Sequence

| | |
|---|---|
| Type | 67 |
| Description | The UPT-Try-Sequence is used as Object-Orientated support to catch errors where it aborts execution of a certain sequence if an exception |
| | is thrown. |
| Behaviour | The UPT-Try-Sequence may not be able to be completed within one Digital-Business-Cycle. If the Psuedo-Stack located inside the |
| | Pseudo-Stack-Field is empty, it indicates that this is the first time the Item-Processor has located the UPT-Try-Sequence. In this case, |
| | the UPT-Sequence contained in the Try-Field is inserted onto the Pseudo-Stack. If there are already UPTs on the Pseudo-Stack, then the |
| | UPT-Try-Sequence attempts to process the Pseudo-Stack as a normal stack. If an exception is thrown during the processing of the UPT, |
| | then a Child is inserted into the Error-Field with the Type identifying the error status and the Pseudo-Stack has its Children deleted. |
| | The UPT-Sequence contained in the Catch-Field is then inserted onto the Pseudo-Stack and processing continues. Once the Pseudo-Stack |
| | is empty the UPT-Try-Sequence is removed from the stack. |

| Child Location | Parameter Name | Description |
|---|---|---|
| 1 | Pseudo-Stack-Field | The Value is the Pseudo-Stack to be processed. |
| 2 | Try-Field | The Value is a UPT-Sequence that is to be inserted onto the Pseudo-Stack. |
| 3 | Catch-Field | The Value is a UPT-Sequence that is to be inserted onto the Pseudo-Stack in the event an exception is |
| | | thrown during processing of the UPT-Sequence held in the Try-Field. |
| 4 | Error-Field | The Type identifies the error status |

UPT-Unentangle

| | |
|---|---|
| Type | 031 |
| Description | The UPT-Unentangle is used to remove an entangled reference to a particular Cursor-Identification. |
| Behaviour | The Asynchronous-Duplicator maintains a hashtable that keeps references of all entangled Cursor-Identifications associated with certain |
| | hashtable keys. This UPT-Unentangle retrieves the hashtable that matches the key in the Key-Field. The UPT-Unentangle locates the |
| | Cursor-Identification that is entangled with the Parent-Identification of the source contained in the Source-Field. The UPT-Unentangle then |
| | removes the entry whose hashtable key matches the Parent-Identification of the aource, and the entry whose hashtable key matches the |
| | Parent-Identification of the retrieved Cursor-Identification from the retrieved hashtable. |

| Child Location | Parameter Name | Description |
|---|---|---|
| 1 | Key-Field | Contains the key that is used to locate the entangled Cursor-Identification. |
| 2 | Source-Field | Contains the source, which is the Cursor-Identification that is to be unentangled. |

UPT-Unmap

| | |
|---|---|
| Type | 050 |
| Description | The UPT-Unmap is used to remove a mapped reference to a particular Cursor-Identification from the hashtable contained in the Partner- |
| | Channel-Manager. |
| Behaviour | The Partner-Channel-Manager maintains a hashtable that keeps references of all mapped sets associated with certain hashtable keys. |
| | The UPT-Unmap retrieves the hashtable that matches the key in the Key-Field. The UPT-Unmap locates the unique hashtable key that is |
| | associated with the Parent-Identification of the Cursor-Identification that is contained in the Source-Field. The UPT-Unmap then removes |
| | both entries in the hashtable that contains the Parent-Identification and the unique hashtable key. Finally, the UPT-Unmap sends the |
| | hashtable key to the Partner-Channel-Manager that informs the Node partner (12010a, 12010b, 12010n of FIG. 61) of the unmapping by |
| | way of the PCM-Interface (130125 of FIG. 66). |

| Child Location | Parameter Name | Description |
|---|---|---|
| 1 | Key-Field | Contains the key that is used to locate all mapped sets that are associated with the hashtable key. |
| 2 | Source-Field | Contains the source, which is the Cursor-Identification whose Parent-Identification is to be unmapped. |

UPT-Xor

| | |
|---|---|
| Type | 003 |
| Description | The UPT-Xor performs a logical Xor on the two Leftmost-UPTs found in the Logic-List and replaces them with the result. |
| Behaviour | The UPT-Xor retrieves the Type of the Leftmost Child of the Logic-List contained in the Logic-List-Field and the Type of the Child to the |
| | Right of the Leftmost Child. These two Children are both removed from the Logic-List. The two Types are either Type-True or Type- |
| | False. If both of these Types are the same, either Type-True or Type-False, then a new Child is inserted into the Leftmost position of the |
| | Logic-List with its Type set to Type-False. Otherwise, if one Type is Type-True and the other Type is Type-False then a new Child is |
| | inserted into the Leftmost position of the Logic-List with its Type set to Type-True. |

| Child Location | Parameter Name | Description |
|---|---|---|
| 1 | Logic-List-Field | The Value is the Logic-List and contains the input and output parameters for another algorithm. |

Field: A Child in a UPT.
Value: The Child located by the Cursor within a Field. All Fields ending in-Field actually include an additional Child known as a Value. This extra Child is not represented on the tables.
Number-Resolution: A Field requiring a number. The Value may contain none, one or two values. If no numbers are attached to the Value, then the number is zero. If there is only a Float or Whole, then that number is used. If there is both a Whole and Float, then the highest resolution in the number system is achieved by overlaying their symmetric spectrums.
Action-Polarity-Resolution: A Field that requires an Action-Polarity. If there is no Value in the Field or the Value that is present is not of Type Type-Left or Type-Right then the Action-Polarity is Left. Otherwise the Action-Polarity is specified by the Value where Type-Left is Left and Type-Right is Right.
Action-Trilarity-Resolution: A Field that requires Action-Trilarity. If there is no Value in the Field or the Value that is present is not of Type Type-Left, Type-Right or Type-Neutral then the Action-Trilarity is Neutral. Otherwise the Type is specified by the Value where Type-Left is Left, Type-Right is Right and Type-Neutral is Neutral.
Lock-Mode-Resolution: A Field that requires Lock-Mode. If there is no Value or the Value that is present is not of Type Type-Lock or Type-Unlock then the Lock-Mode is locked. Otherwise the Type is specified by the Value where Type-Lock is locked and Type-Unlock is unlocked.
Boolean-Resolution: A Child within a Value that is expected to be a Boolean value. If the Value is not of Type Type-True or Type-False then the Boolean value is True. Otherwise the Type is specified by the Type of the Value where Type-True is true and Type-False is false.
Type-Resolution: A Field that requires a Type. If there is no Value in the Field or the Value does not contain a Whole, then the Type is zero; otherwise the Type is specified by the Whole of the Child currently selected.
Primitives: Data that is attached to a Manabars-Set and includes a Whole, Float, Fast-ABS, Slow-ABS and Type.
Logic List: A series of Boolean Primitives that are evaluated by logic operators such as UPT-And.
Spawn: A process where a new Cursor is created for a Manabars-Set with the KI-Insert-And-Spawn KI-Interface method call. See Appendix G. The new Cursor will access the same Children as the original Cursor but is free to move independently of it.
Method-Frame-Indexing: An implementation specific mechanism for encoding variables that can be accessed with an index but is contained within a single Manabars-Set. Method-Frame-Indexing is used heavily during Object Orientated support to enable independent method-frames to access their own variables.
Digital-Business Locking/Unlocking: UPTs that take more than one Digital-Business cycle to process the UPT are responsible for locking the Digital-Business by setting the Value of the Activity-Status-Field (9440 of FIG. 48) to Type-Lock to lock it and Type-Unlock to unlock it.

Appendix C—Interface-Definitions

Interface-Definitions define the communication between two components. The Interface-Definition is asymmetric as the behaviour is different for both components. For example, the telephone answering protocol requires that the person who dialed the number waits for the receiver to say ‘hello’ first before the conversation can begin. Only one party dials while the other says ‘hello’.

All Interface-Definitions are drawn diagrammatically as a single line that connects two components. The asymmetry of the protocol is indicated by assigning a (+) and a (−) to identify the polarity of the protocol. When the Interface-Definition is defined, only the (+) need be articulated, as the (−) can be deduced. In the telephone example, the caller could be assigned the (+) polar definition and the receiver the (−) polar definition. In documenting the (+) Interface-Definition, the caller would:
1) Dial the number.
2) Await call to be answered.
3) Await ‘hello’.
4) Begin conversation

The deduced (−) Interface-Definition that does not require documenting involves the following implied steps:
1) Answer the phone.
2) Say ‘hello’.
3) Await start of the conversation.
   Appendix D—Object Orientation

The III-Emulator (551 of FIG. 3, 751 of FIG. 4, 951 of FIG. 5, 1151 of FIG. 6, 1351 of FIG. 7, 1551 of FIG. 8 and 17001 of FIG. 74) provides support for Object Orientation with a number of UPTs. Set Theory specifically prevents access of information out of scope, so certain functions that rely on shared code would otherwise be impossible to perform without this specialised support.

UPT-Method-Call-Item

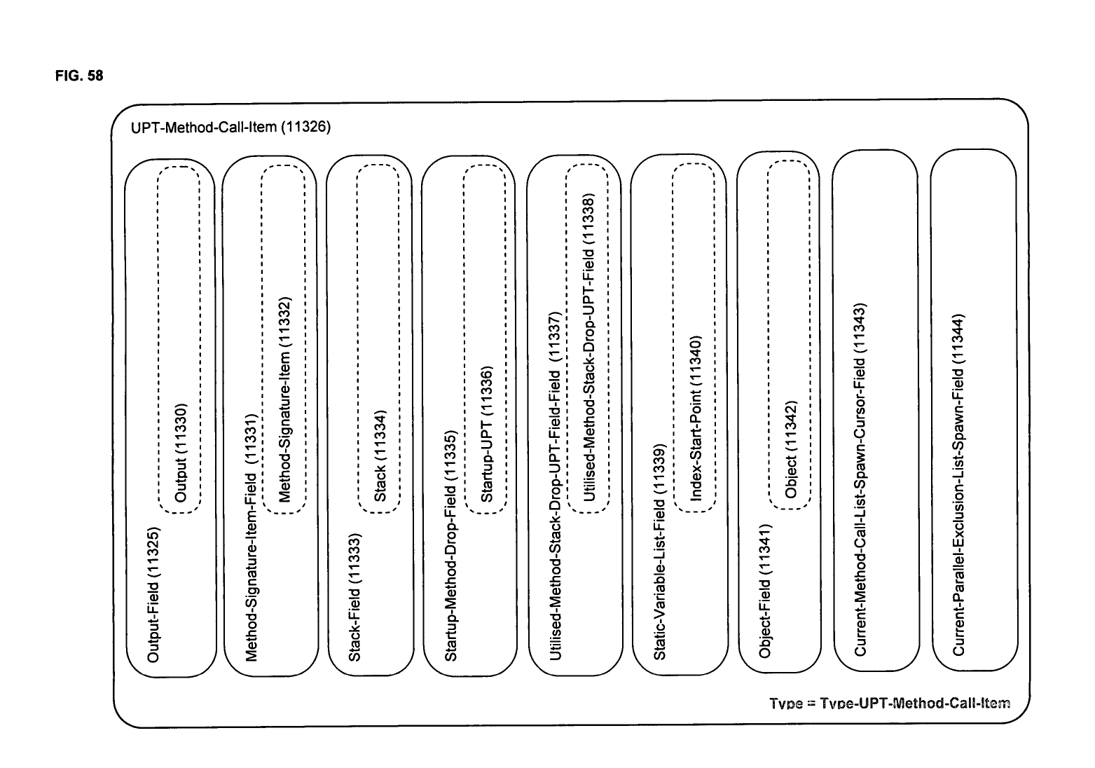

The UPT-Method-Call-Item (11326 of FIG. 58) is used by an Object Orientated compiler to call a new method. The UPT-Method-Call-Item is a record of the method before its birth to after its termination. The UPT-Method-Call-Item is stored inside the Object (11800 of FIG. 60) as a record of every method call (11830 of FIG. 60) as well as for all current method calls (11845 of FIG. 60). The UPT-Method-Call-Item doubles as an active UPT that is recognised directly by the UPT-Cycler hardware to maintain the Data Segment (DS) and Code Segment (CS) separation. Some compilers may not utilise the Historic-Method-Call-List (11825 of FIG. 60) during release builds in order to aid memory management to allow the garbage collector to remove these completed method frames. However, this stack trace is invaluable during debugging.

When the UPT-Cycler encounters a UPT-Method-Call-Item on either the stack or the Pseudo-Stack of a UPT-Method, it attempts to create a new method frame through the establishment of a new UPT-Method. However, before the UPT-Method can be created, the UPT-Cycler first checks if the new method may execute in parallel with the other methods already executing. Methods can be tagged to prevent them from executing in parallel with other methods that have specific signatures. This enables software to control access to data fields inside a class and prevents data corruption through parallel access. The process of checking the execution status may take several Digital-Business-Cycles. At each point, if execution cannot take place, then the UPT-Cycler may execute another method that is allowed to run.

Launch Checking

In order to check that the method can execute, the UPT-Cycler retrieves the Object (11800 of FIG. 60) from the Object-Field of the UPT-Method-Call-Item (see Appendix B and 11341 of FIG. 58). Once the Object is located, the Cursor of the Current-Method-Calls-List (11840 of FIG. 60) of the Current-Method-Calls-List-Field (11835 of FIG. 60) is spawned. By producing a new spawned Cursor-Identification for this transaction, it prevents data corruption across independent method frames. The UPT-Method-Call-Item may span multiple Digital-Business-Cycles so a unique Cursor prevents competing UPT-Method-Call-Items corrupting the current location. This spawned Cursor is inserted into the Current-Method-Call-List-Spawn-Cursor-Field (11359 of FIG. 59) of the UPT-Method (11350 of FIG. 59). The Cursor is shifted to the Leftmost position, prior to the searching of conflicting method frames.

Once the spawned Cursor is in the Leftmost position, the UPT-Cycler can begin checking each UPT-Method-Call-Item in the Child of the Current-Method-Call-List-Spawn-Cursor-Field. For each Method-Call-Item encountered, the UPT-Cycler scans the Method-Signature-Item-Field to retrieve the Method-Signature-Item, which contains the Parallel-Exclusion-List-Field. The Parallel-Exclusion-List contains a series of Method-Signature-Items that each represent an illegal parallel exclusion indicating that a method may not execute until various blocking methods have been completed. The UPT-Cycler checks each of these Method-Signature-Items against the single Method-Signature-Item of the current UPT-Method-Call-Item awaiting execution. This comparison is done by reference only and the actual Method-Signature-Items are not scanned to ensure isomorphism. Providing no Method-Signature-Item is matched, then the method may be launched. If the UPT-Cycler encounters an excessive number of currently executing methods, then it shifts the Cursor Rightwards for each check until it no longer has any remaining time within the current Digital-Business-Cycle. The next time the UPT-Method-Call-Item is encountered, the UPT-Cycler resumes the launch check from the UPT-Method-Call-Item identified by the spawned Cursor. If the UPT-Cycler encounters blocked method execution, then it may choose to execute the currently executing UPT method so as not to waste the current Digital-Business-Cycle.

Method Launching

The method is launched once the UPT-Cycler has determined that there are no conflicting methods that are currently executing. The UPT-Cycler creates a UPT-Method (11350 of FIG. 59) and inserts this into the Leftmost position of the stack, regardless of whether the UPT-Method-Call-Item was on the stack or pseudo stack of another executing UPT-Method. The UPT-Cycler then deletes the original UPT-Method-Call-Item.

UPT-Method

The UPT-Method superstructure (11350 of FIG. 59) is constructed by the UPT-Cycler. The Pseudo-Stack (11352 of FIG. 59) is created with the Utilised-Method-Stack-Drop-UPT and the Startup-UPT (11336 of FIG. 58) inserted in the Leftmost positions (in that order). These UPTs are found in the UPT-Method-Call-Item that is responsible for generating this UPT-Method. The Method-Values (11354 of FIG. 59 and 11200 of FIG. 57) are all newly created with the exception of the Index-Start-Point for the Output-Field, which is retrieved from the UPT-Method-Call-Item. The Object that is hosting the UPT-Method-Call-Item is inserted into the Object-Field (11356 of FIG. 59). This is obtained from the Object-Field (11341 of FIG. 58) of the UPT-Method-Call-Item. The Index-Start-Point of the Static-Variable-List-Field (11357 of FIG. 59) is retrieved from the Static-Variable-List-Field (11339 of FIG. 58) of the UPT-Method-Call-Item and the Current-Method-Call-List is retrieved from the Current-Method-Call-List-Spawn-Cursor-Field (11343 of FIG. 58) of the UPT-Method-Call-Item and is inserted into the Spawned-Current-Method-Call-List-Field (11359 of FIG. 59).

The UPT-Method effectively replaces the UPT-Method-Call-Item on the stack.

Method-Frame-Indexing

Each method frame shares the same code as every other method frame. The program counter is represented by a spawned Cursor available for each method frame to identify its currently executing instruction. However, the parameters, local variables and return values (Data Segment) require hardware support to reference the actual values, as they cannot be stored in the method code (Code Segment). This separation of the Data Segment and Code Segment is performed by four Types that are assigned to the Value of a Field of any UPT executing inside the Pseudo-Stack (1352 of FIG. 59):
Type-Inputs-Field for reading parameters for a method.
Type-Locals-Field for reading and writing local variables.
Type-Outputs-Field for returning values from a method.
Type-Global-Field for enabling global variable access.

Method-Frame-Indexes are therefore used in situ within the UPT on an executing stack, enabling the UPT to locate the actual value from the correct method frame. The UPT-Cycler locates the correct Manabars-Set by using the index established as a Whole on the Value. The actual Manabars-Set is found in the Method-Values of the UPT-Method.

When the Type-Inputs-Field, Type-Locals-Field, Type-Outputs-Field or Type-Global-Field are encountered directly on the stack outside of an embedded pseudo stack, then the entire UPT that holds these Method-Frame-Indexes is ignored.

Method-Frame-Indexes enable method code to execute in parallel without data corruption occurring across UPT Fields that may be used simultaneously by multiple method frames or by UPTs that are dependent on output from other UPTs in a previous execution.

APPENDIX E
AVMF MANDATORY INSTRUCTIONS
Key

| Term | Reference |
|---|---|
| AI-Memory | 270 of FIG. 2 |
| AI-Stack | 340 of FIG. 2 |
| AVMF-Variables | 250 of FIG. 2 |

AVMI-UPT Summary

| AVMI-UPT | Description |
|---|---|
| | AVMF-Variable Management |
| AVMI-W-Store | Takes an item off the AI-Stack and stores it in an AVMF-Variable. The argument for this AVMI identifies the |
| AVMI-F-Store | variable¹ to be assigned as index into the 64-bit AI-Memory. |
| AVMI-W-Load | Takes an item from the AVMF-Variables and places it on top of the AI-Stack. |
| AVMI-F-Load | |
| | Stack Management |
| AVMI-W-Push | Places the argument on top of the AI-Stack. |
| AVMI-F-Push | |
| AVMI-Pop | Removes the topmost element of the AI-Stack. |
| AVMI-Swap | Swaps the topmost two elements of the AI-Stack. |
| AVMI-Dup | Duplicates the topmost element of the AI-Stack. |
| | Number Processing |
| AVMI-W-Add | Removes the topmost 2 elements of the AI-Stack and replaces them with their sum. |
| AVMI-F-Add | |
| AVMI-W-Sub | Removes the topmost 2 elements of the AI-Stack and replaces them with their difference. |
| AVMI-F-Sub | |
| AVM-W-Mul | Removes the topmost 2 elements of the AI-Stack and replaces them with their product. |
| AVMI-F-Mul | |
| AVMI-W-Div | Removes the topmost 2 elements of the AI-Stack and replaces them with their division. |
| AVMI-F-Div | |
| AVMI-W-Rem | Removes the topmost 2 elements of the AI-Stack and replaces them with their remainder. |
| AVMI-F-Rem | |
| AVMI-W-Neg | Removes the top element off the AI-Stack and replaces it with its negation. |
| AVMI-F-Neg | |
| | Bit Manipulation |
| AVMI-W-Shl | Shifts the bits Leftwards by a specific amount. |
| AVMI-W-Shr | Shifts the bits Rightwards by a specific amount. |
| AVMI-W-And | Removes the topmost two elements of the AI-Stack and replaces them with their logical AND. |
| AVMI-W-Or | Removes the topmost two elements of the AI-Stack and replaces them with their logical OR. |
| AVMI-W-Xor | Removes the topmost two elements of the AI-Stack and replaces them with their logical XOR. |
| | Casting |
| AVMI-W-to-F | Replaces the topmost Whole of the AI-Stack and replaces it with its equivalent Float. |
| AVMI-F-to-W | Replaces the topmost Float of the AI-Stack and replaces it with its equivalent Whole. |
| | Arrays |
| AVMI-Array-Len | Retrieves the length of an array. |
| AVMI-W-Array | Creates an array of elements with a specific size. |
| AVMI-F-Array | |
| AVMI-W-Astore | Stores a value to a specific index in an array. |
| AVMI-F-Astore | |
| AVMI-W-Aload | Places a value from a specific index in an array onto the Operand-Stack. |
| AVMI-F-Aload | |
| | Control |
| AVMI-W-Gt | Branches the flow of control if the topmost AI-Stack item is greater than the next AI-Stack item. |
| AVMI-F-Gt | |
| AVMI-W-Gtoe | Branches the flow of control if the topmost AI-Stack item is greater than or equal to the next AI-Stack item. |
| AVMI-F-Gtoe | |
| AVMI-W-Lt | Branches the flow of control if the topmost AI-Stack item is less than the next AI-Stack item. |
| AVMI-F-Lt | |
| AVMI-W-Ltoe | Branches the flow of control if the topmost AI-Stack item is less than or equal to the next AI-Stack item. |
| AVMI-F-Ltoe | |
| AVMI-Goto | Unconditionally branches the flow of control to another location. |
| AVMI-Not-Null | Branches the flow of control if the topmost AI-Stack is not equal to null. |
| AVMI-Null | Branches the flow of control if the topmost AI-Stack is equal to null. |
| AVMI-W-Equal | Branches the flow of control if the top 2 AI-Stack items are equal. |
| AVMI-F-Equal | |
| AVMI-W-Not-Equal | Branches the flow of control if the top 2 AI-Stack items are not equal. |
| AVMI-F-Not-Equal | |
| AVMI-Subroutine | Causes the flow of control to jump to a new location and leaves the address from where it came on the AI-Stack. |
| AVMI-Return | Returns the flow of control to the point prior to the call of a subroutine with AU-Subroutine. |
| AVMI-Exit | Exits execution and copies Output-Return-Data to the appropriate Manabars-Set. |
| | Scoped-FABS-Access |
| AVMI-FABS-Input | Determines the Fast-ABS sequence to become the new 64-bit block input channel. |
| AVMI-FABS-Output | Determines the Fast-ABS sequence to become the new 64-bit block output channel. |
| AVMI-Write-FABS-W | Writes a series of 64-bit Wholes to the currently selected Fast-ABS output channel. |
| AVMI-Write-FABS-F | Write a series of 64-bit Floats to the currently selected Fast-ABS output channel. |
| AVMI-Read-FABS-W | Read a series of 64-bit Wholes from the currently selected Fast-ABS input channel. |
| AVMI-Read-FABS-F | Read a series of 64-bit Floats from the currently selected Fast-ABS input channel. |

Stack Type Behaviour

| | | | | | Argument-#1- | Argument-#2- | |
|---|---|---|---|---|---|---|---|
| AVMI-UPT | Off-#1-Type | Off-#2-Type | Off-#3-Type | On-#1-Type | AVMI | AVMI | Stack-Change |
| | | | AVMF-Variable Management | | | | |
| AVMI-W- | W | | | | W⁴ | | −1 |
| Store | | | | | | | |
| AVMI-F-Store | F | | | | W⁵ | | −1 |
| AVMI-W- | | | | W | W⁶ | | +1 |
| Load | | | | | | | |
| AVMI-F-Load | | | | F | W⁷ | | +1 |
| | | | Stack Management | | | | |
| AVMI-W- | | | | W | W | | +1 |
| Push | | | | | | | |
| AVMI-F-Push | | | | F | F | | +1 |
| AVMI-Pop | W or F | | | | | | −1 |
| AVMI-Swap | | | | | | | 0 |
| AVMI-Dup | | | | W or F | | | +1 |
| | | | Number-Processing-AU | | | | |
| AVMI-W-Add | W | W | | W | | | −1 |
| AVMI-F-Add | F | F | | F | | | −1 |
| AVMI-W-Sub | W | W | | W | | | −1 |
| AVMI-F-Sub | F | F | | F | | | −1 |
| AVMI-W-Mul | W | W | | W | | | −1 |
| AVMI-F-Mul | F | F | | F | | | −1 |
| AVMI-W-Div | W | W | | W | | | −1 |
| AVMI-F-Div | F | F | | F | | | −1 |
| AVMI-W-Rem | W | W | | W | | | −1 |
| AVMI-F-Rem | F | F | | F | | | −1 |
| AVMI-W-Neg | W | W | | W | | | 0 |
| AVMI-F-Neg | F | F | | F | | | 0 |
| | | | Bit-Manipulation-AU | | | | |
| AVMI-W-Shl | W⁸ | W⁹ | | W | | | −1 |
| AVMI-W-Shr | W | W | | W | | | −1 |
| AVMI-W-And | W | W | | W | | | −1 |
| AVMI-W-Or | W | W | | W | | | −1 |
| AVMI-W-Xor | W | W | | W | | | −1 |
| | | | Casting-AU | | | | |
| AVMI-W-to-F | W | | | F | | | 0 |
| AVMI-F-to-W | F | | | W | | | 0 |
| | | | Array-AU | | | | |
| AVMI-Array- | AF or AW | | | W¹⁰ | | | |
| Len | | | | | | | |
| AVMI-W- | W | | | AW | | | 0 |
| Array | | | | | | | |
| AVMI-F- | W | | | AF | | | 0 |
| Array | | | | | | | |
| AVMI-W- | W¹¹ | W¹² | AW¹³ | | | | −3 |
| Astore | | | | | | | |
| AVMI-F- | F | W | AF | | | | −3 |
| Astore | | | | | | | |
| AVMI-W- | W¹⁴ | AW¹⁵ | | W¹⁶ | | | −2 |
| Aload | | | | | | | |
| AVMI-F- | W | AF | | F | | | −2 |
| Aload | | | | | | | |
| | | | Control-AU | | | | |
| AVMI-W-Gt | W | W | | | L | | −2 |
| AVMI-F-Gt | F | F | | | L | | −2 |
| AVMI-W-Gtoe | W | W | | | L | | −2 |
| AVMI-F-Gtoe | F | F | | | L | | −2 |
| AVMI-W-Lt | W | W | | | L | | −2 |
| AVMI-F-Lt | F | F | | | L | | −2 |
| AVMI-W-Ltoe | W | W | | | L | | −2 |
| AVMI-F-Ltoe | F | F | | | L | | −2 |
| AVMI-Not- | AW or AF | | | | L | | −1 |
| Null | | | | | | | |
| AVMI-Null | AW or AF | | | | L | | −1 |
| AVMI-W- | W | W | | | L | | −2 |
| Equals | | | | | | | |
| AVMI-F- | F | F | | | L | | −2 |
| Equals | | | | | | | |
| AVMI-W-Not- | W | W | | | L | | −2 |
| Equal | | | | | | | |
| AVMI-F-Not- | F | F | | | L | | −2 |
| Equal | | | | | | | |
| AVMI-Goto | | | | | L | | 0 |
| AVMI- | | | | L¹⁷ | L¹⁸ | | 1 |
| Subroutine | | | | | | | |
| AVMI-Return | L¹⁹ | | | | | | −1 |
| AVMI-Exit | | | | | | | 0 |
| | | | Scoped-FABS-Access | | | | |
| AVMI-FABS- | W | | | | | | −1 |
| Input | | | | | | | |
| AVMI-FABS- | W | | | | | | −1 |
| Output | | | | | | | |
| AVMI-Write- | W | AW | | | | | −2 |
| FABS-W | | | | | | | |
| AVMI-Write- | W | AF | | | | | −2 |
| FABS-F | | | | | | | |
| AVMI-Read- | W | | | AW | | | 0 |
| FABS-W | | | | | | | |
| AVMI-Read- | W | | | AF | | | 0 |
| FABS-F | | | | | | | |

W Whole
L Location²
F Float
T Trilarity
P Polarity/Boolean³
All Fast-ABS sequences are indexed by the 1^{st} stack item - a Whole that points to the index of the FABS-Parameters (see UPT-AVM of Appendix B) Value, where 1 is the Leftmost Child and 2 is the Child to the Right of the Leftmost Child. At any stage, if the Fast-ABS is indexed with a value for which there is no Child, then the Fast-ABS sequence is considered to be null.
¹Contains a Whole to represent the index.
²A Whole that represents an AVMF index to move the Program-Counter to (310 of FIG. 2).
³Left is equivalent to True
⁴The index into the AVMF-Variable to store the value.
⁵Same as AVMI-W-Store
⁶The index into the AVMF-Variable to locate the value.
⁷Same as AVMI-W-Store
⁸The item to be shifted
⁹The number of bits that the item is to be shifted
¹⁰The size of the array.
¹¹The value to be assigned
¹²The index of the array
¹³The reference that holds the array object
¹⁴The index of the array
¹⁵The reference that holds the array object
¹⁶The value that is returned to the top of the Operand-Stack
¹⁷The current location
¹⁸The target AVMI index
¹⁹The location to return to.

Appendix F

HCM Implementation Scenario

The following is an example of a Mesh-Blueprint and HCM implementation. The actual specification should change as more sensory equipment is invented. Each alteration should only increase the sensory resolution, but leave the format unchanged—enabling backwards and forwards compatibility.

Sensory-Experience

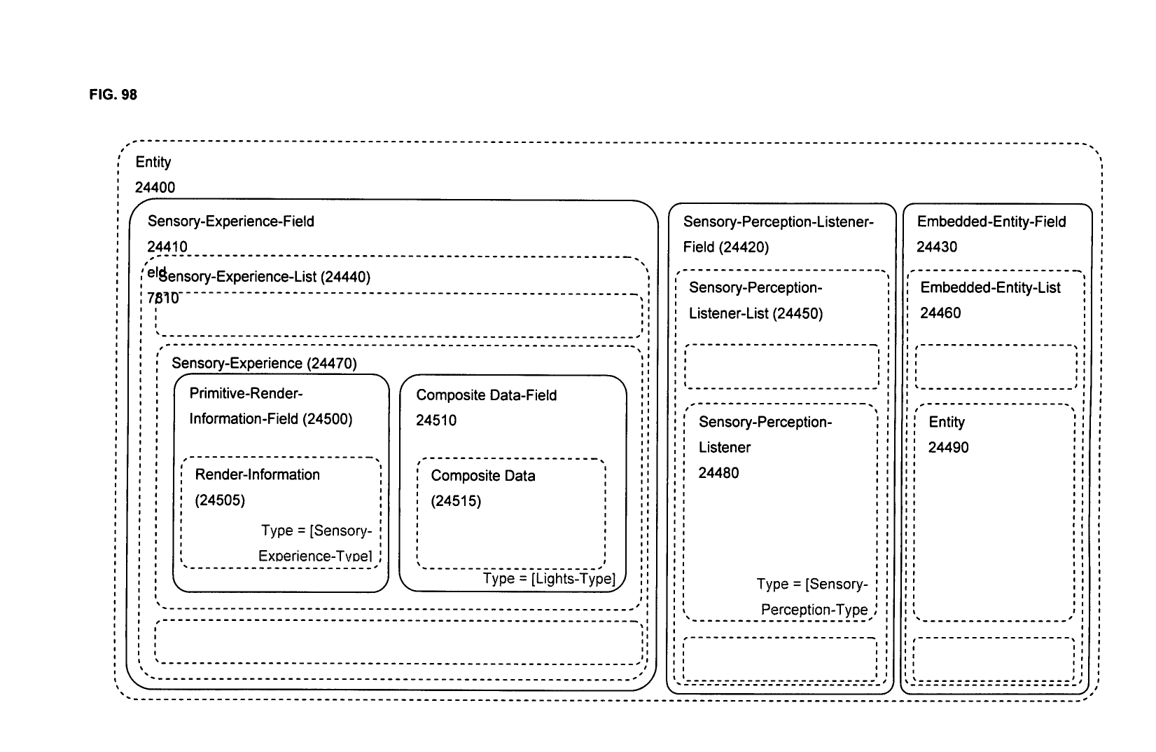

The Sensory-Experience (24470 of FIG. 98) contains the actual data to describe all objects as being perceived through human senses.

Sensory-Perception

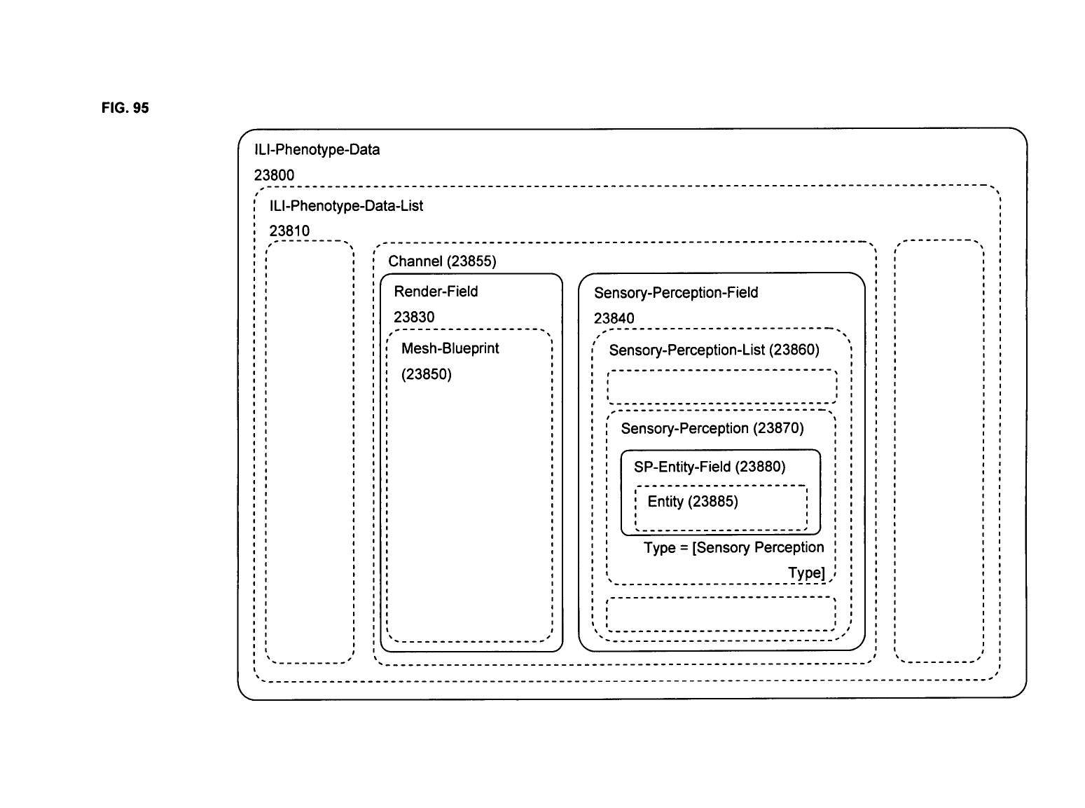

The Sensory Perception (23870 of FIG. 95) contains data generated from the user that has the ability to alter the Sensory-Experience (24470 of FIG. 98). These Sensory-Perceptions can include an anger perception to detect shouting or swearing, an action perception to detect a mouse click or touching of the screen. The types of Sensory-Perceptions are unlimited and only restricted by the ability of the hardware installed.

Mesh-Blueprint

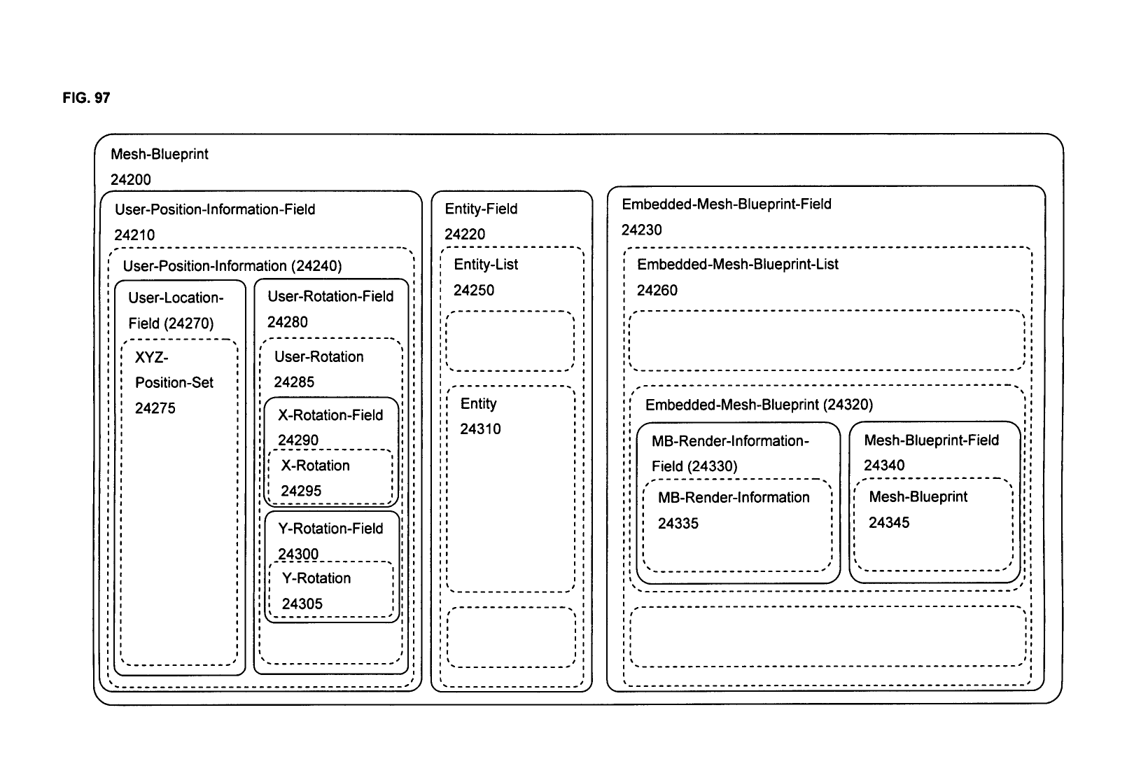

The Mesh-Blueprint (24200 and 24345 of FIG. 97 and 23850 of FIG. 95) contains all data required to deliver a Sensory-Experience (24470 of FIG. 98) and capture the Sensory-Perception (23870 of FIG. 95).

Channel

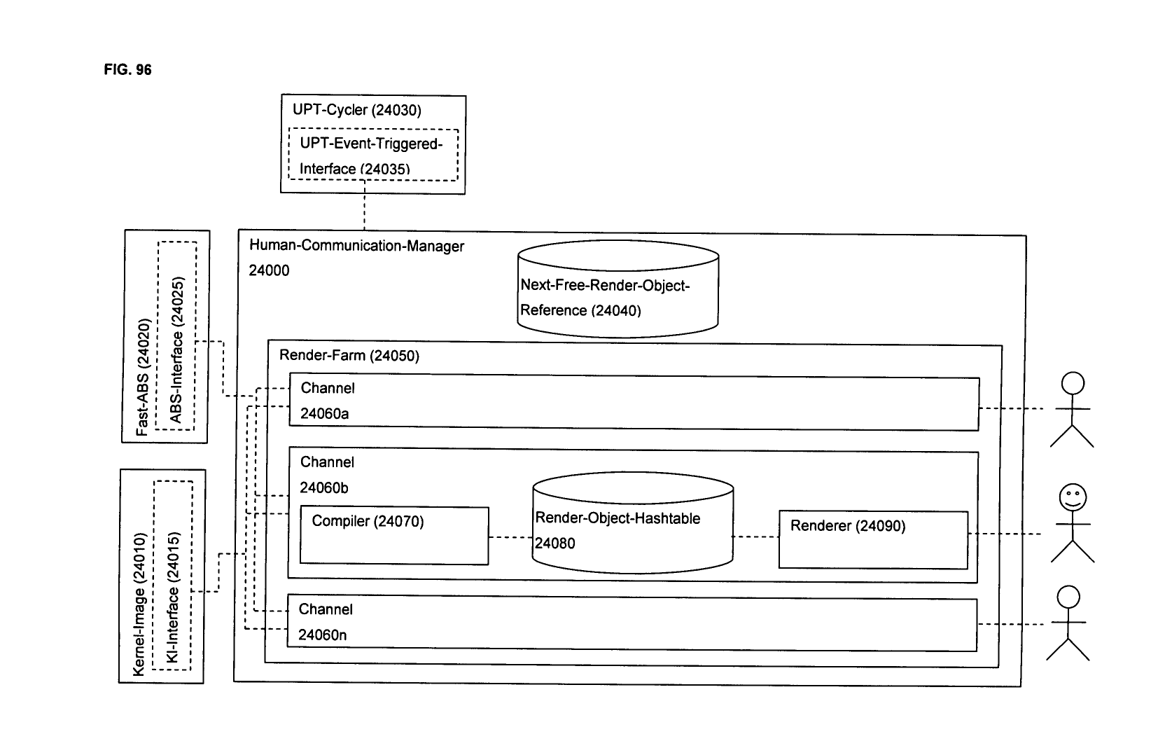

A Channel (24060a-24060n of FIG. 96) is an output device that is connected to the invention within the HCM implementation and may include such items as monitors, speakers, overhead projectors or touch screens. Any output device can be invented and attached. The ILI-Phenotype (6860 of FIG. 35) of the Global-Static-Store (6440 of FIG. 33 and 6800 of FIG. 35) contains an ILI-Phenotype-Data-List (23810 of FIG. 95), which is a list of Channels (23855 of FIG. 95) that are connected to the invention. The Portal inserts the Mesh-Blueprint (23850 of FIG. 95 and 24200 of FIG. 97) into the Render-Field (23830 of FIG. 95) of the Channel. This Mesh-Blueprint (in this example implementation) contains the User-Position-Information (24240 of FIG. 97) that the Human-Communication-Manager (24000 of FIG. 96) utilises when projecting the Sensory-Experience. The Mesh-Blueprint also contains embedded Mesh-Blueprints (24320 of FIG. 97) that the Human-Communication-Manager scans to render all necessary Sensory-Experiences (24470 of FIG. 98). The Mesh-Blueprint (24200 and 24345 of FIG. 97) also contains an Entity-List (24250 of FIG. 97) that contains every Entity (24400 and 24490 of FIG. 98 and 24310 of FIG. 97) that is to be rendered.

Entity

An Entity (24400 and 24490 of FIG. 98 and 24310 of FIG. 97) is one particular Object to be rendered in any Channel (24060a-24060n of FIG. 96). An example of an Entity may be a car on a racetrack. The Entity consists of three Fields explained below:
(1) The Sensory-Experience-Field (24410 of FIG. 98) contains a list of Sensory-Experiences (24470 of FIG. 98), which holds the Render-Information (24505 of FIG. 98) and the Composite-Data (24515 of FIG. 98). The Composite-Data contains information stored in Fast-ABS (850 of FIG. 5) that specifies what the Sensory-Experience (24470 of FIG. 98) is. In the car example above, the Composite-Data for the Entity would contain information about what the car looks like, smells like or sounds like. The Render-Information (24505 of FIG. 98) gives the Human-Communication-Manager (24000 of FIG. 96) extra data such as the location, size and volume. This data is dependant on the Type of the Sensory-Experience (24470 of FIG. 98) and how it is defined. In the example of the car Entity, two cars may be created with the same Composite-Data (24515 of FIG. 98) but with different Render-Information (24505 of FIG. 98), which makes the car look the same, but placed on the racetrack in different positions. This Render-Information (24505 of FIG. 98) is combined with the User-Position-Information (24240 of FIG. 97) to remap the projection to a global location in the virtual universe. Each Channel (24060a-24060n of FIG. 96) may scan through the Sensory-Experience-List (24440 of FIG. 98) and only utilise the information relevant to the specific Channel. For example headphones would only use the Sensory-Experience (24470 of FIG. 98) with a Type of Type-Sound-Experience and ignore all Sensory-Experiences with a Type of Type-Visual-Experience, whereas a computer monitor or printer may utilise the information stored in the Sensory-Experiences with a Type of Type-Visual-Experience and Type-Sound-Experience. There are no limitations to the amount of Sensory-Experiences that the Channel (24060a-24060n of FIG. 96) may use.
(2) The Sensory-Perception-Listener-Field (24420 of FIG. 98) consists of a List of Sensory-Perception-Listeners (24480 of FIG. 98) that contain information about what occurs when the user affects the Entity (24400 of FIG. 98). In the car example, a user may open the door of the car, thereby causing the Render-Information (24505 of FIG. 98) of the door Entity to be altered. These Perception-Listeners are activated through the use of Monitors when the relative Entity (24400 and 24490 of FIG. 98 and 23885 of FIG. 95) is inserted into the SP-Entity-Field (23880 of FIG. 95) of the Sensory-Perception (23870 of FIG. 95) in the Sensory-Perception-List (23860 of FIG. 95).
(3) The Embedded-Entity-Field (24430 of FIG. 98) contains a List of Entities (24490 of FIG. 98) that is affected by the outermost Entity (24400 of FIG. 98). In the car example, an embedded Entity may be the door of the car. The door is attached to the car and moves with the car when the car moves. However, the door also has its own Sensory-Experiences (24470 of FIG. 98) that are separate from the overall car. These Sensory-Experiences allow the door to be opened and closed and may include the sound of the door opening and the smell of the rich leather seats inside.
   Render-Information

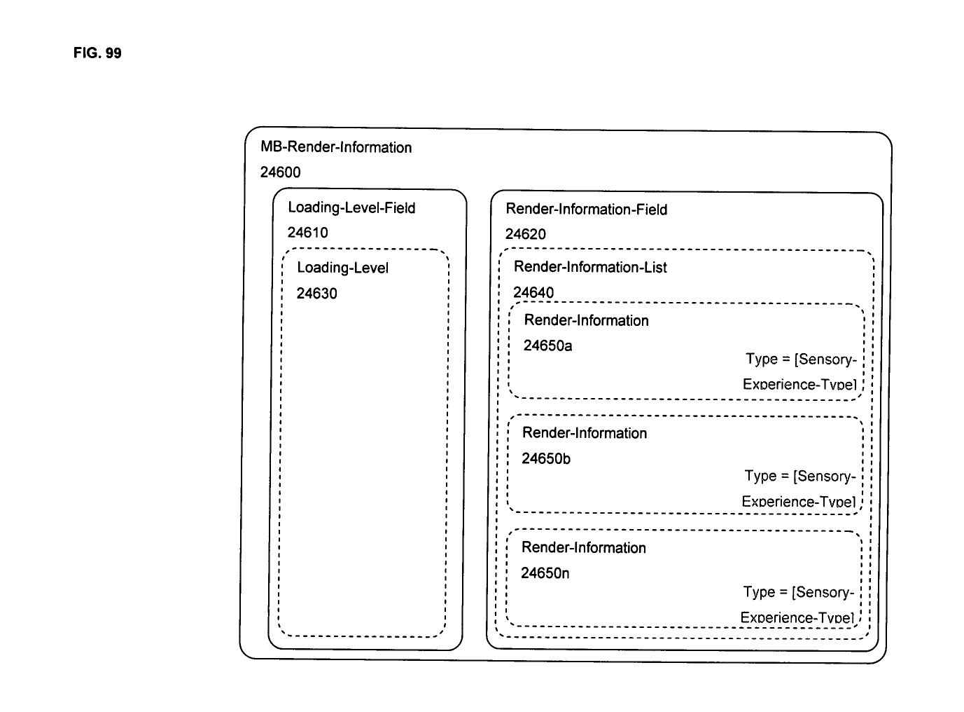

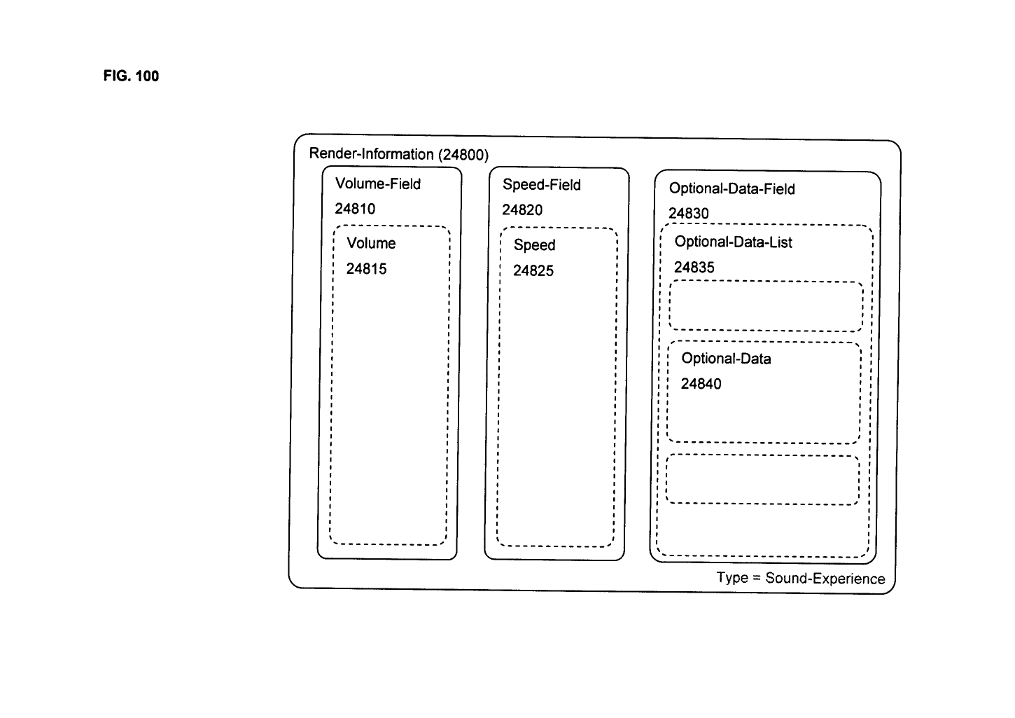

The Render-Information (24505 of FIG. 98 and 24650a-24650n of FIG. 99 and 24800 of FIG. 100 and 25000 of FIG. 101) is used inside the Sensory-Experience (24470 of FIG. 98) of the Entity (24400 of FIG. 98) and inside the MB-Render-Information (24335 of FIG. 98 and 24600 of FIG. 99) of Embedded-Mesh-Blueprints (24320 of FIG. 97). It contains all data used to render the Mesh-Blueprint (24345 of FIG. 97) contained in the Mesh-Blueprint-Field (24340 of FIG. 97).

The MB-Render-Information (24335 of FIG. 98 and 24600 of FIG. 99) holds all other Render-Information that is dependent on the type of the Sensory-Experience (24470 of FIG. 98). For example, a Sensory-Experience with the Type of Type-Sound-Experience determines the volume by the Volume-Field (24810 of FIG. 100) and the playback speed by the Speed-Field (24820 of FIG. 100).

Alternatively, a Sensory-Experience with a Type of Type-Visual-Experience holds the Scale (25015 of FIG. 101), Location via the Location-Field (25020 of FIG. 101), Rotation via the Rotation-Field (25030 of FIG. 101) and overall Appearance (25045 of FIG. 101 and 25200 of FIG. 102) for the rendered object. Furthermore, the Appearance include the Texture (25215 of FIG. 102 and 25400), Colour via the Colour-Field (25240 of FIG. 102), Material (25225 of FIG. 102), Lights (25320 of FIG. 102) via the Lights-List (25235 of FIG. 102) and Transparency (25255 of FIG. 102) of the rendered object.

The Render-Information of the Entity (24400 of FIG. 98) may be reused for all embedded Entities contained in the Embedded-Entity-List (24460 of FIG. 98), unless the embedded Entity contains its own Render-Information. In the given example of the car Entity, the car may have the colour Blue specified in the Render-Information. The door may default to the same colour blue, which means that the Render-Information does not have to be repeated again, or the door Entity may contain data in its own Render-Information that specifies that the door is red—to override the default colour of blue.

RGB-Set

| | |
|---|---|
| Description | Specifies the level of Red, Green and Blue. |

| Child Location | Parameter Name | Description |
|---|---|---|
| 1 | Red-Field | The Value has a Float that indicates |
| | | the amount of Red to be used. |
| 2 | Green-Field | The Value has a Float that indicates |
| | | the amount of Green to be used. |
| 3 | Blue-Field | The Value has a Float that indicates |
| | | the amount of Blue to be used. |

XYZ-Set

| | |
|---|---|
| Description | Contains X, Y and Z co-ordinates. |

| Child Location | Parameter Name | Description |
|---|---|---|
| 1 | X-Field | The Value has a Float that indicates |
| | | a point along a horizontal scale. |
| 2 | Y-Field | The Value has a Float that indicates |
| | | a point along a vertical scale. |
| 3 | Z-Field | The Value has a Float that indicates |
| | | the distance of a point. |

ATTENUATION-SET

| Description | Specifies the intensity of light decreases with distance | |
|---|---|---|
| Child Location | Parameter Name | Description |
| 1 | Constant-Field | The Value holds a Float that is |
| | | subtracted from the intensity of the |
| | | light irrespective of distance. |
| 2 | Linear-Field | The Value holds a Float that is |
| | | subtracted for every unit moved away |
| | | from the light source. |
| 3 | Quadratic-Field | The Value holds a Float that is |
| | | subtracted as a function of a square of |
| | | the distance from the light. |

AMBIENT-LIGHT

| Type | 40500 | |
|---|---|---|
| Description | Defines an Ambient-Light that provides background | |
| | lighting with no particular direction. | |
| Child Location | Parameter Name | Description |
| 1 | Colour | This Value is an RGB-Set that holds |
| | | information about the colour of |
| | | the Light. |

DIRECTIONAL-LIGHT

| Type | 40530 | |
|---|---|---|
| Description | A Light, such as a torch, shining in a specific direction. | |
| Child Location | Parameter Name | Description |
| 1 | Colour | The Value is an RGB-Set that holds |
| | | information about the colour of |
| | | the Light. |
| 2 | Direction | The Value is a XYZ-Set that holds |
| | | information about the direction |
| | | the light is pointing to. |

POINT-LIGHT

| | |
|---|---|
| Type | 40510 |
| Description | Light eminating from a single point |

| Child Location | Parameter Name | Description |
|---|---|---|
| 1 | Colour | The Value is an RGB-Set that holds |
| | | information about the colour of |
| | | the Light. |
| 2 | Position | The Value is a XYZ-Set that holds |
| | | information about where the light |
| | | is situated. |
| 3 | Attenuation | The Value is an Attenuation-Set |
| | | that holds information about how |
| | | the intensity of light |
| | | decreases with distance. |

SPOT-LIGHT

| | |
|---|---|
| Type | 40520 |
| Description | A highly configurable directional light. |

| Child Location | Parameter Name | Description |
|---|---|---|
| 1 | Colour | The Value is an RGB-Set that |
| | | holds information about the colour |
| | | of the Light. |
| 2 | Position | The Value is a XYZ-Set that holds |
| | | information about where the light |
| | | is situated. |
| 3 | Attenuation | The Value is an Attenuation-Set |
| | | that holds information about how |
| | | the intensity of light decreases |
| | | with distance. |
| 4 | Direction | The Value is a XYZ-Set that |
| | | holds information about the |
| | | direction the light is pointing to. |
| 5 | Spread-Angle-Field | The Value holds a Float that |
| | | indicates the width of the beam as |
| | | a Radius. |
| 6 | Concentration-Field | The Value holds a Float that |
| | | indicates the strength of the light. |

Appendix G

This appendix comprises our Co-pending application entitled “A COMPUTATION DEVICE FOR THE MANAGEMENT FOR THE MANAGEMENT OF SETS” filed Oct. 2, 2006 in the name of Manabars IP Limited, the contents of which are incorporated herein in their entirety.

[image]

[image]

[image]

1. A Universal Virtual Computer (UVC) having means to produce a homogeneous grid environment from a set of heterogeneous hosts by enabling computational completeness via a common execution format.

2. A UVC as claimed in claim 1 wherein the common execution format can be simulated on any machine in the grid environment through cross-compilation.

3. A UVC as claimed in claim 1 having means to support an Operating System that serves mobile agents that are able to transcode from hosts on a peer-to-peer network.

4. A UVC as claimed in claim 2 having means to support an Operating System that serves mobile agents that are able to transcode from hosts on a peer-to-peer network.

5. A Universal Virtual Computer comprising a memory store of Sets, a central processor that enables computational completeness and means to transmit instructions to a multitude of components to be completed asynchronously.

6. A UVC in a grid network including means to prevent undesirable hosts from joining the grid network, as directed by the Operating System.

7. A UVC as claimed in claim 2 capable of computational completeness and fully operational without extension.

8. A UVC as claimed in claim 7 extended such that some components allow for the compilation and execution of binaries designed for von Neumann processors.

9. A UVC as claimed in claim 8 wherein the compilation and execution of binaries is derived from an abstract set of machine instructions that can be reproduced on various von Neumann processors.

10. A UVC where a first component processes instructions either synchronously or asynchronously so that synchronous instructions are completed immediately and asynchronous instructions are forwarded to one or more additional components to be completed in parallel while the first component completes further instructions.

11. A UVC that supports a plurality of mobile agents and assigns an account to each mobile agent, and means to add and/or deduct resources to or from the account upon purchase of resources.

12. A UVC as claimed in claim 11 wherein the mobile agent is destroyed when the account has a null balance.

13. A UVC as claimed in claim 1 including multiple components that each provide a resource made available via a market orientated mechanism including but not limited to bandwidth, computation and memory.

14. A UVC as claimed in claim 13 including a Realtime-Marketplace that allows mobile agents to purchase the resource for a specific time period and up to a limited level that is negotiated by the mobile agent prior to resource usage enabling the resource to be drawn on demand.

15. A UVC as claimed in claim 13 including a Prepaid-Marketplace that allows mobile agents to reserve the resource at a required level for a specific time period, for which a price is determined prior to purchasing the resource.

16. A UVC as claimed in claim 13 wherein the purchase can be represented by the Universal Virtual Computer as an identifier to be sold in an open digital marketplace, later to be reclaimed by any mobile agent that presents the same identifier.

17. A UVC as claimed in claim 14 wherein the purchase can be represented by the Universal Virtual Computer as an identifier to be sold in an open digital marketplace, later to be reclaimed by any mobile agent that presents the same identifier.

18. A UVC as claimed in claim 15 wherein the purchase can be represented by the Universal Virtual Computer as an identifier to be sold in an open digital marketplace, later to be reclaimed by any mobile agent that presents the same identifier.

19. A UVC as claimed in claim 13 wherein the capacity of the resource can be recharged at the discretion of the host environment.

20. A UVC as claimed in claim 14 wherein the resource can be made available at a cost effective rate using a standby model where resource availability is erratic and distributed as the remainder after the Realtime-Marketplace has been satisfied.

21. A UVC as claimed in claim 15 wherein the resource can be made available at a cost effective rate using a standby model where resource availability is erratic and distributed as the remainder after the Prepaid-Marketplace has been satisfied.

22. A UVC as claimed in claim 20 wherein resource can be made available at a more cost effective rate using an idle model where resource availability is not only erratic but can experience major lulls and distributed as the remainder after the Realtime-Marketplace has been satisfied.

23. A UVC as claimed in claim 21 wherein resource can be made available at a more cost effective rate using an idle model where resource availability is not only erratic but can experience major lulls and distributed as the remainder after the Prepaid-Marketplace has been satisfied.

24. A UVC as claimed in claim 13 wherein the resource can be made available at the most cost effective rate for one or more marketplaces for the resource using a background model where resource availability is totally unreliable and is distributed as a remainder after all other marketplaces have been satisfied.

25. A UVC as claimed in claim 13 wherein the purchase transaction includes a reimbursement price for which the mobile agent is willing to accept in exchange for the unexpected cancellation of either the purchase transaction as a realtime contract or as a prepaid contract.
